(19) United States
(12) Patent Application Publication
(10) Pub. No.: US 2025/0313978 A1
(43) Pub. Date: Oct. 9, 2025

(54) ENERGY-EFFICIENT FLOW CELL SYSTEM WITH SELF-SUSTAINING POWER CYCLE

(71) Applicant: Lyten, Inc., San Jose, CA (US)

(72) Inventors: Jesse Baucom, Santa Clara, CA (US); Sanjeev Kolli, Santa Clara, CA (US); Engin Tuncer, Milpitas, CA (US); Karel Vanheusden, Woodside, CA (US)

(21) Appl. No.: 19/241,250

(22) Filed: Jun. 17, 2025

Related U.S. Application Data
(63) Continuation-in-part of application No. PCT/US2024/059011, filed on Dec. 6, 2024.
(63) Continuation-in-part of application No. 18/793,550, filed on Aug. 2, 2024.
Application No. 18/793,550 is a continuation of application No. 18/516,724, filed on Nov. 21, 2023, now Pat. No. 12,110,603.
Application No. 18/516,724 is a division of application No. 17/948,030, filed on Sep. 19, 2022, now Pat. No. 11,827,991.
(60) Provisional application No. 63/607,008, filed on Dec. 6, 2023.
(60) Provisional application No. 63/607,453, filed on Dec. 7, 2023.
(60) Provisional application No. 63/607,464, filed on Dec. 7, 2023.
(60) Provisional application No. 63/607,475, filed on Dec. 7, 2023.

(51) Int. Cl. C25C 1/02; C25C 7/02; H01M 10/54

(52) U.S. Cl. CPC C25C 1/02; C25C 7/02; H01M 10/54

(57) ABSTRACT

The present disclosure introduces an innovative green flow cell system for ion extraction and reclamation that significantly reduces energy consumption and environmental impact. The system utilizes at least two cationic selective membranes configured for multiple ion species and is arranged with a unique power supply capable of providing initial startup energy, powering ion extraction, and reclaiming energy during ion reclamation processes. This innovative self-sustaining energy cycle allows the system to operate with minimal external power input. Unlike conventional ion extraction systems, this innovative solution overcomes high energy consumption, limited scalability, and single-directional operation. The system's dual cationic selective membranes, combined with the regeneration of the specific active materials, address the traditional inefficiencies, enabling unprecedented energy efficiency, operational flexibility, and high product purities. By integrating these and other cutting-edge features, this system surpasses existing technologies in efficiency and versatility, opening new possibilities for sustainable ion extraction and purification across a wide range of applications.

### CROSS-REFERENCE TO RELATED APPLICATIONS

This application claims the benefit of and is a continuation in part of PCT Application No. PCT/US2024/059011, entitled “ELECTROCHEMICAL LITHIUM EXTRACTION SYSTEM AND METHOD,” filed on Dec. 6, 2024, which in turn claims the benefit of and priority to: U.S. Provisional Patent Application No. 63/607,008, entitled “ALKALI METAL SORBENT/SOLID ELECTROLYTE DUAL LAYER MEMBRANE,” filed on Dec. 6, 2023; U.S. Provisional Patent Application No. 63/607,453, entitled “NON-FOULING COATING FOR SOLID ELECTROLYTE MEMBRANES,” filed on Dec. 7, 2023; U.S. Provisional Patent Application No. 63/607,464, entitled “PROCESS FOR LITHIUM EXTRACTION,” filed on Dec. 7, 2023; and U.S. Provisional Patent Application No. 63/607,475, entitled “PROCESS FOR LITHIUM EXTRACTION,” filed on Dec. 7, 2023. All such applications are assigned to the assignee hereof, and the entire contents of each of the above applications are hereby incorporated by reference herein.

Additionally, this application is a continuation in part of and claims the benefit of and priority to U.S. patent application Ser. No. 18/793,550, entitled “ENERGY RECLAMATION AND CARBON-NEUTRAL SYSTEM FOR ULTRA-EFFICIENT EV BATTERY RECYCLING,” filed on Aug. 2, 2024, which is a continuation of and claims the benefit of U.S. patent application Ser. No. 18/516,724, entitled “ENERGY RECLAMATION AND CARBON-NEUTRAL SYSTEM FOR ULTRA-EFFICIENT EV BATTERY RECYCLING,” filed on Nov. 21, 2023, which in turn is a divisional continuation of and claims the benefit of priority to U.S. patent application Ser. No. 17/948,030, entitled “ENERGY RECLAMATION AND CARBON-NEUTRAL SYSTEM FOR ULTRA-EFFICIENT EV BATTERY RECYCLING,” filed on Sep. 19, 2023. All such applications are assigned to the assignee hereof, and the entire contents of each of the above applications are hereby incorporated by reference herein.

### FIELD OF THE INVENTION

The present invention relates to lithium extraction systems, and more particularly to an electrochemical process and apparatus for selectively extracting lithium from brine solutions.

### BACKGROUND

Traditionally, lithium has been obtained through two primary methods: hard rock mining and solar evaporation of lithium-rich brines. Hard rock mining involves extracting lithium-containing minerals, such as spodumene, from pegmatite deposits. This process is energy-intensive and can have significant environmental impacts. Solar evaporation, on the other hand, involves pumping lithium-rich brine into large evaporation ponds, where the lithium is concentrated over time as water evaporates. While this method is less energy-intensive, it requires large land areas, consumes significant amounts of water, and can take several months to years to produce usable lithium compounds. Currently, the commercial viability of solar evaporation for lithium extraction is largely restricted to regions in the Andes Mountains, where brines are typically rich in lithium and exhibit low ratios of interfering ions relative to lithium.

As global lithium demand continues to rise, there is a growing need for more efficient and sustainable extraction methods. Many lithium-rich resources, such as geothermal brines and oilfield produced waters, contain relatively low concentrations of lithium or high levels of interfering ions, making traditional extraction methods currently economically unfeasible or environmentally problematic.

Further, conventional critical mineral extraction systems heavily consume energy (in order to separate out, for example, an alkali metal from the feed solution) and/or water (for salar evaporation). As worldwide uses of critical minerals (including alkali metals), and as worldwide uses of lithium in particular (e.g., for electric vehicle of all types), continues to increase, reliance on conventional critical mineral extraction systems will create an unsustainably increasing demand for ever more energy, as well as a strongly unwanted increase in toxic waste streams (such as lithium extraction/leaching from minerals). Moreover, the production of more and more energy as demanded by these conventional extraction systems adds to greenhouse gas emissions (e.g., by fossil fuel fired electric generation facilities).

As such, there is thus a need for addressing these and/or other issues associated with the prior art.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In some aspects, the techniques described herein relate to a membrane for alkali metal extraction, including: a solid electrolyte layer, wherein the solid electrolyte layer is configured to be conductive to an ion of a predetermined alkali metal; and a sorbent layer configured to adsorb the predetermined alkali metal.

In some aspects, the techniques described herein relate to a membrane, wherein the sorbent layer is adjacent to the solid electrolyte layer.

In some aspects, the techniques described herein relate to a membrane, wherein at least one of: the sorbent layer is in contact with a feed solution; the solid electrolyte layer and the sorbent layer are integrated into one cohesive matrix; or the solid electrolyte layer and the sorbent layers are each distinct and separate layers.

In some aspects, the techniques described herein relate to a membrane, wherein the sorbent layer includes sorbent particles that are selective to the predetermined alkali metal.

In some aspects, the techniques described herein relate to a membrane, wherein the sorbent particles are configured to enable reversible adsorption of the ion of the predetermined alkali metal.

In some aspects, the techniques described herein relate to a membrane, wherein the sorbent layer includes a matrix to confine the sorbent particles.

In some aspects, the techniques described herein relate to a membrane, wherein the predetermined alkali metal is lithium.

In some aspects, the techniques described herein relate to a membrane, wherein the sorbent layer includes sorbent particles selected from the group consisting of Al(OH)3, LiAlO2, LiCuO2, Li2MnO3, Li4Mn5O12, Li2SnO3, Li4TiO4, Li3Ti5012, Li7Ti11O24, Li3VO4, Li2TiO3, LiTiO2, Li2FeO3, and Li2Si3O7.

In some aspects, the techniques described herein relate to a membrane, wherein the solid electrolyte layer includes a ceramic material or polymeric material.

In some aspects, the techniques described herein relate to a membrane, wherein the ceramic material is a NASICON-type solid electrolyte.

In some aspects, the techniques described herein relate to a membrane, wherein the NASICON-type solid electrolyte is selected from the group consisting of LATP (Li1.3Al0.3Ti1.7(PO4)3) and LAGP.

In some aspects, the techniques described herein relate to a membrane, wherein the solid electrolyte layer is substantially dense.

In some aspects, the techniques described herein relate to a membrane, wherein the solid electrolyte layer includes solid electrolyte particles embedded in a polymer matrix or the solid electrolyte layer includes a single solid electrolyte particle embedded in the polymer matrix.

In some aspects, the techniques described herein relate to a membrane, further including an anti-fouling layer adjacent to the solid electrolyte layer.

In some aspects, the techniques described herein relate to a membrane, wherein the anti-fouling layer is ionically conductive to the ion of the predetermined alkali metal.

In some aspects, the techniques described herein relate to a membrane, wherein the anti-fouling layer includes a material selected from the group consisting of perfluorinated polymers, super-hydrophilic materials, hydrophobic materials, and carbonaceous materials.

In some aspects, the techniques described herein relate to a membrane, wherein the perfluorinated polymers are perfluorosulfonic acid (PFSA) polymers and further include at least one of Nafion and Aquivion.

In some aspects, the techniques described herein relate to a membrane, wherein the super-hydrophilic materials include at least one of polyethylene glycol (PEG), polyethylene oxide (PEO), poly(DMAPS), poly(2-Methacryloyloxyethyl phosphorylcholine) (pMPC), or polymers made from monomers of at least one of ethylene glycol, ethylene oxide, MPC, or DMAPS.

In some aspects, the techniques described herein relate to a membrane, wherein the hydrophobic materials include at least one of polyethylene, polypropylene, polyether ether ketone (PEEK), and sulfonated polyether ether ketone (SPEEK).

In some aspects, the techniques described herein relate to a membrane, wherein the carbonaceous materials include at least one of graphene, graphene oxide, carbon nano onions, and graphene nanoplatelets.

In some aspects, the techniques described herein relate to a membrane, wherein the solid electrolyte layer is fabricated by a method selected from the group consisting of tape casting, roll-to-roll coating, and die compaction followed by sintering.

In some aspects, the techniques described herein relate to a membrane, wherein the sorbent layer includes a matrix material selected from the group consisting of AmberSep G26 H, Amberlite IRN9687 Li/OH Ion exchange resin, poly(acrylic acid), Nafion, and Aquivion.

In some aspects, the techniques described herein relate to a membrane, wherein the solid electrolyte layer has a thickness between 0.1 mm and 2 mm.

In some aspects, the techniques described herein relate to a membrane, wherein the sorbent layer has a thickness between 0.05 mm and 1 mm.

In some aspects, the techniques described herein relate to a membrane, wherein the solid electrolyte layer has an ionic conductivity for the predetermined alkali metal ion of at least 10-4 S/cm.

In some aspects, the techniques described herein relate to a membrane, wherein the sorbent layer has a capacity to adsorb at least 1 mg of the predetermined alkali metal per gram of sorbent material.

In some aspects, the techniques described herein relate to a membrane, wherein the membrane has a selectivity ratio for the predetermined alkali metal ion over sodium ions of at least 10:1.

In some aspects, the techniques described herein relate to a membrane, wherein the membrane is configured to maintain at least 80% of its initial ion conductivity after exposure to a feed solution containing at least 1000 ppm of calcium ions for 100 hours.

In some aspects, the techniques described herein relate to a membrane, wherein the membrane is configured to extract at least 90% of the predetermined alkali metal ions from a feed solution containing 100 ppm of the predetermined alkali metal.

In some aspects, the techniques described herein relate to a membrane, wherein the membrane is configured to be used in a flow cell system for continuous extraction of the predetermined alkali metal from a feed solution.

In some aspects, the techniques described herein relate to a membrane for alkali metal extraction, including: a solid electrolyte layer, wherein the solid electrolyte layer is configured to be conductive to an ion of a predetermined alkali metal; and an anti-fouling layer adjacent to the solid electrolyte layer, wherein the anti-fouling layer is ionically conductive to the ion of the predetermined alkali metal.

In some aspects, the techniques described herein relate to a membrane, wherein the anti-fouling layer interfaces with a feed solution and is configured as a barrier between the feed solution and the solid electrolyte layer.

In some aspects, the techniques described herein relate to a membrane, wherein the anti-fouling layer includes a material selected from the group consisting of perfluorinated polymers, super-hydrophilic materials, hydrophobic materials, and carbonaceous materials.

In some aspects, the techniques described herein relate to a membrane, wherein the perfluorinated polymers are perfluorosulfonic acid (PFSA) polymers and further include at least one of Nafion and Aquivion.

In some aspects, the techniques described herein relate to a membrane, wherein the super-hydrophilic materials include at least one of polyethylene glycol (PEG), polyethylene oxide (PEO), poly(DMAPS), poly(2-Methacryloyloxyethyl phosphorylcholine) (pMPC), or polymers made from monomers of at least one of ethylene glycol, ethylene oxide, MPC, or DMAPS.

In some aspects, the techniques described herein relate to a membrane, wherein the hydrophobic materials include at least one of polyethylene, polypropylene, polyether ether ketone (PEEK), and sulfonated polyether ether ketone (SPEEK).

In some aspects, the techniques described herein relate to a membrane, wherein the carbonaceous materials include at least one of graphene, graphene oxide, carbon nano onions, and graphene nanoplatelets.

In some aspects, the techniques described herein relate to a membrane, wherein the predetermined alkali metal is lithium.

In some aspects, the techniques described herein relate to a membrane, wherein the solid electrolyte layer includes a ceramic material or polymeric material.

In some aspects, the techniques described herein relate to a membrane, wherein the ceramic material is a NASICON-type solid electrolyte.

In some aspects, the techniques described herein relate to a membrane, wherein the NASICON-type solid electrolyte is selected from the group consisting of LATP (Li1.3Al0.3Ti1.7(PO4)3) and LAGP.

In some aspects, the techniques described herein relate to a membrane, wherein the solid electrolyte layer is substantially dense.

In some aspects, the techniques described herein relate to a membrane, wherein the solid electrolyte layer includes solid electrolyte particles embedded in a polymer matrix.

In some aspects, the techniques described herein relate to a membrane, wherein the solid electrolyte layer is fabricated by a method selected from the group consisting of tape casting, roll-to-roll coating, and die compaction followed by sintering.

In some aspects, the techniques described herein relate to a membrane, wherein the solid electrolyte layer has a thickness between 0.1 mm and 2 mm.

In some aspects, the techniques described herein relate to a membrane, wherein the anti-fouling layer has a thickness between 0.01 mm and 0.5 mm.

In some aspects, the techniques described herein relate to a membrane, wherein the solid electrolyte layer has an ionic conductivity for the predetermined alkali metal ion of at least 10-4 S/cm.

In some aspects, the techniques described herein relate to a membrane, wherein the membrane has a selectivity ratio for the predetermined alkali metal ion over sodium ions of at least 10:1.

In some aspects, the techniques described herein relate to a membrane, wherein the membrane is configured to maintain at least 80% of its initial ion conductivity after exposure to a feed solution containing at least 1000 ppm of calcium ions for 100 hours.

In some aspects, the techniques described herein relate to a membrane, wherein the membrane is configured to extract at least 90% of the predetermined alkali metal ions from a feed solution containing 100 ppm of the predetermined alkali metal.

In some aspects, the techniques described herein relate to a membrane, wherein the membrane is configured to be used in a flow cell system for continuous extraction of the predetermined alkali metal from a feed solution.

In some aspects, the techniques described herein relate to a membrane, further including a sorbent layer configured to adsorb the predetermined alkali metal.

In some aspects, the techniques described herein relate to a membrane, wherein the sorbent layer is positioned between the solid electrolyte layer and the anti-fouling layer.

In some aspects, the techniques described herein relate to a membrane, wherein the sorbent layer includes sorbent particles that are selective to the predetermined alkali metal.

In some aspects, the techniques described herein relate to a membrane, wherein the sorbent particles are configured to enable reversible adsorption of the ion of the predetermined alkali metal.

In some aspects, the techniques described herein relate to a membrane, wherein the sorbent layer includes a matrix to confine the sorbent particles.

In some aspects, the techniques described herein relate to a membrane, wherein the sorbent layer includes sorbent particles selected from the group consisting of Al(OH)3, LiAlO2, LiCuO2, Li2MnO3, Li4Mn5O12, Li2SnO3, Li4TiO4, Li3Ti5O12, Li7Ti11O24, Li3VO4, Li2TiO3, LiTiO2, Li2FeO3, and Li2Si3O7.

In some aspects, the techniques described herein relate to a membrane, wherein the sorbent layer has a thickness between 0.05 mm and 1 mm.

In some aspects, the techniques described herein relate to a membrane, wherein the sorbent layer has a capacity to adsorb at least 1 mg of the predetermined alkali metal per gram of sorbent material.

In some aspects, the techniques described herein relate to a membrane, wherein the anti-fouling layer includes a polymer with functional groups that provide selectivity towards cations in the feed solution.

In some aspects, the techniques described herein relate to a system for lithium extraction, including: a first electrolyte configured to store lithium ions; a second electrolyte configured to store non-lithium ions; a first solid membrane layer configured to be lithium ion selective and positioned to transport lithium ions from a feed solution to the first electrolyte; and a second solid membrane layer configured to be ion selective to the non-lithium ions and positioned to transport the non-lithium ions from the second electrolyte to the feed solution. In some aspects, the second electrolyte is configured to store non-lithium ions, and the second solid membrane layer may be configured to be selective for sodium, potassium, or both sodium and potassium.

In some aspects, the techniques described herein relate to a system, wherein the first electrolyte includes an active material configured to reversibly store electrons and the non-lithium ions comprise sodium ions or potassium ions.

In some aspects, the techniques described herein relate to a system, wherein the active material is selected from the group consisting of Fe(CN)₆^{3-/4-}, lithium titanate (LTO), lithium iron phosphate (LFP), lithium manganese oxide (LMO), pervanadyl (VO₂⁺), vanadyl (VO₂⁺), V₂⁺, V₃⁺, and H₂/H+.

In some aspects, the techniques described herein relate to a system, wherein the second electrolyte includes an active material configured to reversibly store electrons.

In some aspects, the techniques described herein relate to a system, wherein the active material is selected from the group consisting of Fe(CN)₆^{3-/4-} and Prussian Blue.

In some aspects, the techniques described herein relate to a system, wherein the first solid membrane layer includes a NASICON-type solid electrolyte.

In some aspects, the techniques described herein relate to a system, wherein the NASICON-type solid electrolyte is selected from the group consisting of LATP (Li1.3Al0.3Ti1.7(PO4)3) and LAGP.

In some aspects, the techniques described herein relate to a system, wherein the second solid membrane layer includes a NASICON-type solid electrolyte.

In some aspects, the techniques described herein relate to a system, wherein the NASICON-type solid electrolyte is Na3Si2Zr2PO12.

In some aspects, the techniques described herein relate to a system, further including a power supply configured to apply an electrical potential between the first electrolyte and the second electrolyte.

In some aspects, the techniques described herein relate to a system, wherein the power supply is configured to apply a potential difference of between 0.1 V and 5 V.

In some aspects, the techniques described herein relate to a system, further including a pump configured to circulate the feed solution through the system.

In some aspects, the techniques described herein relate to a system, further including a lithium collection tank configured to receive lithium ions transported through the first solid membrane layer.

In some aspects, the techniques described herein relate to a system, wherein the lithium collection tank includes a buffer solution configured to maintain a high concentration of carbonate anions.

In some aspects, the techniques described herein relate to a system, wherein the first solid membrane layer further includes an anti-fouling layer adjacent to the lithium ion selective layer.

In some aspects, the techniques described herein relate to a system, wherein the anti-fouling layer includes a material selected from the group consisting of perfluorinated polymers, super-hydrophilic materials, hydrophobic materials, and carbonaceous materials.

In some aspects, the techniques described herein relate to a system, wherein the first solid membrane layer further includes a sorbent layer configured to adsorb lithium ions.

In some aspects, the techniques described herein relate to a system, wherein the sorbent layer includes sorbent particles selected from the group consisting of Al(OH)3, LiAlO2, LiCuO2, Li2MnO3, Li4Mn5O12, Li2SnO3, Li4TiO4, Li3Ti5012, Li7Ti11O24, Li3VO4, Li2TiO3, LiTiO2, Li2FeO3, and Li2Si3O7.

In some aspects, the techniques described herein relate to a system, further including a precipitation tank configured to receive lithium ions from the first electrolyte and precipitate lithium carbonate.

In some aspects, the techniques described herein relate to a system, further including a source of sodium carbonate configured to supply sodium carbonate to the precipitation tank.

In some aspects, the techniques described herein relate to a system, wherein the system is configured to operate in a continuous flow mode.

In some aspects, the techniques described herein relate to a system, wherein the system is configured to operate in a batch mode.

In some aspects, the techniques described herein relate to a system, wherein the feed solution includes a geothermal brine.

In some aspects, the techniques described herein relate to a system, wherein the feed solution includes a solution derived from recycled lithium-ion batteries.

In some aspects, the techniques described herein relate to a system, further including a brine pretreatment unit configured to prepare the feed solution for lithium extraction.

In some aspects, the techniques described herein relate to a system, wherein the system is configured to extract lithium from a feed solution containing less than 200 ppm of lithium.

In some aspects, the techniques described herein relate to a system, wherein the system is configured to concentrate lithium to at least 20 g/L in the first electrolyte.

In some aspects, the techniques described herein relate to a system, wherein the system is configured to maintain at least 80% of its initial lithium extraction efficiency after 1000 hours of operation.

In some aspects, the techniques described herein relate to a system, wherein the system is configured to extract at least 90% of lithium ions from the feed solution in a single pass.

In some aspects, the techniques described herein relate to a system, wherein the system is modular and scalable to accommodate different lithium extraction capacities.

In some aspects, the techniques described herein relate to a modular lithium extraction system, including: a plurality of flow cell modules, each flow cell module including: a first flow cell and a second flow cell; a lithium-selective membrane in the first flow cell; a sodium-selective membrane in the second flow cell; a lithium storage solution compartment; a sodium storage solution compartment; and at least one power supply configured to apply an electrical potential across each of the first flow cell and the second flow cell; a feed solution inlet configured to supply a lithium-containing brine to the flow cell modules; a collection solution outlet configured to receive a lithium-enriched solution from the flow cell modules; a brine outlet configured to discharge processed brine from the plurality of flow cell modules; wherein the modular lithium extraction system is configured to extract lithium from the lithium-containing brine by: circulating the lithium-containing brine through the first flow cell to selectively transport lithium ions across at least the lithium-selective membrane into the lithium storage solution compartment; and circulating a sodium-containing solution through the second flow cell to selectively transport sodium ions across at least the sodium-selective membrane into the brine, thereby maintaining charge balance in the system. In some aspects, a potassium-containing solution may be circulated through the second flow cell (such as for refinement of lithium for making lithium metal).

In some aspects, the techniques described herein relate to a modular lithium extraction system, wherein the flow cell modules are configured to operate in parallel to enable scalable lithium extraction capacity.

In some aspects, the techniques described herein relate to a modular lithium extraction system, wherein each flow cell module is configured to produce a predetermined amount of lithium carbonate equivalent per year.

In some aspects, the techniques described herein relate to a modular lithium extraction system, further including a control system configured to monitor and adjust operating parameters of each flow cell module.

In some aspects, the techniques described herein relate to a modular lithium extraction system, wherein the lithium-selective membrane includes a solid electrolyte layer and an anti-fouling layer.

In some aspects, the techniques described herein relate to a modular lithium extraction system, wherein the anti-fouling layer includes a material selected from the group consisting of perfluorinated polymers, zwitterionic materials, and carbonaceous materials.

In some aspects, the techniques described herein relate to a modular lithium extraction system, wherein the lithium-selective membrane includes a solid electrolyte layer and a sorbent layer.

In some aspects, the techniques described herein relate to a modular lithium extraction system, wherein the sorbent layer includes lithium sorbent particles selected from the group consisting of Al(OH)3, LiAlO2, LiCuO2, Li2MnO3, Li4Mn5O12, Li2SnO3, Li4TiO4, Li3Ti5012, Li7Ti11O24, Li3VO4, Li2TiO3, LiTiO2, Li2FeO3, and Li2Si3O7.

In some aspects, the techniques described herein relate to a modular lithium extraction system, wherein the lithium storage solution compartment and the sodium storage solution compartment each include an active material configured to reversibly store electrons.

In some aspects, the techniques described herein relate to a modular lithium extraction system, wherein the active material in the lithium storage solution compartment is selected from the group consisting of Fe(CN)63-/4-, lithium titanate (LTO), lithium iron phosphate (LFP), lithium manganese oxide (LMO), pervanadyl (VO₂⁺), vanadyl (VO²⁺), V²⁺, V³⁺, and H₂/H+.

In some aspects, the techniques described herein relate to a modular lithium extraction system, wherein the active material in the sodium storage solution compartment is selected from the group consisting of Fe(CN)63-/4- and Prussian Blue.

In some aspects, the techniques described herein relate to a modular lithium extraction system, further including a precipitation tank configured to receive the lithium-enriched solution and precipitate lithium carbonate.

In some aspects, the techniques described herein relate to a modular lithium extraction system, further including a source of sodium carbonate configured to supply sodium carbonate to the precipitation tank.

In some aspects, the techniques described herein relate to a modular lithium extraction system, wherein the system is configured to operate in a continuous flow mode.

In some aspects, the techniques described herein relate to a modular lithium extraction system, wherein the system is configured to operate in a batch mode.

In some aspects, the techniques described herein relate to a modular lithium extraction system, further including a brine pretreatment unit configured to prepare the lithium-containing brine for lithium extraction.

In some aspects, the techniques described herein relate to a modular lithium extraction system, wherein the system is configured to extract lithium from a brine containing less than 200 ppm of lithium.

In some aspects, the techniques described herein relate to a modular lithium extraction system, wherein the system is configured to concentrate lithium to at least 20 g/L in the lithium storage solution compartment.

In some aspects, the techniques described herein relate to a modular lithium extraction system, wherein the system is configured to maintain at least 80% of its initial lithium extraction efficiency after 1000 hours of operation.

In some aspects, the techniques described herein relate to a modular lithium extraction system, wherein the system is configured to extract at least 90% of lithium ions from the lithium-containing brine in a single pass.

In some aspects, the techniques described herein relate to a modular lithium extraction system, wherein the lithium-selective membrane includes a NASICON-type solid electrolyte.

In some aspects, the techniques described herein relate to a modular lithium extraction system, wherein the NASICON-type solid electrolyte is selected from the group consisting of LATP (Li1.3Al0.3Ti1.7(PO4)3) and LAGP.

In some aspects, the techniques described herein relate to a modular lithium extraction system, wherein the sodium-selective membrane includes a NASICON-type solid electrolyte.

In some aspects, the techniques described herein relate to a modular lithium extraction system, wherein the NASICON-type solid electrolyte is Na3Si2Zr2PO12.

In some aspects, the techniques described herein relate to a modular lithium extraction system, wherein each flow cell module further includes a pump configured to circulate solutions through the flow cells.

In some aspects, the techniques described herein relate to a modular lithium extraction system, further including an energy reclamation system configured to recover at least a portion of input energy used for lithium extraction.

In some aspects, the techniques described herein relate to a modular lithium extraction system, wherein the system is configured to remove sodium impurities from the lithium-containing brine.

In some aspects, the techniques described herein relate to a modular lithium extraction system, further including an in-situ monitoring system configured to assess performance and integrity of the membranes during operation.

In some aspects, the techniques described herein relate to a modular lithium extraction system, wherein each flow cell module is contained within a standardized container to facilitate transportation and deployment.

In some aspects, the techniques described herein relate to a modular lithium extraction system, wherein each standardized container is a shipping container.

According to an aspect of the present disclosure, a membrane for alkali metal extraction is provided. The membrane includes a solid electrolyte layer, wherein the solid electrolyte layer is configured to be conductive to an ion of a predetermined alkali metal. The membrane also includes an anti-fouling layer adjacent to the solid electrolyte layer, wherein the anti-fouling layer is ionically conductive to the ion of the predetermined alkali metal.

According to other aspects of the present disclosure, the membrane may include one or more of the following features. The anti-fouling layer may interface with a feed solution and may be configured as a barrier between the feed solution and the solid electrolyte layer. The membrane may include a sorbent layer configured to the predetermined alkali metal. The sorbent layer may consist of sorbent particles that are selective to the predetermined alkali metal. The sorbent particles may be configured to enable reversible adsorption of the ion of the predetermined alkali metal. The sorbent layer may comprise a matrix to confine the sorbent particles.

According to another aspect of the present disclosure, a method for extracting lithium is provided. The method includes providing a first electrolyte and providing a second electrolyte. The method also includes transporting the lithium ions from the feed solution to a first electrolyte via a solid membrane layer, wherein the solid membrane layer is configured to be lithium ion selective. The method further includes transporting the sodium ions from the second electrolyte to the feed solution via a second solid membrane layer, wherein the second solid membrane layer is configured to be sodium ion selective.

In one embodiment, a membrane-based alkali metal extraction system is provided. In use, an alkali metal extraction system includes an anode and a cathode, where the anode is configured for oxidation and the cathode is configured for reduction. Additionally, wherein migration of a predetermined alkali metal ion through an ion-selective solid electrolyte membrane is driven by a current across the anode and the cathode, and the ion-selective solid electrolyte membrane is selectively permeable to the predetermined alkali metal ion. The alkali metal extraction system further includes at least one active material, a first solution comprising the predetermined alkali metal ion, and a second solution comprising the migrated predetermined alkali metal ion.

In various embodiments, the first solution may include an anolyte, and the second solution may include a catholyte. Additionally, an active material of each of the anolyte and the catholyte may include one or more electroactive solutes or an electrode coating immersed in each of the anolyte and the catholyte, one or more dissolved alkali metal cations (including the predetermined alkali metal ion), one or more dissolved anions, and a solvent. Alternatively, the active material may be a solid, liquid, and/or gaseous species (such as H₂) that is continuously fed to either the anode or cathode that may or may not dissolve into either the anolyte or catholyte, respectively.

In various embodiments, the one or more active material may include one or more of: H₂, Na⁺, Li metal, LFP, LMO, NCA, NMC, graphite; Na-based active materials including Prussian Blue; and/or electroactive solutes include but are not limited to: ferricyanide, ferrocyanide, or a redox state ferricyanide or ferrocyanide ([Fe(CN)₆]³⁻/[Fe(CN)₆]⁴⁻); ferrocene (Fe(C₅H₅)₂, ferrocenium Fe(C₅H₅)₂⁺, cobaltocene (Co(C₅H₅)₂, cobaltocenium Co(C₅H₅)₂⁺, or any organic derivatives thereof; vanadium-containing ions or vanadium coordination complexes, including one or more of pervanadyl (VO₂⁺), vanadyl (VO²⁺), V²⁺, V³⁺; phosphotungstic acid, or a redox state of phosphotungstic acid ([PW₁₂O₄₀]³⁻/[P₂W₂₁O₇₁]⁶⁻/[PW₁₁O₃₉]⁷⁻, etc.); phosphomolybdic acid, or a redox state of phosphomolybdic acid; silicotungstic acid, or a redox state of slicotungstic acid; and/or an ion of any common redox state of Fe, Co, Ni, or Cu, including one or more of Fe²⁺, Fe³⁺, Co²⁺, Co³⁺, Ni²⁺, Ni³⁺, Cu²⁺, Cu⁺, or any coordination complex thereof.

In various embodiments, a first current collector may be in contact with the first solution, and a second current collector may be in contact with the second solution. The current collector may planar, round, and/or rod-shaped; and may be dense/non-porous, meshed, and/or porous. Additionally, each of the first current collector and the second current collector may be electronically conductive, and made of at least one of aluminum, nickel, copper, titanium, stainless steel, graphite felt, or carbon fiber.

In various embodiments, the anode may have a first mean potential, and the cathode may have a second mean potential, where the first mean potential is less than or equal to the second mean potential such that the anode receives electronic charge as the predetermined alkali metal migrates from the first solution to the second solution. Additionally, the first solution may include one or more secondary ions, and/or a first concentration of the one or more secondary ions in the first solution may be greater than a second concentration of the one or more secondary ions in the second solution.

In various embodiments, the configuration of the ion-selective solid electrolyte membrane may include a solid electrolyte particle with a predetermined pore size corresponding with the predetermined metal ion. The first solution may be a geothermal brine or a salar brine. Still yet, the first solution may comprise at least one of lithium minerals, lithium-containing brines, recycled lithium batteries, or seawater. In one embodiment, the ion-selective membrane may include a nanofiltration membrane, which may be comprised of a polymer with anionic groups (a polyelectrolyte). These anionic groups may be arranged into channels of specific pore size corresponding to the predetermined metal ion (Li).

In various embodiments, the second solution may comprise a first electroactive solute, where the reduction of the first electroactive solute coincides with the migration of the predetermined alkali metal ion. Additionally, the first solution may comprise a second electroactive solute, where oxidation of the second electroactive solute coincides with the migration of the predetermined alkali metal ion. A first concentration of at least one H⁺ ion or at least one Na⁺ ion may decrease in the second solution, and a second concentration of the at least one H⁺ ion or the at least one Na⁺ ion may increase in the first solution.

In various embodiments, the first solution may include LiOH at a first solubility, and the second solution may include an organic solution with second solubility, wherein the second solubility is lower than the first solubility. Additionally, the organic solution may comprise H₂O, where the H₂O is configured to facilitate formation of an alkali salt.

In various embodiments, the migrated predetermined alkali metal ion may be configured to recombine with a hydroxyl group to precipitate. Additionally, input energy used to migrate the predetermined metal alkali ion may be stored and recovered, at least in part, as electrochemical energy of the migrated predetermined metal alkali ion at the cathode. Further, the input energy may correspond with an electric charging at an electrode with the predetermined metal alkali ion and the electrochemical energy may correspond with an electric discharge at the electrode of the predetermined metal alkali ion. Still yet, the recovery of the input energy may reduce a carbon footprint of a manufacturing facility.

In one embodiment, a membrane-based critical minerals purification system is provided. In use, a critical minerals purification system includes an anode and a cathode, where the anode is configured for oxidation and the cathode is configured for reduction. Additionally, migration of a predetermined alkali metal ion through an ion-selective solid electrolyte membrane is driven by a current across the anode and the cathode, and the ion-selective solid electrolyte membrane is selectively permeable to the predetermined alkali metal ion. Additionally, the critical minerals purification system includes at least one active material, a precursor solution comprising the predetermined alkali metal ion, where the precursor solution is characterized by a first purity with respect to an alkali metal salt, and a second solution comprising the migrated predetermined alkali metal ion, wherein the second solution is characterized by a second purity with respect to the alkali metal salt.

In various embodiments, the second purity may be greater than the first purity. Additionally, the at least one active material at the anode and/or the cathode includes at least one of: H₂, Na⁺, Li metal, LFP, LMO, NCA, NMC, graphite; Na-based active materials including Prussian Blue; ferricyanide, ferrocyanide, or a redox state ferricyanide or ferrocyanide ([Fe(CN)₆]³⁻/[Fe(CN)₆]⁴⁻); ferrocene (Fe(C₅H₅)₂, ferrocenium Fe(C₅H₅)₂⁺, cobaltocene (Co(C₅H₅)₂⁺, cobaltocenium Co(C₅H₅)₂⁺, or any organic derivatives thereof; vanadium-containing ions or vanadium coordination complexes, including one or more of pervanadyl (VO₂⁺), vanadyl (VO²⁺), V²⁺, V³⁺; phosphotungstic acid, or a redox state of phosphotungstic acid ([PW₁₂O₄₀]³⁻/[P₂W₂₁O₇₁]⁶⁻/[PW₁₁O₃₉]⁷⁻, etc.); phosphomolybdic acid, or a redox state of phosphomolybdic acid; silicotungstic acid, or a redox state of slicotungstic acid; or an ion of any common redox state of Fe, Co, Ni, or Cu, including one or more of Fe²⁺, Fe³⁺, Co²⁺, Co³⁺, Ni²⁺, Ni³⁺, Cu²⁺, Cu⁺, or any coordination complex thereof.

In various embodiments, the ion-selective solid electrolyte membrane may be the at least one active material. Additionally, the second solution may include H₂, where the H₂ is an output of the reduction of the cathode. Further, the first solution may include H₂, where the H₂ is an input of the oxidation of the anode.

In various embodiments, the anode may use a first active material, the cathode may use a second active material, and the first active material may differ from the second active material. Additionally, energy lost to the output of the reduction may be regained by the input of the oxidation. Further, the precursor solution may be in contact with the anode. The precursor solution may include LiOH.

In various embodiments, the second solution may be in contact with the cathode. The second solution may include H₂O. Additionally, the H₂O may function as a reagent and a solvent. Further, the alkali metal salt may be extracted from the second solution. The extracted alkali metal salt at the second purity may be used for battery components.

In various embodiments, a reagent may be added to the second solution, where the reagent is configured to cause the migrated predetermined alkali metal ion to combine with a hydroxyl group to form the alkali metal salt at the second purity. Additionally, the precursor solution may include at least one of lithium minerals, lithium-containing brines, recycled lithium batteries, or seawater.

In various embodiments, input energy used to migrate the predetermined metal alkali ion may be saved and recovered, at least in part, as electrochemical energy of the migrated predetermined metal alkali ion at the cathode. Additionally, the input energy may correspond with an electric charge process and the electrochemical energy may correspond with an electric discharge process. Further, the recovery of the input energy may reduce a carbon footprint of a manufacturing facility.

In one embodiment, a membrane-based alkali metal salt precipitation system is provided. In use, an alkali metal salt precipitation system includes an anode and a cathode, where the anode is configured for oxidation and the cathode is configured for reduction. Additionally, migration of a predetermined alkali metal ion through an ion-selective solid electrolyte membrane is driven by a current across the anode and the cathode, and the ion-selective solid electrolyte membrane is selectively permeable to the predetermined alkali metal ion. The alkali metal salt precipitation system further includes at least one active material, a precursor solution comprising the predetermined metal ion, where the precursor solution is at a first solubility of an alkali metal salt, and a second solution comprising the predetermined metal ion, where the second solution is at a second solubility of the alkali metal salt which causes the migrated predetermined metal ion to precipitate.

In various embodiments, the precursor solution may include at least one of LiOH, LiCl, or Li₂CO₃. Additionally, the LiOH may be insoluble in the second solution. Further, the first solubility may be higher than the second solubility.

In various embodiments, the precursor solution may include one or more buffers. The one or more buffers may include at least one of HCO₃⁻ or CO₃²⁻. Additionally, the one or more buffers may be used to protect the ion-selective solid electrolyte membrane. Further, the migrated predetermined metal ion may be Li+, and/or the second solution may comprise at least one LiOH precipitate. Still yet, the second solution may comprise H₂O, where the H₂O may be configured to facilitate the LiOH precipitate formation. The H₂O may function as a reagent.

In various embodiments, the second solution may comprise at least one ether. Additionally, the precursor solution may include an electroactive solute. The cathode and the anode each may include an electronically conductive substrate made of at least one of: graphite, CNO, graphene, Pt, Au, Ag, Ti, Cu, Al, or stainless steel.

In various embodiments, the at least one active material may comprise an electrode slurry casted on a current collector. The cathode may include a catalyst electrically coupled with an electrically conductive substrate of the cathode. Additionally, the anode may include a catalyst electrically coupled with an electrically conductive substrate of the anode.

In various embodiments, input energy used to migrate the predetermined metal ion may be saved and recovered, at least in part, as electrochemical energy of the migrated predetermined metal ion at the cathode. Additionally, the input energy may correspond with an electric charge process and the electrochemical energy may correspond with an electric discharge process. Further, the recovery of the input energy may reduce a carbon footprint of a manufacturing facility.

In one embodiment, a membrane-based ion exchange system is provided. In use, an ion exchange system includes an anode, and a cathode, where the anode is configured for oxidation and the cathode is configured for reduction. Additionally, migration of a predetermined alkali metal cation through an ion-selective solid electrolyte membrane is driven by a current across the anode and the cathode. Further, the ion-selective solid electrolyte membrane may be selectively permeable to the predetermined alkali metal cation. The ion exchange system further includes a first active material associated with the anode, a second active material associated with the cathode, an anolyte solution comprising the predetermined alkali metal cation and a first anion, and a catholyte solution comprising the migrated predetermined alkali metal cation and a second anion, where the migrated predetermined alkali metal cation and the second anion are configured to combine to form a dissolved salt in the catholyte solution.

In various embodiments, the catholyte solution may include H₂O or HCl. Additionally, the H₂O or the HCl may be added at the same rate at which the predetermined alkali metal cation passes through the ion-selective solid electrolyte membrane. The catholyte solution may comprise the H₂O or the HCl as a reagent. Further, the formation may be based on a reduction of H⁺ from H₂O or HCl to LiOH.

In various embodiments, the second anion may comprise a hydroxyl group, the predetermined alkali metal cation may comprise Li⁺, and the first anion may differ from the second anion. Additionally, the first anion and/or the second anion may include one or more of: CO₃²⁻, HCO₃⁻, NO₃⁻, PO₄³⁻, OH⁻, Cl⁻, Br⁻, or I⁻. Further, the anolyte solution and the catholyte each independently may comprise a solvent comprising one or more of: water, alcohol, ester, ether, carbonate, or hydrocarbon.

In various embodiments, the first active material includes one or more of: H₂, H₂O, OH⁻, Cl⁻, Br⁻, or I⁻; and the second active material may include one or more of: H⁺, H₂O, O₂, Cl₂, Br₂, or I₂. Further, the ion exchange system may include a buffer in one or more of the anolyte and the catholyte. Additionally, a second ion-selective solid electrolyte membrane may be configured to selectively allow passage of the migrated predetermined alkali metal cation, and a third solution may include the allowed migrated predetermined alkali metal ion.

In various embodiments, the dissolved salt may be an alkali metal salt, and a purity of the alkali metal salt in the catholyte may be less than a purity of the dissolved salt in the third solution. Additionally, the alkali metal salt may be insoluble in the third solution.

In various embodiments, input energy used to migrate the predetermined metal alkali ion may be saved and recovered, at least in part, as electrochemical energy of the migrated predetermined metal alkali ion at the cathode. Additionally, the input energy may correspond with an electric charge process and the electrochemical energy may correspond with an electric discharge process. Further, the recovery of the input energy may reduce a carbon footprint of a manufacturing facility.

In one embodiment, a membrane-based alkali metal production system is provided. In use, an alkali metal production system includes an anode, and a cathode, where the anode is configured for oxidation and the cathode is configured for reduction. Additionally, migration of a predetermined metal ion through an ion-selective solid electrolyte membrane is driven by a current across the anode and the cathode. Further, the ion-selective solid electrolyte membrane is selectively permeable to the predetermined metal ion. The alkali metal production system further includes at least one active material, a first solution comprising an aqueous electrolyte (where the aqueous electrolyte includes the predetermined metal ion), and a second solution comprising a metal atom based on the migrated predetermined metal ion, wherein the second solution is at least partially disposed in a liquid state of the metal atom.

In various embodiments, the at least one active material includes a hydroxyl group for the anode, and/or the at least one active material includes lithium metal for the cathode. Additionally, the liquid state is a molten solution of the metal atom.

In various embodiments, the anode is a carbon rod, and/or the carbon rod includes a Pt catalyst. Additionally, the cathode may comprise a carbon rod or mesh, or a metal rod or mesh. Further, the at least one active material for the anode may include at least one of: H₂, OH⁻, Cl⁻, Br⁻, or I⁻.

In various embodiments, the at least one active material for the cathode may include a liquid metal. The liquid metal may within the temperature range of 25° C.-250° C. Additionally, the liquid metal may be configured to form a molten alloy with lithium. The liquid metal may include one of: Ga, Ga—In, Ga—In—Sn (Galinstan) Na—K alloys, Na—K—Cs alloys, or Ga—In alloys.

In another embodiment, a system for alkali metal production is provided, which includes a first electrode, a first electrolyte comprising an alkali metal salt, where the first electrolyte is configured to be in contact with the first electrode, and a second electrode, where when a current is passed from the first electrode to the second electrode, the current causes migration of an alkali metal ion of the alkali metal salt. Additionally, an ion-selective solid electrolyte membrane is configured to selectively allow the alkali metal ion to migrate. A second solution includes an alkali metal atom based on the migrated alkali metal ion and galinstan. Additionally, the system includes a third electrode, where when a second current passed from the second electrode to the third electrode, the second current causes second migration of the alkali metal atom of the second solution. A second ion-selective solid electrolyte membrane is configured to selectively allow the alkali metal atom to migrate, and a third solution includes the second migrated alkali metal atom.

In various embodiments, the second migrated alkali metal atom may be in a molten state. Additionally, the migration may occur at ambient conditions, and/or the second migration may occur at controlled conditions, wherein the controlled conditions include at least one of: an inert environment, or Ar atmosphere.

In various embodiments, a thickness of the second ion-selective solid electrolyte membrane may be configured to increase a purity of the second migrated alkali metal atom. Additionally, the migration and the second migration may occur concurrently, and/or the migration and the second migration may occur in series or a batch configuration.

In various embodiments, the alkali metal ion may be Li⁺, and/or the second solution may include lithiated galinstan. Further, the third solution may include only the second migrated alkali metal atom.

In one embodiment, an energy reclamation and carbon-neutral system for critical mineral extraction is provided. In use, a method for critical mineral reclamation includes driving migration of lithium ions using a current passing from an anode to cathode, where the current is driven by a redox configuration of the anode and the cathode. Additionally, the lithium ions are extracted from a first solution into a second solution through an ion-selective solid electrolyte membrane, where the ion-selective solid electrolyte membrane is configured to selectively allow the lithium ions to pass. Further, an input of energy is provided for the extraction, and after the extraction, a reclamation of the lithium ions is caused, where the reclamation recovers at least a portion of the input of energy.

In various embodiments, the reclamation may include converting the lithium ions to lithium carbonate or lithium hydroxide. Additionally, the reclamation may include purifying the lithium ions to a minimum of 99.9% lithium by mass. Further, the input of energy may be stored as electrochemical energy of the lithium ions.

In various embodiments, recovering the at least a portion of the input of energy may reduce a carbon footprint of a manufacturing facility. Additionally, the first solution may be based on at least one of lithium minerals, lithium-containing brines, recycled lithium batteries, geothermal brines, salar brines, or seawater.

In various embodiments, the ion-selective solid electrolyte membrane may be water impermeable. Additionally, the reclamation may include transporting the lithium ions from the second solution to a third solution via the ion-selective solid electrolyte membrane, and/or transporting second ions from the third solution to a fourth solution via a second ion-selective solid electrolyte membrane, wherein the transporting of the second ions from the third solution to the fourth solution coincides with the transporting of the lithium ions from the second solution to the third solution. Still yet, extracting the lithium ions from the first solution to the second solution may coincide with an uptake of second ions from a third solution to the first solution.

In various embodiments, the first solution may be a feed solution, the second solution may be an anolyte, a third solution may be a catholyte, and a second ion-selective solid electrolyte membrane may be selectively permeable to sodium. The anolyte may include a lithium electrolyte and the catholyte may include a sodium electrolyte. Additionally, at least one of the anode or the cathode may be made of stainless steel mesh. The extraction of the lithium ions from the first solution to the second solution may coincide with an extraction of sodium ions from the third solution to the first solution, and the reclamation of the lithium ions may include transporting the lithium ions from the second solution to a fourth solution which may coincide with transporting the sodium ions from the fourth solution to the third solution. Further, the transporting of the lithium ions may coincide with an electric discharge of electrochemical energy of the lithium ions.

In various embodiments, the extraction and reclamation may be performed, at least in part, using a lithium module which includes the ion-selective solid electrolyte membrane, the second solution (where the second solution includes a lithium electrolyte), and an active material electrode in direct contact with the second solution. Additionally, the extraction and reclamation may be further performed, at least in part, using a sodium module which includes a second ion-selective solid electrolyte membrane (where the second ion-selective solid electrolyte membrane is sodium selective), a third solution (where the third solution includes a sodium electrolyte), and a second active material electrode in direct contact with the third solution. Further, the lithium module and the sodium module may be configured to be part of a module array, the module array configured to have multiple lithium modules comprising the lithium module, and multiple sodium modules comprising the sodium module.

In various embodiments, the first solution may be a feed solution that flows into the module array and between each of the multiple lithium modules and each of the multiple sodium modules. Additionally, the first solution may be used for the extraction, and a fourth solution may be used for the reclamation, where the first solution differs from the fourth solution, and the fourth solution replaces the third solution after the extraction. Further, the first solution may comprise at least one of lithium minerals, lithium-containing brines, recycled lithium batteries, geothermal brines, salar brines, or seawater, and the fourth solution may comprise a Na₂CO₃ and Li₂CO₃ feed in which Li₂CO₃ may be saturated.

### BRIEF DESCRIPTION OF THE DRAWINGS

FIG. 1 illustrates a solid electrolyte membrane, in accordance with one embodiment.

FIG. 2 illustrates a method for creating a solid electrolyte membrane, in accordance with one embodiment.

FIG. 3 illustrates a process for mechanical polishing the solid electrolyte membrane, in accordance with one embodiment.

FIG. 4 illustrates a roll-to-roll process for mechanical polishing the solid electrolyte membrane, in accordance with one embodiment.

FIG. 5 illustrates an ion-selective solid electrolyte membrane, in accordance with one embodiment.

FIG. 6 illustrates a voltage drop using a carbon-based membrane, in accordance with one embodiment.

FIG. 7 illustrates a close-up diagram of graphitic carbon, in accordance with one embodiment.

FIG. 8 illustrates a process for recovering energy from lithium extraction, in accordance with one embodiment.

FIG. 9 illustrates a cell architecture, in accordance with one embodiment.

FIG. 10 illustrates a system and method for a carbon-neutral energy reclamation battery recycling, in accordance with one embodiment.

FIG. 11 Illustrates various processes where an ion-selective electrolyte membrane separator may be incorporated, in accordance with one embodiment.

FIG. 12 illustrates electrode modules, in accordance with one embodiment.

FIG. 13 illustrates redox electrode modules, in accordance with one embodiment.

FIG. 14 illustrates a membrane separation cell, in accordance with one embodiment.

FIG. 15 illustrates a lithium extractor with active materials, in accordance with one embodiment.

FIG. 16 illustrates a lithium extractor with redox flow active materials, in accordance with one embodiment.

FIG. 17 illustrates redox electrode modules for critical minerals purification, in accordance with one embodiment.

FIG. 18 illustrates redox electrode modules for critical minerals purification, in accordance with one embodiment.

FIG. 19 illustrates redox electrode modules for metal salt precipitation, in accordance with one embodiment.

FIG. 20 illustrates redox electrode modules being set up for metal salt precipitation, in accordance with one embodiment.

FIG. 21 illustrates redox electrode modules for metal salt precipitation during reaction, in accordance with one embodiment.

FIG. 22 illustrates redox electrode modules for ion exchange, in accordance with one embodiment.

FIG. 23 illustrates a membrane separation system, in accordance with one embodiment.

FIG. 24 illustrates redox electrode modules for ion exchange, in accordance with one embodiment.

FIG. 25 illustrates membrane-based alkali metal production, in accordance with one embodiment.

FIG. 26 illustrates a process for carbon-neutral mineral recycling and reclamation.

FIG. 27 illustrates membrane-based alkali metal production, in accordance with one embodiment.

FIG. 28 illustrates another implementation of membrane-based alkali metal production, in accordance with one embodiment.

FIG. 29 illustrates membrane-based alkali metal production, in accordance with one embodiment.

FIG. 30 illustrates another implementation of membrane-based alkali metal production, in accordance with one embodiment.

FIG. 31 illustrates a redox electrode system for alkali metal extraction, in accordance with one embodiment.

FIG. 32 illustrates a redox electrode system for alkali metal extraction and precipitation, in accordance with one embodiment.

FIG. 33 illustrates a lithium extraction system, in accordance with one embodiment.

FIG. 34 illustrates an energy reclamation process for alkali metal extraction, in accordance with one embodiment.

FIG. 35 illustrates a lithium extraction cell, in accordance with one embodiment.

FIG. 36 illustrates a data plot of lithium extraction, in accordance with one embodiment.

FIG. 37 illustrates a data plot of lithium reclamation, in accordance with one embodiment.

FIG. 38 illustrates an exemplary electrode module, in accordance with one embodiment.

FIG. 39 illustrates an electrode module array, in accordance with one embodiment.

FIG. 40 illustrates an exemplary system for conversion to lithium hydroxide, in accordance with one embodiment.

FIG. 41 illustrates a subset of the exemplary system for conversion to lithium hydroxide, in accordance with one embodiment.

FIG. 42 illustrates a subset of the exemplary system for conversion to lithium hydroxide, in accordance with one embodiment.

FIG. 43 illustrates a subset of the exemplary system for conversion to lithium hydroxide, in accordance with one embodiment.

FIG. 44 illustrates an exemplary process for lithium metal production, in accordance with one embodiment.

FIG. 45 illustrates an exemplary process for lithium metal production, in accordance with one embodiment.

FIG. 46 illustrates results using redox electrode modules, in accordance with one embodiment.

FIG. 47 illustrates results using redox electrode modules, in accordance with one embodiment.

FIG. 48 illustrates results using redox electrode modules, in accordance with one embodiment.

FIG. 49 illustrates a section view of a composite membrane structure for lithium extraction, according to aspects of the present disclosure.

FIG. 50 depicts graphs showing lithium concentration profiles near a Li-selective membrane, according to an embodiment.

FIG. 51 illustrates a system diagram of a lithium extraction apparatus, according to aspects of the present disclosure.

FIG. 52 illustrates a system for lithium extraction in two configurations, according to an embodiment.

FIG. 53 illustrates a perspective view of a lithium extraction apparatus, according to aspects of the present disclosure.

FIG. 54 illustrates steps of a system diagram for a lithium extraction process, according to an embodiment.

FIG. 55 illustrates a system diagram of a lithium extraction system during extraction, according to aspects of the present disclosure.

FIG. 56 illustrates a system diagram of a lithium extraction apparatus during lithium release, according to an embodiment.

FIG. 57 illustrates a system diagram for a lithium extraction process during precipitation, according to aspects of the present disclosure.

FIG. 58 depicts graphs illustrating lithium extraction and sodium depletion cycles, according to an embodiment.

FIG. 59 illustrates an orthogonal view of a container holding precipitated lithium carbonate, according to aspects of the present disclosure.

FIG. 60 depicts X-ray diffraction results for lithium carbonate samples, according to an embodiment.

FIG. 61 illustrates steps of a system diagram for a lithium extraction process, according to aspects of the present disclosure.

FIG. 62 depicts graphs showing concentration changes of lithium and sodium ions over time, according to an embodiment.

FIG. 63 illustrates a system diagram of a lithium extraction apparatus, according to aspects of the present disclosure.

FIG. 64 illustrates an exploded view of a lithium extraction apparatus, according to an embodiment.

FIG. 65 illustrates perspective views of components of a lithium extraction apparatus, according to aspects of the present disclosure.

FIG. 66 depicts graphs showing concentration changes of lithium and other ions over time, according to an embodiment.

FIG. 67 illustrates a system diagram of a lithium extraction process, according to aspects of the present disclosure.

FIG. 68 illustrates a perspective view of a lithium extraction apparatus, according to an embodiment.

### DETAILED DESCRIPTION

Lithium has become ubiquitous in nearly all electric or electronic products, from batteries to armor plating, from to bicycle frames to glass, from lubricants to ceramics and more. Conventional systems and methods for obtaining lithium extract the lithium from raw materials such as from rocks and/or from mineral springs. It is well known that the global demand for lithium will deplete all known commercially viable sources of such raw materials. It therefore becomes imperative to recycle lithium. One source of lithium that is a candidate for recycling is from used lithium-containing batteries. However, to be sustainable, the techniques for lithium extraction must be highly energy efficient and scalable.

Efforts to develop alternative lithium extraction technologies have focused on various approaches, including adsorption, ion exchange, and membrane-based processes. These methods aim to selectively recover lithium from complex brine solutions while minimizing environmental impact and reducing processing time. However, challenges remain in developing processes that are both highly selective for lithium and economically viable at commercial scales. The disclosure herein resolves such deficiencies and issues. Further, such disclosure could potentially unlock new lithium resources, reduce environmental impacts, and help meet the growing global demand for this critical element. Advancements in this field may have far-reaching implications for the clean energy transition and the future of energy storage technologies.

Lithium reclamation techniques disclosed herein may be scalable so as to be able to meet the forecasted worldwide EV battery recycling demands through this decade and into the decades to follow. To illustrate the needed scale, it is estimated that 10 TWh of EV battery capacity will be demanded between now and the beginning of 2030, with over 1 TWh being demanded in calendar year 2025 alone. This demand, in turn, may require around 125,000 tons (or more) of lithium for EV batteries each year. It is acknowledged that a substantial high percentage of this lithium tonnage can be reclaimed from spent batteries.

In view of this large scale, a primary challenge is reclamation efficiency. The techniques disclosed herein meet this challenge by implementing energy recycling, resulting in an extremely low demand for energy that is needed to accomplish the lithium reclamation. For example, for a single factory that reclaims 500 tons of lithium per year, using the energy reclamation techniques disclosed herein, a continuous power demand of only 44 KW may be required (a number that is small enough to be provided by banks of solar panels that fit on the roof-space of an EV battery factory). As such, the disclosure herein may provide for more efficient separation of lithium from feed solution, but additionally, may provide for significant energy reclamation associated with the lithium extraction. Additionally, it is to be understood that the above provided estimate for power needed may change depending on how the system is designed. As such, the power demand and reclamation amounts provided are merely exemplary for one particular configuration, but other configurations (with other power needs) are envisioned.

Additionally, known separation membranes often will crack and fail as time goes on, resulting in both time inefficiencies and fiscal losses (in having to replace the electrolyte). Further, other membranes (e.g., adsorption membranes, etc.) may have membrane fouling, which in turn, may decrease the efficiency and lifetime of the membrane. Using a solid state electrolyte membrane, in combination with a redox reaction, may assist with decreasing fouling or membrane cracking (e.g., as a consequence of volume expansion during extraction, etc.), which in turn, may increase longevity of the electrolyte and the membrane, thereby overcoming said inefficiencies and losses.

Further, the use of a solid state electrolyte membrane may allow for energy reclamation within the context of a cell design used also for alkali metal separation. For example, separating lithium may cause an electric charge which can be reclaimed for additional (or future) processing. In this manner, a near self-sufficient flow may be created (after activation energy of the reaction is initially overcome). It is to be understood that a full energy reclamation system may not be feasible (due to waste heat, impedance of the solid electrolyte membrane, etc.). However, using the systems and methods disclosed herein, a significant amount of energy may be reclaimed (thereby making the system more fiscally efficient and environmentally responsible).

### DEFINITIONS AND USE OF FIGURES

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the Figures. It should be noted that the Figures are not necessarily drawn to scale, and that elements of similar structures or functions are sometimes represented by like reference characters throughout the Figures. It should also be noted that the Figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

Within the context of the present description, the term “membrane” shall be understood as referring to a barrier or lining which separates a solution from a filtrate. The solution may include any feed material/solution, and the filtrate may include that which has been filtered by the membrane. Further, a solid electrolyte (which may be embedded within the membrane) may refer to a solid-form electrolyte capable of migrating ions. Additionally, a matrix may include and/or refer to, an epoxy, a polymer matrix, any polymeric binder, a multifunctional amine, and/or a multifunctional epoxide. In this manner, a matrix may provide mechanical strength required to keep a film intact over the life of its operation, including preventing cracks from forming when a membrane is removed from water (or any other feed solution), and acting as a barrier.

Within the context of the present description, the term “electrode” refers to an electric conductor. The electrode may compose an active material which may serve as a host for extracted ions (such as lithium) and store the energy input for extraction in the form of electrochemical energy.

Within the context of the present description, the term “electrolyte” refers to a substance that contains ions. For example, the substance may include a liquid, a semi-solid (e.g., gel), and/or solid (e.g., paste). Additionally, the electrolyte may allow for an electrical current to flow between an anode and a cathode (thereby allowing movement of the ions).

Within the context of the present description, an “ion selective electrolyte membrane separator” refers to separation system that selectively removes ions. For example, the ion selective electrolyte membrane separator may be used to selectively remove alkali metal ions or H+ from one solution or material to a new solution or material by applying a potential across an ion-selective electrolyte membrane.

Within the context of the present description, “ion exchange” refers to system that replaces an ion with a new ion. For example, the ion exchange may include a separation system that replaces one or more anions/cations in a solution with a new anion/cation.

Within the context of the present description, “direct lithium extraction” refers to removing lithium ions from a solution. For example, direct lithium extraction may include a separation system that removes lithium ions from a solution to a new solution.

Within the context of the present description, “salt precipitation” refers to a salt created by precipitation. For example, salt precipitation may include a separation system that enables the removal of a salt from a solution through precipitation.

Within the context of the present description, “purification” refers to increasing purity. For example, purification may include a separation system designed specifically to increase the purity of an alkali metal salt.

Within the context of the present description, “alkali metal electrolysis” refers to conversion of an alkali metal salt to its corresponding metal.

Within the context of the present description, an “active material” may include any material that takes place in a redox reaction that is used as a source/sink of electrons in the anode/cathode. Further, an “electroactive solute” may include an active material that is dissolved in the electrolyte (either anolyte or catholyte).

Within the context of the present description, a separation process using an ion-selective electrolyte membrane refers to any process to remove an ion from a solution via an ion-selective electrolyte membrane. For example, it may include a process through which an alkali metal or H+ may be selectively removed from a solution or material to a new solution or material by applying a potential across an ion-selective electrolyte membrane.

Within the context of the present description, a reclamation process refers to a process where input energy is recovered. For example, the reclamation process may include alkali metal being selectively removed from a solution or material using a 2-step charge/discharge process in which the electrochemical energy input in the charge step may be at least partially recovered during the discharge step.

Within the context of the present description, a liquid metal intermediate process refers to a process where an alkali metal salt is reduced to an alkali metal with liquid metal used as an intermediate. For example, the process may include reducing an alkali metal salt to its corresponding alkali metal in which a liquid metal is used as an intermediate. In one embodiment, the intermediate may be used to prevent a feed solution from coming in contact with lithium metal and its environment.

### Descriptions of Exemplary Embodiments

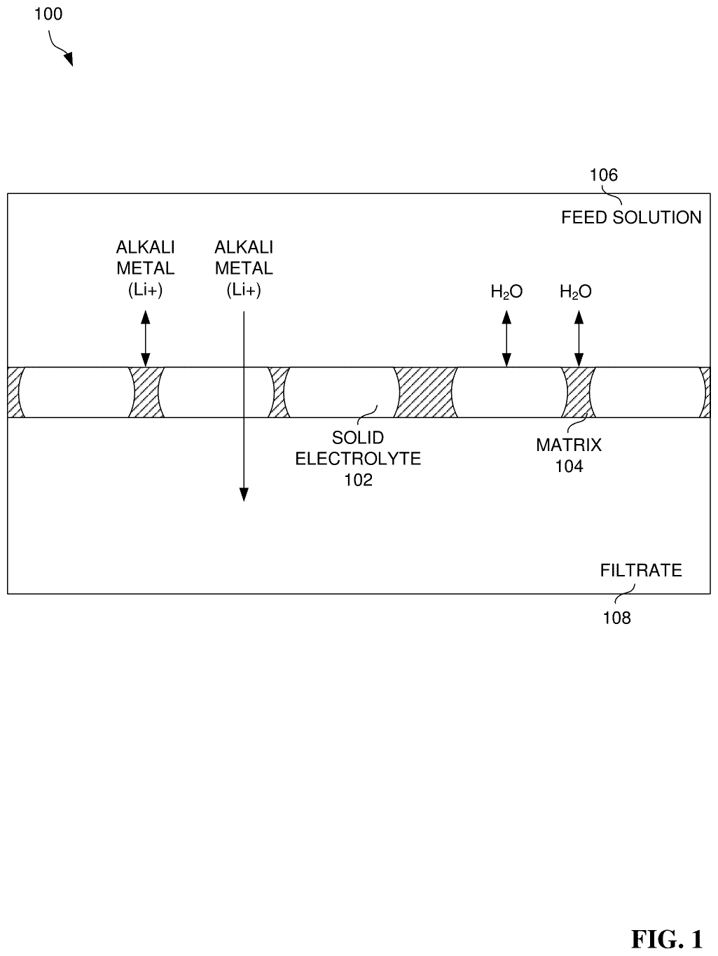

FIG. 1 illustrates a solid electrolyte membrane 100, in accordance with one embodiment. In the context of the present description, the solid electrolyte membrane 100 may be used to enable the passage of Li+ (or any preconfigured alkali metal) ions while preventing all other unwanted substances, such as water, from passing through the solid electrolyte, or through a substrate in which the solid electrolyte is embedded. Additionally, the structure of the solid electrolyte membrane 100 is extremely durable, enabling operation for a significant time without structural degradation or decrease in performance. Of course, it is to be appreciated that the solid electrolyte membrane 100 could be configured to allow passage of any specific ion. Further, the solid electrolyte membrane 100 may be configured for a high selectivity ratio of ions (such as Na+/Li+, Na+/K+, etc.).

The solid electrolyte membrane 100 improves and solves problems previously associated with prior selective membrane. For example, when using the solid electrolyte membrane 100 as an ion-selective membrane for electrochemical lithium extraction/recycling, it may prevent the electrode from contacting water (which may adversely react with it). Further, the ion-selective membrane may prevent the electrode active material from needing to be directly soaked in the feed solution, which would cause the electrode to dry out, which in turn may lead to cracking when removed from the solution while making the electrode material vulnerable to the contents of the feed solution. Additionally, the ion-selective membrane may resist cracking when taken out of the feed solution due to the fact that the ion-selective membrane may be held together by a densely crosslinked matrix, which may prevent a reconfiguration of the polymer structure (which may occur when a liquid with high surface tension, such as water, is removed from the ion-selective membrane, etc.).

Further, the solid electrolyte membrane 100 may be used as a polysulfide barrier, which may attenuate or remove (even near completely) the polysulfide shuttle phenomena in Li—S batteries. Still yet, the solid electrolyte membrane 100 may protect Li metal (or any alkali metal) from air, enabling the use of Li-air batteries, which have the highest specific energy of any known chemistry for lithium-ion batteries. As such, the solid electrolyte membrane 100 may be used as a conductive barrier to air.

As shown, a solid electrolyte 102 is embedded in a matrix 104. In one embodiment, the solid electrolyte 102 may be embedded in aluminized mylar. The combination of the solid electrolyte 102 and the matrix 104 represents a membrane. In one embodiment, as illustrated, feed solution 106 may include an alkali metal (such as Li⁺) and a liquid (such as water, H₂O). The membrane may be water impermeable such that the water may be prevented from crossing the solid electrolyte 102 and the matrix 104. In contrast, the alkali metal (such as Li⁺) may not pass thorough the matrix 104 but may pass through the solid electrolyte 102. That which passes through the membrane may be found in the filtrate 108. Additionally, in addition to repelling water, the membrane may also repel polysulfides, air (including but not limited to oxygen, nitrogen, carbon dioxide, etc.), etc.

The membrane may be composed of solid electrolyte particles (shown as the solid electrolyte 102) within a dense matrix (shown as the matrix 104). Each individual solid electrolyte particle may completely traverse the membrane such that a Li+ ion (or any alkali metal ion) entering from one side of the membrane enters the membrane through the same solid electrolyte particle that it exits the membrane from (i.e., it does not need to pass through any solid-solid interface). In one embodiment, completely traversing the membrane as a single particle may allow for higher conductivity, as the transport pathway may be more direct (especially compared to Li+ transport pathways that go through many solid-solid interfaces which may in turn have lower Li+ conductivity).

In one embodiment, the solid electrolyte membrane 102 may also prevent water from passing through the space in between the solid electrolyte particles and the matrix 104. In one embodiment, this may be due to the fact that the matrix 104 may interact strongly with the solid electrolyte particles of the solid electrolyte 102. Additionally, the solid electrolyte particles of the solid electrolyte 102 may be functionalized to improve interactions with the matrix 104. For example, in one embodiment, if using the solid electrolyte LATP, which is rich in phosphates, acrylic acid derivatives (such as 2-(aminoethyl)methacrylate) may be used to react with the surface phosphates (via michael addition) in order to enrich the surface of the solid electrolyte 102 with amine groups. As such, the epoxide molecules from the matrix 104 may covalently bond with the solid electrolyte particles of the solid electrolyte 102.

Although the alkali metal is shown as Li+ in the solid electrolyte membrane 100, it is to be appreciated that any ion of choice can be selected. Depending on the ion that should be separated, the solid electrolyte may be replaced with the appropriate material. For example, in one embodiment, if Na+ separation is desired, then NASICON can be used in place of LiSICON as the solid electrolyte. Of course, it is to be appreciated that any other ions (such as K+, Rb+, Cs+, etc.) may be separated based on accompanying solid electrolyte materials. Further, it is to be appreciated that LiSICON is a member of the NASICON family of solids, which is composed of ZrO6 octahedra and PO4/SiO4 tetrahedra that share common corners, with Na+ in the interstitial space. LiSICON may have a structural analogue with MO6 (M=Ti, Ge, Zr, Hf, Sn) octahedra and PO4 tetrahedra and Li+ in the interstitial sites. Such solid electrolytes may have high resistance to degradation and/or corrosion in water. It is to be appreciated that other materials may likewise work (that provide resistance to degradation and/or corrosion in water).

Additionally, the process can be tuned such that any desired volume fraction of solid electrolyte particles within the matrix can be achieved. For example, a slurry may be cast in which all particles are the same size and are hexagonally close packed such that the volume fraction of particles in the casted membrane is maximized. For example, maximizing the volume fraction may include maximizing the volume for a particular given particle size distribution. In other words, if all the particles are the same exact size, then hexagonally close packing may be the most efficient way to make use of the volume. However, in one embodiment, it may be possible to use an even higher volume fraction of the membrane if particles of multiple sizes and/or of different shapes are used. The volume fraction of solid electrolyte particles may then be further increased by removing an increasingly large amount of membrane (via abrasive polishing) on both sides. In this manner, any volume fraction of solid electrolyte particles can be achieved. Creating a membrane with a higher volume fraction of solid electrolyte may require polishing down the membrane film to thinner membranes, thereby removing higher fractions of the initial membrane.

Further, although the solid electrolyte membrane 100 are shown as having spherical solid electrolyte particles, it is to be appreciated that particles of the solid electrolyte 102 do not necessarily need to be spherical. For example, the particles of the solid electrolyte 102 may be donut shaped, blood-cell shaped, and/or any other specifically desired shape (which may be created based on the tuning the spray drying process, specifically the feed rate of the aqueous precursor, to shape the particles). Additionally, particles of the solid electrolyte 102 can be prepared by preparing a precursor solution and regular drying, followed by sintering, yielding non-spherical particles. Ball milling can then be used to reduce the particle size.

To maximize kinetic flow, it is recommended that an ion traverse a single particle of the solid electrolyte 102. However, the solid electrolyte membrane 100 may include multiple layers of the solid electrolyte 102, which may cause an ion to traverse or hop from one particle of the solid electrolyte 102 to another particle of the solid electrolyte 102. Having multiple layers of the solid electrolyte 102 may allow for more uniform distribution of particles within the matrix.

Additionally, multiple membranes (such as the solid electrolyte membrane 100 and another of the solid electrolyte membrane 100) can be stacked together to make a thicker membrane (which may be used for ion selectivity, kinetic flow, greater filtering capability, etc.). In such an embodiment, the individual layers of more than one membranes can be joined together with a Li+ (or whatever alkali metal ion selected) conductive adhesive, such as a matrix containing polyethylene glycol diglycidyl ether (PEG-DGE) and/or Jeffamine D-230, and a lithium, salt such as LiTFSI. Of course, it is to be appreciated that other Li+ conductive adhesives may be used to enable the fabrication of a multilayered membrane.

In one embodiment, rather than using mechanical polishing, laser ablation and/or chemical etching may be used to shave down the surfaces of the solid electrolyte membrane 100 and expose the particles of the solid electrolyte 102 to the surfaces. Additionally, ion milling or focused ion beams (FIB) may be used to polish the surface.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

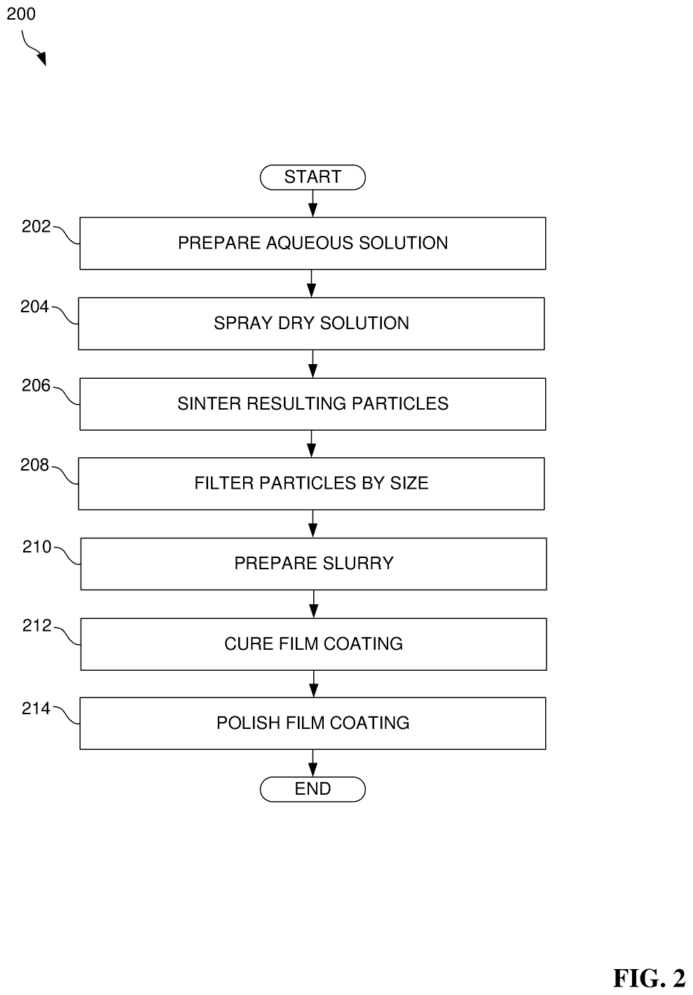

FIG. 2 illustrates a method 200 for creating a solid electrolyte membrane, in accordance with one embodiment. As an option, the method 200 may be implemented in the context of any one or more of the embodiments set forth in any previous and/or subsequent Figures and/or description thereof. Of course, however, the method 200 may be implemented in the context of any desired environment. Further, the aforementioned definitions may equally apply to the description below.

As shown, individual particles of the solid electrolyte of choice are prepared (step 202). In one embodiment, in the case of using LiSICON as the solid electrolyte material, an aqueous solution containing a precursor (Li2CO3, LiNO3, Al2O3, TiO2, GeO2, NH4H2PO4) may be spray-dried (step 204) into spherical particles 1 um-1 mm (or even smaller than 1 um) in diameter. It is to be appreciated that the precursors enumerated are not to be construed as only limited thereto. Other precursors may be used that are compatible with the desired and selected solid electrolyte material. Additionally, the particle size may directly influence the resistance for ion transport. For example, a thinner membrane may result in a lower resistance for ion transport. That being said, the membrane may be adjusted such that it is sufficiently thick to prevent any appreciable penetration of water (or a feed solution). The resulting particles are then sintered at high temperature (step 206) in order to densify the particles. The temperature and time of sintering may depend on the selected solid electrolyte material. The densified particles may result in undesired substances (such as water) being prevented from diffusing through the bulk of the aqueous solution, while also homogenizing the distribution of atoms in the particle (which increases Li+ conductivity).

The precursors solution for the solid electrolyte may be composed of salts, inorganic or organic compounds containing the elements of the solid electrolyte. The following tables show possible precursor and candidate materials to result in the solid electrolyte:

TABLE 1
Possible Precursors

| Solid Electrolyte | Precursors |
|---|---|
| LATP | LiNO₃, Al₂O₃, TiO₂, NH₄H₂PO₄ |
| LAGP | LiNO₃, Al₂O₃, GeO₂, NH₄H₂PO₄ |
| LiSICON | LiNO₃, Al₂O₃, GeO₂, TiO₂, NH₄H₂PO₄ |
| LTO | LiNO₃, TiO₂ |
| NaSICON | Na₂CO₃, Al₂O₃, GeO₂, TiO₂, NH₄H₂PO₄ |

TABLE 2
Candidate Materials for Solid Electrolyte
Alkali Metals

| | |
|---|---|
| Li | Li₂CO₃, LiNO₃, LiOH, LiOR (R = Alkyl) |
| Na | Na₂CO₃, NaNO₃, NaOH, NaOR (R = Alkyl) |
| K | K₂CO₃, LiNO₃, KOH, KOR (R = Alkyl) |

Tetravalent Metals

| | |
|---|---|
| Ti | TiO₂, Ti(OR)₄ (R = Alkyl) |
| Si | SiO₂, Si(OR)₄ (R = Alkyl) |
| Ge | GeO₂, Ge(OR)₄ (R = Alkyl) |
| Zr | ZrO₂, Zr(OR)₄ (R = Alkyl) |

Phosphorus

| | |
|---|---|
| P | H₃PO₄, (NH₄)₃₋ₓHₓPO₄ (x = 0, 1, 2) |

Trivalent Metals

| | |
|---|---|
| Al | Al(NO₃)₃, Al₂O₃, Al(OR)₃ (R = Alkyl) |
| Cr | Cr(NO₃)₃, Cr₂O₃, Cr(OR)₃ (R = Alkyl) |
| Ga | Ga(NO₃)₃, Ga₂O₃, Ga(OR)₃ (R = Alkyl) |
| Fe | Fe(NO₃)₃, Fe₂O₃, Fe(OR)₃ (R = Alkyl) |
| Sc | Sc(NO₃)₃, Sc₂O₃, Sc(OR)₃ (R = Alkyl) |
| In | In(NO₃)₃, In₂O₃, In(OR)₃ (R = Alkyl) |
| Lu | Lu(NO₃)₃, Lu₂O₃, Lu(OR)₃ (R = Alkyl) |
| Y | Y(NO₃)₃, Y₂O₃, Y(OR)₃ (R = Alkyl) |
| La | La(NO₃)₃, La₂O₃, La(OR)₃ (R = Alkyl) |
| Eu | Eu(NO₃)₃, Eu₂O₃, Eu(OR)₃ (R = Alkyl) |

where R=any alkyl substituent, including methyl, ethyl, propyl, butyl, isopropyl, isobutyl groups. Notable precursors include titanium isopropoxide (TTIP) for Ti and tetraethyl orthosilicate (TEOS) for Si.

For the lithium-selective membrane, the solid electrolyte may be composed of any NASICON-type Li+ conductor such as LATP, LAGP, LAGTP, LATP, LTASP, LLZP (L=Li if it is the first letter of the anagram, A=Al, T=Ti, G=Ge, L=La if it is not the first letter of the anagram, Z=Zr, S=Si, P=PO₄₃-). Of the aforementioned electrolytes in the NASICON-type Li+ conductors, any tetravalent metal may be partially or completely substituted with any other tetravalent metal mentioned in the table above, and any of the trivalent metals (Al) may be partially or completely substituted with any other trivalent metal mentioned in the table above. Additionally, any trivalent or tetravalent metal may be partially or completely removed. Other potential solid electrolyte materials may include lithium iron phosphate (LFP), lithium titanium oxide (LTO). Further, the precursors used may depend on the elements used in the solid electrolyte. Of course, for each element selected, a suitable precursor may be listed in the table provided herein.

Additionally, more than one membrane may be used. For example, as shown in process 200 detailed hereinbelow, a first solid electrolyte membrane may be used to selectively extract lithium from a feed solution, and a second solid electrolyte membrane may be used to transfer ions (such as sodium) from a second electrode into the feed solution (from which the lithium was extracted). In such an embodiment, the second solid electrolyte membrane, the composition may depend on the specific ion to be utilized for the second electrode. For example, in the case of sodium, the solid electrolyte may be composed of any NASICON-type conductor of the form Na₁₊ₓZr₂SiₓP₃₋ₓO₁₂ (0<x<3). For the aforementioned NASICON-type conductor, any tetravalent metal (Zr, Si) may be partially or completely replaced by any other isovalent metal in the table provided hereinabove. Additionally, the electrolyte may be doped with any trivalent metal in the above table. In the case of potassium, the solid electrolyte can be composed of K₂Fe₄O₇. The precursors used may therefore depend on the elements used in the solid electrolyte, where for each element selected, a suitable precursors may be listed in the table provided herein.

Next, the particles may be preferably filtered (step 208) based on size (e.g., using a sieve) to remove the excessively small particles and/or to narrow the size distribution of the batch of particles. Suitable materials for the solid electrolyte materials may include, but not be limited to, NASICON-type Li+ conductors (also known as LiSICON), including LATP/LAGP/LAGTP, as well as lithium titanium oxides (LTO), and lithium iron phosphate (LFP). In general, any material that is water-stable, has Li+ (or whatever alkali metal selected) conductivity of at least 10\hat{ }−6 S/cm, and a dense crystal structure that has a high selectivity for Li+ (or whatever ion is desired) over other ions, may be acceptable as a solid electrolyte material.

In one embodiment, the crystal structure of the solid electrolyte may include a tetrahedra structure (such as ZrO₆), and/or an octahedra structure (such as PO₄, SiO₄, etc.). Additionally, using the process disclosed herein, the microparticles may be sized as needed for efficient membrane ion transfer. For example, a microparticle for the solid electrolyte may be sized at or greater than 100 microns (μm) when used in a membrane with a thickness of 100 microns.

Next, a slurry containing the particles, and matrix (such as epoxy pre-polymers), is casted onto a substrate (step 210) to form a dense coating in which the particles may be embedded in a matrix. In one embodiment, the matrix materials (such as pre-polymers) may function also as a thickener. Additionally, the substrate may include but not be limited to: fluorinated ethylene propylene (FEP), polytetrafluoroethane (PTFE), silicone, polyethylene (PE), polypropylene, kapton, polyethylene terephthalate (PET), etc. Additionally, the substrate may also be composed of one material but coated with one of the aforementioned materials (fluorinated ethylene propylene (FEP), polytetrafluoroethane (PTFE), silicone, polyethylene (PE), polypropylene, kapton, polyethylene terephthalate (PET), etc.) to give the resulting substrate similar or same surface properties enabling delamination of the resulting coating. The film coating is then cured (step 212). As an example, the curing may occur through thermal, and/or UV curing. A result of the curing may include a densely crosslinked matrix.

In various embodiments, suitable materials for the pre-polymers for thermally crosslinked epoxies may include any multifunctional epoxide molecule (Epon828, and/or PEG-DGE, etc.) and amine crosslinkers (melamine, phenylenediamine, and/or jeffamine D-230, etc.). Suitable materials for UV-cured polymers may include multifunctional acrylates/methacrylates (e.g., PEGDMA, and/or PEGDA, Urethane dimethacrylate, bisphenyl A diglycidyl ether acrylate etc.) and photoinitiators (e.g., Darocur 1173). Thermal initiators such as AIBN or BPO may be used in place of a photoinitiator. The crosslinked matrix may have a structure that prevents the diffusion of any substance (most notably water and gases), as a result of its hydrophobic structure and densely crosslinked nature.

Lastly, the film coating is then polished (step 214), including one or both sides, using an abrasive pad. This could be done on a roll-to-roll operation in which the membrane roll with the film coating may be passed through a series of abrasive pads that rotate/slide in order to grind down the surfaces of the membrane, thereby removing the outermost regions of the membrane. After polishing, individual solid electrolyte particles embedded in the membrane may each have large areas of exposed surfaces on both sides of the membrane, providing a route for Li+ ions (or any membrane specific ion) to completely traverse the membrane without the need to travel through multiple particles.

The membrane as discussed herein can be fabricated using web coaters. With respect to scalability of production of such a membrane, as increased battery manufacturing capability comes online to meet growing demand, a single conventional roll-to-roll coater (having a footprint small enough to fit in an office cubicle) can produce enough membrane (such as the solid electrolyte membrane 100) to match each additional 2GWH of lithium battery manufacturing capacity. Additional web coaters can be added to operate in parallel (as lithium battery manufacturing capacity continues to increase with time). Moreover, these web coaters can be collocated near the battery factory. In this manner, production of the solid electrolyte is space-efficient and scalable, and can satisfy expected industry demands.

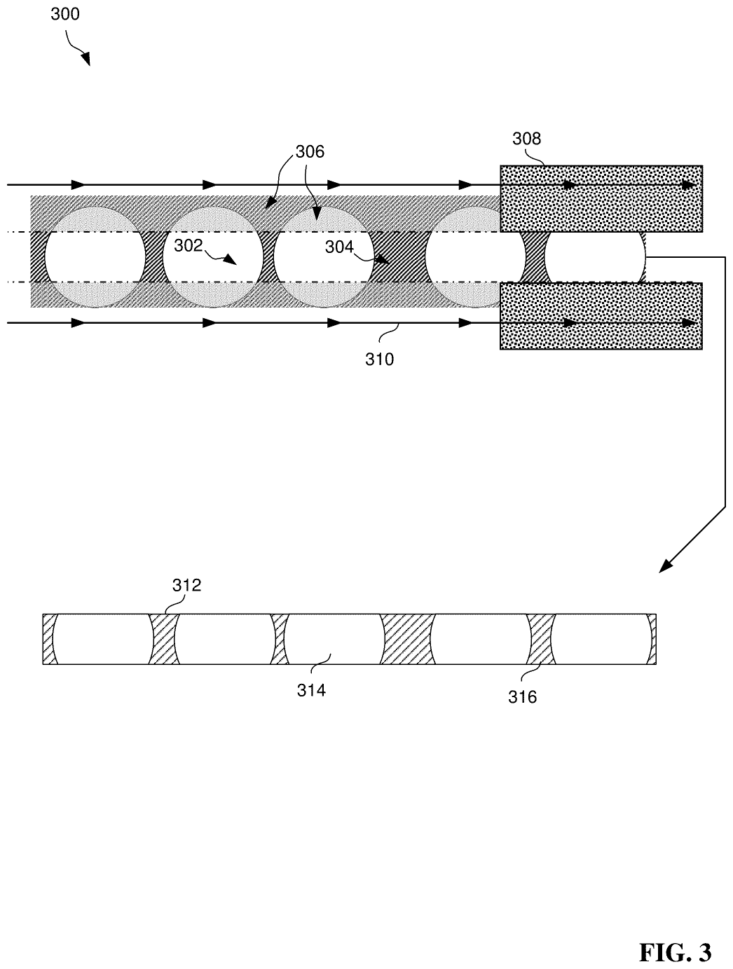

FIG. 3 illustrates a process 300 for mechanical polishing the solid electrolyte membrane, in accordance with one embodiment. As an option, the process 300 may be implemented in the context of any one or more of the embodiments set forth in any previous and/or subsequent Figures and/or description thereof. Of course, however, the process 300 may be implemented in the context of any desired environment. Further, the aforementioned definitions may equally apply to the description below.

As shown, the solid electrolyte 302 is embedded within a matrix 304. Mechanical polishers 308 may be used to polish one or more surfaces of the membrane film (containing both the solid electrolyte 302 and the matrix 304). In various embodiments, the solid electrolyte 302 may extend to a surface of the membrane film. In other embodiments, the matrix 304 may extend to a surface of the membrane film. In either case, additional material 306 (either of the solid electrolyte 302 and/or the matrix 304) may be present within the membrane film. In various embodiments, the polishing may occur one side at a time (in series), or both sides simultaneously (assuming both sides polished is desired). Additionally, in one embodiment, a first side may be polished, the coating may then be removed from the release film and transferred to the surface of the electrode (active material coating), where the polished side faces the active material coating, then the resulting laminate is polished once again to expose the solid electrolyte particles on the remaining side.

The membrane film may be polished by passing 310 the membrane film through one or more series of abrasive pads that rotate/slide in order to grind down the surfaces of the membrane film, thereby removing the outermost regions of the membrane film.

After polishing one or more surfaces of the membrane film, polished membrane 312 includes a first exposed surface 314 of the solid electrolyte and a second exposed surface 316 of the matrix. As such, individual solid electrolyte particles embedded in the membrane film may each have large areas of exposed surfaces on both sides of the membrane, providing a route for Li+ ions to completely traverse the membrane without the need to travel through multiple particles.

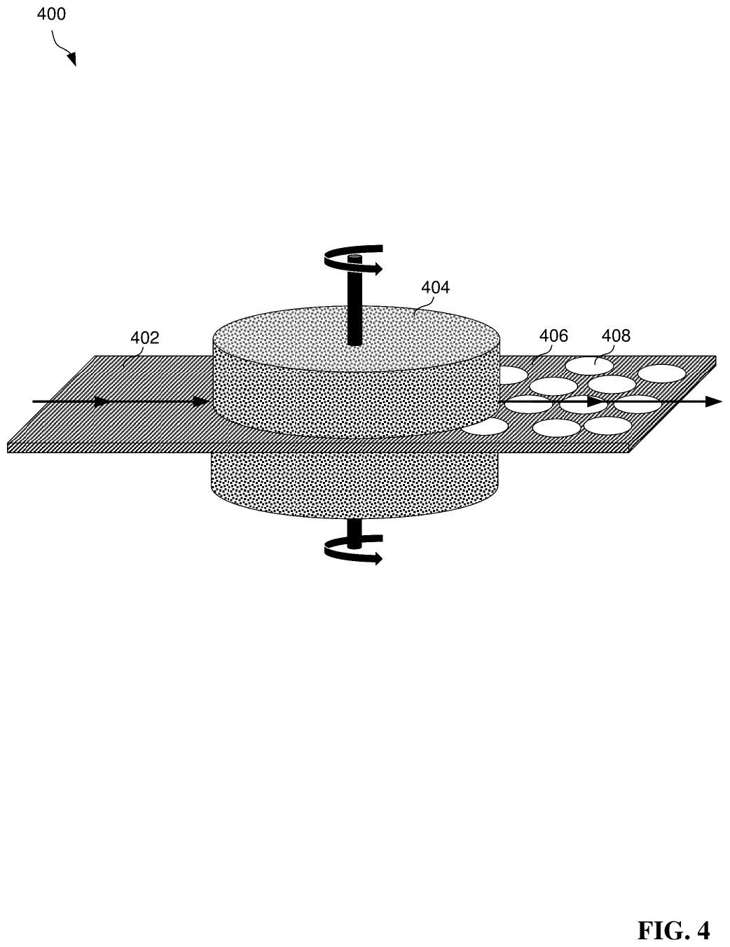

FIG. 4 illustrates a roll-to-roll process 400 for mechanical polishing the solid electrolyte membrane, in accordance with one embodiment. As an option, the roll-to-roll process 400 may be implemented in the context of any one or more of the embodiments set forth in any previous and/or subsequent Figures and/or description thereof. Of course, however, the roll-to-roll process 400 may be implemented in the context of any desired environment. Further, the aforementioned definitions may equally apply to the description below.

As shown, a membrane film 402 may be polished on one or more sides (shown as polishing on both sides in the roll-to-roll process 400) using a mechanical polisher 404 (such as an abrasive pad). The roll-to-roll process 400 shows a roll-to-roll operation in which the membrane film 402 roll is passed through a series of mechanical polishers 404 that rotate/slide in order to grind down the surfaces of the membrane film 402, thereby removing the outermost regions of the membrane film 402. After passing through the mechanical polishers 404, a first exposed surface of the matrix 406 and a second exposed surface of the solid electrolyte 408 may be shown.

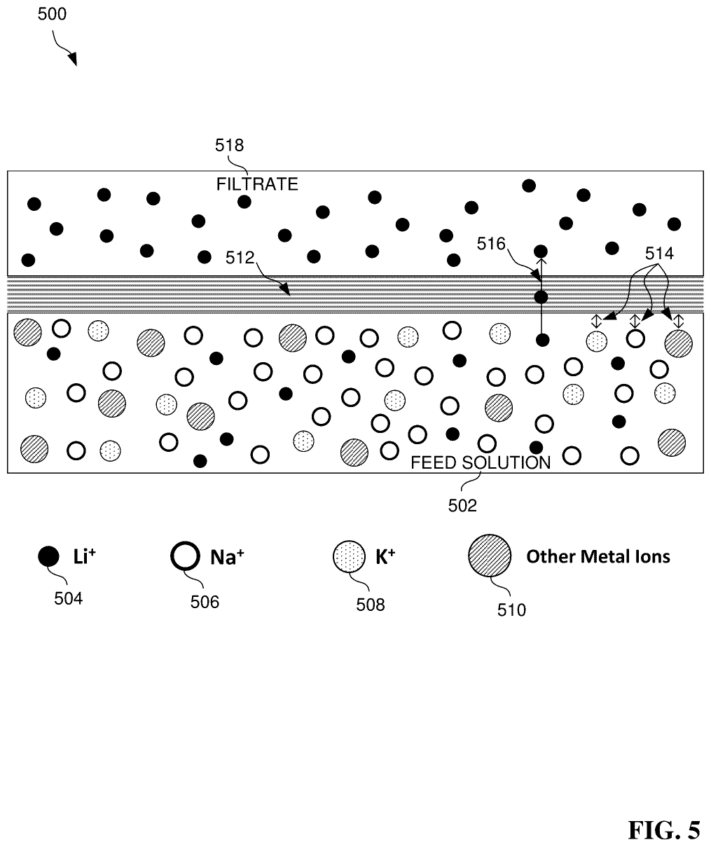

FIG. 5 illustrates an ion-selective solid electrolyte membrane 500, in accordance with one embodiment. As an option, the ion-selective solid electrolyte membrane 500 may be implemented in the context of any one or more of the embodiments set forth in any previous and/or subsequent Figures and/or description thereof. Of course, however, the ion-selective solid electrolyte membrane 500 may be implemented in the context of any desired environment. Further, the aforementioned definitions may equally apply to the description below.

As shown, the ion-selective solid electrolyte membrane 500 includes a feed solution 502, which may include a collection of many different types of ions, including but not limited to lithium Li⁺ 504, sodium Na⁺ 506, potassium K⁺, and/or other metal ions 510. The feed solution 502 may additionally include any aqueous solution containing one or more of lithium Li⁺ 504, sodium Na⁺ 506, potassium K⁺, and/or other metal ions 510.

Additionally, a membrane 512 may be used to selectively allow an ion, in this exemplified case, lithium Li⁺ 504, to pass 516 through the membrane 512. In contrast, the membrane 512 may be used to prevent other ions, in this exemplified case, sodium Na⁺ 506, potassium K⁺, and/or other metal ions 510, from passing 514 through the membrane 512. The accumulated ions that pass through the membrane 512 may be found in the filtrate 518.

It is to be appreciated that world demands for lithium continues to increase (especially as demands for electrification of vehicles increase). Using the ion-selective solid electrolyte membrane 500 may allow for extraction of lithium from lithium minerals, as well as from otherwise unused or discarded sources, including but not limited to recycled lithium batteries, and even seawater (especially as seawater contains >99% of the Earth's accessible Li supply). Current systems (such as from Li brines and/or Li minerals) fail to recover lithium (and other alkali metals) from unconventional sources, and/or are problematic (in terms of selectivity, durability, and/or scalability).

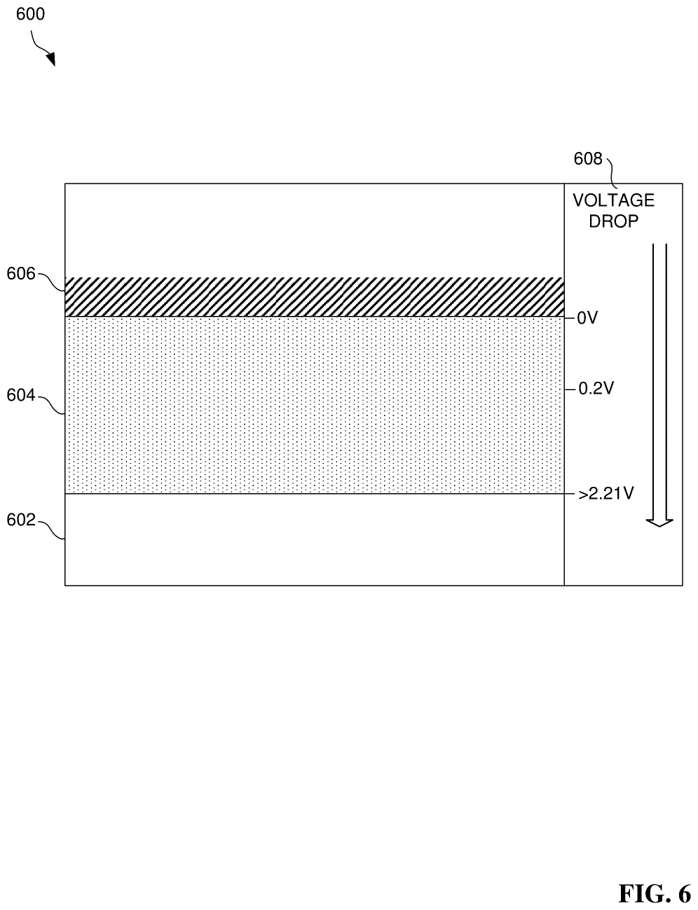

FIG. 6 illustrates voltage drop 600 using a carbon-based membrane, in accordance with one embodiment. As an option, the voltage drop 600 may be implemented in the context of any one or more of the embodiments set forth in any previous and/or subsequent Figures and/or description thereof. Of course, however, the voltage drop 600 may be implemented in the context of any desired environment. Further, the aforementioned definitions may equally apply to the description below.

As shown, the voltage drop 600 may occur using a membrane 604. For example, the membrane 604 may be in contact with a feed solution 602 and an electrode 606. As ions pass through the membrane 604, they may experience a voltage drop 608. In various embodiments, the membrane 604 may be carbon-based (without solid electrolyte particles). In this particular embodiment, carbon-based particles may carry lithium ions through capacitive adsorption rather than through the intrinsic crystal structure of the material (as is the case with solid electrolyte particles). It is to be understood, however, that the voltage drop 600 may occur for any type of membrane used (whether it be carbon-based or solid electrolyte particles).

In one particular embodiment (and as an alternative to the membrane 604), the separation membrane may include multiple layers of graphitic carbon. For example a capacitor-like carbon-based membrane may interface and be in contact with the feed solution 602. Additionally, a graphitic carbon membrane may be a second layer within the membrane. It is to be appreciated that any number of layers of graphitic carbon may be used. Based on interaction with the graphitic carbon, the ions that pass through the capacitor-like carbon-based membrane and the graphitic carbon membrane may accumulate as solid metal (such as metallic lithium Li). Further, ions may accumulate at the electrode 606 (which may include but not be limited to graphite). The electrode 606 may be made of low-porosity graphite, prepared via high-temperature sintering of carbonaceous precursors (e.g., polymers such as polyacrylonitrile (PAN)) over prolonged periods of time.

In one embodiment, the membrane 604 and/or the multilayer membrane of graphitic carbon may be configured to selectively extract lithium ions (and/or any preconfigured alkali metal ion) from a precursor/feed solution containing an abundance of the selected ion and other ions. This precursor/feed solution may include lithium-rich brines, an aqueous solution of ions produced upon acid leaching of lithium minerals, an aqueous solution of ions produced via dissolution (with or without acid) of a discarded/recycled battery, sea water, and/or any other aqueous solution containing the desired ions to be extracted.

With respect to the multilayer membrane of graphitic carbon, it may consist of multiple layers (such as the capacitor-like carbon-based membrane, the graphitic carbon membrane, etc.) each composed of various types of carbon.

Additionally, with respect to the graphitic carbon membrane of the multilayer membrane of graphitic carbon, it may be composed of graphitic carbons bound together with a matrix (including polymeric binders such as polyvinylidene fluoride (PVDF), epoxy) and/or compression plates. With respect to the capacitor-like carbon-based membrane, it may be another membrane layer composed of carbon particles bound together via polymeric binders or compression plates (similar to the graphitic carbon membrane).

In one embodiment, regardless of whether the membrane 604 or the multilayer membrane of graphitic carbon is used, as the alkali metal (such as lithium) travels through the membrane, the alkali metal may be electrochemically reduced to its metallic state (such as Li). Additionally, with respect to the membrane 604, the alkali metal may be reduced to its metallic state. As such, an active material (such as graphite) may be chosen with a reduction potential close to that of metallic alkali metal (such as Li), such that the membrane may be in direct electrical contact with the active material, and the current density may be high enough (or the active material may be overcharged) to initiate formation of metallic alkali metal (Li). Further, the cell design may include a separator between the active material coating and the membrane 604 to prevent direct electrical contact. Additionally, if it were desired to plate metallic Li, an electrode could be created with no active material (such that metallic Li may directly plate on the current collector or any electronically-conductive surface in the electrode), and/or the active material may be overcharged such that all available sites for Li insertion into the active material may be occupied (leading to plating of metallic Li upon further charging). It is to be understood that although reduction to a metallic state is feasible, the system may be set to prioritize energy efficiency (which in turn may require low current density demands to reduce energy loss due to ohmic resistance). As such, the system may be modified to prioritize desired outcomes (such as, but not limited to, energy efficiency, metallic reduction, etc.).

In one embodiment, the voltage drop may relate to the stability of the membrane 604 with respect to water. With respect to this particular application, the voltage drop may be either ionic or electronic in nature. Additionally, if the voltage drop were electronic, that may allow for safe operation of the membrane 604 in contact with water.

In this manner, the feed solution 602 may function as an electrolyte, and the electrode 606 may function as an anode. Such phenomenon is illustrated by voltage drop 608. The voltage drop may be due to Ohmic resistance as described by V=IR. The resistance R of the membrane layer(s) may be fixed based on the design, but the voltage drop V varies with the current I that is applied. Since the intercalation of lithium ions into graphite (lithiation) occurs at reduction potentials well below the reduction potential of water, a voltage drop may be necessary in order to prevent the current from reducing water (which would significantly reduce the efficiency of the design). Since the difference in reduction potential of lithium metal and water is 2.21 V (but preferably higher to provide an adequate electrochemical buffer), in one embodiment, the membrane may operate at a current I such that the electrons experience a voltage drop of at least 2.21 V as to not reduce water.

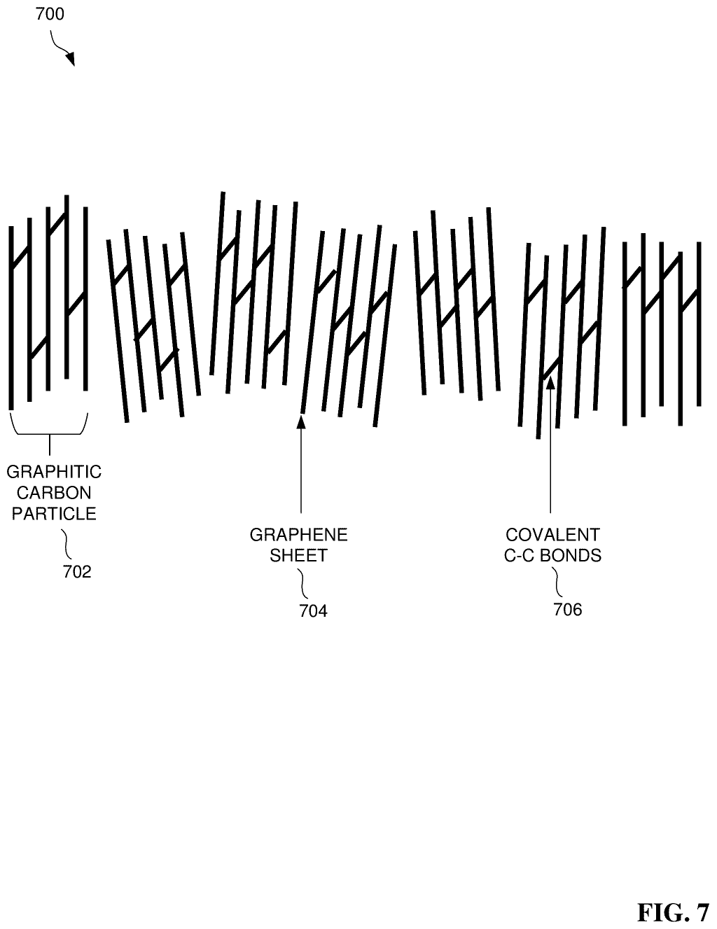

As shown later (in FIG. 7), individual sheets of graphene within the carbon particles (of either or both of the capacitor-like carbon-based membrane and the graphitic carbon membrane of the multilayer membrane of graphitic carbon) may be covalently adhered to one another (as opposed to van der Waals forces). This covalent bond may significantly increase the amount of energy required to push apart the lattices (e.g., it is intolerable to strain). Thus, the sizing of the distance between the sheets of graphene may be tuned to the particular size ion that should pass through the membrane.

In operation, the graphitic carbon particles of the multilayer membrane of graphitic carbon (in either or both of the capacitor-like carbon-based membrane and the graphitic carbon membrane) may extract ions from the feed solution 602 via electrochemical intercalation/adsorption. Since electrochemical intercalation of Li requires the lowest strain (10 vol %) among all ions that are likely to be found in the feed solution 602, the selectivity of Li will be highest. Additionally, by increasing the degree of covalent C—C bonds between adjacent sheets of graphene, the selectivity of Li over other ions is even further enhanced, as a substantial amount of strain would be required for other ions to intercalate. In this manner, an effective voltage drop may occur as the selected ion (such as Li⁺) passes through the capacitor-like membrane and the graphitic carbon membrane of the multilayer membrane of graphitic carbon. In similar manner, as the selected ion (such as Li+) passes through the membrane 604, it may also experience an effective volage drop.

In one embodiment, the carbon particles contained in the capacitor-like carbon-based membrane of the multilayer membrane of graphitic carbon may serve multiple purposes. For example, they may serve as an electrical buffer layer between the graphitic carbon membrane and the feed solution 602 (which is likely to be an aqueous solution). Additionally, the carbon particles may extract ions from the feed solution 602 and transport such ions to the graphitic carbon membrane of the multilayer membrane of graphitic carbon.

Additionally, the electrochemical buffering effect may be achieved via the hydrophobic nature of the materials (such as carbon) in the capacitor-like carbon-based membrane, and by a large electrochemical voltage drop across the capacitor-like carbon-based membrane. Such voltage drop 608 may prevent the reduction of water at the interface between the feed solution 602 and the capacitor-like carbon-based membrane of the multilayer membrane of graphitic carbon. This voltage drop is achieved by tuning the thickness and resistivity of the membrane, as governed by Ohm's law (V=IR, where R=(resistivity)*(thickness/area).

As such, alkali metal ions may be extracted via electrochemical and capacitive adsorption of ions on the surface of the carbon particles. By tuning the porosity and surface area of the carbon particles, the kinetics of ion transport can be tuned. Though all ions are possible to adsorb onto the carbon particles, lighter ions and monovalent ions (e.g., alkali metal ions) can move much more rapidly through the membrane 604 (to the electrode 606).

In various embodiments, the design of the membrane 604 can be modified such that the alkali ion (such as lithium) does not fully reduce all the way to its metallic state (such as metallic Li) and/or plate on the surface of the electrode 606.

In one embodiment, reducing the alkali ion to its metallic stage may be limited by making the graphitic carbon membrane substantially larger (in terms of thickness of layer) such that the alkali metal (such as lithium) extracted may be completely contained within the graphitic carbon membrane (and subsequently removed).

In like manner, using the membrane 604 may allow for recovery of the electrical energy used to drive this reaction, reducing the net energy requirement and therefore cost of the material. In other words, energy used to drive the displacement of alkali metals (from a feed solution) to an electrode may, in turn, be stored in the form of electrochemical energy, which may discharged at a later time.

FIG. 7 illustrates a close-up diagram 700 of graphitic carbon, in accordance with one embodiment. As an option, the close-up diagram 700 may be implemented in the context of any one or more of the embodiments set forth in any previous and/or subsequent Figures and/or description thereof. Of course, however, the close-up diagram 700 may be implemented in the context of any desired environment. Further, the aforementioned definitions may equally apply to the description below.

As shown, the close up diagram 700 of graphitic carbon includes a graphitic carbon particle 702. Additionally, such graphitic carbon particle 702 (collectively) may include individual graphene sheets 704, where a covalent carbon-carbon bond 706 links the individual graphene sheets 704 together.

In one embodiment, the graphitic carbon membrane 606 described hereinabove may be tuned such that the surface area (of the graphitic carbon particle 702) may be minimized, and the interplanar fusion (e.g., covalent C—C bonds between adjacent sheets of graphene in the lattices) may be maximized.

By decreasing the surface area of the graphitic carbon particle 702, the amount of ions that can be held on the surface of the carbon particles may be greatly decreased, minimizing the amount of undesired ions extracted from the membrane.

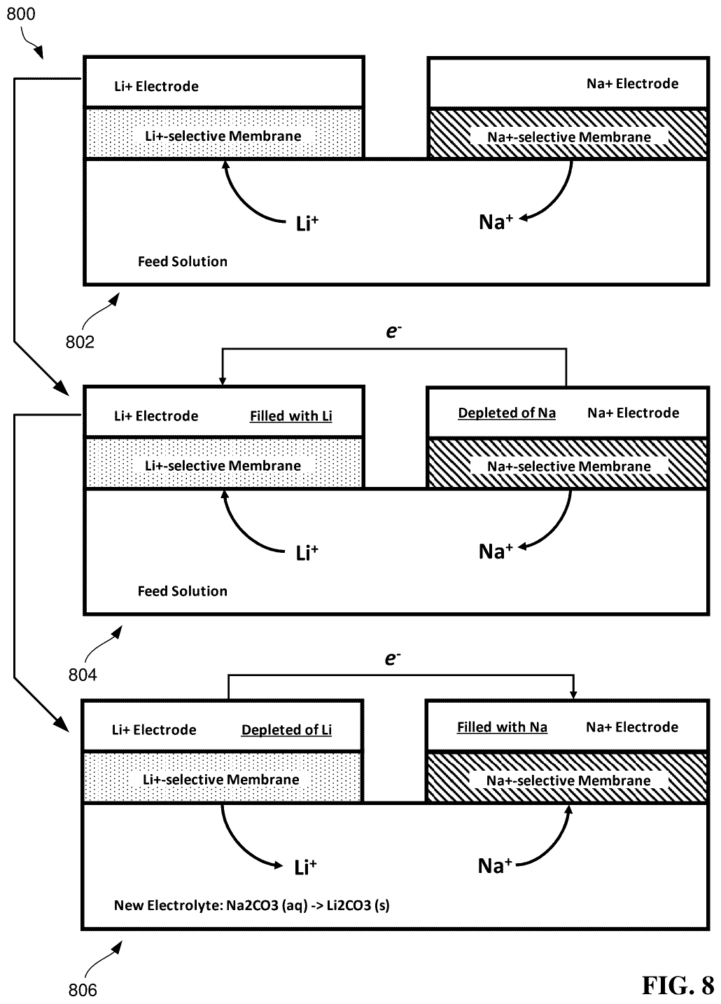

FIG. 8 illustrates a process 800 for recovering energy from lithium extraction, in accordance with one embodiment. As an option, the process 800 may be implemented in the context of any one or more of the embodiments set forth in any previous and/or subsequent Figures and/or description thereof. Of course, however, the process 800 may be implemented in the context of any desired environment. Further, the aforementioned definitions may equally apply to the description below.

As shown, step 802 shows lithium present in a feed solution. Two membranes may be interfaced with the feed solution, a first membrane as a lithium selective membrane (consistent with use of the solid electrolyte 102 embedded in the matrix 104 disclosed herein), and a second membrane as a sodium selective membrane. In one embodiment, the sodium selective membrane may use a solid electrolyte embedded in a matrix (similar to the first membrane), but tuned to the particular ion (such as sodium). The first membrane may interface with an electrode, and the second membrane may interface with a second electrode (in other words, a separate electrode for each of the lithium ions and the sodium ions). It is to be appreciated that although lithium and sodium are used in the context of the process 800, the solid electrolyte may be tuned for separation of any particular ion, as disclosed hereinabove. Further, although sodium is shown, any ion which is less reducing than lithium (or the ion to be extracted) may be used.

At step 804, a voltage is applied to the process 800 which, in turn, may cause the lithium ions to transfer from the feed solution to the lithium electrode via the lithium selective membrane. As lithium is removed from the feed solution, sodium ions may be depleted from the sodium electrode (and transfer to the feed solution). Once the lithium ions are stored in the lithium electrode, the energy inputted (to cause the lithium ions to transfer to the lithium electrode) may be stored in the form of electrochemical energy.

At step 806, the feed solution may be changed to a new electrolyte (to such as Na2CO3), and lithium ions stored at the lithium electrode may transfer back to the new electrolyte (which in turn may then form Li2CO3). Sodium ions that were in the new electrolyte may transfer from the new electrolyte to the sodium electrode (via the sodium selective membrane).

The electrochemical energy (stored via the lithium ions on the lithium electrode) may be released with the transfer of the lithium ions from the lithium electrode to the new feed solution (the new electrolyte). In one embodiment, the energy released through the transfer may be stored via any conventional system (such as an external battery, etc.). Such released energy may then be used to drive the process 800 again to extract the ions, which after extraction, the energy may be reclaimed (to drive future extraction of lithium ions). In this manner, once the process 800 is initially established (such that the initial extraction is achieved), energy may be reclaimed, and in turn, used to drive future extraction/separation.

By way of greater detail, the energy required for extraction of lithium from the feed solution into the lithium electrode and for expulsion of lithium from the lithium electrode to the new electrolyte (the final solution) may be dependent on the current density, where a higher current density corresponds with a higher energy need to overcome energy dissipation through ohmic resistance, and the difference in reduction potentials of the electrodes used for the two electrodes (shown as the lithium electrode and the sodium electrode). If the active material for the lithium electrode has a lower reduction potential than the active material for the opposite electrode (shown as the sodium electrode), an input of energy may be required to extract lithium ions from the feed solution (corresponding to the expulsion of the second ion from the opposite electrode, again, shown as the sodium ion from the sodium electrode), which can be recovered when subsequently expelling the lithium from the lithium electrode to the new electrolyte, which may correspond with the extraction of the second ion (shown as sodium) from the new electrolyte to the sodium electrode. If the active material for the lithium electrode has a higher reduction potential than the active material for the opposite electrode (shown as sodium electrode), an input of energy may be required to expel lithium ions from the feed solution (corresponding to the expulsion of the second ion from the opposite electrode), which can be recovered when subsequently extracting lithium from the lithium electrode.

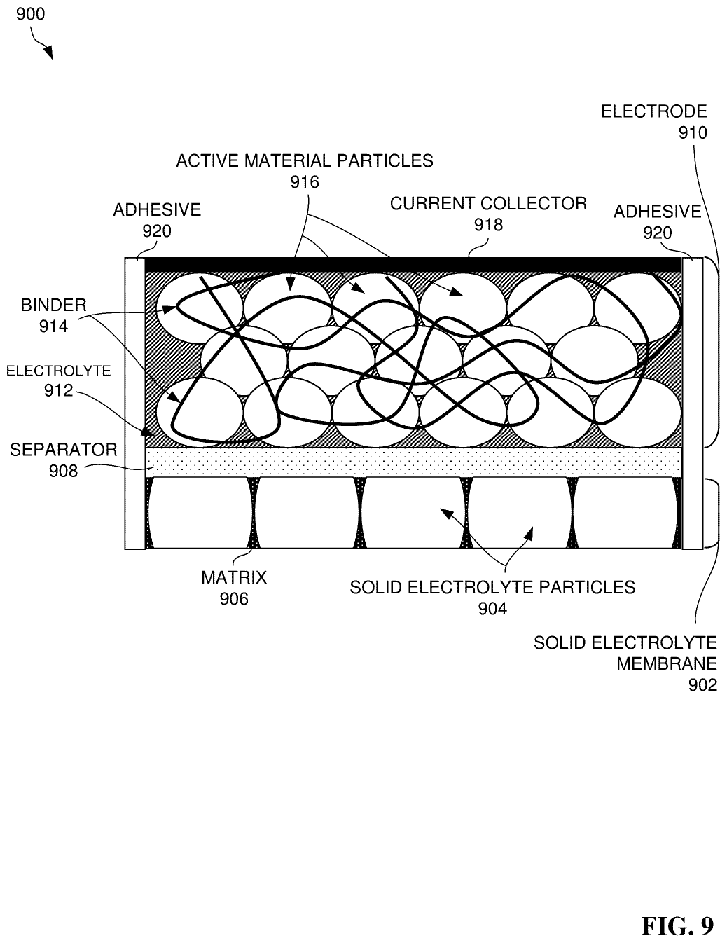

FIG. 9 illustrates a cell architecture 900, in accordance with one embodiment. As an option, the cell architecture 900 may be implemented in the context of any one or more of the embodiments set forth in any previous and/or subsequent Figures and/or description thereof. Of course, however, the cell architecture 900 may be implemented in the context of any desired environment. Further, the aforementioned definitions may equally apply to the description below.

As shown, the cell architecture 900 may include a solid electrolyte membrane 902, which in turn, may comprise solid electrolyte particles 904 embedded in a matrix 906. The solid electrolyte membrane 902 may be separated from the electrode 910 via the separator 908. The electrode 910 may comprise an electrolyte 912, a binder(s) 914, active material particles 916, and a current collector 918. An adhesive 920 may line the entirety (on both sides) of the solid electrolyte membrane 902, the separator 908, and the electrode 910.

With respect to the electrode 910, the current collector 918 may serve as an electronically conductive substrate for transferring electricity on which the active material coating is bound on. Additionally, the current collector may be one of the following (but not limited thereto): copper, aluminum, stainless steel, nickel, titanium, graphene.

The active material particles 916 may be the location where alkali metal ions and electrochemical energy are stored. Additionally, the active material particles 916 may serve as a host for the extracted lithium ions and store the energy input for extraction in the form of electrochemical energy.

In various embodiments, suitable electrode materials for a lithium electrode may include, but not be limited to, carbon-based materials (graphite, carbon nanotubes (CNT), graphene, carbon nano onions (CNO), hard carbons), lithium intercalation materials such as lithium titanium oxide (LTO), lithium manganese oxide (LMO), lithium iron phosphate (LFP), lithium manganese phosphate, lithium cobalt phosphate, lithium cobalt oxide (LCO), lithium nickel oxide, lithium nickel manganese cobalt oxide (NMC), lithium nickel cobalt aluminum oxide (NCA), lithium titanium sulfide, lithium vanadium phosphate (LVP), lithium iron sulfate fluoride (LFPF), lithium conversion materials such as halides of the form MXx, where M can be Fe, Co, Ni, Bi, Cu, Ag, and X can be F, Cl, Br, or I, lithium chalcogenides such as S, Se, Te, metals and metalloids that alloy with lithium such as Si, Sn, Ge, Ga, Mg, Al, Zn, In, Au, Ag, Pt, other nonmetals in the group of iodine or oxygen, or lithium metal.

With respect to a sodium electrode (or a less reducing element compared to the ion to be extracted), it may be composed of an active material which may serve as a host for the sodium ion (or whatever ion is selected). In the case of Na+ or K+, the active material may be composed of Fe4[Fe(CN)6]3 (Prussian blue), Prussian blue analogues of the form M1x[M2y(CN)6]3, where M1 and M2 is a metal in the group of Fe, Ni, Cu, Mn, Co, Ti, Cr, Zn, carbon-based materials (graphite, carbon nanotubes (CNT), graphene, carbon nano onions (CNO), hard carbons). In the case of Na+, the active materials may also include materials alloying with sodium such as P, K, or sodium metal. In the case of K+, the active materials may also include materials alloying with potassium such as Na, or potassium metal.

In one embodiment, the active material particles 916 may also store ions via capacitive/pseudocapacitive mechanisms, such as graphene, carbon nanotubes (CNT), carbon nano onions (CNO), Mxenes, metal oxides, such as ZnO, TiO2, SnO2, RuO2, Co304, MnO2, NiO, NiCo2O4, Fe3O4, Fe2O3, and V2O5.

The binder 914 may adhere the active material particles 916 to the current collector 918 while providing cohesion among active material particles and other additives. The binder 914 may include one or more of the following (but not be limited thereto): poly(vinylidene fluoride) (PVDF), carboxymethylcellulose (CMC), styrene-butadiene rubber (SBR).

The electrolyte 912 may serve as a medium for transporting alkali metal ions to and from the active material (including the active material particles 916) and solid electrolyte membrane 902. The electrolyte may contain one or more salts dissolved in a solvent system of one or more components. The salt may contain one or more of any of the following cations: H+, Li+, Na+, K+, Cs+; and one or more of any of the following anions: Cl—, Br—, I—, NO3-, SO42-, PO43-, PF6-, TFSI-, FSI-, OTf-, ClO4-. The solvent may be one or more of the following: Water, dimethoxyethane (DME), dioxolane (DOL), tetrahydrofuran (THF), dimethyl carbonate (DMC), propylene carbonate (PC), ethylene carbonate (EC), ethyl methyl carbonate (EMC).

Still yet, the separator 908 may optionally serve as a reservoir for the electrolyte 912 and as an electronically insulating barrier between the active material (such as the active material particles 916) and the solid electrolyte membrane 902.

The adhesive 920 may surround the edges of the electrode 910, and may serve as an impermeable barrier between the inside and outside of the electrode 910. The adhesive may be composed of (but not be limited thereto) epoxy, polyurethanes, polyimides, cyanoacrylates, or acrylic adhesives cured via thermal or UV curing.

Still yet, a second electrolyte (including liquid) may be used in the electrode 910. The edges of the electrode 910 may be protected (edge sealant, glue sealant, etc.) to prevent a feed solution from reaching the active material (such as the active material particles 916) through these exposed areas.

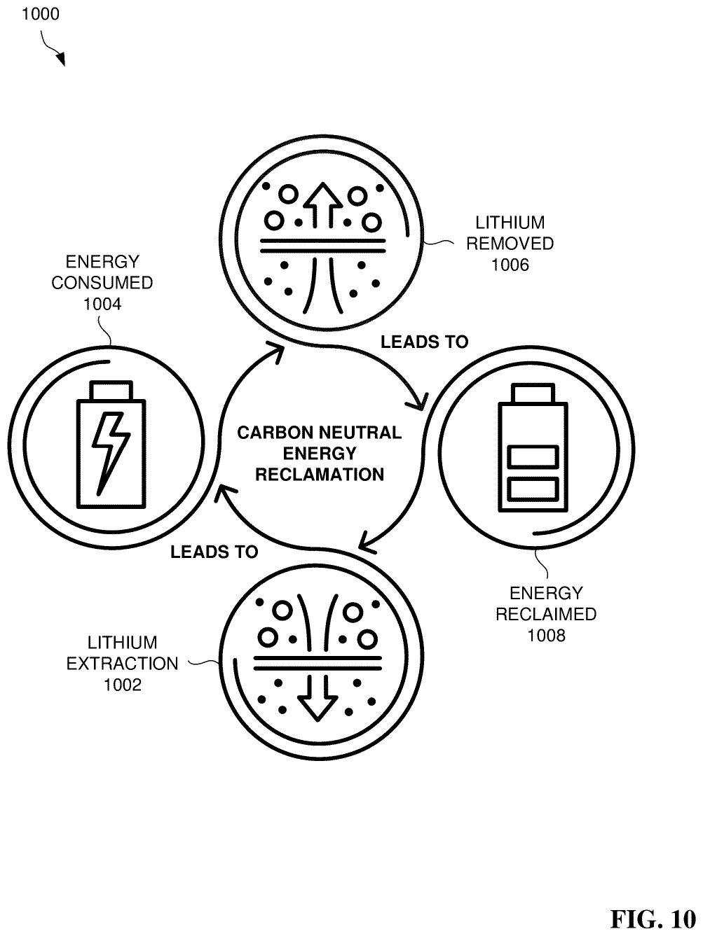

FIG. 10 illustrates a system and method 1000 for a carbon-neutral energy reclamation battery recycling, in accordance with one embodiment. As an option, the system and method 1000 may be implemented in the context of any one or more of the embodiments set forth in any previous and/or subsequent Figures and/or description thereof. Of course, however, the system and method 1000 may be implemented in the context of any desired environment. Further, the aforementioned definitions may equally apply to the description below.

FIG. 10 is being presented to illustrate a virtuous cycle that encompasses sustainability of both lithium extraction as well as sustainability of energy reclamation. For example, lithium has become ubiquitous in nearly all electric or electronic products, from batteries to armor plating, from to bicycle frames to glass, from lubricants to ceramics and more. Conventional systems and methods for obtaining lithium extract the lithium from raw materials such as from rocks and/or from mineral springs. It is well known that the global demand for lithium will deplete all known commercially viable sources of such raw materials. It therefore becomes imperative to recycle lithium. One source of lithium that is a candidate for recycling is from used lithium-containing batteries. However, to be sustainable, the techniques for lithium extraction must be highly energy efficient and scalable.

The present description relates not only to extraction methods for lithium, but additionally to how to recover energy spent to extract the lithium. In use, extracting lithium ions from a feed solution using a membrane having a solid electrolyte may cause a voltage drop. The extracted lithium ions may be stored on an electrode. When needed, the lithium ions can then be transferred from the electrode, which in turn, may cause a discharge of the energy stored. In this manner, the extraction, storage, and discharge steps correspond with a typical anode and cathode assembly, and the typical charging/discharging of energy based on the flow of ions.

Additionally, reclamation techniques disclosed herein are scalable so as to be able to meet the forecasted worldwide EV battery recycling demands through this decade and into the decades to follow. To illustrate the needed scale, it is estimated that 10TWh of EV battery capacity will be demanded between now and the beginning of 2030, with over 1TWh being demanded in calendar year 2025 alone. This demand, in turn, may require around 125,000 tons (or more) of lithium for EV batteries each year. It is acknowledged that a substantial high percentage of this lithium tonnage can be reclaimed from spent batteries.

In view of this large scale, a primary challenge is reclamation efficiency. The techniques disclosed herein meet this challenge by implementing energy recycling, resulting in an extremely low demand for energy needed to accomplish the lithium reclamation. For example, for a single factory that reclaims 1500 tons of lithium per year, using the energy reclamation techniques disclosed herein, a continuous power demand of only 44 KW may be required (a number that is small enough to be provided by banks of solar panels that fit on the roof-space of an EV battery factory). As such, the disclosure herein not only provides for more efficient separation of lithium from feed solution, but additionally provides for significant energy reclamation associated with the lithium extraction.

As such, based on the ability to recover energy spent (to extract) through the discharging of ions may allow for a near carbon-neutral system for ultra-efficient electric battery recycling. As demand for lithium continues to increase, the need to recycle and recover lithium sustainably from preexisting lithium-containing items will likewise increase. Additionally, with the push for more green energy, the present description provides for recovery of a substantial fraction of energy spent for extracting lithium ions, which in turn results in an environmentally prudent and responsible alternative to known methods and systems.

Additionally, known separation membranes often will crack and fail as time goes on, resulting in both time inefficiencies and fiscal losses (in having to replace the electrolyte). Further, other membranes (e.g., adsorption membranes, etc.) may have membrane fouling, which in turn, may decrease the efficiency and lifetime of the membrane. The membrane disclosed herein, in contrast, is bound in a stable matrix that does not suffer from (or have much less of) membrane fouling or membrane cracking (e.g., as a consequence of volume expansion during extraction, etc.), which in turn, increases longevity of the electrolyte and the membrane, thereby overcoming said inefficiencies and losses.

As shown, the system and method 1000 includes extracting lithium (step 1002). The extraction of lithium may occur using a solid electrolyte membrane (such as the solid electrolyte membrane 100, detailed herein). In extracting the lithium, energy may be consumed (step 1004).

In one embodiment, a voltage drop (such as the voltage drop 608 due to transporting of lithium ions) may be due to ohmic resistance (V=IR). Since I (or desired current I) is generally dictated by a desired extraction rate of Li, an extractor may be configured to minimize R in order to result in the lowest voltage drop V (corresponding to, for example, unreclaimable electricity). Since resistance is proportional to the membrane thickness and inversely proportional to conductivity, the system may be constructed to use charge-conducting components (e.g., such as the Li+ extraction membrane) with minimal thickness and maximum conductivity.

The lithium ions that are extracted are stored on an electrode. When the energy is needed, a second electrolyte may be used to facilitate the removal and transfer of lithium ions from the electrode (step 1006). In removing and transferring the lithium ions from the electrode, energy may be reclaimed (step 1008).

In operation, therefore, lithium may be extracted from a feed solution using a first membrane, stored on an electrode, and then transferred out using an electrolyte solution. The energy required to extract the lithium ions from the feed solution may be recovered when the lithium ions are transferred from the electrode. Once the lithium ions are transferred out (to the electrolyte solution), the lithium ions may be in the form of lithium carbonate (or an equivalent thereof). In operation, as the lithium is extracted (per step 1002), it may be removed from the feed solution and stored on the electrode. As lithium ions are transported from the feed solution, they may be, in turn, replaced with other ions (such as sodium) which may be transported from a second electrode, through a second membrane and into the feed solution. At a later time, the feed solution may be removed and replaced with an electrolyte solution. For example, in various embodiments, the membrane may be physically removed from the feed solution (like a sponge is removed from a bath), or the membrane may be immersed in a tank containing the electrolyte solution (where the electrolyte solutions can be pumped in/out to change the electrolyte solution. In another embodiment, the extracted lithium may be put into a new solution without needing to replace the original feed solution.

The lithium ions stored on the electrode may then be transported from the electrode to the electrolyte solution. This removal of lithium ions (and transporting of them via the membrane) may cause an energy release which may be reclaimed (via an external battery, for example). In other words, the energy stored in the form of electrochemical energy of the extracted lithium may be reclaimed upon removal of the lithium. As lithium ions move from the electrode to the electrolyte solution, another ion (such as sodium) present in the electrolyte solution may transfer (via the second membrane) to the second electrode. In this manner, as lithium is transported to the electrode, energy may be consumed, and as lithium is transferred from the electrode, energy may be released. This release of energy may, in turn, be used to provide most of the input energy needed for the lithium extraction (via the lithium extraction step 1002 and the energy consumed step 1004).

As such, therefore, the operation of extracting the lithium ions, storing, and then discharging mimics energy charge and discharge cycles of a battery, which in turn, may provide high energy efficiency (due to the recovery of energy inputted).

With respect to the feed solution, previously used and spent batteries may be added to the aqueous solution, and may be the basis from which the lithium ions may be extracted. If it were desired to have greater selectivity (for example of lithium ions), the first membrane (used to extract the lithium ions) may be thickened. To clarify, a thicker membrane may have lower permeation (rate of diffusion through) of water by virtue of a longer distance that the water may need to travel through. As such, a thicker membrane may have a higher selectivity for Li+ uptake via electrodialysis over water uptake via diffusion. Additionally, in one embodiment, the greater the thickness, the greater the voltage drop as well. In other words, the voltage drop may scale linearly with thickness, since resistance scales linearly with thickness.

For example, the first membrane may be tuned to the ion that is to pass through it. In this manner, the membrane may be tuned such that a larger ion, for example, may pass through a first membrane layer, and a smaller ion, for example, may pass through a second membrane layer. For example, a solid electrolyte material may be selected whose crystal structures have inherent selectivity for the desired ion. The ease at which a specific ion may pass through the solid electrolyte material may depend on the amount of energy it takes for ions to “hop” through different sites of the crystal lattice. Ions that are too large or too small will require more energy to hop from site to site. As such, for any given solid electrolyte structure, an “optimal” ion size with the lowest activation energy (and therefore the highest ionic conductivity and selectivity over other ions) may be tuned to the particular solid electrolyte structure. In this manner, a structure of the crystal lattice (of the solid electrolyte) may be tuned for a specific ion (where if the activation energy is too high, it simply will not pass through the membrane, or it will pass through in small or insignificant quantities.

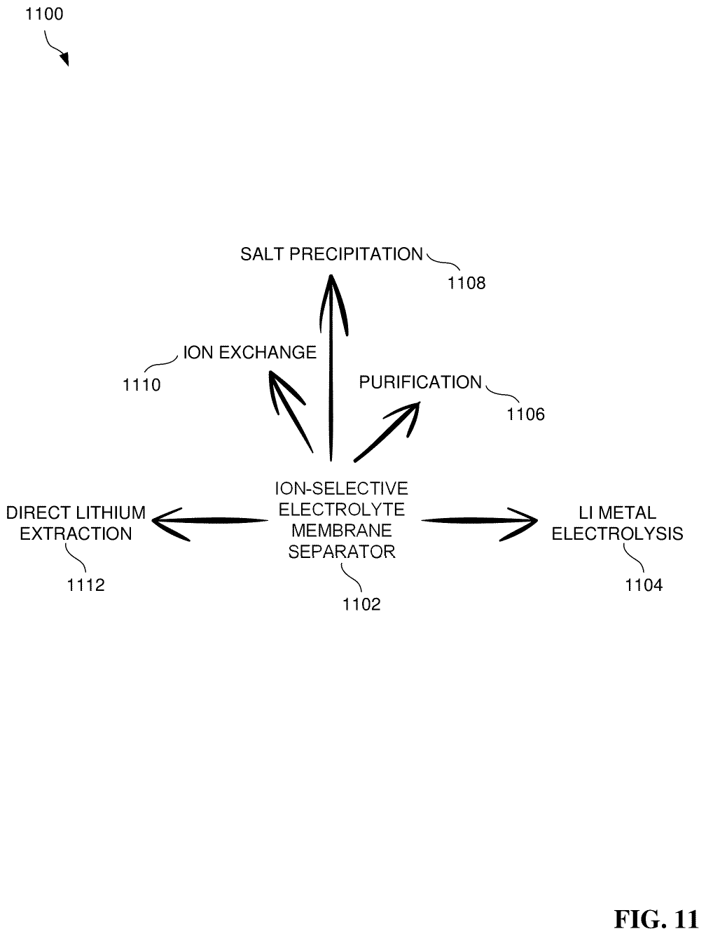

FIG. 11 illustrates various processes 1100 where an ion-selective electrolyte membrane separator may be incorporated, in accordance with one embodiment. As an option, the various processes 1100 may be implemented in the context of any one or more of the embodiments set forth in any previous and/or subsequent Figures and/or description thereof. Of course, however, the various processes 1100 may be implemented in the context of any desired environment. Further, the aforementioned definitions may equally apply to the description below.

In one embodiment, the ion-selective electrolyte membrane separator 1102 may comprise multiple layers of membrane to help further facilitate various ion-oriented processes including, but not limited to purification 1106, salt precipitation 1108, ion exchange 1110, direct lithium extraction 1112, and/or electrolysis 1104.

The ion-selective electrolyte membrane separator 1102 may be applied consistent with the discussion relating to any of the prior (or subsequent) Figures. As shown at a high level, the application of the ion-selective electrolyte membrane separator 1102 may apply to many processes and industries. In particular, such an application may apply to critical mineral industry which may have need of the purification 1106, the salt precipitation 1108, the ion exchange 1110, the direct lithium extraction 1112, and/or the electrolysis 1104. It is to be understood that although much discussion within the present description focuses on lithium, the application of the ion-selective electrolyte membrane separator 1102 may apply equally to any critical mineral.

In one embodiment, existing direct lithium extraction (DLE) battery technology may be used to develop a DLE cell that electrochemically extracts lithium from various brines using an ion-selective solid electrolyte membrane disclosed herein. In operation, DLE cells in combination with the ion-selective solid electrolyte membrane 1102 may be used to convert untapped deposits including, but not limited to, recycled materials, lithium-based alloys, and/or solutions containing atoms such as lithium hydroxide into high-volume sources of lithium. As a result, the resulting lithium may then support production of greater volumes of EV batteries.

In one embodiment, a composition, density, and/or structure of complex brines and the ion-selective electrolyte membrane may be mapped via high-fidelity synchrotron X-ray based imaging, diffraction, and/or spectroscopy.

In one embodiment, electrolyte membrane-assisted direct lithium extraction 1112 may include applications upon lithium battery cell materials, membranes, and/or cell design, which may result in optimized systems capable of pilot-scale (≥1,000 T/year pure lithium basis) extraction of lithium from geothermal brines. Additionally, such electrolyte membrane-assisted direct lithium extraction 1112 practices may be designed to assist accompanying economic and environmental analyses.

In one embodiment, sodium (Na) super ionic conductor (NASICON)-type ceramic electrolytes such as lithium aluminum titanium phosphate (LATP) and lithium aluminum germanium phosphate (LAGP), which have previously been demonstrated to be stable in water and known to have high charge-transport selectivity for lithium ions (Li+) over common ions such as sodium (Na+) and magnesium (Mg²⁺), may be embedded in an impermeable matrix wherein Li+ is selectively removed from a solution under the influence of an electric potential across the membrane. In addition, the ion-selective electrolyte membrane separator 1102 may be incorporated into a cell design consisting of two electrodes immersed in separate electrolytes, wherein one cell is configured to reversibly store Li+ and the other cell is configured to reversibly store Na+. Such a construction may provide a low-cost, environmentally-benign-waste product. Additionally, each electrolyte may contain a pair of ferricyanide (Fe(CN)₆]^{3-/4-}) electroactive solutes and the alkali metal ion that it may be configured to store. Further, in one implementation, the electrochemical cell design may result from the layering of individual electrode modules assembled into a lithium extractor.

In another embodiment, the electrochemical cell (such as for direct lithium extraction 1112) may be configured to extract Li+ from geothermal brine and produce a solid lithium salt product, lithium carbonate (Li₂CO₃), via a two-step process. It is noted that other resulting products may be provided as desired (based on the electrolyte solution, the precursor, the configuration of the membrane, etc.). In operation, one step may comprise a process for Li+ extraction in which all Na+ electrode modules may be loaded with Na+ at maximum capacity and Li+ modules may be loaded at minimum capacity. Additionally, under steady-state operation, brine may be pumped through the Li extractor and a charge may be transferred from ferrocyanide (Fe(CN)₆]⁴⁻) within Na+ electrodes to ferricyanide in Li+ electrodes. Correspondingly, Li+ from the brine may be selectively transported into Li+ modules, and Na+ transported from Na+ modules into the brine as waste. In further operation, a second step may comprise a process for Li+ reclamation in which an aqueous solution of sodium carbonate (Na₂CO₃) and saturated lithium carbonate may be pumped from a silo into the extractor where it may completely replace the brine. In addition, under batch operation, charge may be transferred from the Li+ modules to the Na+ modules. Correspondingly, Li+ may be transported from the Li+ modules into the carbonate salt solution, and Na+ may be selectively transported into the Na+ modules, resulting in the precipitation (such as the salt precipitation 1108) of solid lithium carbonate that may be collected (such as in a decanter) at the bottom of the Li extractor and reconstitution of the lithium extractor into its initial state.

Current, electrochemical DLE methods historically require fragile active material electrode coatings to directly contact brine, produce toxic byproducts, or utilize non-scalable fabrication processes, limiting their viability. In contrast, the direct lithium extraction 1112 (which in particular uses the ion-selective electrolyte membrane separator 1102) may not require any active material electrode coatings, such as those used in lithium-ion batteries, which may significantly reduce cost and circumvent issues of stability in brines pumped through DLEs. In addition, other advantages may include environmentally responsible measures that may produce Na+ as waste product and may use no acid reagents, scalable ion-selective membranes which may be produced via roll-to-roll coating and polishing, robust designs featuring durable membranes which may protect vulnerable components from geothermal brine, highly selective lithium ion membrane technology which may be based on size and charge fitting of ion in solid electrolyte, adequate performance based on low-cost materials including, but not limited to, lithium, aluminum, titanium, sodium, silicon, zirconium, and iron, and/or a capacity to operate at low Li+ concentrations, which may potentially include seawater, thus diversifying Li+ resources.

In one embodiment, a Li+-selective membrane with bulk ionic resistance of 1,000Ω per cm2 may be produced for membranes of sub-mm thickness based on reported conductivity values of NASICON-type conductors. It should be noted that Na+ conductors may have less resistance than Li+ analogues and may thereby be assumed to be inconsequential. Further, at an operating potential of 0.4 V (within the 1.23 V electrochemical stability window for H2O) and 10 hours of Li+ extraction per day, 4 mAh worth of Li (1 gram Li=3,860 mAh) may be extracted per cm2 of membrane per day. As a result, a 1,000 T pure Li/year target may thus meet with approximately 300,000 m2 of each membrane.

The ion-selective electrolyte membrane separator 1102 may, in like manner, be used for the ion exchange 1110, the salt precipitation 1108, the purification 1106, and/or the lithium metal electrolysis 1104, all of which are detailed hereinbelow. As such, the technology disclosed herein relate to critical mineral extraction, purification, exchange, etc. may be viable for long-term DLE from feed solutions (such as geothermal brine).

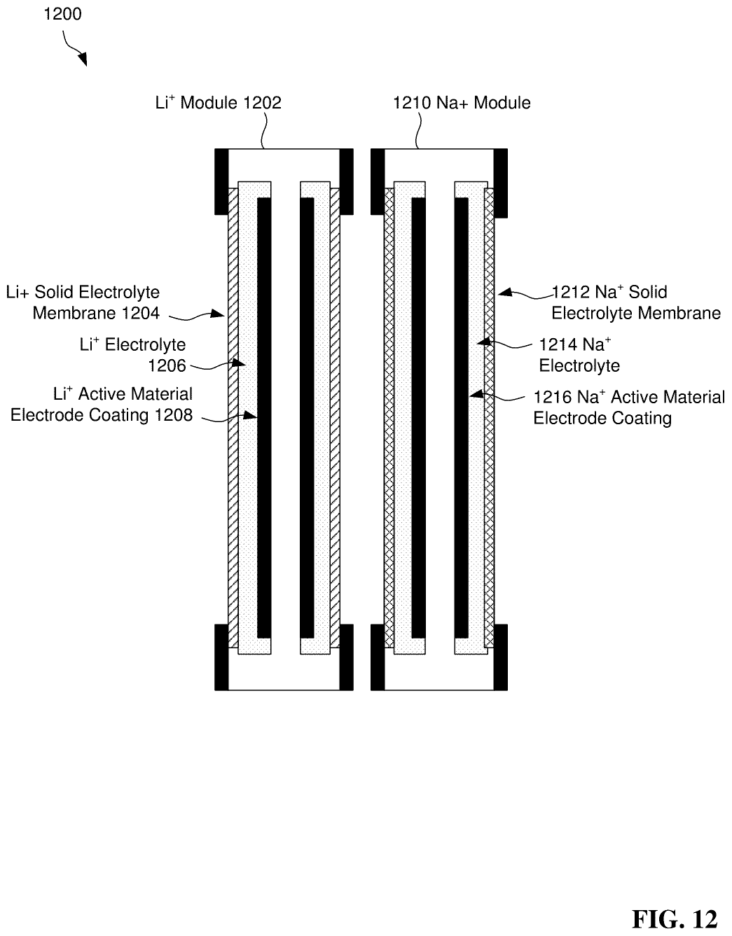

FIG. 12 illustrates electrode modules 1200, in accordance with one embodiment. As an option, the electrode modules 1200 may be implemented in the context of any one or more of the embodiments set forth in any previous and/or subsequent Figures and/or description thereof. Of course, however, the electrode modules 1200 may be implemented in the context of any desired environment. Further, the aforementioned definitions may equally apply to the description below.

As shown, the electrode modules 1200 may include a lithium module 1202 (functioning as an anode) comprising a Li⁺ solid electrolyte membrane 1204, a Li⁺ electrolyte 1206, and Li⁺ active material electrode coating 1208. In like manner, the electrode modules 1200 may include a sodium module 1210 (functioning as a cathode) comprising a Na⁺ solid electrolyte membrane 1212, a Na⁺ electrolyte 1214, and a Na⁺ active material electrode coating 1216. It is to be appreciated that, in order to function as a redox system, both an anode and a cathode would be needed. For simplicity, the redox electrode module is presented in a singular form (a single module electrode) to describe the elements of the module that are consistent for either and/or both of the anode module and the cathode module.

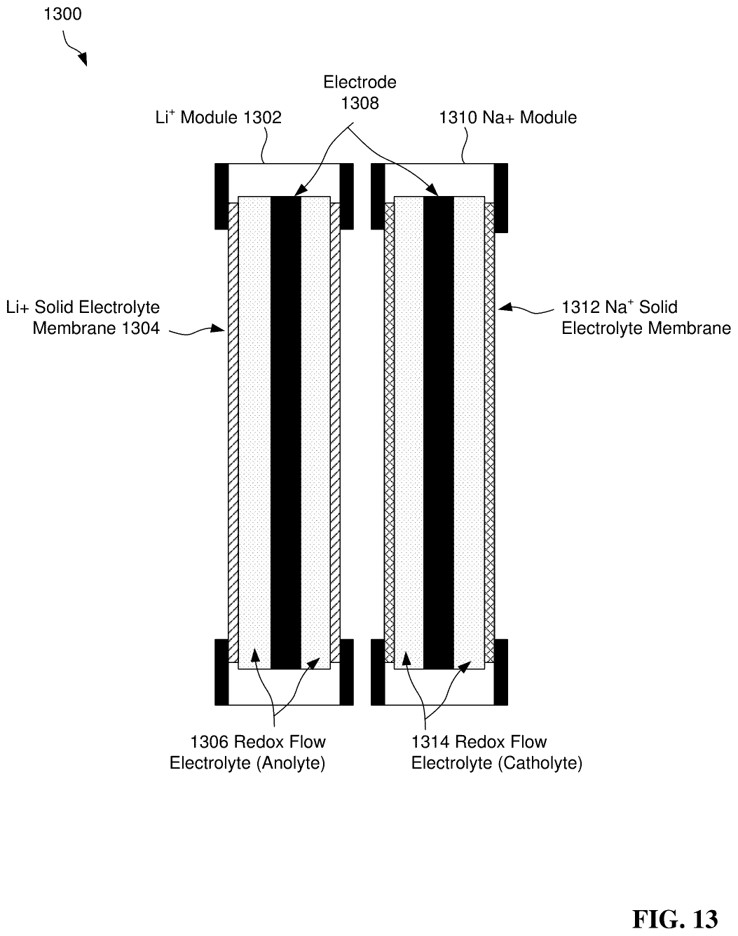

The Li⁺ solid electrolyte membrane 1204 may interface with a feed solution. Additionally, in one embodiment, the Li⁺ electrolyte 1206 may function as an anolyte, and the Na⁺ electrolyte 1214 may function as a catholyte. Taking a step back, FIG. 12 may depict an electrode module design that uses active material coatings (such as those found in lithium-ion and sodium-ion batteries). Further, FIG. 13 (shown and described hereinbelow) is a variation of FIG. 12 that uses “redox flow” active materials (including electroactive solutes). In addition, a redox flow electrolyte may comprise one or more electroactive solutes. In one embodiment, each electroactive solute may be characterized by its ability to adopt multiple oxidation states whose relative concentrations within the electrolyte may be manipulated through the addition or removal of charge (electrons) from the electrolyte. Further, the redox flow electrolyte may include one or more dissolved alkali metal cations. Further, the redox flow electrolyte may include one or more dissolved anions to balance the charge of cations in the solution. The current collector may be in direct contact with the redox flow electrolyte.

In operation, the lithium electrode module 1200 may be used to separate lithium from a feed solution (via the Li⁺ solid electrolyte membrane 1204). Additional details relating to the separation of lithium via the solid electrolyte membrane 1204 may be found in relation to the disclosure of FIG. 1-FIG. 6 hereinabove. In practice, the solid electrolyte membrane may interface directly with the redox flow electrolyte, on one side, and a feed solution on the other side. The feed solution may comprise ions which may be effectively separated from the feed solution via the solid electrolyte membrane. The solid electrolyte membrane may be tuned to selectively separate desired ions from the feed solution. In other words, the solid electrolyte membrane may be configured to allow selective passage of a specific alkali metal cation.

In operation, the ion module may be configured as an anode electrode module or a cathode electrode module. Once again, it is emphasized that the redox electrode module is shown in singularity (with a single module). FIG. 13 discussed hereinbelow displays redox electrode modules 1300 including both an anode electrode module and a cathode electrode module.

Further, the electrode modules 1200 may be used to reclaim energy used during the separation process. For example, as lithium is extracted, it may be stored in the form of electrochemical energy which may be subsequently released.

FIG. 13 illustrates redox electrode modules 1300, in accordance with one embodiment. As an option, the redox electrode modules 1300 may be implemented in the context of any one or more of the embodiments set forth in any previous and/or subsequent Figures and/or description thereof. Of course, however, the redox electrode modules 1300 may be implemented in the context of any desired environment. Further, the aforementioned definitions may equally apply to the description below.

As shown the redox electrode modules 1300 includes the lithium (Li⁺) module 1302, the Li⁺ solid electrolyte membrane 1304, the redox flow electrolyte 1306, the electrode 1308, the sodium (Na⁺) module 1310, the Na⁺ solid electrolyte membrane 1312, and a redox flow electrolyte 1314. The lithium module 1302 may function as an electrode for an anode, and the sodium module 1310 may function as an electrode for a cathode. In like manner, the redox flow electrolyte 1306 may function as an anolyte and the redox flow electrolyte 1314 may function as a catholyte. In one embodiment, the redox flow electrolyte 1306 and the redox flow electrolyte 1314 may contain electractive solutes that function as an active material.

In practice, the redox electrode modules 1300 may be used for the separation of ions (such as lithium) from a feed solution via the use of the Li⁺ solid electrolyte membrane 1304 and the Na⁺ solid electrolyte 1312 (each of which may be ion-selective), and redox flow electrodes (such as the lithium module 1302 and the sodium module 1310). Such an invention can be used for the selective extraction of Li+ from a suitable feed source. For example, the suitable feed solution may include lithium (or other ions, etc.) brines, seawater, and/or a solution prepared from recycled battery waste. In one embodiment, the lithium solid electrolyte membrane 1304 and/or the sodium solid electrolyte membrane 1312 may be constructed in a manner consistent, e.g., with FIG. 1-FIG. 6.

In one embodiment, the feed solution may be a first solution and may include a target alkali metal ion (or H⁺) that is desired to be selectively removed from the rest of the solution. Additionally, a second solution, where a target alkali metal ion (or H⁺) may be removed from the first solution may be discharged to the second solution during the separation process.

The second solution may contain a dissolved alkali metal ion (or H⁺) that may be discharged into the feed solution (the first solution) as a waste product during the process. In one embodiment, the anion within the second solution may be selected as desired. The second solution may also include one or more other dissolved salts as desired. When applied as an extraction system for Li⁺, the second solution may contain Na⁺ ions in the form of dissolved Na₂CO₃, where the Na⁺ cations may be used as the eventual waste product discharged into the feed solution, while the carbonate anions (CO₃²⁻) may serve as the anion that combines with the extracted Li⁺ ions to form Li₂CO₃. In one embodiment, the second solution may include saturated Li₂CO₃ as a second dissolved species to facilitate the removal of the extracted Li⁺ ions in the form of Li₂CO₃ via precipitation.

In one embodiment, the two electrode modules (including the lithium module 1302 and the sodium module 1310) may include an “anode” electrode module and another as a “cathode” electrode module. Each of the lithium module 1302 and the sodium module 1310 may include an electrolyte solution. In the context of the present description, the electrolyte for the “anode” electrode module may be referred to as the “anolyte” (such as the redox flow electrolyte 1306), and the electrolyte for the “cathode” electrode module may be referred to as the “catholyte” (such as the redox flow electrolyte 1314). Each of the redox flow electrolyte 1306 and the redox flow electrolyte 1314 may include one or more electroactive solutes. In one embodiment, each electroactive solute may be characterized by its ability to adopt multiple oxidation states whose relative concentrations within the electrolyte may be manipulated through the addition or removal of charge (electrons) from the electrolyte. For example, the electroactive solute may include, but not be limited to: ferricyanide/ferrocyanide ([Fe(CN)₆]³⁻/[Fe(CN)₆]⁴⁻), pervanadyl/vanadyl (VO₂⁺/VO₂⁺), phosphotungstic acid and its various redox states ([PW₁₂O₄₀]³⁻/[P₂W₂₁O₇₁]⁶⁻/[PW₁₁O₃₉]⁷⁻, etc.), phosphomolybdic acid and its various redox states, and/or silicotungstic acid and its various redox states. In one embodiment, the same electroactive solutes or set of electroactive solutes may be used for both the anolyte and catholyte.

Additionally, each of the redox flow electrolyte 1306 and the redox flow electrolyte 1314 may include one or more dissolved alkali metal cations. In one embodiment, each electrolyte may contain one type of alkali metal cation (or H⁺), depending on the ion that the system is configured to extract and/or expel as a waste product in the process. Further, each of the redox flow electrolyte 1306 and the redox flow electrolyte 1314 may include one or more dissolved anions to balance the charge of cations in the solution. In one embodiment, the electroactive solute(s) may serve as the dissolved anions if the dissolved anions are anionic. Still yet, each of the redox flow electrolyte 1306 and the redox flow electrolyte 1314 may include a solvent including but not limited to water, an alcohol, a carbonate, and/or an ether-based solvent.

As shown, the electrode 1308 may be in direct contact with the electrolyte solution (such as the redox flow electrolyte 1306 and the redox flow electrolyte 1314). The electrode 1308 may be electronically conductive (such as a metal or carbon-based material). The electrode 1308 may also be porous or non-porous. In one embodiment, a non-porous current collection may be selected in order to increase the surface area of contact between the electrode 1308 and either or both of the redox flow electrolyte 1306 and/or the redox flow electrolyte 1314. Further, the electrode 1308 may be constructed of, but not limited to aluminum, nickel, copper, titanium, stainless steel, graphite felt, and/or carbon fiber. The electrode 1308 may also be a carbon-based material coated onto the surface of a metallic substrate. Still yet, the electrode 1308 may include meshed aluminum (or any desired material in meshed structure).

In one embodiment, an ion-selective solid electrolyte membrane (such as the lithium solid electrolyte membrane 1304 and/or the sodium solid electrolyte membrane 1312) may be configured to allow selective passage of a specific alkali metal cation (or H⁺). The positioning of the ion-selective solid electrolyte membrane may be chosen such that it separates the feed solution (first solution) and a second solution from contacting the redox flow electrolyte 1306 and/or the redox flow electrolyte 1314, the electrode 1308, and/or any other electronically-conductive parts of each of the lithium module 1302 and/or the sodium module 1310 used to transfer charge to/from each module. In this way, only the target alkali metal cation (or H⁺) may be able to transfer to/from the feed solution (first solution) and the second solution to the electrolyte solution (such as the redox flow electrolyte 1306 and/or the redox flow electrolyte 1314).

With respect to the lithium solid electrolyte membrane 1304 and/or the sodium solid electrolyte membrane 1312, each or both may consist of a matrix (used as a durable, impermeable scaffold for the membrane), and solid electrolyte particles (selected on the basis of the ion that the membrane is designed to allow selective passage through). In the case where H⁺ is the ion of choice, Nafion may function as both the matrix and the ion-selective material, circumventing the need for a solid electrolyte particle.

In one embodiment, the lithium module 1302 and/or the sodium module may include a structural framework, which maybe designed in such a way to sequester the redox flow electrolyte 1306, the redox flow electrolyte 1314, and/or the electrode 1308 from the external environment. One or more surfaces of the structural framework may be composed of the ion-selective solid electrolyte membrane (such as the lithium solid electrolyte membrane 1304 and/or the sodium solid electrolyte membrane 1312) to enable selective passage of the desired alkali metal ion (or H⁺) to/from the exterior of the module/framework to the interior of the module/framework.

In various embodiments, the traditional concept of “discharge” and “charge” may not necessarily apply to the redox electrode modules 1300, particularly in the case where the same set of electroactive solutes may be used for both the lithium module 1302 and/or the sodium module 1312. For example, a single step of charge transfer between the lithium module 1302 and the sodium module 1310 may include both the input of energy and reclamation of energy. In this case, the “anode” electrode module (such as the lithium module 1302) may be the module with the lower mean potential (as current may be transferred between electrode modules throughout the extraction/reclamation steps), and the “cathode” electrode module (such as the sodium module 1310) may be the module with the higher mean potential (as current may be transferred between electrode modules throughout the extraction/reclamation steps).

In the case where the mean potential of each electrode module is equal throughout the extraction/reclamation steps, the “anode” electrode module may be identified by any method convenient to the user. In the context of a Li⁺ extraction system, the “anode” electrode module may be referred to as the module that receives charge as Li⁺ may be selectively removed from the feed solution to the electrode module (such as the lithium module 1302).

When the redox electrode modules 1300 is utilized as a system for extracting Li⁺ from a feed solution (such as a Li⁺-containing brine), the following steps may be used: 1) extraction; and 2) reclamation.

With respect to the step of extraction, a feed solution may be fed between the cathode/anode modules. To initiate removal of Li⁺ from the feed solution, a current may be flowed from the cathode electrode module to the anode electrode module. During this step, the electroactive solute in the cathode electrode module may be oxidized, coinciding with the removal of the alkali metal ion or H⁺ within the catholyte into the feed solution through the solid electrolyte membrane of the cathode electrode module. Additionally, the electrons fed from the cathode electrode module to the anode electrode module may result in the reduction of the electroactive solute in the anode electrode module and the selective transfer of Li⁺ from the feed solution to the anolyte. In this manner, the Li⁺ ions extracted from the feed solution may be temporarily stored within the anolyte, while the alkali metal ions or H+ initially contained within the catholyte may be expelled to the feed solution as a waste product.

With respect to the step of reclamation, a second solution may be fed between the cathode/anode modules. The second solution may contain saturated Li₂CO₃ and a carbonate salt (such as Na₂CO₃), depending on what alkali metal ion the cathode electrode module may be configured to selectively remove. To initiate the reclamation of Li⁺ and precipitation of Li₂CO₃, a charge may be transferred from the anode electrode module to the cathode electrode module. During this step, the electroactive solute in the anode electrode module may be oxidized, coinciding with the removal of the Li+ within the anolyte into the feed solution through the solid electrolyte membrane of the anode electrode module. Additionally, the electrons fed from the anode electrode module (such as the lithium module 1302) to the cathode electrode module (such as the sodium module 1310) results in the reduction of the electroactive solute in the cathode electrode module and the selective transfer of Na+ (or any other alkali metal ion or H+ that the cathode electrode module is configured to transport) from the feed solution to the catholyte. In this manner, the alkali metal ions or H+ extracted from the feed solution may be temporarily stored within the catholyte, restoring the system to its initial state before the preceding extraction state.

In one embodiment, the redox electrode modules 1300 may be used for grid-scale energy storage. It is noted that theoretically, the redox electrode modules 1300 may function for grid-scale energy storage with any electroactive solutes (although it may be better to use different active materials for each side so that the voltage of the cell is higher). Additionally, in one embodiment, solvents used in the redox electrode modules 1300 may be used as both an electrode and an electrolyte.

In one embodiment, electroactive solutes used for vanadium redox flow batteries (pervanadyl (VO2+), vanadyl (VO2+), V2+, V3+) may be viable substitutes for the electroactive solutes discussed herein ([Fe(CN)6]3-/4-).

Conventional lithium extraction systems from Li-containing brines may often comprise a multi-step process requiring the use of many reagents, high amounts of energy, and/or high amounts of evaporated water. As such, these processes may only be economically viable when Li+ concentrations in the brines are high. In addition, extraction from ore and clay requires large volumes of water and may produce toxic waste streams. It should be noted that it may only be economically viable to perform extraction upon Li-rich brines, as the process may rely on creating high surface area pools of the brine (often in the order of square kilometers of area) to evaporate the water, thereby making it possible to precipitate the lithium out in the form of lithium carbonate.

In contrast, the systems disclose herein allow for the ability to extract Li+ from more dilute sources using less energy input and less chemical reagents may make extraction from many of these sources economically viable, thus providing increased levels of Li+ to supply the ever-growing lithium-ion battery industry. Advantageously, performing these processes without producing toxic waste streams may ultimately preserve the surrounding environment and be more sustainable.

In one embodiment, electrolyte membrane-assisted lithium extraction may include a system for extraction of Li+ from a Li-containing brine composed of Li+ electrode modules, which act as reservoirs for reversibly storing Li+ extracted from a feed solution, Na+ (or another ion, such as K+ or H+) electrode modules, which act as reservoirs for reversible storing Na+ extracted from a feed solution, an array of Li+/Na+ modules positioned such that the surface of each Li+ module faces the surface of a Na+ module so that both modules may exchange ions from a feed solution positioned in the space between the modules. In one embodiment, the array of modules may be encased in a rectangular enclosure such that the spaces between the modules form rectangular ducts (or any shape) through which feed solutions may be passed. It should be noted that, within the system, an extractor may include the array and the requisite enclosure. Additionally, the electrolyte membrane-assisted lithium extraction system may further comprise a set of pipes and pumps, which may transport the feed solution (containing Li+) to the extractor and through the rectangular ducts of the extractor, within which Li+/Na+ may be reversibly transported to and from the feed solution through the electrode modules. In addition, the system may comprise a silo for storing an aqueous solution of sodium carbonate and/or lithium carbonate (i.e. a carbonate solution), which may contain a stirrer such that extra sodium carbonate may be added and dissolved into the aqueous solution. It should be noted that, when stored, the concentration of lithium carbonate may be maintained such that it is fully saturated. Further, the system may comprise a decanter, which may be positioned at the bottom of the extractor to collect lithium carbonate that precipitates as Li+ stored in the extractor (as a result of extracting it from the feed solution). To assist in the precipitation of lithium carbonate, a sonicator may be used either directly within the extractor or within a separate tank where the solution is pumped to after the reclamation step.

In likewise embodiment, each module may consist of an active material coating on a current collector welded to both sides of a metal plate, an ion-selective solid electrolyte membrane covering the active material coating on both sides of the metal plate, a metal frame, which may be electronically connected to the internal active material coating and function as a framework for protecting the active material coating from the external environment, an elastomeric sealant around the edges of the metal frame/solid electrolyte membrane where the frame and membrane touch, which may prevent substances from leaking into the electrode module through the membrane, an electrolyte, which may fill up the space on the interior of the module, acting as a medium for transporting ions between the active material and solid electrolyte membrane, and/or a separator between each active material coating and solid electrolyte membrane (optional), which may provide mechanical support and electronically isolate the active material from the solid electrolyte membrane.

In operation, the Na+ modules of the extractor may be completely filled with Na+ in the active material, and the Li+ modules of the extractor may be completely devoid (or near devoid) of Li+ in the active material. Additionally, a feed solution (e.g., a Li+-containing brine) may be pumped into the extractor, where Li+ ions are extracted from the feed into the Li+ electrode modules while Na+ ions are released from the Na+ modules. It should be noted that this step may operate continuously (i.e., the solution may constantly flow through the extractor as Li+/Na+ ions are transported to and from the solution). In addition, the outlet stream may be returned to the feed, where the only waste material may be Na+. Further, the carbonate solution may then be pumped from the feed silo and transferred back into the extractor such that the extractor may be completely filled with the carbonate solution. Further still, once the extractor has been filled with carbonate solution, the flow of water may be halted, after which the Li+ stored in the Li+ electrode modules may be expelled while Na+ ions from the carbonate solution may be transported into the Na+ electrode modules. It should be appreciated that, since the carbonate solution may be already fully saturated with lithium carbonate, the Li+ expelled from the extractor may immediately precipitate as a solid and collect in the decanter located at or near the bottom of the extractor. As indicated hereinabove, a supersaturated solution may benefit from an input of energy (e.g. via sonication) to initiate precipitation.

Further yet, the lithium carbonate collected in the decanter may be removed and the carbonate solution returned to the silo where additional sodium carbonate may also then be added to the silo to compensate for the material lost during reclamation. Of course, it is appreciated the solution may be configured such that the Li+ may not precipitate. For example, the solution may be configured such that the Li+ may undergo an ion exchange, as discussed herein as well.

In other embodiments, a solution of pure water may be passed through the system between the extraction and reclamation steps to ensure that the extractor has been purged of any contaminants. Additionally, the reclamation step may also be run under a constant flow, where the solution may be circulated through the extractor, back to the silo, and then back to the extractor again. In addition, the extraction step may also be run as a batch operation, where the feed solution may first be transferred to the extractor, the Li+/Na+ than may go through the exchange process, and the solution may then be removed at the end.

In another embodiment, the system may also be run such that the reclamation and extraction steps occur simultaneously. This may include two electrodes within each module (that may be electronically isolated from one another). This may also include every other rectangular duct in the extractor to have the Li brine flowing through it, and every other rectangular duct to have the carbonate solution flow through it. Within each module, one electrode may function as be an “extraction” module and one electrode may function as a “reclamation” module. During operation, the “extraction” electrodes may work in parallel such that charge is transferred from the “extraction” electrodes in Na+ modules to the “extraction” electrodes in Li+ modules; and during reclamation, charge may be transferred from “reclamation” electrodes in Li+ modules to the “reclamation” electrode in Na+ modules.

As such, this particular embodiment may enable a higher throughput of lithium to be extracted for a given period of time. This may also circumvent the need to “replace” the brine with the carbonate solution and to “wash” the module between runs. Further, this embodiment, may also be advantageous in that it may function as a “heat exchanger” for the brine. For example, as a “heat exchanger”, the heat from the brine may dissipate into the carbonate solution. Further, this, in turn, may assist the Li carbonate to precipitate (Li carbonate has a lower solubility in water at higher temperatures).

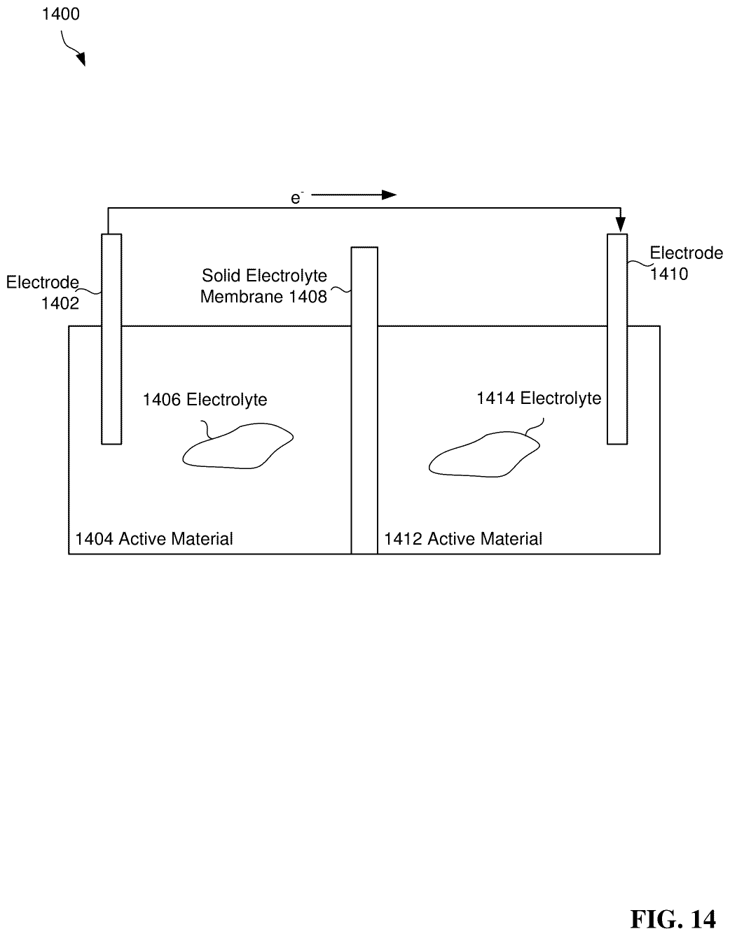

FIG. 14 illustrates a membrane separation cell 1400, in accordance with one embodiment. As an option, the membrane separation cell 1400 may be implemented in the context of any one or more of the embodiments set forth in any previous and/or subsequent Figures and/or description thereof. Of course, however, the membrane separation cell 1400 may be implemented in the context of any desired environment. Further, the aforementioned definitions may equally apply to the description below.

As shown, the membrane separation cell 1400 includes an electrode 1402 that is in direct contact with an active material 1404 and an electrolyte 1406. Additionally, the membrane separation cell 1400 includes an electrode 1410 that is in direct contact with an active material 1412 and an electrolyte 1414. A solid electrolyte membrane 1408 may separate the active material 1404 and the electrolyte 1406 from the active material 1412 and the electrolyte 1414. The solid electrolyte membrane 1408 may be ion selective such that preconfigured ions can pass from one solution (such as the electrolyte 1406) to another (such as the electrolyte 1414). In one example, if a liquid electrolyte (such as the electrolyte 1406 and/or the electrolyte 1414) were used as either the anolyte or catholyte, it would need to be in direct contact with the solid electrolyte membrane 1408, and in some instances, would also be in direct contact with the electrode (such as the electrode 1402, the electrode 1410, etc.).

In operation, the membrane separation cell 1400 may be used to selectively remove a particular type of alkali metal from one electrolyte or active material to another electrolyte or active material.

In one embodiment, the membrane separation cell 1400 shows electrode 1402 and/or the electrode 1410. It is to be understood that any number of electrodes may be associated with the membrane separation cell 1400. The electrode 1402 and/or the electrode 1410 may each be an electronically conductive material that interfaces with electroactive substances to partake in redox chemical reactions. Additionally, the electrode 1402 and/or the electrode 1410 may be in electrical contact with an external circuit that controls the flow of electrons between one or more other electrodes. When charge is transferred between electrode (such as between the electrode 1402 and the electrode 1410), the electrode that supplies electrons for a reduction reaction is referred to as a cathode, whereas the electrode that supplies electrons for the oxidation reaction is referred to as an anode.

In another embodiment, a single electrode may be used as both an “anode” and a “cathode” at different times of a given process. However, if more than one electrode is configured for the system, each may be referred to specifically as either an “anode” or “cathode”, regardless of whether the specific electrode is currently used for a reduction or oxidation. The assignment of an electrode as the “anode” and/or “cathode” may be preconfigured as desired (although the naming generally coincides with whether the electrode functions predominately as an “anode” or “cathode” during the most relevant step of the process).

The electrode 1402 and/or the electrode 1410 may include an electronically-conductive substrate, and, optionally, a catalyst. The electronically-conductive substrate may include carbon-based materials (such as but not limited to graphite, graphene, carbon nano onions (CNO), carbon nanotubes (CNT), carbon nanofibers (CNF), and carbon felt), and/or other materials (such as but not limited to metals such as Al, Cu, Li, Na, Stainless Steel, Ti, Ni, Ta, Au, Ag, Pt, Rh, Ir, Pd). Additionally, the catalyst may participate in a chemical reaction (but may not be generated or consumed by the overall reaction). A catalyst may function to lower the activation energy of the reaction, thereby increasing its rate and improving the energy efficiency of the overall system.

With respect to the active material 1404 and/or the active material 1412, it is to be understood that two or any number of active materials may be involved in the membrane separation cell 1400. The active material 1404 and/or the active material 1412 may be any substance (such as but not limited to a solid, liquid, gas, solute, or ionic species) that serves as a reactant or product for a redox reaction. As electrons are transferred between two electrodes, at least one active material may be oxidized at one electrode, and at least one active material may be reduced at the opposite electrode. The active material 1404 and/or the active material 1412 may include, but not limited to carbon-based materials (such as but not limited to graphite, graphene, carbon nano onions (CNO), carbon nanotubes (CNT)); pure alkali metals (such as but not limited to Li, Na, K, Rb, Cs); metals and metalloids that alloy with alkali metals (such as but not limited to Si, P, Mg, Ca, Sn, Ga, In, Ge, Au, Ag, Pd, Pt, and any alloys of these metals); oxide materials (such as but not limited to LTO, LMO, NCA, NMC, LCO); phosphate materials (such as but not limited to LFP, NVP); Prussian blue and Prussian blue analogues; metal hydrides (such as but not limited to NiO(OH)/NiO(OH)); gases, liquids, and solids (such as but not limited to H₂, O₂, H₂O, H₂O₂, CO₂, CH₄, F₂, Cl₂, Br₂, I₂); and/or aqueous solutes (such as but not limited to H⁺, OH⁻, OH²⁻). It is to be understood that H+ may be a common notation for H₃O+ (the hydronium cation, or protonated water) but may also include protonated alcohols and ethers such as CH₃(OH₂)⁺ (protonated methanol) and CH₃CH₂(OH⁺)CH₂CH₃ (protonated dimethyl ether).

With respect to the electrolyte 1406 and/or the electrolyte 1414, it is to be understood that they may be same or different substance. The electrolyte 1406 and/or the electrolyte 1414 may be configured to transport ions between different electrodes under the application of a potential difference between electrodes. An electrolyte in contact with the anode, but not in contact with the cathode is referred to as the “anolyte”, whereas an electrolyte in contact with a cathode but not an anode is referred to as the “catholyte”. It is to be appreciated that the electrolyte 1406 and/or the electrolyte 1414 may be in either/or liquid, semi-solid (such as gel), or solid form.

The electrolyte 1406 and/or the electrolyte 1414, in liquid electrolyte form, may consist of one or more liquid solvents (such as but not limited to water, alcohols, carbonates, ethers, hydrocarbons, etc.), and/or multiple ionic solutes (one of which may include the alkali metal cation of interest or H+, and another of which may include at least one anion). Alkali metal cations of interest may include Li+, Na+, K+, H+. A single substance can function as both a liquid solvent and as an ionic solute, such as in the case of ionic liquids. In one embodiment, the liquid electrolyte may contain an active material (such as the active material 1404 and/or the active material 1412) as a solute. In another embodiment, a single solute may function as both an active material and an ionic solute. Further, the liquid electrolyte may contain one or more solutes acting as a buffer, which may stabilize the pH within a narrow, desired range.

The electrolyte 1406 and/or the electrolyte 1414, in solid electrolyte form, may be either an ion-conducting ceramic, glass, polymer, polymer/salt hybrid, or any combination thereof. In another embodiment, the electrolyte 1406 and/or the electrolyte 1414 may also include a plasticizer (which may be but not be limited to a solid or liquid distributed throughout the electrolyte to increase segmental motion of the electrolyte, thereby increasing its ionic conductivity), and/or a mechanical additive (which may serve to improve any mechanical property of interest such as hardness, modulus, or elasticity of the electrolyte).

With respect to the solid electrolyte membrane 1408, it may be configured as an ion-selective solid electrolyte membrane, and may be a particular subset of electrolytes that enables highly selective separation of alkali metals. In one embodiment, the driving force of separation may be a potential difference across the solid electrolyte membrane 1408, which may be precisely controlled by controlling the potential difference between two electrodes (such as the electrode 1402 and the electrode 1410) positioned at opposite sides of the solid electrolyte membrane 1408.

In one embodiment, the solid electrolyte membrane 1408 may consist of (but not limited to) an ion-selective solid electrolyte, a matrix, and/or mechanical additives. With respect to the ion-selective solid electrolyte, it may have high ionic conductivity for the alkali metal of interest and low (such as negligible, or no) ionic conductivity for other substances. For example, in one embodiment, if the alkali metal of interest was Li⁺, the applicable solid electrolyte membrane 1408 may include, but not be limited to any member of the family of NASICON-type structure (including but not be limited to LAGP, or LATP) as well as other compositions (such as any of LFP, LTO, NCM, or LMO). If Na⁺ was the alkali metal of interest, the applicable solid electrolyte membrane 1408 may include, but not be limited to, any member of the family of NASICON-type structure. Further, if K⁺ was the alkali metal of interest, the applicable solid electrolyte membrane 1408 may include, but not be limited to, K2Fe4O7. If H⁺ was the alkali metal of interest, the applicable solid electrolyte membrane 1408 may include, but not be limited to, Nafion. Additionally, the solid electrolyte membrane 1408 may include Rb+ (such as RbxFeyVzO4, where x y and z denote subscripts), Cs (such as CsxPyZzO4, where x y z are subscripts and Z is an element from S, Cr, Mo, W; CsxMyPO4, where M is a metal from Mg, Ca, Sr, Ba; and/or CsxPO4M, where M is a metal from Sc, Y, La, Sm, Nd.

With respect to the matrix of the solid electrolyte membrane 1408, the matrix may serve as a scaffold that holds the ion-selective solid electrolyte in place. The matrix may inhibit the permeation of all materials across the solid electrolyte membrane 1408. The matrix may or may not be covalently crosslinked and may or may not be covalently bonded to the ion-selective solid electrolyte. In one embodiment, the matrix may also comprise a metal (such as Sn, etc.), which may make it easier to polish the membrane to a preconfigured roughness, and configure the matrix for increased impermeability.

With respect to the mechanical additives of the solid electrolyte membrane 1408, the mechanical additives may serve to maintain the structural integrity of the solid electrolyte membrane 1408 to prevent the uptake of solvent and/or loss of impermeability of the solid electrolyte membrane 1408 to unwanted substances. For example, mechanical additives may include, but not be limited to carbon-based materials (such as but not limited to graphene, carbon nano onions (CNO), carbon nanotubes (CNT), carbon nanofibers (CNF), diamond), metals (such as but not limited to titanium, stainless steel), and/or ceramics (such as but not limited to TiO₂, SiO₂, Al₂O₃).

In one embodiment, the membrane separation cell 1400 may relate to a membrane-based alkali metal extraction system. In use, an alkali metal extraction system includes an anode and a cathode, where the anode is configured for oxidation and the cathode is configured for reduction. Additionally, wherein migration of a predetermined alkali metal ion through an ion-selective solid electrolyte membrane is driven by a potential across the anode and the cathode, and the ion-selective solid electrolyte membrane is selectively permeable to the predetermined alkali metal ion. The alkali metal extraction system further includes at least one active material, a first solution comprising the predetermined alkali metal ion, and a second solution comprising the migrated predetermined alkali metal ion.

In various embodiments, the first solution may include an anolyte, and the second solution may include a catholyte. Additionally, each of the anolyte and the catholyte may include an active material (including for example, one or more electroactive solutes) or an electrode coating immersed in each of the anolyte and the catholyte, one or more dissolved alkali metal cations (including the predetermined alkali metal ion), one or more dissolved anions, and a solvent.

In various embodiments, the active material may include one or more of: H₂, Na⁺, Li metal, LFP, LMO, NCA, NMC, graphite; Na-based active materials including Prussian Blue; and/or electroactive solutes include but are not limited to: ferricyanide, ferrocyanide, or a redox state ferricyanide or ferrocyanide ([Fe(CN)₆]³⁻/[Fe(CN)₆]⁴⁻); ferrocene (Fe(C₅H₅)₂, ferrocenium Fe(C₅H₅)₂⁺, cobaltocene (Co(C₅H₅)₂, cobaltocenium Co(C₅H₅)₂⁺, or any organic derivatives thereof; vanadium-containing ions or vanadium coordination complexes, including one or more of pervanadyl (VO₂⁺), vanadyl (VO²⁺), V²⁺, V³⁺; phosphotungstic acid, or a redox state of phosphotungstic acid ([PW₁₂O₄₀]³⁻/[P₂W₂₁O₇₁]⁶⁻/[PW₁O₃₉]⁷⁻, etc.); phosphomolybdic acid, or a redox state of phosphomolybdic acid; silicotungstic acid, or a redox state of slicotungstic acid; and/or an ion of any common redox state of Fe, Co, Ni, or Cu, including one or more of Fe²⁺, Fe³⁺, Co²⁺, Co³⁺, Ni²⁺, Ni³⁺, Cu²⁺, Cu⁺, or any coordination complex thereof.

In various embodiments, a first current collector may be in contact with the first solution, and a second current collector may be in contact with the second solution. Additionally, each of the first current collector and the second current collector may be electronically conductive, and made of at least one of aluminum, nickel, copper, titanium, stainless steel, graphite felt, or carbon fiber.

In various embodiments, the anode may have a first mean potential, and the cathode may have a second mean potential, where the first mean potential is less than or equal to the second mean potential such that the anode receives electronic charge as the predetermined alkali metal migrates from the first solution to the second solution. Additionally, the first solution may include one or more secondary ions, and/or a first concentration of the one or more secondary ions in the first solution may be greater than a second concentration of the one or more secondary ions in the second solution.

In various embodiments, the configuration of the ion-selective solid electrolyte membrane may include a solid electrolyte particle with a predetermined pore size corresponding with the predetermined metal ion. In one embodiment, ionic selectivity of the material may be based on the barrier for diffusion for the ion through a crystal lattice (of the material). The energy barrier for diffusion may be a function of charge and size of the ion and may not necessarily correlate with either. The first solution may be a geothermal brine or a salar brine. Still yet, the first solution may comprise at least one of lithium minerals, lithium-containing brines, recycled lithium batteries, or seawater.

In various embodiments, the second solution may comprise a first electroactive solute, where the reduction of the first electroactive solute coincides with the migration of the predetermined alkali metal ion. Additionally, the first solution may comprise a second electroactive solute, where oxidation of the second electroactive solute coincides with the migration of the predetermined alkali metal ion. A first concentration of at least one H⁺ ion or at least one Na⁺ ion may decrease in the second solution, and a second concentration of the at least one H⁺ ion or the at least one Na⁺ ion may increase in the first solution.

In various embodiments, the first solution may include LiOH at a first solubility, and the second solution may include an organic solution with second solubility, wherein the second solubility is lower than the first solubility. Additionally, the organic solution may comprise H₂O, where the H₂O is configured to facilitate formation of an alkali salt.

In various embodiments, the migrated predetermined alkali metal ion may be configured to recombine with a hydroxyl group to precipitate. Additionally, input energy used to migrate the predetermined metal alkali ion may be stored and recovered, at least in part, as electrochemical energy of the migrated predetermined metal alkali ion at the cathode. Further, the input energy may correspond with an electric charging at an electrode with the predetermined metal alkali ion and the electrochemical energy may correspond with an electric discharge at the electrode of the predetermined metal alkali ion. Still yet, the recovery of the input energy may reduce a carbon footprint of a manufacturing facility.

In another embodiment, recovering energy may apply to a design where the reduction potential of the anode and cathode are different (e.g. each of the anode and cathode use different active materials). In this case, it may take an input of energy to move charge from a cathode side to an anode side (which may correspond to the migration of an alkali metal ion from cathode to anode), but such energy may be recovered when the cell then moves charge from the anode to the cathode (which may correspond to the migration of an alkali metal ion from anode to cathode). The recovery therefore may occur via a two-step process where the direction of current changes.

In another embodiment where the anode and cathode have equal mean reduction potentials (as is the case when using the same active materials on both sides), it may not be required to have any net energy input to drive the electrochemical reaction in either direction. In any case, an input of irrecoverable energy is always required to move charge (per Ohm's law).

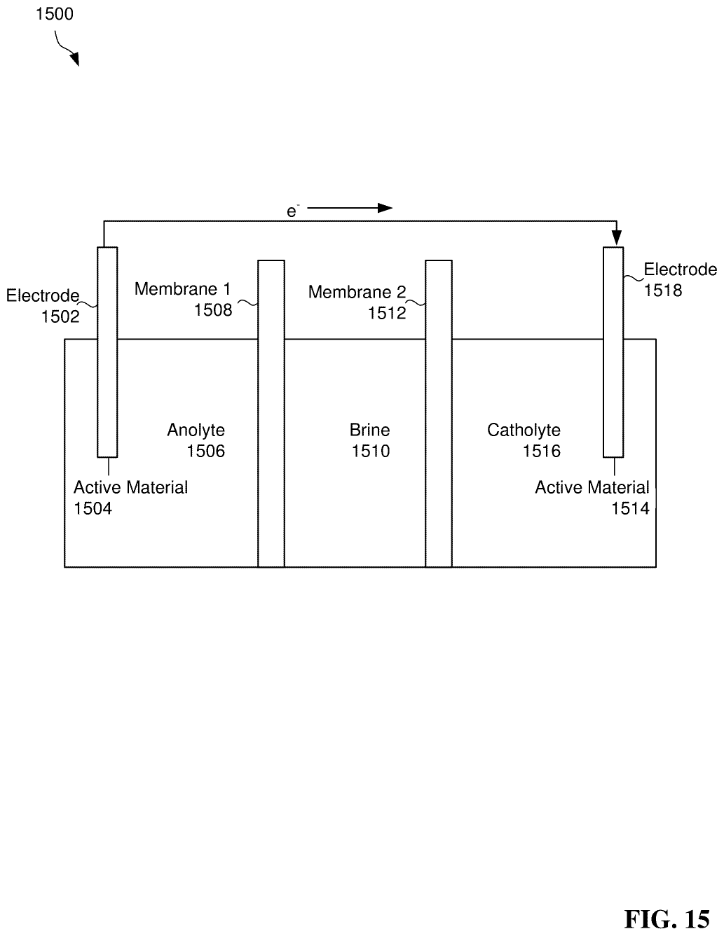

FIG. 15 illustrates a lithium extractor 1500 with active materials, in accordance with one embodiment. As an option, the lithium extractor 1500 may be implemented in the context of any one or more of the embodiments set forth in any previous and/or subsequent Figures and/or description thereof. Of course, however, the lithium extractor 1500 may be implemented in the context of any desired environment. Further, the aforementioned definitions may equally apply to the description below.

As shown, the lithium extractor 1500 includes an electrode 1502 in contact with active material 1504, and an anolyte 1506. The anolyte 1506 may be separated from brine 1510 via a membrane 1 1508. Further, the brine 1510 may be separated from a catholyte 1516 via a membrane 2 1512. The electrode 1518 may be in contact with active material 1514, and the catholyte 1516. The active material 1504 may be a coating on the surface of the electrode 1502, and the active material 1514 may be a coating on the surface of the electrode 1518.

In one embodiment, the electrode 1502 may be copper (Cu), and the electrode 1518 may be aluminum (Al). In other embodiments, the anode electrode (such as the electrode 1502) may be a sheet of Al or Cu foil coated with the anode active material, and the cathode (such as the electrode 1518) may be a sheet of Al or Cu foil coated with the cathode active material.

In operation, the lithium extractor 1500 may include three electrolytes (anolyte 1506, brine 1510, catholyte 1516) which may be used in series. Each of the three electrolytes may be separated from each other via an ion-selective solid electrolyte membrane (such as the membrane 1 1508 and the membrane 2 1512). One liquid electrolyte may in direct contact with the anode (such as the anolyte 1506), a second liquid electrolyte may be in direct contact with the cathode (such as the catholyte 1516), and a third liquid electrolyte (such as the brine 1510) may be a Li ion-containing brine.

The membrane 1 1502 may include an ion-selective solid electrolyte membrane separating the anolyte 1506 and the brine 1510, and may be selective for Li ions. In contrast, the membrane 2 1512 may include an ion-selective solid electrolyte membrane separating the catholyte 1516 from the brine 1510, and may be selective for a different type of ion (such as Na ions).

In one embodiment, the anolyte 1506 may be an aqueous solution containing Li+ cations and SO₄²⁻ anions. Further, the catholyte 1516 may be an aqueous solution containing Na+ cations and SO₄²⁻ anions.

With respect to the active material 1504 (for the anode), the active material 1504 may include, but not be limited to LMO, LTO, LFP, etc.. Further, the active material 1514 (for the cathode) may include, but not be limited to Na iron phosphate (NFP), Prussian Blue, etc.

In other embodiments, the anolyte 1506 may include, but not be limited to, a solvent (water), cations (Li+), and/or anions (TFSI-). The catholyte 1516 may include, but not be limited to, a solvent (water), cations (Na+), and/or anions (TFSI-). The brine 1510 may include, but not be limited to, a solvent (water, naturally present), cations (Na+, Li+, naturally present), and anions (naturally present).

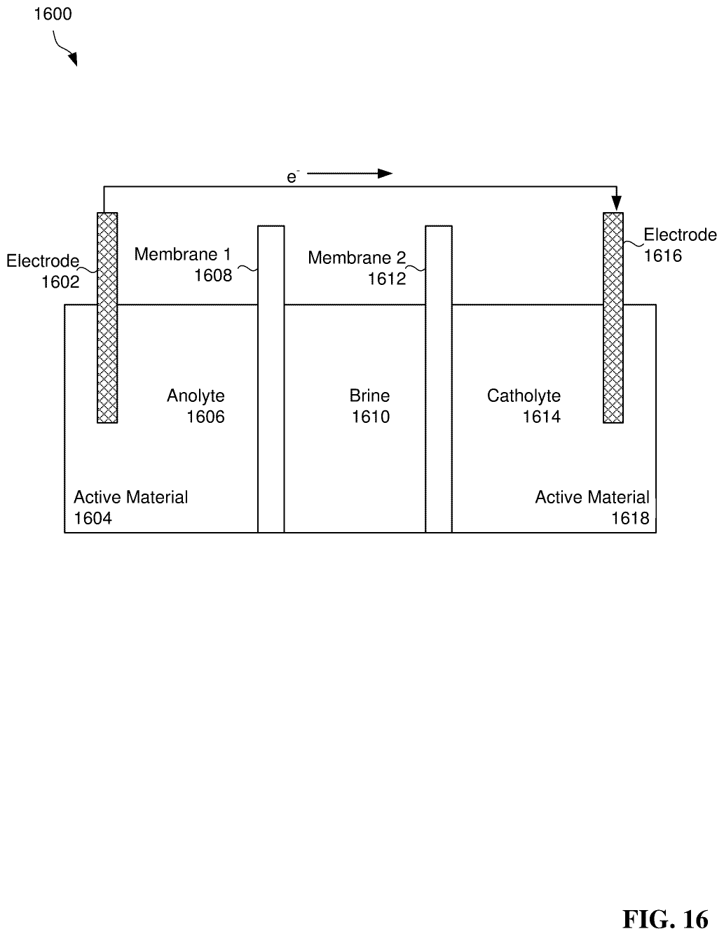

FIG. 16 illustrates a lithium extractor 1600 with redox flow active materials, in accordance with one embodiment. As an option, the lithium extractor 1600 may be implemented in the context of any one or more of the embodiments set forth in any previous and/or subsequent Figures and/or description thereof. Of course, however, the lithium extractor 1600 may be implemented in the context of any desired environment. Further, the aforementioned definitions may equally apply to the description below.

As shown, the lithium extractor 1600 includes an electrode 1602 in contact with active material 1604, and an anolyte 1606. The anolyte 1606 may be separated from brine 1610 via a membrane 1 1608. Further, the brine 1610 may be separated from a catholyte 1614 via a membrane 2 1612. The electrode 1616 may be in contact with active material 1618, and the catholyte 1614. In one embodiment, the active material 1604 may include an electroactive solute.

In operation, the lithium extractor 1600 may include three electrolytes (anolyte 1606, brine 1610, catholyte 1614), which may be used in series. The three electrolytes may be separated from each other via an ion-selective solid electrolyte membrane (such as the membrane 1 1608 and the membrane 2 1612). One liquid electrolyte may be in direct contact with the anode (the anolyte 1606), a second liquid electrolyte may be in direct contact with the cathode (the catholyte 1614), and a third liquid electrolyte (the brine 1610) may be a Li ion-containing brine.

The membrane 1 may be an ion-selective solid electrolyte membrane separating the anolyte 1606 and the brine 1610, and may be selective for Li ions, whereas the membrane 2 may be an ion-selective solid electrolyte membrane separating the catholyte 1614 from the brine 1610, and may be selective for a different type of ions (such as but not limited to Na ions).

In various embodiments, the anolyte 1606 may be an aqueous solution containing, but not be limited to, Li+ cations and [Fe(CN)₆]⁴⁻ and [Fe(CN)₆]³⁻ anions. Additionally, the catholyte 1614 may be an aqueous solution containing, but not be limited to, Na+ cations and [Fe(CN)₆]⁴⁻ and [Fe(CN)₆]³⁻ anions.

The anode (such as the electrode 1602) may be a porous mesh composed of stainless steel. Additionally, the cathode (such as the electrode 1616) may be a porous mesh. In various embodiments, the porous mesh may be composed of titanium, stainless steel, etc.. Further, the active material 1604 (the active material for the anode) may be, but not be limited to, [Fe(CN)⁶]⁴⁻. The active material 1618 (the active material for the cathode), may be, but not be limited to, is [Fe(CN)₆]³⁻.

In other embodiments, the anolyte 1606 may include, but not be limited to, a solvent (water), cations (Li+), and/or anions ([Fe(CN)₆]³⁻, [Fe(CN)₆]³⁻). The catholyte 1614 may include, but not be limited to, a solvent (water), cations (Na+), and/or anions ([Fe(CN)6]3, [Fe(CN)6]3-). The brine 1610 may include, but not be limited to, a solvent (water, naturally present), cations (Na+, Li+, naturally present), and anions (naturally present).

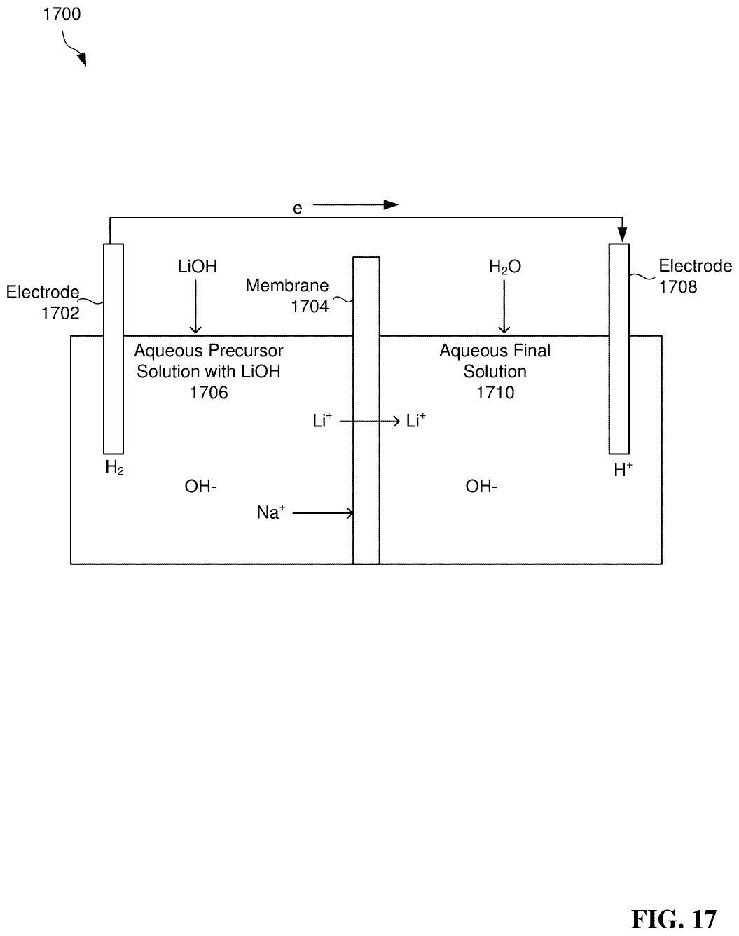

FIG. 17 illustrates redox electrode modules 1700 for critical minerals purification, in accordance with one embodiment. As an option, the redox electrode modules 1700 may be implemented in the context of any one or more of the embodiments set forth in any previous and/or subsequent Figures and/or description thereof. Of course, however, the redox electrode modules 1700 may be implemented in the context of any desired environment. Further, the aforementioned definitions may equally apply to the description below.

As shown, lithium ions (Li⁺) may pass from an anode comprised of aqueous precursor solution 1706 through a solid electrolyte membrane 1704 to a cathode comprised of an aqueous final solution 1710. In operation, lithium hydroxide (LiOH) atoms present in the aqueous precursor solution 1706 may break apart into positively-charged lithium ions and negatively-charged hydroxide (OH⁻) atoms. In addition, the lithium ions may then be drawn across the electrolyte membrane 1704 into the aqueous final solution 1710 where they may recombine with hydroxide atoms to reform into additional lithium hydroxide atoms, thus yielding a higher concentration of lithium hydroxide in the aqueous final solution 1710 upon completion of the purification process. Further, the purification process may simultaneously combine the actions of reduction of H⁺ at a cathode electrode 1708, forming H₂ (sent to an anode), and oxidation of H₂ at the anode electrode 1702, forming H⁺ waste.

In one embodiment, the solid electrolyte membrane 1704 may be impermeable such that the aqueous solution may be prevented from crossing the solid electrolyte and matrix, yet simultaneously allow an alkali metal (such as Li⁺) to pass through the solid electrolyte.

In one embodiment, the redox electrode modules 1700 may relate to a membrane-based critical minerals purification system. In use, a critical minerals purification system includes an anode and a cathode, where the anode is configured for oxidation and the cathode is configured for reduction. Additionally, migration of a predetermined alkali metal ion through an ion-selective solid electrolyte membrane is driven by a current across the anode and the cathode, and the ion-selective solid electrolyte membrane is selectively permeable to the predetermined alkali metal ion. Additionally, the critical minerals purification system includes at least one active material, a precursor solution comprising the predetermined alkali metal ion, where the precursor solution is characterized by a first purity with respect to an alkali metal salt, and a second solution comprising the migrated predetermined alkali metal ion, wherein the second solution is characterized by a second purity with respect to the alkali metal salt.

In various embodiments, the second purity may be greater than the first purity. Additionally, the at least one active material at the anode and/or the cathode includes at least one of: H₂, Na⁺, Li metal, LFP, LMO, NCA, NMC, graphite; Na-based active materials including Prussian Blue; ferricyanide, ferrocyanide, or a redox state ferricyanide or ferrocyanide ([Fe(CN)₆]³⁻/[Fe(CN)₆]⁴⁻); ferrocene (Fe(C₅H₅)₂, ferrocenium Fe(C₅H₅)₂⁺, cobaltocene (Co(C₅H₅)₂, cobaltocenium Co(C₅H₅)₂⁺, or any organic derivatives thereof; vanadium-containing ions or vanadium coordination complexes, including one or more of pervanadyl (VO₂⁺), vanadyl (VO²⁺), V²⁺, V³⁺; phosphotungstic acid, or a redox state of phosphotungstic acid ([PW₁₂O₄₀]³⁻/[P₂W₂₁O₇₁]⁶⁻/[PW₁₁O₃₉]⁷⁻, etc.); phosphomolybdic acid, or a redox state of phosphomolybdic acid; silicotungstic acid, or a redox state of slicotungstic acid; or an ion of any common redox state of Fe, Co, Ni, or Cu, including one or more of Fe²⁺, Fe³⁺, Co²⁺, Co³⁺, Ni²⁺, Ni³⁺, Cu²⁺, Cu⁺, or any coordination complex thereof.

In various embodiments, the ion-selective solid electrolyte membrane may be the at least one active material. Additionally, the second solution may include H₂, where the H₂ is an output of the reduction of the cathode. Further, the first solution may include H₂, where the H₂ is an input of the oxidation of the anode. In one embodiment, Cl₂ may be produced from Cl— at the anode and consumed at the cathode (and converted back to Cl—).

In various embodiments, the anode may use a first active material, the cathode may use a second active material, and the first active material may differ from the second active material. Additionally, energy lost to the output of the reduction may be regained by the input of the oxidation. Further, the precursor solution may be in contact with the anode. The precursor solution may include LiOH.

In one embodiment, the aqueous precursor solution 1706 may contain any type of dissolved salt, not limited to LiOH (e.g. Li₂CO₃, LiCl, etc.). The flexibility of the aqueous precursor solution 1706 is further exemplified via LiX 1806 discussed hereinbelow.

In various embodiments, the second solution may be in contact with the cathode. The second solution may include H₂O. Additionally, the H₂O may function as a reagent and a solvent. Further, the alkali metal salt may be extracted from the second solution. The extracted alkali metal salt at the second purity may be used for battery components.

In various embodiments, a reagent may be added to the second solution, where the reagent is configured to cause the migrated predetermined alkali metal ion to combine with a hydroxyl group to form the alkali metal salt at the second purity. Additionally, the precursor solution may include at least one of lithium minerals, lithium-containing brines, recycled lithium batteries, or seawater.

In various embodiments, input energy used to migrate the predetermined metal alkali ion may be saved and recovered, at least in part, as electrochemical energy of the migrated predetermined metal alkali ion at the cathode. Additionally, the input energy may correspond with an electric charge process and the electrochemical energy may correspond with an electric discharge process. Further, the recovery of the input energy may reduce a carbon footprint of a manufacturing facility.

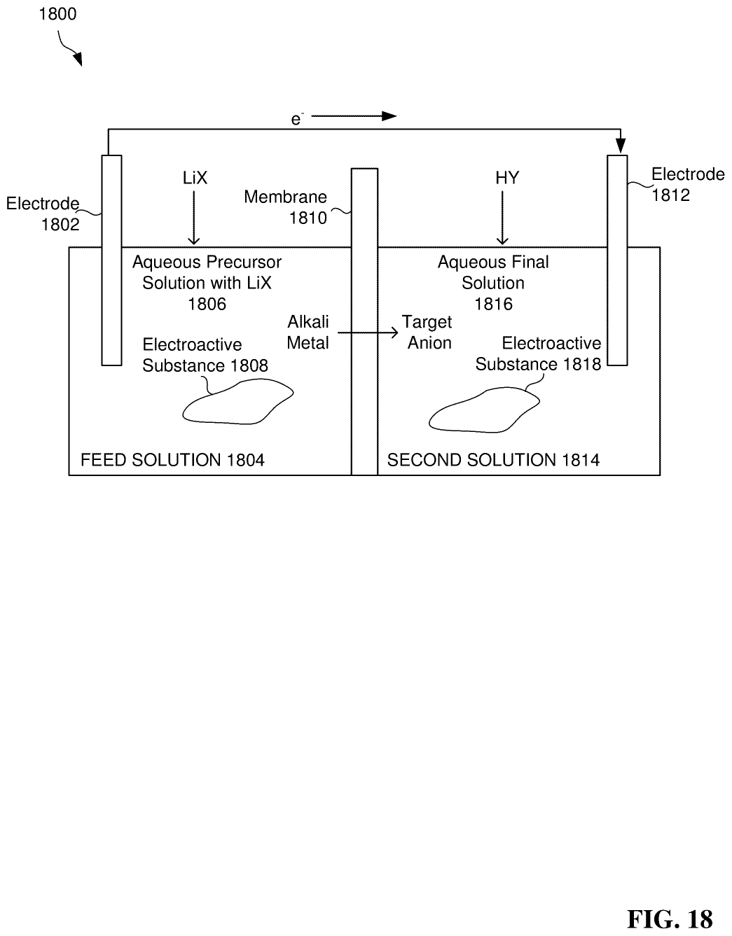

FIG. 18 illustrates redox electrode modules 1800 for critical minerals purification, in accordance with one embodiment. As an option, the redox electrode modules 1800 may be implemented in the context of any one or more of the embodiments set forth in any previous and/or subsequent Figures and/or description thereof. Of course, however, the redox electrode modules 1800 may be implemented in the context of any desired environment. Further, the aforementioned definitions may equally apply to the description below.

As shown, alkali metal ions may pass from an anode comprised of aqueous precursor solution with LiX 1806 in a feed solution 1804 through a solid electrolyte membrane 1810 to a cathode comprised of an aqueous final solution 1816 in a second solution 1814. In one embodiment, LiX 1806 may include any lithium salt, including but not limited to monovalent anions (e.g. Cl—, Br—, I—, etc.), Li₂CO₃, and/or any other anion disclosed herein. In operation, alkali metal atoms comprising an electroactive substance 1808 present in the aqueous precursor solution with LiX 1806 may break apart into positively-charged metal ions and counterpart negatively-charged atoms. In addition, the alkali metal ions may then be drawn across the electrolyte membrane 1810 into the aqueous final solution 1816 where they may recombine with other counterpart atoms to reform into new atoms comprising a higher concentration of electroactive substance 1818 in the aqueous final solution 1816 upon completion of the purification process. In one embodiment, the purification process may simultaneously combine the actions of reduction of H⁺ at a cathode electrode 1812, forming H₂ (sent to an anode electrode), and oxidation of H₂ at the anode electrode 1802, forming H⁺ waste.

In one embodiment, the solid electrolyte membrane 1810 may be impermeable such that the aqueous solution may be prevented from crossing the solid electrolyte and matrix, yet simultaneously allow an alkali metal (such as Li⁺) to pass through the solid electrolyte.

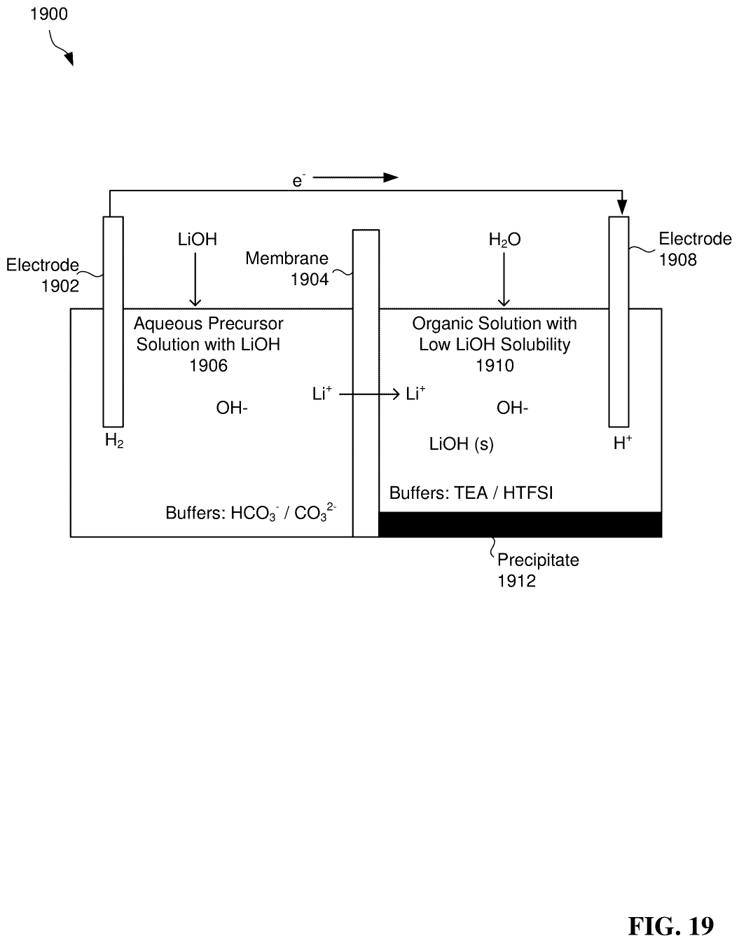

FIG. 19 illustrates redox electrode modules 1900 for metal salt precipitation, in accordance with one embodiment. As an option, the redox electrode modules 1900 may be implemented in the context of any one or more of the embodiments set forth in any previous and/or subsequent Figures and/or description thereof. Of course, however, the redox electrode modules 1900 may be implemented in the context of any desired environment. Further, the aforementioned definitions may equally apply to the description below.

As shown, lithium ions (Li⁺) may pass from an anode comprised of aqueous precursor solution with lithium hydroxide (LiOH) 1906 through a solid electrolyte membrane 1904 to a cathode comprised of an organic solution with low LiOH solubility 1910. In operation, lithium hydroxide atoms present in the aqueous precursor solution 1906 may break apart into positively-charged lithium ions and negatively-charged hydroxide (OH⁻) atoms. In addition, the lithium ions may then be drawn across the electrolyte membrane 1904 into the organic solution with low LiOH solubility 1910 where they may recombine with hydroxide atoms to reform into additional lithium hydroxide atoms, thus yielding a high concentration of lithium hydroxide in the organic solution with low LiOH solubility 1910 resulting in the formation of a concentrated precipitate salt 1912 upon completion of the precipitation process.

Additionally, in one embodiment, the precipitation process may simultaneously combine the actions of reduction of H⁺ at a cathode electrode 1908, forming H₂ (sent to an anode), and oxidation of H₂ at the anode electrode 1902, forming H⁺ waste. Further, to prevent corrosion and degradation of the effectiveness of the solid electrolyte membrane 1904, suitable buffers may be used to coat the solid electrolyte membrane 1904 in the case of contact with both the aqueous precursor solution with lithium hydroxide 1906 and organic solution with low LiOH solubility 1910. By way of example, the compound used to comprise the buffer in the aqueous precursor solution with lithium hydroxide 1906 may include, but not be limited to, bicarbonate (HCO₃⁻) and/or Carbonate ion (CO₃²⁻). Conversely, the compound used to comprise the buffer in the organic solution with low LiOH solubility 1910 may include, but not be limited to, Triethylamine (TEA) and/or bis(trifluoromethanesulfonyl)imide (HTFSI).

In one embodiment, the redox electrode modules 1900 may relate to a membrane-based alkali metal salt precipitation system. In use, an alkali metal salt precipitation system includes an anode and a cathode, where the anode is configured for oxidation and the cathode is configured for reduction. Additionally, migration of a predetermined alkali metal ion through an ion-selective solid electrolyte membrane is driven by a current across the anode and the cathode, and the ion-selective solid electrolyte membrane is selectively permeable to the predetermined alkali metal ion. The alkali metal salt precipitation system further includes at least one active material, a precursor solution comprising the predetermined metal ion, where the precursor solution is at a first solubility of an alkali metal salt, and a second solution comprising the predetermined metal ion, where the second solution is at a second solubility of the alkali metal salt which causes the migrated predetermined metal ion to precipitate.

In various embodiments, the precursor solution may include at least one of LiOH, LiCl, or Li₂CO₃. Additionally, the LiOH may be insoluble in the second solution. Further, the first solubility may be higher than the second solubility.

In various embodiments, the precursor solution may include one or more buffers. The one or more buffers may include at least one of HCO₃⁻ or CO₃²⁻. Additionally, the one or more buffers may be used to protect the ion-selective solid electrolyte membrane. Further, the migrated predetermined metal ion may be Li+, and/or the second solution may comprise at least one LiOH precipitate. Still yet, the second solution may comprise H₂O, where the H₂O may be configured to facilitate the LiOH precipitate formation. The H₂O may function as a reagent.

In various embodiments, the second solution may comprise at least one ether. In other embodiments, the second solution may comprise alcohols, organic carbonates, esters, and/or ketones. Additionally, the precursor solution may include an electroactive solute. The cathode and the anode each may include an electronically conductive substrate made of at least one of: graphite, CNO, graphene, Pt, Au, Ag, Ti, Cu, Al, or stainless steel.

In various embodiments, the at least one active material may comprise an electrode slurry casted on a current collector. The cathode may include a catalyst electrically coupled with an electrically conductive substrate of the cathode. Additionally, the anode may include a catalyst electrically coupled with an electrically conductive substrate of the anode.

In various embodiments, input energy used to migrate the predetermined metal ion may be saved and recovered, at least in part, as electrochemical energy of the migrated predetermined metal ion at the cathode. Additionally, the input energy may correspond with an electric charge process and the electrochemical energy may correspond with an electric discharge process. Further, the recovery of the input energy may reduce a carbon footprint of a manufacturing facility.

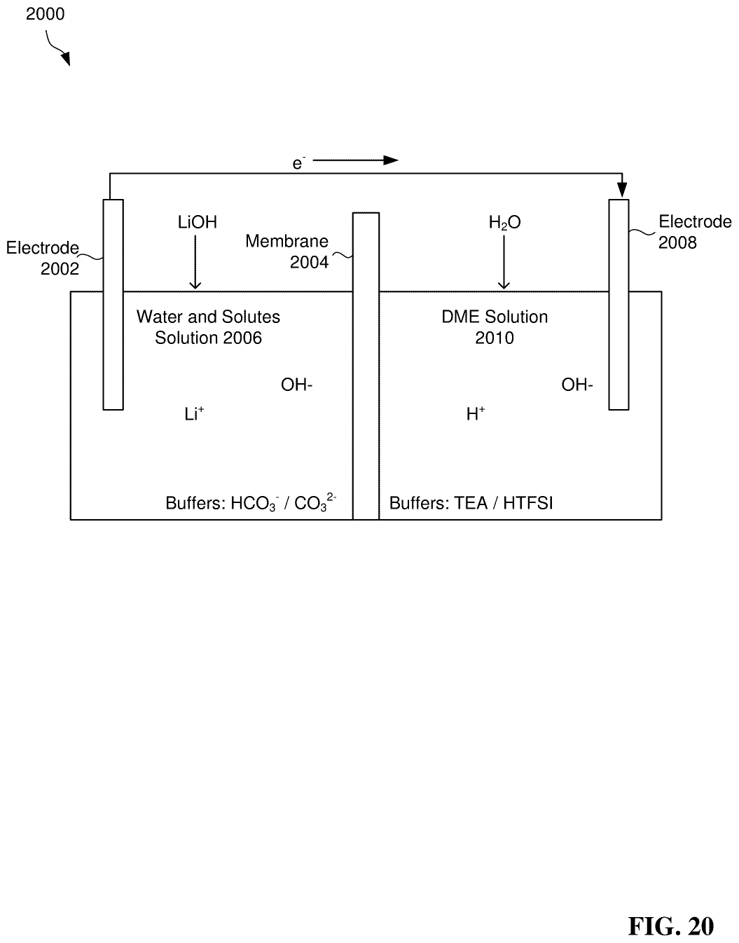

FIG. 20 illustrates redox electrode modules 2000 being set up for metal salt precipitation, in accordance with one embodiment. As an option, the redox electrode modules 2000 may be implemented in the context of any one or more of the embodiments set forth in any previous and/or subsequent Figures and/or description thereof. Of course, however, the redox electrode modules 2000 may be implemented in the context of any desired environment. Further, the aforementioned definitions may equally apply to the description below.

As shown, anode electrode 2002 may be comprised of platinum, and cathode electrode 2008 comprised of copper. The anode electrode 2002 may be in contact with a water and solutes solution 2006 and the cathode electrode 2008 may be in contact with a dimethoxyethane (DME) solution 2010. By design, a current may pass from the anode to the cathode and lithium ions (Li+) may simultaneously pass from the water and solutes solution 2006 through a LATP/epoxy membrane 2004 to the Dimethoxyethane (DME) solution 2010. It should be noted that, in order to prevent corrosion and degradation of the effectiveness of the LATP/epoxy membrane 2004, suitable buffers may be used to coat the LATP/epoxy membrane 2004 in the case of contact with both the water and solutes solution 2006 and Dimethoxyethane (DME) solution 2010. By way of example, the compound used to comprise the buffer in the water and solutes solution 2006 may include bicarbonate (HCO₃⁻) and/or Carbonate ion (CO₃²⁻). Conversely, the compound used to comprise the buffer in the dimethoxyethane (DME) solution 2010 may include triethylamine (TEA) and/or bis(trifluoromethanesulfonyl)imide (HTFSI).

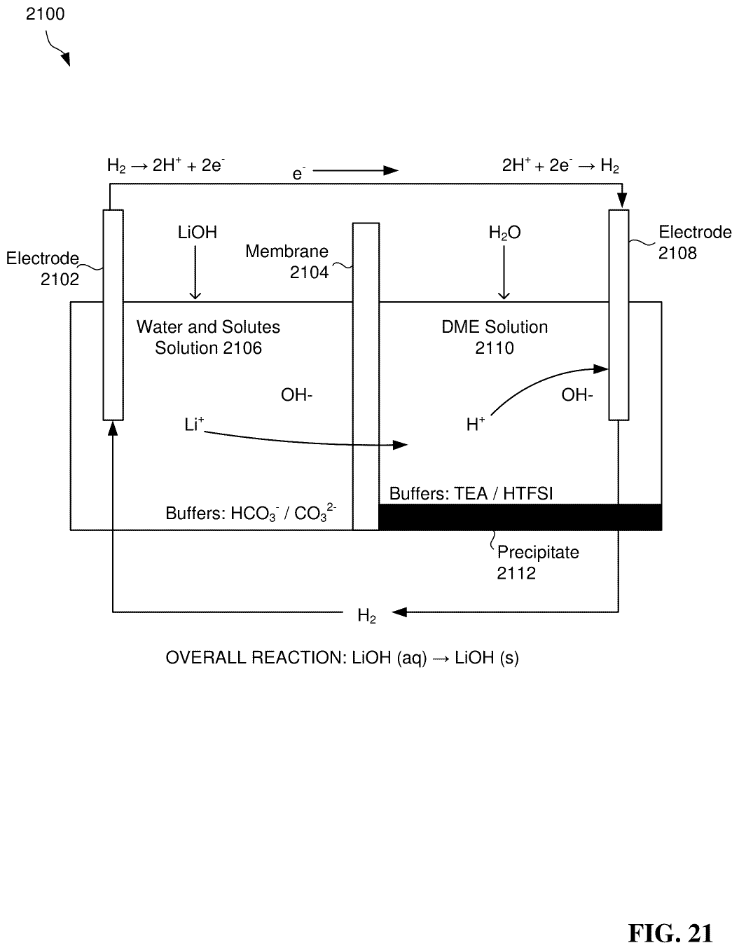

FIG. 21 illustrates redox electrode modules 2100 for metal salt precipitation during reaction, in accordance with one embodiment. As an option, the redox electrode modules 2100 may be implemented in the context of any one or more of the embodiments set forth in any previous and/or subsequent Figures and/or description thereof. Of course, however, the redox electrode modules 2100 may be implemented in the context of any desired environment. Further, the aforementioned definitions may equally apply to the description below.

As shown, anode electrode 2102 may be comprised of platinum and cathode electrode 2108 may be comprised of copper. The anode electrode 2102 may be in contact with a water and solutes solution 2106, and the cathode electrode 2108 may be in contact with a dimethoxyethane (DME) solution 2110. In operation, a current may pass from the anode electrode 2102 to the cathode electrode 2108 and lithium ions (Li+) may simultaneously pass from the anode containing the water and solutes solution 2106 through a LATP/epoxy membrane 2104 to the cathode comprised of the dimethoxyethane (DME) solution 2110. Additionally, lithium hydroxide atoms present in the water and solutes solution 2106 may break apart into positively-charged lithium ions and negatively-charged hydroxide (OH⁻) atoms. Further, the lithium ions may then be drawn across the LATP/epoxy membrane 2104 into the dimethoxyethane (DME) solution 2110 where they may recombine with hydroxide atoms to reform into additional lithium hydroxide atoms, thus yielding a high concentration of lithium hydroxide in the dimethoxyethane (DME) solution 2110 resulting in the formation of a concentrated precipitate salt 2112 upon completion of the precipitation process. Further still, the precipitation process may simultaneously combine the actions of oxidation of H₂ at the anode electrode 2102, forming H⁺ waste and reduction of H⁺ at the cathode electrode 2108, forming H₂ (sent to the anode).

It should be noted that, in order to prevent corrosion and degradation of the effectiveness of the LATP/epoxy membrane 2104, suitable buffers may be used to coat the LATP/epoxy membrane 2104 in the case of contact with both the water and solutes solution 2106 and dimethoxyethane (DME) solution 2110. By way of example, the compound used to comprise the buffer in the water and solutes solution 2106 may include, but not be limited to, bicarbonate (HCO₃—) and/or Carbonate ion (CO₃²⁻). Conversely, the compound used to comprise the buffer in the Dimethoxyethane (DME) solution 2110 may include Triethylamine (TEA), and/or bis(trifluoromethanesulfonyl)imide (HTFSI).

In one embodiment, a net result of the completed reaction process may yield a concentrated precipitate salt 2112 in the form of a mass of lithium hydroxide (LiOH) solid.

It is acknowledged that conventional removal of an ionic species from solution, particularly an aqueous solution, may be a complex and expensive process due to the high amounts of energy and time required to remove water by methods such as boiling, evaporation, reverse osmosis, and/or centrifugation. Known industrial methods include manipulation of temperature, either to induce precipitation of the target species or to remove the solvent, manipulation of evaporation rate, either by altering temperature, humidity, or pressure of the system, or addition of kinetic energy, such as via centrifugation. All these methods typically require either a long time or a high amount of energy and add to complexity of processes. In addition, in the context of traditional chemical processes, the introduction of an additional liquid phase, such as in water/organic extraction, and the precipitation of a solute by addition of a second solvent, can be used. The former is only applicable to some chemicals, particularly organic acids/bases, while the latter requires either a large amount of second (typically organic) solvent as a consumable, or additional processing to remove the second solvent. As such, a process for removing highly soluble salts, such as lithium chloride (LiCl) and/or lithium hydroxide (LiOH), may make the precipitation process much less expensive, and thus enable additional potential applications. It should be noted that such a process may also significantly reduce the energy required, which may also realize the added benefit of decreasing the carbon footprint of the facility.

In various embodiments, the redox electrode modules 2100 may be used for precipitation of an ionic compound. Such an application may be, in particular, for those solutions with a high solubility in water and that contain an alkali metal cation. Additionally, the solutions may consist of a feed solution containing a precursor ionic compound (which in turn may contain the alkali metal cation of the salt that the system is designed to precipitate). In one embodiment, the precursor ionic compound may be lithium hydroxide or any other ionic compound containing Li+, which is the alkali metal cation that the system is designed to precipitate. It is acknowledged that although lithium is focused on as the desired mineral to be extracted and precipitated, other critical minerals may, in like manner, be extracted and precipitated.

In another embodiment, the precursor ionic compound and/or target ionic compound may have a high solubility in the feed solution, the solvent for which may be water, an alcohol, a carbonate, an ether, a hydrocarbon, and/or a liquid metal solution. Additionally, the system may comprise a second solution containing a target anion, which may be identical to or different from the anion of the precursor compound. Additionally, in one embodiment, the solvent for the second solution may be selected such that the target compound that the system may be designed to precipitate at low solubility. For example, the solvent for the second solution may be water, an alcohol, a carbonate, an ether, a hydrocarbon, or a liquid metal solution. In one embodiment, the system may be designed to precipitate a salt containing the target anion.

The system for precipitation of an ionic compound may also comprise a solid electrolyte membrane, which may serve as a barrier for the precursor solution and nonvolatile solution and selectively transport lithium in the form of lithium ions through the membrane. Additionally, the solid electrolyte membrane may contain an ion-selective solid, such as lithium aluminum titanium phosphate, lithium aluminum germanium phosphate and/or any other member of the NASICON-type solid electrolyte structure family. As discussed herein, the solid electrolyte membrane may be constructed to be ion-specific in selectively allowing a predesignated ion to pass.

The system for precipitation of an ionic compound may also comprise an alkali metal cation or H+ initially dissolved in the feed solution. Additionally, the alkali metal cation may also ultimately be the salt that the system is designed to precipitate. In like manner, the system may also comprise a target anion initially dissolved in the second solution, the salt for which the system is designed to precipitate.

The system for precipitation of an ionic compound may also comprise a first electroactive solute, which can be oxidized and donate electrons for the system and may be a single solute or set of solutes that undergo electrochemical reactions. Such reactions may include electrons as a product, based on one or more of hydrogen gas, hydroxide, water, a chloride ion, a bromide ion, and/or an iodide ion. Additionally, the system may comprise a second electroactive solute, which can be reduced and receive electrons from the system. Such second electroactive solute may include a single solute or set of solutes that undergo electrochemical reactions in which electrons are a reactant, based on one or more of oxygen gas, a hydrogen ion, water, chlorine, bromine, and/or iodine.

The system for precipitation of an ionic compound may also comprise a first buffer which may be dissolved in the feed solution and may be comprised of a set of multiple solutes that together maintain a pH of the solution within a desired range (such as pH 7 or any desired level). Additionally, the system may comprise a second buffer, which may be dissolved in the second solution and may comprise a set of multiple solutes that together maintain the pH of the solution within a desired range (such as pH 7 or any desired level). In addition, a buffering system with two components may contain a base, whose conjugate acid (for example, triethylamine (TEA), and/or an acid, etc.) may form a substance that when combined with the target anion, or any other anion found in the second solution, may be soluble in the second solution during operation of the system, whose conjugate base (for example, (bis(trifluoromethylsulfoniminic) acid (HTFSI), etc.) may form a substance that when combined with the target alkali metal cation or H+, or any other cation found in the second solution, may be soluble in the second solution during operation of the system. It should be noted that either the conjugate acid of the base or the acid may have a moderate pKa, (such as a pH of around 7).

The system for precipitation of an ionic compound may also comprise an anode, immersed in a feed solution consisting of an electronically conductive substrate, such as a metal, metalloid, or carbon-based material, an active material (optional). The feed solution may be electronically in contact with the electronically conductive substrate and may undergo a chemical reaction with the first electroactive solute, and/or a catalyst (optional). The feed solution may further be in contact with the electronically conductive substrate and, when utilized, may lower the activation energy/overpotential of the oxidation of the first electroactive solute.

In one embodiment, the electronically conductive substrate may be a sheet, a rod, and/or a sphere immersed in the solution. Additionally, the substrate may be selected such that the reduction potential of the material is higher than that of the first electroactive solute. The first electrode may include, but not be limited to graphite, cyanate, graphene, platinum, gold, silver, titanium, copper, aluminum, and/or stainless steel. In another embodiment, the catalyst may be comprised of platinum, gold, silver, iridium, iron, ruthenium, rhodium, and/or palladium.

The system for precipitation of an ionic compound may also comprise a cathode immersed in the second solution further comprised of an electronically conductive substrate. The electronically conductive substrate may include, but not be limited to a metal, metalloid, or carbon-based material that may be a sheet, a rod, and/or a sphere, and may be immersed in the solution. In addition, the electronically conductive substrate may be selected such that the reduction potential of the material is higher than that of the second electroactive solute. Additionally, the system may comprise an active material (optional), which may be electronically in contact with the electronically conductive substrate and, when utilized, may react with the second electroactive solute. Further, the system may comprise a catalyst (optional), which may be in contact with the electronically conductive substrate and, when utilized, may lower the activation energy/overpotential of the oxidation of the second electroactive solute.

In one embodiment, the electronically conductive substrate may be comprised of, but not limited to, graphite, cyanate, graphene, platinum, gold, silver, titanium, copper, aluminum, and/or stainless steel. In a related embodiment, the catalyst may be comprised of platinum, gold, silver, iridium, iron, ruthenium, rhodium, and/or palladium.

In operation, the process for precipitation of an ionic compound may comprise transferring current from the anode to the cathode, which may result in selective transport of the alkali metal cation or a Hydrogen ion from a first solution, through the solid electrolyte membrane, and into a second solution. In addition, the process may include oxidation of the first electroactive species at the anode and reduction of the second electroactive species at the cathode. Additionally, the process may include transport of gaseous products from one electrode to another. In one embodiment, the terms anode and cathode may both be referred to as electrodes.

In further operation, the process for precipitation of an ionic compound may comprise a change in relative concentration of the buffering species of the first buffer and the second buffer, which may maintain the pH of the feed and second solutions. Additionally, the process may include precipitation of target salt, which may occur due to, in one embodiment, low solubility of the salt in the second solution, thus resulting in a precipitated salt formed in the bottom of the second solution.

In one embodiment, an active material may be an electrode slurry applied to a current collector. In another embodiment, additional solutions may be added to the system, wherein the additional solutions may be situated between the feed and second solution and separated by any other solutions via ion-selective solid electrolyte membranes.

In still another embodiment, a system for circulating any gaseous species formed at either the cathode or anode may be used to partially reclaim the energy input required for the system. Additionally, a second system of solutions and/or ionically selective solid electrolyte membranes may be used to recycle any gaseous species formed at either the cathode or anode.

It is to be appreciated that the system may be used in conjunction with any other membrane-assisted system, such as those used for selective extraction of alkali metal ions or hydrogen ions from a feed solution, an ion-exchange system, a system for the production of lithium metal via electrolysis (solid metal production), and/or a system for purification of alkali metal ions. This can be configured in such a way where all processes take place in series and only a single anode or cathode may be used to run all processes simultaneously.

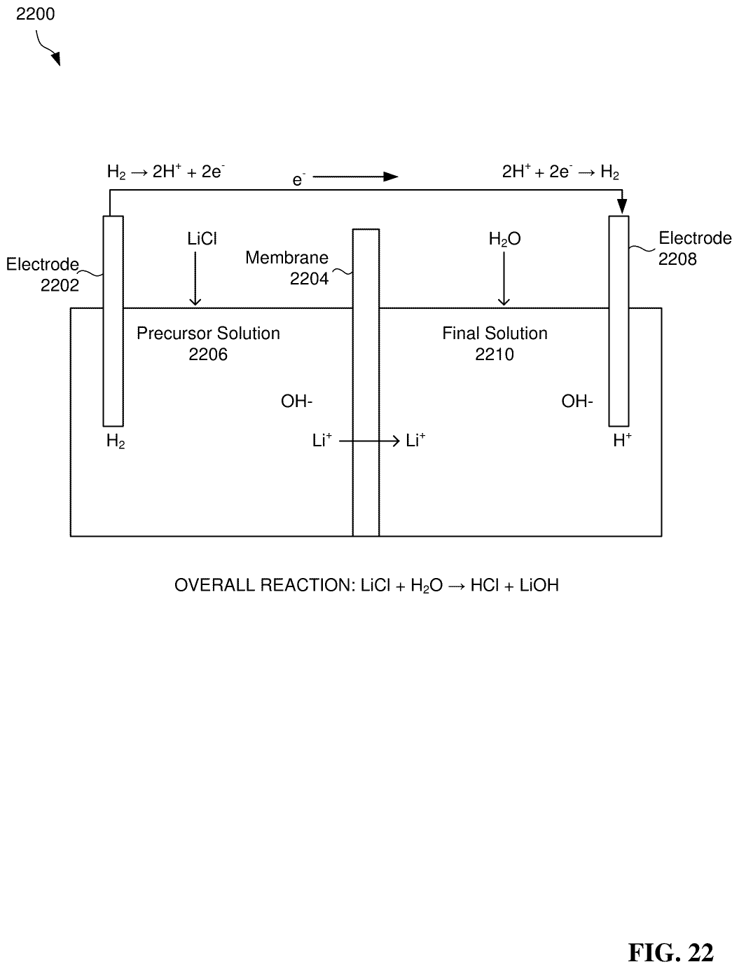

FIG. 22 illustrates redox electrode modules 2200 for ion exchange, in accordance with one embodiment. As an option, the redox electrode modules 2200 may be implemented in the context of any one or more of the embodiments set forth in any previous and/or subsequent Figures and/or description thereof. Of course, however, the redox electrode modules 2200 may be implemented in the context of any desired environment. Further, the aforementioned definitions may equally apply to the description below.

As shown, lithium ions (Li⁺) may pass from an anode comprised of aqueous precursor solution 2206 through a solid electrolyte membrane 2204 to a cathode comprised of an aqueous final solution 2210. In operation, lithium hydroxide (LiOH) atoms present in the aqueous precursor solution 2206 may break apart into positively-charged lithium ions and negatively-charged hydroxide (OH⁻) atoms. In addition, the lithium ions may then be drawn across the electrolyte membrane 2204 into the aqueous final solution 2210 where they may recombine with hydroxide atoms to reform into additional lithium hydroxide atoms, thus yielding a higher concentration of lithium hydroxide in the aqueous final solution 2210 upon completion of the ion exchange process. Further, the ion exchange process may simultaneously combine the actions of reduction of H⁺ at a cathode electrode 2208, forming H₂ (sent to an anode), and oxidation of H₂ at the anode electrode 2202, forming H⁺ in the precursor solution 2206.

In one embodiment, redox electrode modules 2200 may relate to a membrane-based ion exchange system. In use, an ion exchange system includes an anode, and a cathode, where the anode is configured for oxidation and the cathode is configured for reduction. Additionally, migration of a predetermined alkali metal cation through an ion-selective solid electrolyte membrane is driven by a current across the anode and the cathode. Further, the ion-selective solid electrolyte membrane may be selectively permeable to the predetermined alkali metal cation. The ion exchange system further includes a first active material associated with the anode, a second active material associated with the cathode, an anolyte solution comprising the predetermined alkali metal cation and a first anion, and a catholyte solution comprising the migrated predetermined alkali metal cation and a second anion, where the migrated predetermined alkali metal cation and the second anion are configured to combine to form a dissolved salt in the catholyte solution.

In various embodiments, the catholyte solution may include H₂O or HCl. Additionally, the H₂O or the HCl may be added at the same rate at which the predetermined alkali metal cation passes through the ion-selective solid electrolyte membrane. The catholyte solution may comprise the H₂O or the HCl as a reagent. Further, the formation may be based on a reduction of LiOH.

In various embodiments, the second anion may comprise a hydroxyl group, the predetermined alkali metal cation may comprise Li⁺, and the first anion may differ from the second anion. Additionally, the first anion and/or the second anion may include one or more of: CO₃²⁻, HCO₃⁻, NO₃⁻, PO⁻, OH⁻, Cl⁻, Br⁻, or I⁻. Further, the anolyte solution and the catholyte each independently may comprise a solvent comprising one or more of: water, alcohol, ester, ether, carbonate, or hydrocarbon.

In various embodiments, the first active material includes one or more of: H₂, H₂O, OH⁻, Cl⁻, Br⁻, or I⁻; and the second active material may include one or more of: H⁺, H₂O, O₂, Cl₂, Br₂, or I₂. Further, the ion exchange system may include a buffer in one or more of the anolyte and the catholyte. Additionally, a second ion-selective solid electrolyte membrane may be configured to selectively allow passage of the migrated predetermined alkali metal cation, and a third solution may include the allowed migrated predetermined alkali metal ion.

In various embodiments, the dissolved salt may be an alkali metal salt, and a purity of the alkali metal salt in the catholyte may be less than a purity of the dissolved salt in the third solution. Additionally, the alkali metal salt may be insoluble in the third solution.

In various embodiments, input energy used to migrate the predetermined metal alkali ion may be saved and recovered, at least in part, as electrochemical energy of the migrated predetermined metal alkali ion at the cathode. Additionally, the input energy may correspond with an electric charge process and the electrochemical energy may correspond with an electric discharge process. Further, the recovery of the input energy may reduce a carbon footprint of a manufacturing facility.

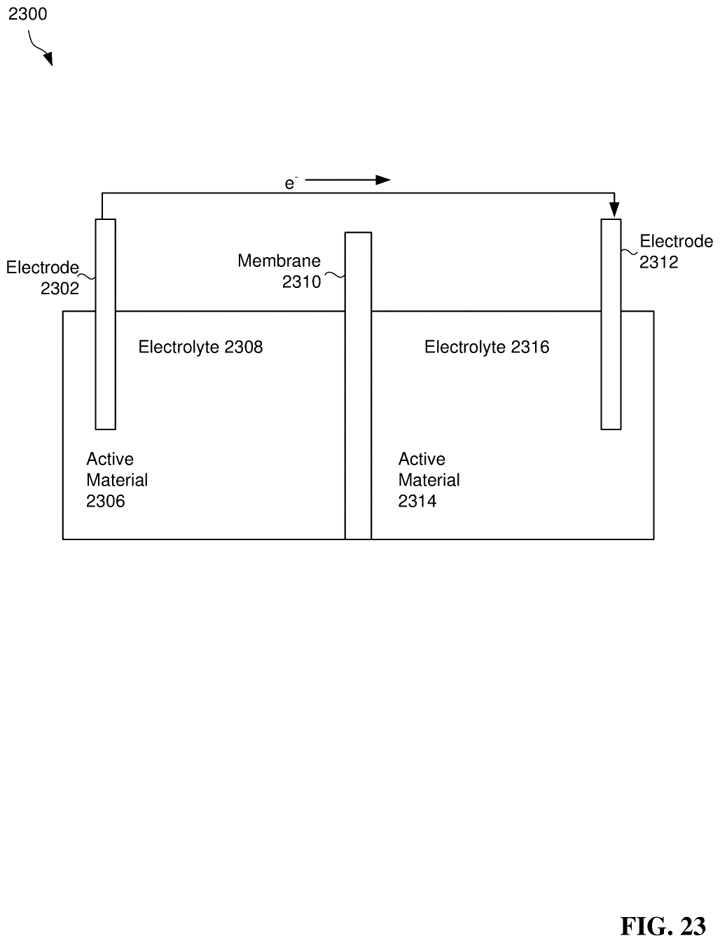

FIG. 23 illustrates a membrane separation system 2300, in accordance with one embodiment. As an option, the membrane separation system 2300 may be implemented in the context of any one or more of the embodiments set forth in any previous and/or subsequent Figures and/or description thereof. Of course, however, the membrane separation system 2300 may be implemented in the context of any desired environment. Further, the aforementioned definitions may equally apply to the description below.

As shown, an ion-selective solid electrolyte membrane 2310 separates anode electrolyte 2308 containing an active material 2306 from cathode electrolyte 2316 containing another active material 2314 in an exemplary system. In addition, anode electrode 2302 and cathode electrode 2312 may be in contact with anode electrolyte 2308 and anode electrolyte 2316 within the exemplary system, respectively.

In one embodiment, the ion-selective solid electrolyte membrane 2310 may facilitate various ion-oriented processes including, but not limited to purification, salt precipitation, ion exchange, ion extraction, and/or electrolysis. In a related embodiment, the ion-selective solid electrolyte membrane 2310 may comprise two or more layers of membrane to help control various aspects of ion-oriented processes including, but not limited to, increased purity of allowable ion transfer and/or rate of reaction. Additionally, the membrane separate system 2300 may be further configured as needed, including having three solutions (similar to a configuration found in FIG. 15), depending on the needs of the input feed(s), and the needs of the output. For example, a three solution separation system (such as that found in FIG. 15) may be more efficient, in one embodiment, for an assembly for continuous processing.

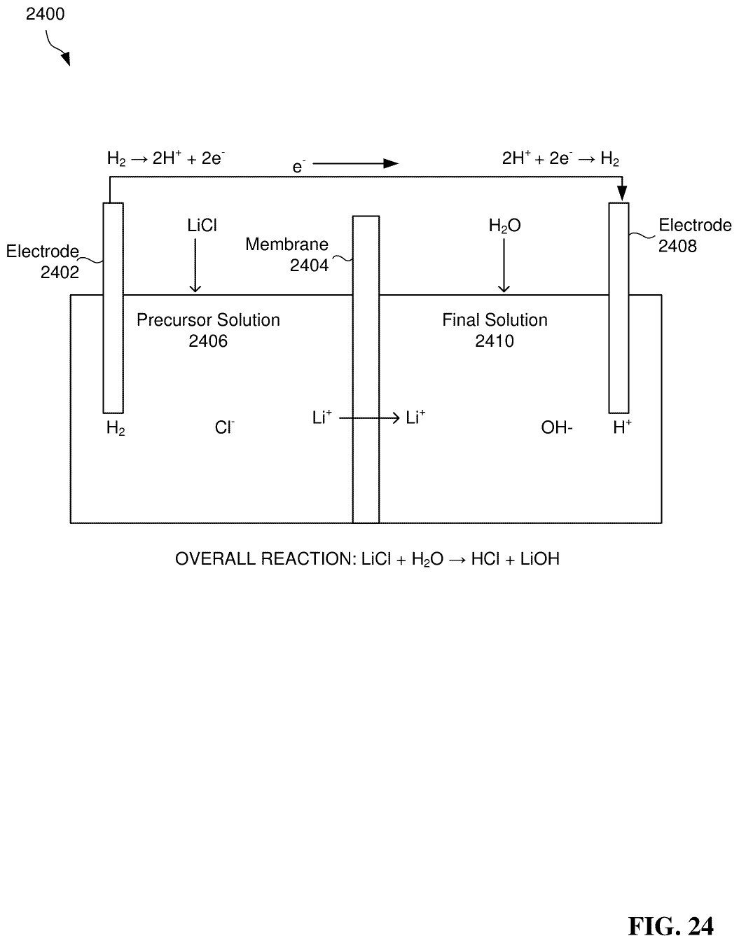

FIG. 24 illustrates redox electrode modules 2400 for ion exchange, in accordance with one embodiment. As an option, the redox electrode modules 2400 may be implemented in the context of any one or more of the embodiments set forth in any previous and/or subsequent Figures and/or description thereof. Of course, however, the redox electrode modules 2400 may be implemented in the context of any desired environment. Further, the aforementioned definitions may equally apply to the description below.

As shown, lithium ions (Li⁺) may pass from an anode comprised of aqueous precursor solution 2406 through a solid electrolyte membrane 2404 to a cathode comprised of an aqueous final solution 2410. In operation, lithium hydroxide (LiOH) atoms present in the aqueous precursor solution 2406 may break apart into positively-charged lithium ions and negatively-charged hydroxide (OH⁻) atoms. In addition, the lithium ions may then be drawn across the electrolyte membrane 2404 into the aqueous final solution 2410 where they may recombine with hydroxide atoms to reform into additional lithium hydroxide atoms, thus yielding a higher concentration of lithium hydroxide in the aqueous final solution 2410 upon completion of the ion exchange process. Further, the ion exchange process may simultaneously combine the actions of reduction of H⁺ at a cathode electrode 2408, forming H₂ (sent to an anode), and oxidation of H₂ at the anode electrode 2402, forming H⁺ in the precursor solution 2406.

In conventional systems, cations and/or anions may be exchanged by the use of ion-exchange resins. However, use of these resins may limit the extent of ion exchange (i.e., the resulting materials are less pure than they could be). Additionally, ion exchange resins for lithium, specifically, are far less successful compared to other ions. In contrast, the processes detailed herein enable enabling the ability to exchange cations and/or anions of various ionic compounds, including lithium compounds, in a cost-effective and highly-selective, complete manner which can simplify the processing of a wide range of materials, reduce costs, and allow for a wider range of material precursors to fit into current processes that require specific cations and/or anions.

In one embodiment, a system for ion exchange of ionic compounds containing an alkali metal cation may comprise two electrodes including a carbon rod with a platinum catalyst on the anode side and a carbon or metal rod and/or mesh on the cathode side, two active materials (including, but not limited to hydrogen on the anode side and hydrogen ions on the cathode side, etc.), two liquid electrolytes (including but not limited to an anode electrolyte, anolyte, containing a solvent like water), a cation (including but not limited to hydrogen ions, lithium ions, sodium ions, potassium ions, etc.), anions (including but not limited to carbonate, bicarbonate (HCO₃⁻), nitrate (NO₃⁻), phosphate (PO₄³⁻), hydroxide, chlorine ions, bromine ions, iodine ions, etc.), a buffer (optional), and/or feed salt dissolved in the solvent, a cathode liquid electrolyte (catholyte) containing a solvent like water, a final anion (which is the desired target product of the ion exchange system), an ion-selective solid electrolyte membrane (including solid electrolyte particles such as but not limited to lithium, aluminum, titanium phosphate, lithium aluminum, germanium phosphate, NASICON, potassium Ferrate (K₂Fe₄O₇), etc.), a matrix of epoxy and/or polymers, and mechanical fillers like carbon and/or ceramic particles.

In one embodiment, the anode active material may include, but not be limited to, hydroxide, chlorine ions, bromine ions, and/or iridium ions. In a related embodiment, the cathode active material may include, but not be limited to, oxygen, chlorine, bromine, and/or iodine. In another embodiment, the anolyte may include, but not be limited to, alcohols, esters, ethers, carbonates, and/or hydrocarbons. In yet another embodiment, the feed salt may be the source of one or more of the cations, anions, the buffer, and/or anode active material. In still another embodiment, the catholyte may also include, but not be limited to, alcohols, esters, ethers, carbonates, and/or hydrocarbons. In one embodiment, the final anion may be in the form of an acid (for example, if the final anion is bromine ions, then hydrogen bromide (HBr) may be dissolved in the liquid electrolyte to provide bromine ions, etc.). In a related embodiment, the final anion may be the source of one or more of the anions, buffer, and/or cathode active material.

In operation, the process for ion exchange of ionic compounds containing an alkali metal cation may include passing current from the anode to cathode, which may result in reduction of the cathode active material and oxidation of the anode active material. This current may also cause a spontaneous migration of the target cations (e.g., lithium ions) across the solid electrolyte membrane from the anolyte to the catholyte, resulting in the catholyte (which may initially contain the “final anion”) containing a dissolved salt of the alkali metal cation and target anion.

In one embodiment, the process for ion exchange of ionic compounds containing an alkali metal cation may be performed in series or in parallel with other separation processes using the ion-selective solid electrolyte membrane, such as alkali metal purification, direct lithium extraction, salt precipitation, or alkali metal production. In another embodiment, if the product at the cathode is a gas (such as hydrogen, for example), the product may be transferred to the anode and function as the active material, thereby enabling partial recovery of the energy required to drive the cathode side reaction.

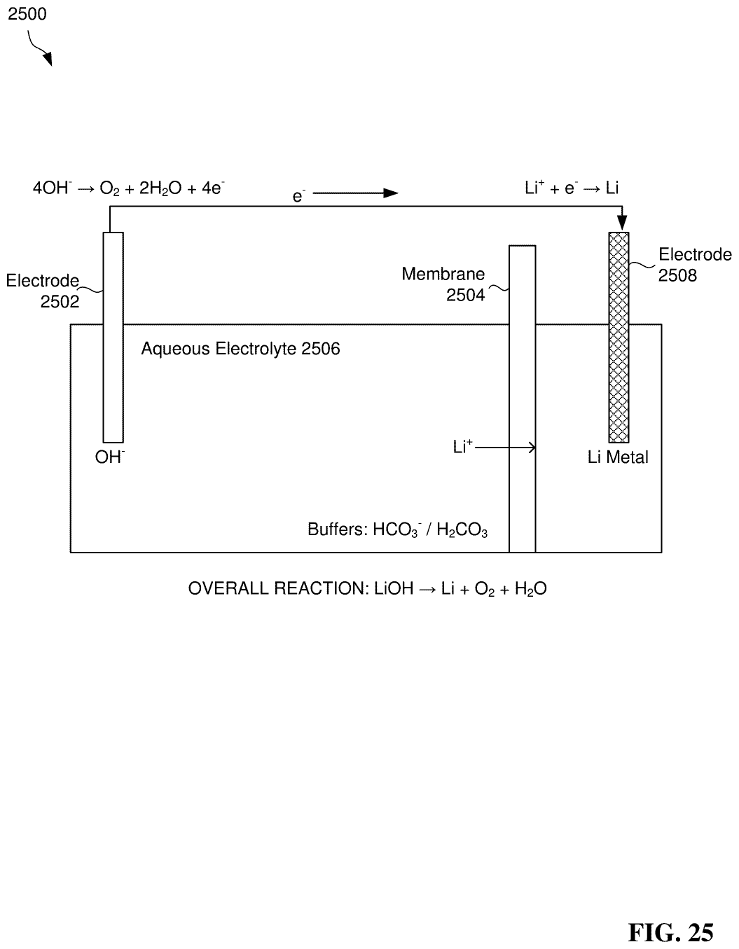

FIG. 25 illustrates membrane-based alkali metal production 2500, in accordance with one embodiment. As an option, the membrane-based alkali metal production 2500 may be implemented in the context of any one or more of the embodiments set forth in any previous and/or subsequent Figures and/or description thereof. Of course, however, the membrane-based alkali metal production 2500 may be implemented in the context of any desired environment. Further, the aforementioned definitions may equally apply to the description below.

As shown, lithium ions (Li⁺) may pass from an anode comprised of aqueous electrolyte 2506 through a solid electrolyte membrane 2504 to a cathode comprised of an alkali metal—in this instance, lithium metal. In operation, lithium hydroxide atoms present in the aqueous electrolyte 2506 may break apart into positively-charged lithium ions and negatively-charged hydroxide (OH⁻) atoms. In addition, the lithium ions may then be drawn across the electrolyte membrane 2504 to the cathode containing the aggregated alkali metal (such as Li+ metal). Additionally, the alkali metal production may simultaneously combine the actions of reduction of Li⁺ at a cathode electrode 2508, forming lithium metal, and oxidation of OH— at the anode electrode 2502, forming O₂ and/or H₂O waste. Further, to prevent corrosion and degradation of the effectiveness of the solid electrolyte membrane 2504, a suitable buffer may be used to coat the solid electrolyte membrane 2504 in the case of contact with the aqueous electrolyte 2506. By way of example, the compound used to comprise the buffer in the aqueous electrolyte 2506 may include bicarbonate (HCO₃⁻) and/or carbonic acid (H₂CO₃).

In one embodiment, the resulting alkali metal may be in solid and/or liquid metal form upon completion of the alkali metal production process.

In one embodiment, the membrane-based alkali metal production 2500 may relate to a membrane-based alkali metal production system. In use, an alkali metal production system includes an anode, and a cathode, where the anode is configured for oxidation and the cathode is configured for reduction. Additionally, migration of a predetermined metal ion through an ion-selective solid electrolyte membrane is driven by a current across the anode and the cathode. Further, the ion-selective solid electrolyte membrane is selectively permeable to the predetermined metal ion. The alkali metal production system further includes at least one active material, a first solution comprising an aqueous electrolyte (where the aqueous electrolyte includes the predetermined metal ion), and a second solution comprising a metal atom based on the migrated predetermined metal ion, wherein the second solution is at least partially disposed in a liquid state of the metal atom.

In various embodiments, the at least one active material includes a hydroxyl group for the anode, and/or the at least one active material includes lithium metal for the cathode. Additionally, the liquid state is a molten solution of the metal atom.

In various embodiments, the anode is a carbon rod, and/or the carbon rod includes a Pt catalyst. Additionally, the cathode may comprise a carbon rod or mesh, or a metal rod or mesh. Further, the at least one active material for the anode may include at least one of: H₂, OH⁻, Cl⁻, Br⁻, or I⁻.

In various embodiments, the at least one active material for the cathode may include a liquid metal. The liquid metal may within the temperature range of 25° C.-250° C. Additionally, the liquid metal may be configured to form a molten alloy with lithium. The liquid metal may include one of: Ga, Ga—In, Na—K alloys, Na—K—Cs alloys, or Ga—In—Sn alloys.

In another embodiment, a system for alkali metal production is provided, which includes a first electrode, a first electrolyte comprising an alkali metal salt, where the first electrolyte is configured to be in contact with the first electrode, and a second electrode, where when a current is passed from the first electrode to the second electrode, the current causes migration of an alkali metal ion of the alkali metal salt. Additionally, an ion-selective solid electrolyte membrane is configured to selectively allow the alkali metal ion to migrate. A second solution includes an alkali metal atom based on the migrated alkali metal ion and galinstan (i.e. Ga—In—Sn alloy). Additionally, the system includes a third electrode, where when a second current passed from the second electrode to the third electrode, the second current causes second migration of the alkali metal atom of the second solution. A second ion-selective solid electrolyte membrane is configured to selectively allow the alkali metal atom to migrate, and a third solution includes the second migrated alkali metal atom.

In various embodiments, the second migrated alkali metal atom may be in a molten state. Additionally, the migration may occur at ambient conditions, and/or the second migration may occur at controlled conditions, wherein the controlled conditions include at least one of: an inert environment, or Ar atmosphere.

In various embodiments, a thickness of the second ion-selective solid electrolyte membrane may be configured to increase a purity of the second migrated alkali metal atom. Additionally, the migration and the second migration may occur concurrently, and/or the migration and the second migration may occur in series or a batch configuration.

In various embodiments, the alkali metal ion may be Li⁺, and/or the second solution may include lithiated galinstan. Further, the third solution may include only the second migrated alkali metal atom.

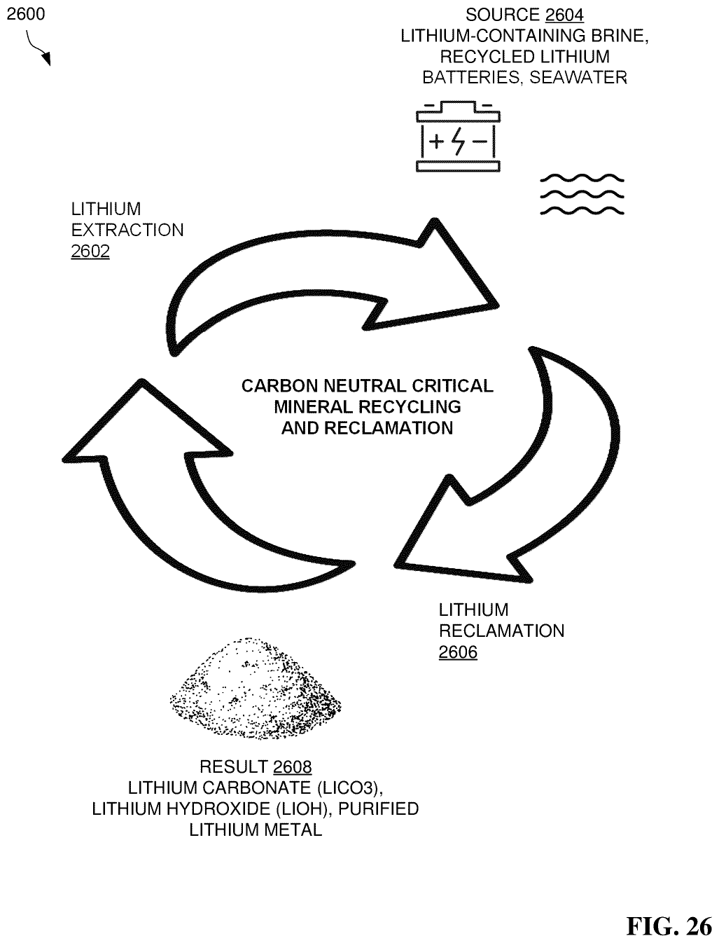

FIG. 26 illustrates a process 2600 for carbon neutral critical mineral recycling and reclamation, in accordance with one embodiment. As an option, the process 2600 may be implemented in the context of any one or more of the embodiments set forth in any previous and/or subsequent Figures and/or description thereof. Of course, however, the process 2600 may be implemented in the context of any desired environment. Further, the aforementioned definitions may equally apply to the description below.

As shown, a process for carbon neutral critical mineral recycling and reclamation 2600 may include cyclical steps including, but not limited to, a critical mineral (in this instance, lithium) source 2604, lithium reclamation 2606, a critical mineral and result 2608, and lithium extraction 2602. In operation, the process 2600 may begin with the lithium source(s) from which lithium metal may ultimately be extracted in the form of lithium-containing brine, recycled lithium batteries, and/or seawater. Additionally, lithium reclamation 2606 subprocesses may be employed to produce resulting materials (the result 2608) including, but not limited to, lithium carbonate (LiCO₃), lithium hydroxide (LiOH), and purified lithium metal. In addition, lithium extraction 2602 may be employed to provide raw lithium metal and/or other forms of lithium for use in products and/or processes such as new lithium battery electrolytes for anodes and cathodes, by way of one example. Further, once such new lithium-based products have reached the end of their practical and/or useful life, those products may again become lithium source 2604 materials to initiate another process for carbon neutral critical mineral recycling and reclamation 2600. In this manner, the lithium extraction 2602 and the lithium reclamation 2606 steps may provide for a near carbon neutral system for extracting lithium from sources, and producing a lithium that can be reused. Additionally, although the process 2600 is discussed in particular with respect to lithium, it is to be appreciated that the process 2600 may apply in like manner to any critical mineral.

In one embodiment, the process 2600 may relate to an energy reclamation and carbon-neutral system for critical mineral extraction. In use, a method for critical mineral reclamation includes driving migration of lithium ions using a current passing from an anode to cathode, where the current is driven by a redox configuration of the anode and the cathode. Additionally, the lithium ions are extracted from a first solution into a second solution through an ion-selective solid electrolyte membrane, where the ion-selective solid electrolyte membrane is configured to selectively allow the lithium ions to pass. Further, an input of energy is provided for the extraction, and after the extraction, a reclamation of the lithium ions is caused, where the reclamation recovers at least a portion of the input of energy.

In various embodiments, the reclamation may include converting the lithium ions to lithium carbonate or lithium hydroxide. Additionally, the reclamation may include purifying the lithium ions to a minimum of 99.9% desired lithium salt, or 99.9% lithium trace metals basis. Further, the input of energy may be stored as electrochemical energy of the lithium ions.

In various embodiments, recovering the at least a portion of the input of energy may reduce a carbon footprint of a manufacturing facility. Additionally, the first solution may be based on at least one of lithium minerals, lithium-containing brines, recycled lithium batteries, geothermal brines, salar brines, or seawater.

In various embodiments, the ion-selective solid electrolyte membrane may be water impermeable. Additionally, the reclamation may include transporting the lithium ions from the second solution to a third solution via the ion-selective solid electrolyte membrane, and/or transporting second ions from the third solution to a fourth solution via a second ion-selective solid electrolyte membrane, wherein the transporting of the second ions from the third solution to the fourth solution coincides with the transporting of the lithium ions from the second solution to the third solution. Still yet, extracting the lithium ions from the first solution to the second solution may coincide with an uptake of second ions from a third solution to the first solution.

In various embodiments, the first solution may be a feed solution, the second solution may be an anolyte, a third solution may be a catholyte, and a second ion-selective solid electrolyte membrane may be selectively permeable to sodium. The anolyte may include a lithium electrolyte and the catholyte may include a sodium electrolyte. Additionally, at least one of the anode or the cathode may be made of at least one of titanium mesh, stainless steel mesh, etc. The extraction of the lithium ions from the first solution to the second solution may coincide with an extraction of sodium ions from the third solution to the first solution, and the reclamation of the lithium ions may include transporting the lithium ions from the second solution to a fourth solution which may coincide with transporting the sodium ions from the fourth solution to the third solution. Further, the transporting of the lithium ions may coincide with an electric discharge of electrochemical energy of the lithium ions.

In various embodiments, the extraction and reclamation may be performed, at least in part, using a lithium module which includes the ion-selective solid electrolyte membrane, the second solution (where the second solution includes a lithium electrolyte), and an active material electrode in direct contact with the second solution. Additionally, the extraction and reclamation may be further performed, at least in part, using a sodium module which includes a second ion-selective solid electrolyte membrane (where the second ion-selective solid electrolyte membrane is sodium selective), a third solution (where the third solution includes a sodium electrolyte), and a second active material electrode in direct contact with the third solution. Further, the lithium module and the sodium module may be configured to be part of a module array, the module array configured to have multiple lithium modules comprising the lithium module, and multiple sodium modules comprising the sodium module.

In various embodiments, the first solution may be a feed solution that flows into the module array and between each of the multiple lithium modules and each of the multiple sodium modules. Additionally, the first solution may be used for the extraction, and a fourth solution may be used for the reclamation, where the first solution differs from the fourth solution, and the fourth solution replaces the third solution after the extraction. Further, the first solution may comprise at least one of lithium minerals, lithium-containing brines, recycled lithium batteries, geothermal brines, salar brines, or seawater, and the fourth solution may comprise a Na₂CO₃ feed.

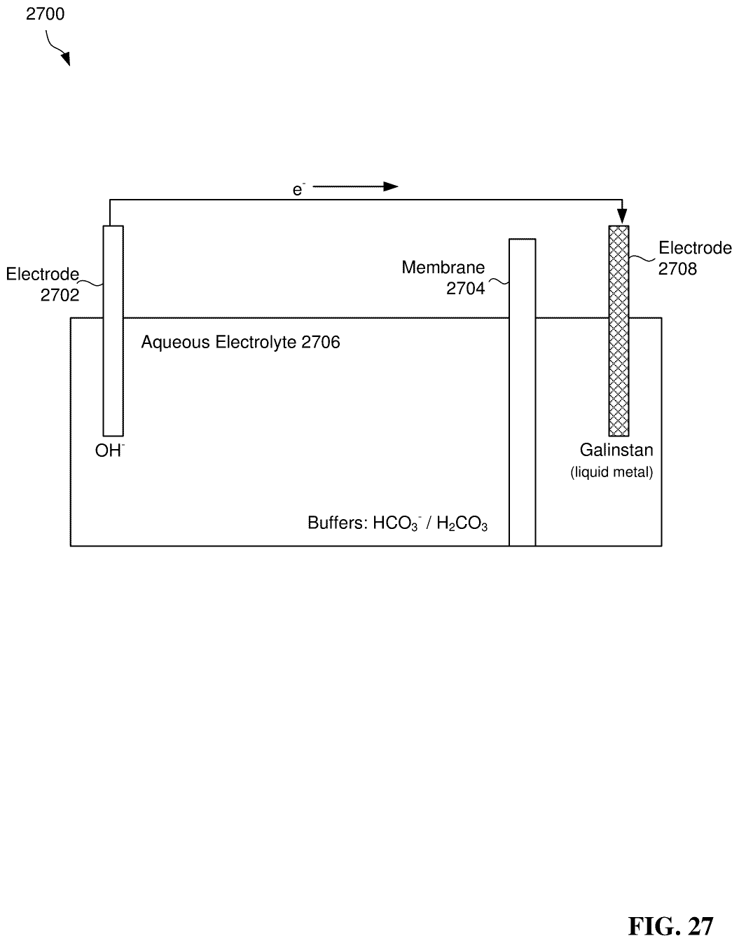

FIG. 27 illustrates membrane-based alkali metal production 2700, in accordance with one embodiment. As an option, the membrane-based alkali metal production 2700 may be implemented in the context of any one or more of the embodiments set forth in any previous and/or subsequent Figures and/or description thereof. Of course, however, the membrane-based alkali metal production 2700 may be implemented in the context of any desired environment. Further, the aforementioned definitions may equally apply to the description below.

As shown, lithium ions (Li⁺) may pass from an anode comprised of aqueous electrolyte 2706 through a lithium ion-selective solid electrolyte membrane 2704 to a cathode comprised of lithiated galinstan (Ga—In—Sn) liquid metal. In operation, lithium hydroxide atoms present in the aqueous electrolyte 2706 may break apart into positively-charged lithium ions and negatively-charged hydroxide (OH⁻) atoms. In addition, the lithium ions may then be drawn across the lithium ion-selective solid electrolyte membrane 2704 into the cathode containing the lithiated galinstan liquid metal. Additionally, the alkali metal production may simultaneously combine the actions of reduction of galinstan at a carbon/metal rod/metal mesh 2708, resulting in the recombination of lithium ions and electrons to form a lithiated galinstan liquid metal, and oxidation of OH— at a carbon rod with Pt catalyst 2702, producing oxygen gas (O₂), water (H₂O), and electrons. Further, to prevent corrosion and degradation of the effectiveness of the lithium ion-selective solid electrolyte membrane 2704, a suitable buffer may be used to coat the lithium ion-selective solid electrolyte membrane 2704 in the case of contact with the aqueous electrolyte 2706. By way of example, the compound used to comprise the buffer in the aqueous electrolyte 2706 may include bicarbonate (HCO₃⁻) and/or carbonic acid (H₂CO₃).

In various embodiments, conventional lithium precursors may undergo a series of many complex steps to be converted and purified into lithium chloride (LiCl) and may be separated from any associated solution (i.e., dry), which can be expensive, as lithium chloride and other precursors are hygroscopic, making water difficult and expensive to remove. In addition, downs cell electrolysis is currently only possible via high-temperature electrolysis of a lithium chloride/potassium chloride (KCl) eutectic system, producing toxic chlorine gas as a byproduct. Yet, the downs cell electrolysis system remains the only current economically feasible method for producing lithium metal. In contrast, using lithium salt of any purity as a precursor for lithium metal electrolysis (metal production), as shown in the membrane-based alkali metal production 2700 allows for the entire lithium metal value chain to be much more simple and cheaper and may have fewer points of potential failure. Additionally, the lithium salt may be processed at lower temperatures that do not require distillation for removal, do not introduce potassium impurities, and/or do not affect treatment of undesired chlorine byproducts, thus making the cost of production much cheaper and remove many safety concerns.

It is to be appreciated that within the context of the present description, the term electrolysis refers to any system where an electric current is passed through a substance to effect a chemical change. Further metal electrolysis may include metal production such that, as a result of the electrolysis, compounds may be separated into their discrete parts (including a molten liquid form of metal). The term metal electrolysis and metal production may therefore be used interchangeably within the context of the present description.

In one embodiment, the metal electrolysis process may consist of different designs for an ion-selective solid electrolyte membrane separator and a process for the production of lithium metal from any aqueous precursor. For example, a first separator design may comprise two electrodes, including an anode in the form of a carbon rod with a platinum catalyst, and a cathode in the form of a carbon/metal rod and/or mesh. In addition, the first separator may comprise two active materials, including hydroxide (OH⁻) anions, as well as other materials such as hydrogen gas (H₂), chlorine ions (Cl—), bromine ions (Br—), and/or iodine ions (I—) on the anode side and a metal that remains in liquid state and features low volatility in the 25-250 Celsius temperature range, and may form a molten alloy with lithium. The range of solubility of lithium in the alloy may include at least a small region where the alloy remains molten and has a high reduction potential on the cathode side. In one embodiment, materials comprising the cathode may include gallium, gallium-indium, and gallium-indium alloys (galinstan). It is envisioned that other materials (for active materials, cathode, anode, etc.) may be selected.

The first separator may comprise a liquid electrolyte (anolyte) of, in one embodiment, water, cations including lithium ions (which also may also be used for sodium ions and potassium ions for the production of sodium and potassium, respectively), anions including hydroxide and carbonate (CO₃²⁻), a buffer of carbonic acid/bicarbonate, and/or an ion-selective solid electrolyte membrane. In an alternate embodiment, the liquid electrolyte (anolyte) may also contain alcohols, carbonates, ethers, hydrocarbons, esters, and ionic liquids. In a related embodiment, other potential anions may include bicarbonate, chloride, bromide, iodide, perchlorate, nitrate, sulfate, and/or phosphate. In another embodiment, the buffer may be comprised of lead sulfide (PBS), HEPES, and/or acetate.

In various embodiment, the second separator may comprise two electrodes including an anode in the form of a stainless steel slab and a cathode in the form of a carbon rod and/or mesh, two active materials including lithiated liquid metal on the anode side and molten lithium metal on the cathode side, and/or an ion-selective solid electrolyte membrane. The ion-selective solid electrolyte membrane may be composed of ion-selective solid electrolyte material including, but not limited to Li₁₀GeP₂S₁₂ (LGPS), Li₇La₃Zr₂O₁₂ (LLZO), lithium aluminum titanium phosphate (LATP), and/or lithium aluminum germanium phosphate (LAGP), a matrix (which may or may not include solid electrolyte material). The ion-selective solid electrolyte membrane may also include a lithium-stable layer of lithium fluoride and/or lithium oxide (Li2O) in contact with the molten lithium-facing (cathode) side, and/or additives (including but not limited to one or more of a variety of carbons including graphene, graphite, cyanate, diamond, and/or boron nitride). In one embodiment, the anode may also comprise metals such as aluminum, copper, titanium, nickel, and/or carbon.

In one embodiment, lithium metal production may include two steps. It is acknowledged that the lithium metal production process may be set up in series or parallel (for continuous processing). In any event, it is to be understood that the number of steps may fluctuate (increase or decrease) depending on the setup and implementation of the process. As such, in an exemplary configuration, the first step may include a process wherein lithium salt may be fed to the electrolyte, and current may be passed from an anode to a cathode. In one embodiment, the feeding in of the lithium salt to the electrolyte may occur continuously. This first step may result in: oxidation of the active material (such as hydroxide) and formation of electrons at the anode, a potential (electric and/or chemical) forming across the ion-selective membrane, migration of alkali metal ions across the membrane as a result of the potential, and/or reduction of the active material (such as galinstan) at the cathode. As such, this first step may result in the recombination of the lithium ions with electrons and the lithiation of galinstan. In the exemplary configuration, a second step may include a process where lithiated galinstan (from the first step) may be fed to the anode (of a separate cell), and a current may be passed from the anode to the cathode. This second step may result in: oxidation of the active material (such as lithiated galinstan) and the formation of electrons at the anode, a potential forming across the ion-selective membrane, migration of alkali metal ions across the membrane as a result of the potential, and/or reduction of the active material (such as molten lithium) at the cathode. As such, this second step may result in the recombination of lithium ions with electrons and the production of additional molten lithium. In one embodiment, the feeding of the lithiated galinstan to the anode may occur continuously.

In one embodiment, the first and second steps in the exemplary lithium metal production process may be performed concurrently, where the product of the first step (lithiated galinstan) may be continuously fed and/or circulated back to the anode for the second step. In a related embodiment, both steps may also be performed in a batch process, where the active material may be first fully transferred into a separation system before a current is applied. In another embodiment, the first step may be done in an inert environment (for example, an argon atmosphere). Additionally, the first step may also be performed in a dry room environment and/or in ambient conditions. In still another embodiment, the second step may also be performed in an inert argon atmosphere.

In one embodiment, each membrane may be substituted for a thicker membrane and/or multiple membranes in series to increase the purity of the final product (and/or to protect the integrity of the membrane from the harsh conditions of the lithiated galinstan).

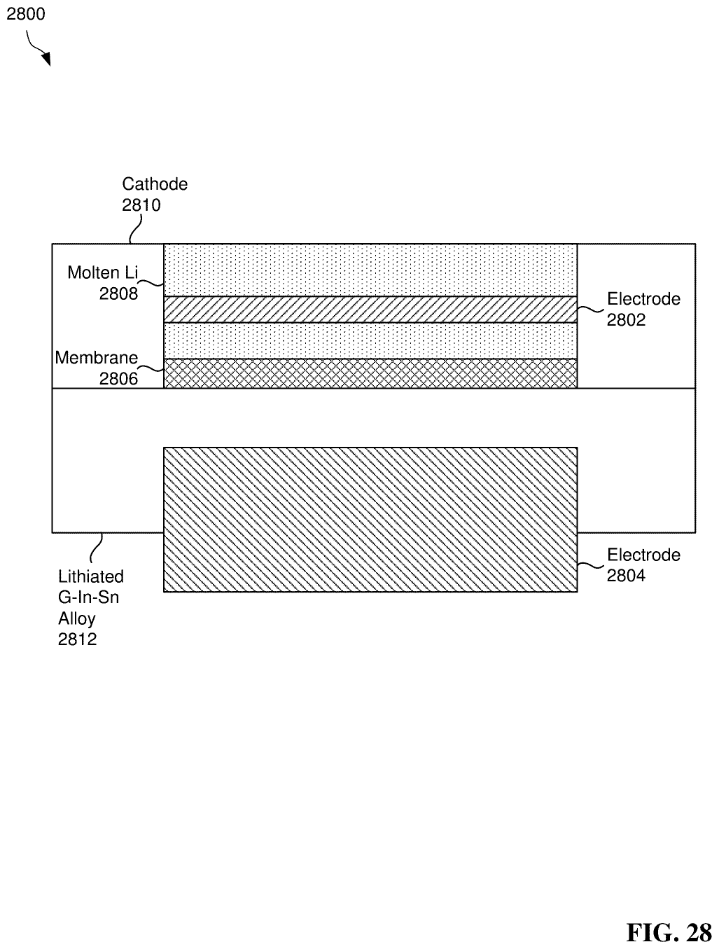

FIG. 28 illustrates another implementation of membrane-based alkali metal production 2800, in accordance with one embodiment. As an option, the other implementation of membrane-based alkali metal production 2800 may be implemented in the context of any one or more of the embodiments set forth in any previous and/or subsequent Figures and/or description thereof. Of course, however, the other implementation of membrane-based alkali metal production 2800 may be implemented in the context of any desired environment. Further, the aforementioned definitions may equally apply to the description below.

As shown, lithium ions (Li⁺) may pass from an anode comprised of lithiated galinstan (Ga—In—Sn) alloy 2812 through a lithium ion-selective solid electrolyte membrane 2806 to a cathode 2810 comprised of molten lithium 2808. In operation, lithiated galinstan alloy may be continuously fed into the anode (if an adequate amount of such lithiated galinstan alloy is not already present) where lithium ions may then be drawn across the lithium ion-selective solid electrolyte membrane 2806 into the cathode comprised of molten lithium 2808. Additionally, the alkali metal production process may simultaneously combine the actions of oxidation of galinstan-Li at a stainless steel slab electrode 2804, resulting in lithium ions and electrons, and reduction at the carbon rod/metal mesh 2802 where lithium ions are recombined with electrons to form the new lithium metal.

In one embodiment, the lithium ion-selective solid electrolyte membrane 2806 may comprise a layer of Li₁₀GeP₂Si₂ (LGPS) with a lithium-stable coating of, for example, lithium fluoride (LiF) and/or lithium oxide (Li₂O).

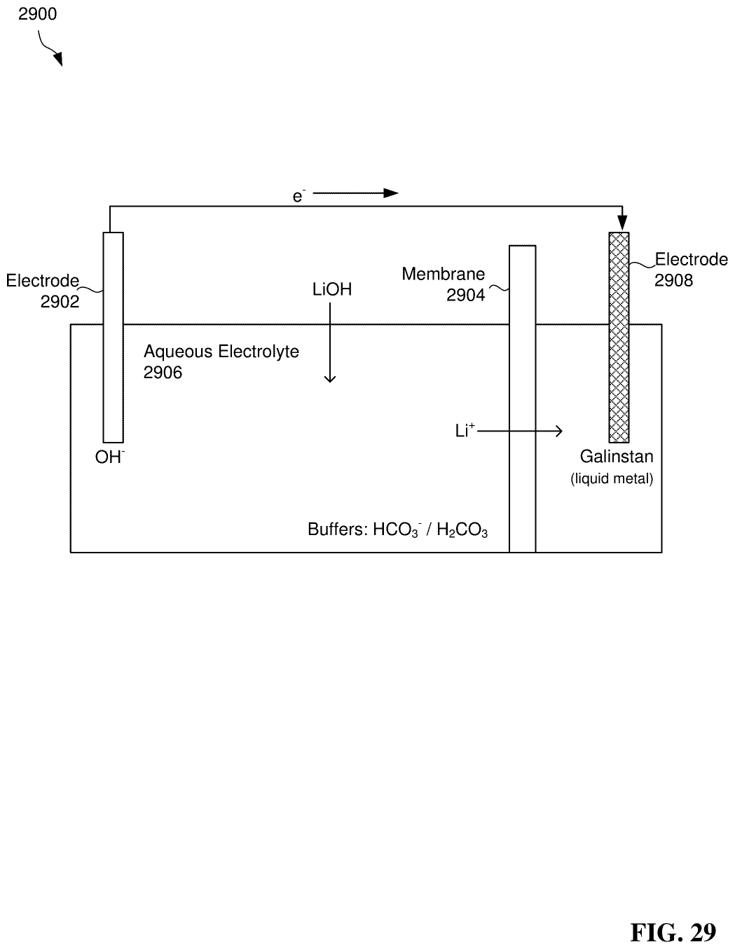

FIG. 29 illustrates membrane-based alkali metal production 2900, in accordance with one embodiment. As an option, the membrane-based alkali metal production 2900 may be implemented in the context of any one or more of the embodiments set forth in any previous and/or subsequent Figures and/or description thereof. Of course, however, the membrane-based alkali metal production 2900 may be implemented in the context of any desired environment. Further, the aforementioned definitions may equally apply to the description below.

As shown, lithium ions (Li⁺) may pass from an anode comprised of aqueous electrolyte 2906 through a lithium ion-selective solid electrolyte membrane 2904 to a cathode comprised of lithiated galinstan (Ga—In—Sn) liquid metal. In operation, lithium hydroxide atoms may be continuously fed into the aqueous electrolyte 2906 (if an adequate amount of lithium hydroxide is not already present) and may break apart into positively-charged lithium ions and negatively-charged hydroxide (OH⁻) atoms. In addition, the lithium ions may then be drawn across the lithium ion-selective solid electrolyte membrane 2904 into the cathode containing the lithiated galinstan liquid metal. Additionally, the alkali metal production may simultaneously combine the actions of reduction of galinstan at a carbon/metal rod/metal mesh 2908, resulting in the recombination of lithium ions and electrons to form a lithiated galinstan liquid metal, and oxidation of OH— at a carbon rod with Pt catalyst 2902, producing O₂, H₂O, and electrons. Further, to prevent corrosion and degradation of the effectiveness of the lithium ion-selective solid electrolyte membrane 2904, a suitable buffer may be used to coat the lithium ion-selective solid electrolyte membrane 2904 in the case of contact with the aqueous electrolyte 2906. By way of example, the compound used to comprise the buffer in the aqueous electrolyte 2906 may include bicarbonate (HCO₃—) and/or carbonic acid (H₂CO₃).

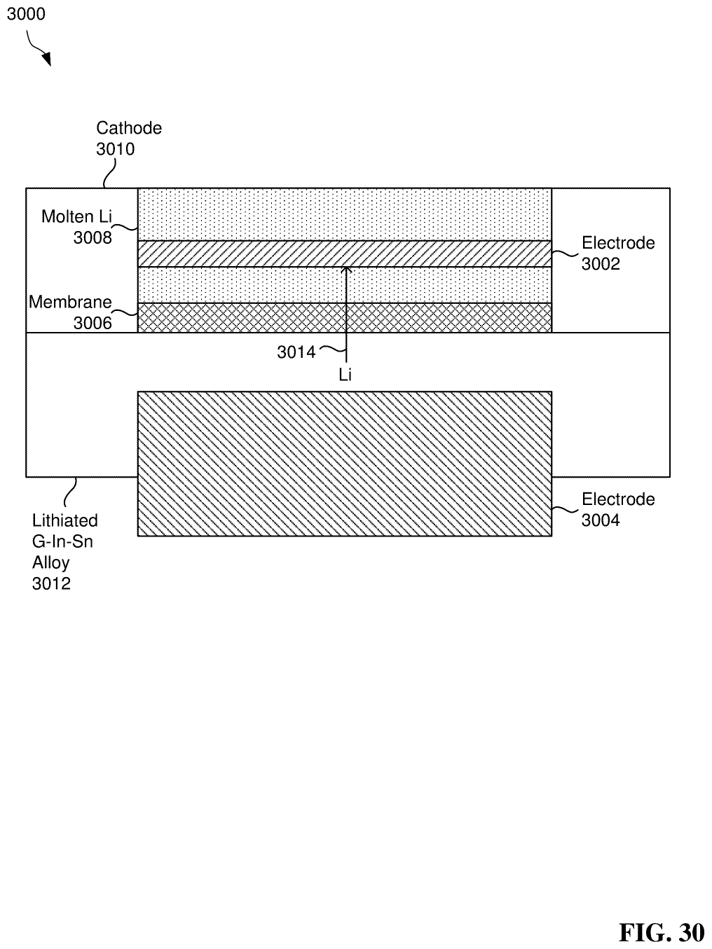

FIG. 30 illustrates another implementation of membrane-based alkali metal production 3000, in accordance with one embodiment. As an option, the other implementation of membrane-based alkali metal production 3000 may be implemented in the context of any one or more of the embodiments set forth in any previous and/or subsequent Figures and/or description thereof. Of course, however, the other implementation of membrane-based alkali metal production 3000 may be implemented in the context of any desired environment. Further, the aforementioned definitions may equally apply to the description below.

As shown, lithium ions (Li⁺) 3014 may pass from an anode comprised of lithiated galinstan (Ga—In—Sn) alloy 3012 through a lithium ion-selective solid electrolyte membrane 3006 to a cathode 3010 comprised of molten lithium 3008. In operation, lithiated galinstan alloy may be continuously fed into the anode (if an adequate amount of such lithiated galinstan alloy is not already present) where lithium ions 3014 may then be drawn across the lithium ion-selective solid electrolyte membrane 3006 into the cathode comprised of molten lithium 3008. Additionally, the alkali metal production process may simultaneously combine the actions of oxidation of galinstan-Li at a stainless steel slab electrode 3004, resulting in lithium ions 3014 and electrons, and reduction at the carbon rod/metal mesh 3002 where lithium ions 3014 are recombined with electrons to form the new lithium metal.

In one embodiment, the lithium ion-selective solid electrolyte membrane 3006 may comprise a layer of Li₁₀GeP₂Si₂ (LGPS) with a lithium-stable coating of, for example, lithium fluoride (LiF) and/or lithium oxide (Li₂O).

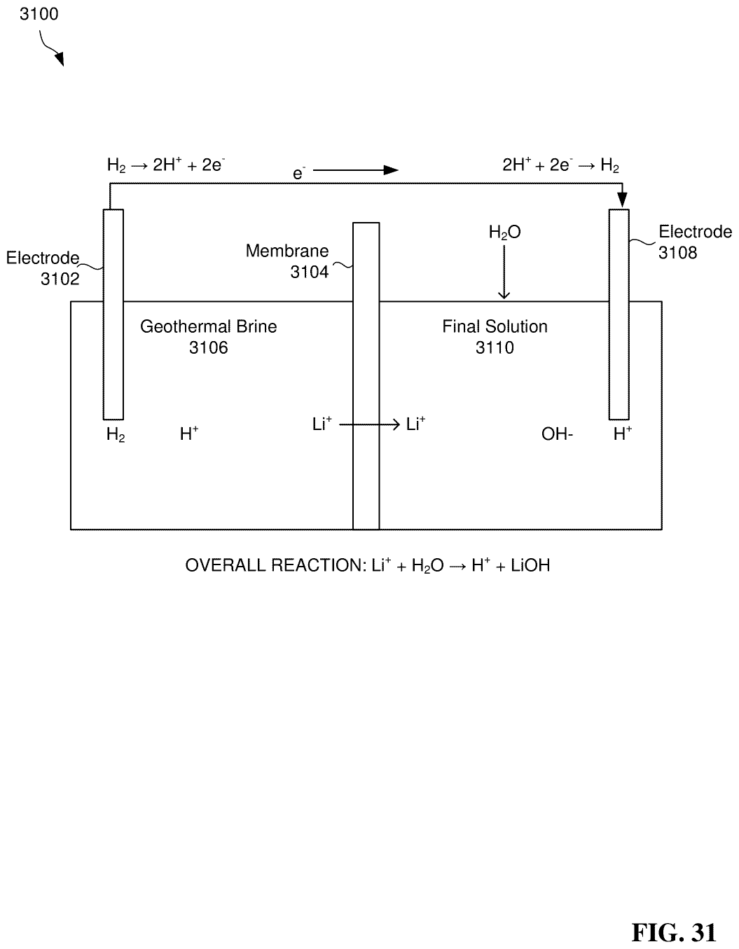

FIG. 31 illustrates a redox electrode system 3100 for alkali metal extraction, in accordance with one embodiment. As an option, the redox electrode system 3100 may be implemented in the context of any one or more of the embodiments set forth in any previous and/or subsequent Figures and/or description thereof. Of course, however, the redox electrode system 3100 may be implemented in the context of any desired environment. Further, the aforementioned definitions may equally apply to the description below.

As shown, lithium ions (Li⁺) may pass from an anode comprised of geothermal brine 3106 through a solid electrolyte membrane 3104 to a cathode comprised of an aqueous final solution 3110. In operation, lithium hydroxide (LiOH) atoms present in the geothermal brine 3106 may react with an H₂O reagent and break apart into positively-charged lithium ions and negatively-charged hydroxide (OH⁻) atoms. In addition, the lithium ions may then be drawn across the electrolyte membrane 3104 into the aqueous final solution 3110 where they may recombine with hydroxide atoms to reform into lithium hydroxide atoms, thus yielding a concentration of lithium hydroxide in the aqueous final solution 3110 upon completion of the alkali metal extraction process. Further, the alkali metal extraction process may simultaneously combine the actions of reduction of H⁺ at a cathode electrode 3108, forming H₂ (sent to an anode), and oxidation of H₂ at the anode electrode 3102, forming H⁺ waste.

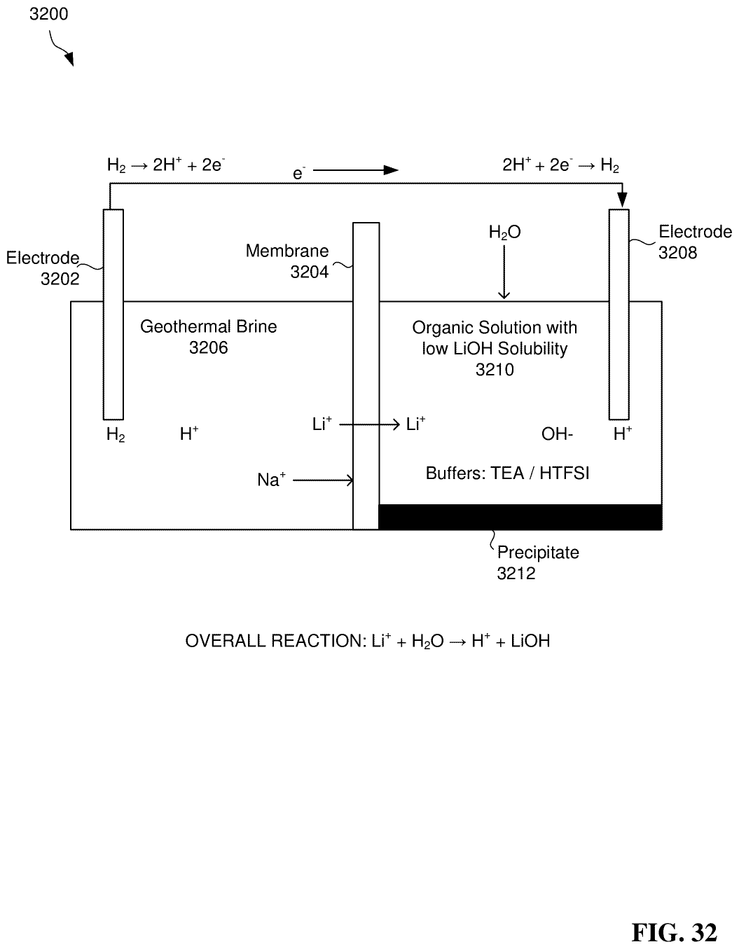

FIG. 32 illustrates a redox electrode system 3200 for alkali metal extraction and precipitation, in accordance with one embodiment. As an option, the redox electrode system 3200 may be implemented in the context of any one or more of the embodiments set forth in any previous and/or subsequent Figures and/or description thereof. Of course, however, the redox electrode system 3200 may be implemented in the context of any desired environment. Further, the aforementioned definitions may equally apply to the description below.

As shown, lithium ions (Li⁺) may pass from an anode comprised of geothermal brine 3206 through a solid electrolyte membrane 3204 to a cathode comprised of an organic solution with low LiOH solubility 3210. In operation, lithium hydroxide (LiOH) atoms present in the geothermal brine 3206 may react with an H₂O reagent and break apart into positively-charged lithium ions and negatively-charged hydroxide (OH⁻) atoms. In addition, the lithium ions may then be drawn across the electrolyte membrane 3204 into the organic solution with low LiOH solubility 3210 where they may recombine with hydroxide atoms to reform into lithium hydroxide atoms, thus yielding a concentration of lithium hydroxide in the organic solution with low LiOH solubility 3210 resulting in the formation of a concentrated precipitate salt 3212 upon completion of the alkali metal extraction process. Additionally, the alkali metal extraction process may simultaneously combine the actions of reduction of H⁺ at a cathode electrode 3208, forming H₂ (sent to an anode), and oxidation of H₂ at the anode electrode 3202, forming H⁺ waste. Further, to prevent corrosion and degradation of the effectiveness of the solid electrolyte membrane 3204, a suitable buffer may be used to coat the solid electrolyte membrane 3204 in the case of contact with the organic solution with low LiOH solubility 3210. By way of example, the compound used to comprise the buffer in the organic solution with low LiOH solubility 3210 may include Triethylamine (TEA) and/or bis(trifluoromethanesulfonyl)imide (HTFSI).

The redox electrode system 3200 shows, in particular, that many of the processes disclosed herein (such as extraction, purification, ion exchange, precipitation, etc.) may be combined together as desired to create an efficient process.

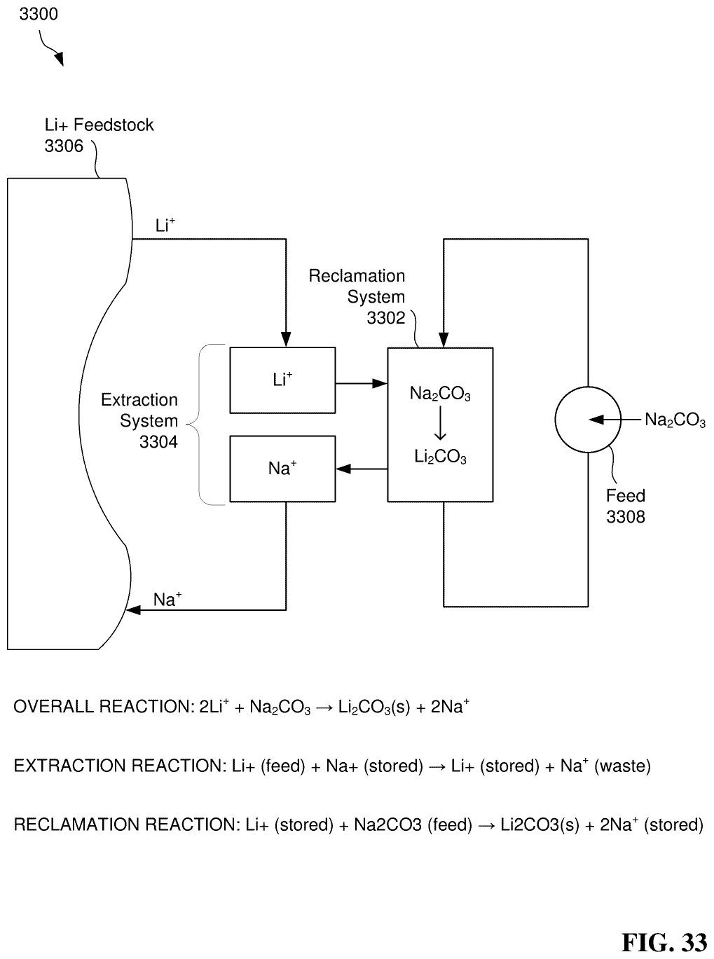

FIG. 33 illustrates a lithium extraction system 3300, in accordance with one embodiment. As an option, the lithium extraction system 3300 may be implemented in the context of any one or more of the embodiments set forth in any previous and/or subsequent Figures and/or description thereof. Of course, however, the lithium extraction system 3300 may be implemented in the context of any desired environment. Further, the aforementioned definitions may equally apply to the description below.

As shown, a lithium ion (Li+) feedstock 3306 may contain a collection of lithium ions to be fed into an extraction system 3304 and combined with a sodium carbonate (Na₂CO₃) reagent from another Feed 3308. In operation, the lithium ions fed into the extraction system 3304 chemically react with the sodium carbonate to form lithium carbonate (Li₂CO₃) atoms and a concentration of sodium ions (Na+), which may then ultimately be handled as waste byproduct.

In one embodiment, conversely, a reclamation reaction process may yield a concentration of lithium carbonate solid and a sodium ion concentration which may be stored for another future purpose.

The extraction reaction may include: Li+(feed)+Na+(stored)→Li+(stored)+Na+(waste). The reclamation reaction may include: 2Li+(stored)+Na₂CO₃ (feed)→Li₂CO₃(s)+2Na+(stored). Additionally, the overall reaction may include: 2Li⁺+Na₂CO₃→Li₂CO₃(s)+2Na+.

In this manner, the extraction system 3304 may be used to extract lithium from the Li+ feedstock 3306. The lithium ions may be replaced by sodium ions from the feed 3308.

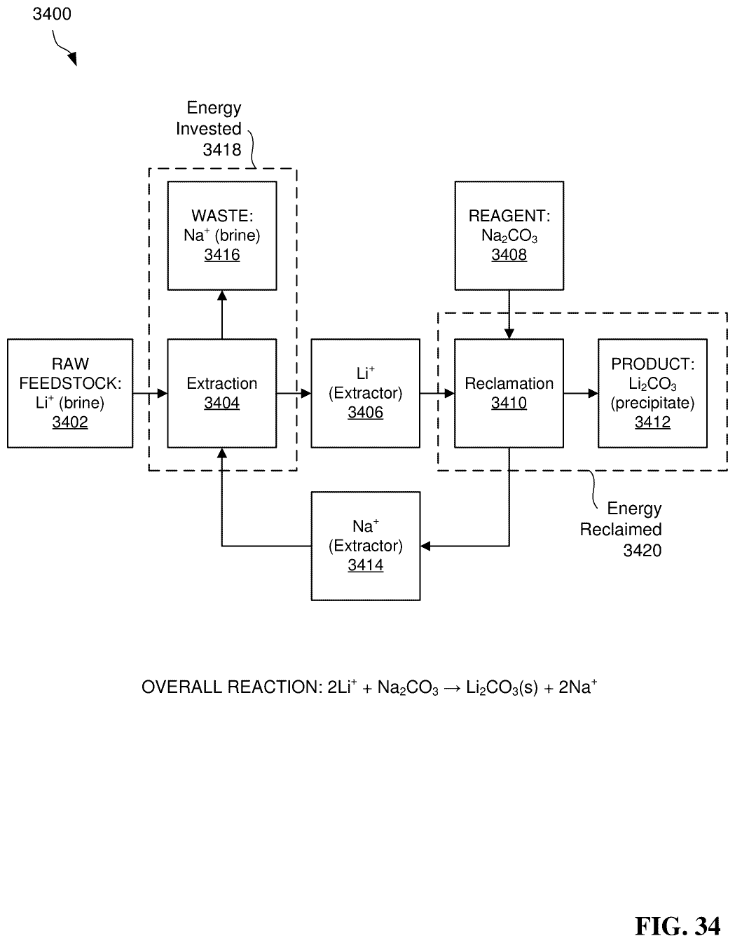

FIG. 34 illustrates an energy reclamation process 3400 for alkali metal extraction, in accordance with one embodiment. As an option, the energy reclamation process 3400 may be implemented in the context of any one or more of the embodiments set forth in any previous and/or subsequent Figures and/or description thereof. Of course, however, the energy reclamation process 3400 may be implemented in the context of any desired environment. Further, the aforementioned definitions may equally apply to the description below.

In operation, an alkali metal (in this case, lithium ion (Li+)) raw feedstock 3402, which may take the form of a brine, may feed lithium ions into an extraction subprocess 3404 and extractor 3406. In addition, the lithium ions may be passed from the extractor 3406 into a reclamation subprocess 3410 and combined with a sodium carbonate (Na₂CO₃) reagent 3408, wherein the lithium ions chemically react with the sodium carbonate reagent 3408 to produce a lithium carbonate (Li₂CO₃) precipitate salt 3412 and a concentration of sodium ions (Na+). The reclamation 3410 may also result in a solution which may be passed to an extractor 3414, passed back through the extraction subprocess 3404, and may ultimately be reclaimed in the form of a waste brine comprised of a mass of sodium ions 3416.

In one embodiment, the measure of energy output may be derived by combining the measure of energy invested 3418 with the measure of energy reclaimed 3420. In a related embodiment, the measure of energy invested may be quantified by measuring the waste brine comprised of the mass of sodium ions 3416 produced via the extraction subprocess 3404. In a counterpart embodiment, the measure of energy reclaimed may be quantified by measuring the lithium carbonate (Li₂CO₃) precipitate salt 3412 produced via the reclamation subprocess 3410.

In one exemplary embodiment, the energy reclamation process may include the following overall reaction: 2Li⁺+Na₂CO₃→Li₂CO₃(s)+2Na⁺.

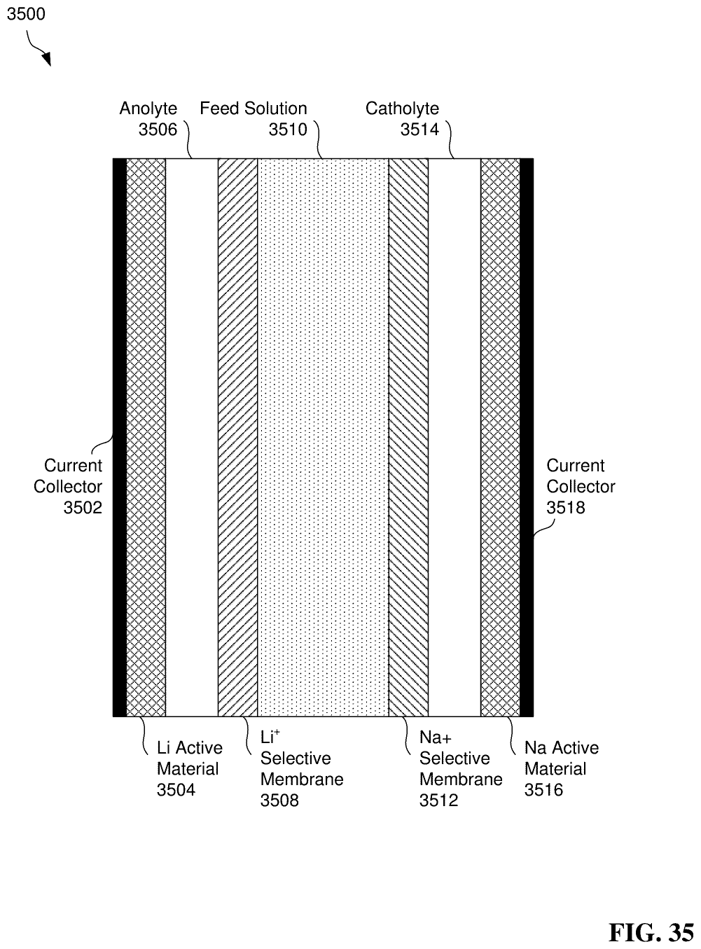

FIG. 35 illustrates a lithium extraction cell 3500, in accordance with one embodiment. As an option, the lithium extraction cell 3500 may be implemented in the context of any one or more of the embodiments set forth in any previous and/or subsequent Figures and/or description thereof. Of course, however, the lithium extraction cell 3500 may be implemented in the context of any desired environment. Further, the aforementioned definitions may equally apply to the description below.

As shown an anode-side current collector 3502 may form one outside contact surface of the lithium extraction cell 3500 and be in direct contact with a mass of lithium active material 3504. Additionally, an anolyte 3506 may be situated between the lithium active material 3504 and a lithium ion-selective solid electrolyte membrane 3508. Additionally, a feed solution 3510 may be positioned between the lithium ion-selective solid electrolyte membrane 3508 on the anode side of the lithium extraction cell 3500 and a sodium ion-selective solid electrolyte membrane 3512 on the cathode side of the lithium extraction cell 3500. Further, within the cathode portion of the lithium extraction cell 3500, a catholyte 3514 may be situated between the sodium ion-selective solid electrolyte membrane 3512 and sodium active material 3516. Further still the cathode side of the lithium extraction cell 3500 may be “capped” by another current collector 3518.

In one embodiment, the lithium active material 3504 may be comprised of lithium-titanate or lithium-titanium-oxide (LTO). In another embodiment, the anolyte 3506 may be formed of lithium ion electrolyte. In a likewise embodiment, the catholyte 3514 may be comprised of sodium ion electrolyte. In yet another embodiment, the sodium active material 3516 may be comprised of Prussian Blue (or iron cyanides).

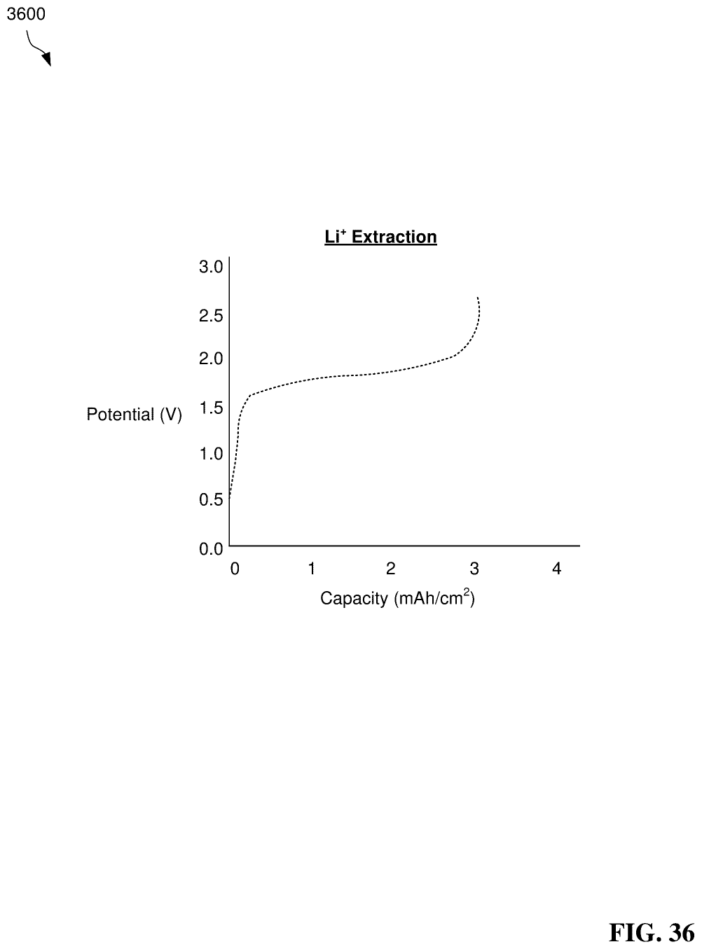

FIG. 36 illustrates a data plot of lithium extraction 3600, in accordance with one embodiment. As an option, the data plot of lithium extraction 3600 may be implemented in the context of any one or more of the embodiments set forth in any previous and/or subsequent Figures and/or description thereof. Of course, however, the data plot of lithium extraction 3600 may be implemented in the context of any desired environment. Further, the aforementioned definitions may equally apply to the description below.

As shown, a data plot of lithium extraction 3600 may show relative measures of electrode capacity, measured in mAh/cm², along an x-axis over the course of a lithium extraction reaction, juxtaposed with counterpart voltage potential measurement along a y-axis over the course of the same reaction time.

By way of just one example, in a scenario where 0.78 mg/cm² of lithium extract results from a reaction in which 6.15 mWh/cm² of electrochemical energy has been consumed, where 3 mAh/cm² of capacity is realized.

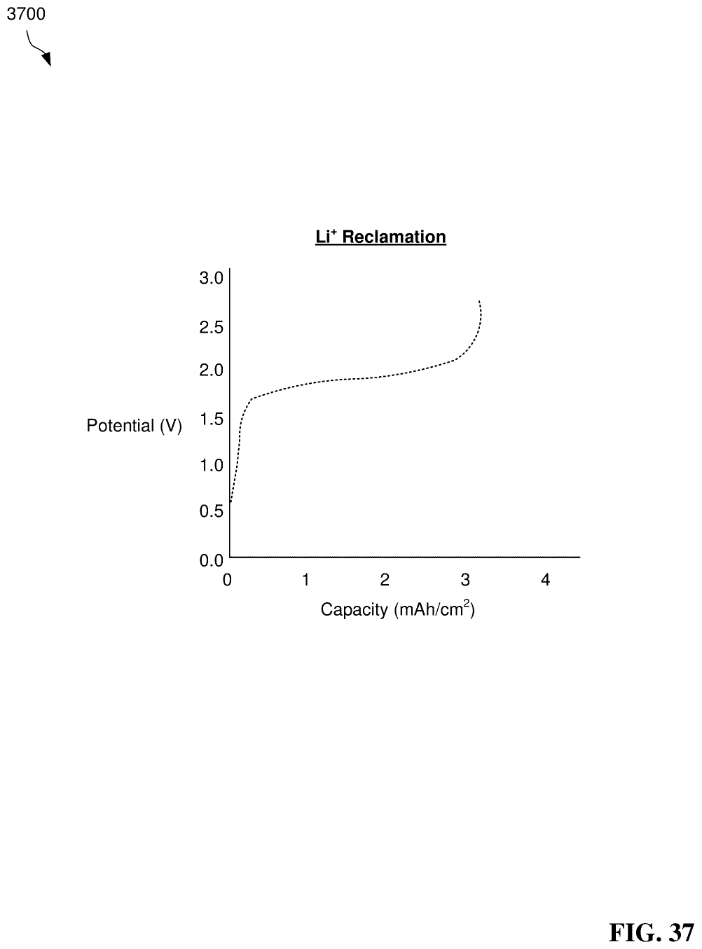

FIG. 37 illustrates a data plot of lithium reclamation 3700, in accordance with one embodiment. As an option, the data plot of lithium reclamation 3700 may be implemented in the context of any one or more of the embodiments set forth in any previous and/or subsequent Figures and/or description thereof. Of course, however, the data plot of lithium reclamation 3700 may be implemented in the context of any desired environment. Further, the aforementioned definitions may equally apply to the description below.

As shown, a data plot of lithium reclamation 3700 may show relative measures of electrode capacity, measured in mAh/cm², along an x-axis over the course of a lithium reclamation reaction, juxtaposed with counterpart voltage potential measurement along a y-axis over the course of the same reaction time.

By way of just one example, in a scenario where 0.78 mg/cm² of lithium extract results from a reaction in which 4.95 mWh/cm² of electrochemical energy has been consumed (or invested) and 1.2 mWh/cm² has been irreversibly lost, and 3 mAh/cm² of capacity is realized.

In various embodiments, FIG. 36 is intended to show recovered energy, and FIG. 37 is intended to show that which is consumed or invested.

Based on FIGS. 36 and 37, energy associated with effectively extracting lithium may be recoupled via a reclamation step. For example, for the step exemplified in FIG. 36, an investment of 6.15 mWh/cm2 of energy may be made, and in the step exemplified in FIG. 37, 4.95 mWh/cm2 may be reclaimed.

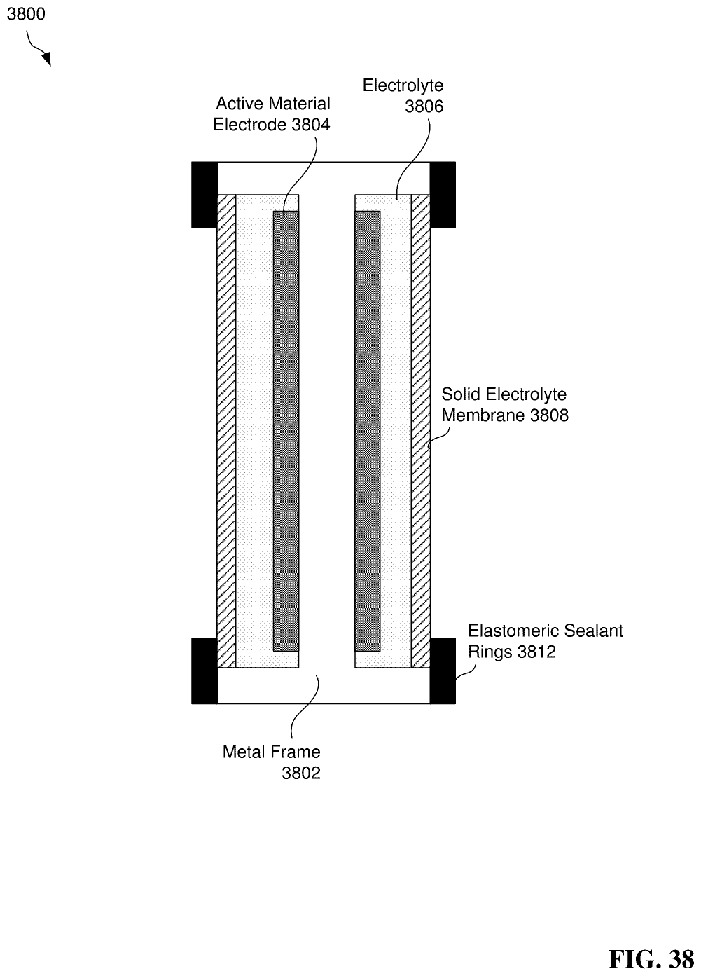

FIG. 38 illustrates an exemplary electrode module 3800, in accordance with one embodiment. As an option, the exemplary electrode module 3800 may be implemented in the context of any one or more of the embodiments set forth in any previous and/or subsequent Figures and/or description thereof. Of course, however, the exemplary electrode module 3800 may be implemented in the context of any desired environment. Further, the aforementioned definitions may equally apply to the description below.

As shown, the electrode module 3800 may comprise a solid electrolyte membrane 3808, an interstitial liquid electrolyte 3806, and an active material electrode 3804, all encased by and in direct contact with a metal frame 3802. Additionally, the electrode module 3800 may include elastometric sealant rings 3812 to bind the electrode module 3800 casing. It is to be appreciated that, in order to function as a redox system, both an anode and a cathode would be needed. For simplicity, the redox electrode module is presented in a singular form (a single module electrode) to describe the elements of the module that are consistent for either and/or both of the anode module and the cathode module.

In one embodiment, the solid electrolyte membrane 3808 may interface with a feed solution. Additionally, the electrolyte 3806 may function as an anolyte on the anode side of the electrode module 3800 and as a catholyte on the cathode side of the electrode module 3800. In addition, the interstitial liquid electrolyte 3806 may comprise one or more electroactive solutes. In one embodiment, each electroactive solute may be characterized by its ability to adopt multiple oxidation states whose relative concentrations within the electrolyte may be manipulated through the addition or removal of charge (electrons) from the interstitial liquid electrolyte 3806. Further, the interstitial liquid electrolyte 3806 may include one or more dissolved alkali metal cations. Further, the interstitial liquid electrolyte 3806 may include one or more dissolved anions to balance the charge of cations in the solution. The current collector may be in direct contact with the interstitial liquid electrolyte 3806.

In a related embodiment, the metal frame 3802 may be comprised of stainless steel, aluminum, and/or a hybrid of both metals.

In operation, the electrode module 3800 may be used to separate lithium from a feed solution (via the solid electrolyte membrane 3808). Additional details relating to the separation of lithium via the solid electrolyte membrane 3808 may be found in relation to the disclosure of FIG. 1-FIG. 6 hereinabove. In practice, the solid electrolyte membrane may interface directly with the interstitial liquid electrolyte 3806, on one side, and a feed solution on the other side. The feed solution may comprise ions which may be effectively separately from the feed solution via the solid electrolyte membrane 3808. The solid electrolyte membrane 3808 may be tuned to selectively separate desired ions from the feed solution. In other words, the solid electrolyte membrane 3808 may be configured to allow selective passage of a specific alkali metal cation.

Further, the electrode module 3800 may be used to reclaim energy used during the separation process. For example, as lithium is extracted, it may be stored in the form of electrochemical energy which may be subsequently released.

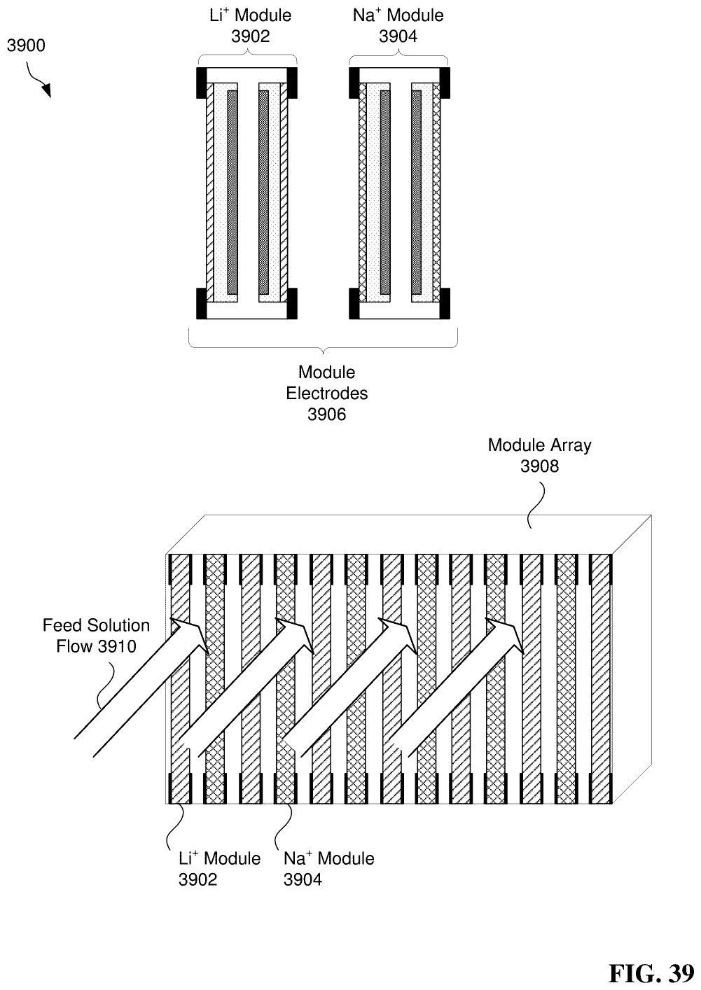

FIG. 39 illustrates an electrode module array 3900, in accordance with one embodiment. As an option, the electrode module array 3900 may be implemented in the context of any one or more of the embodiments set forth in any previous and/or subsequent Figures and/or description thereof. Of course, however, the electrode module array 3900 may be implemented in the context of any desired environment. Further, the aforementioned definitions may equally apply to the description below.

As shown, the module electrodes 3906 may include a lithium ion (Li+) module 3902 functioning as an anode and a sodium ion (Na+) module 3904 functioning as a cathode. It is to be appreciated that, in order to function as a redox system, both an anode and a cathode would be needed.

As shown, a module array 3908 may comprise two or more sets of module electrodes 3906 organized into a collection and designed to provide maximum battery storage capacity. In operation, a feed solution 3910 may flow through the module array 3908 with the intention that the feed solution 3910 completely envelop all lithium ion (Li+) module 3902 and sodium ion (Na+) module 3904 pairs.

In one embodiment, the feed solution flow 3910 may comprise ions which may be effectively separated from the feed solution via the solid electrolyte membrane. To facilitate separation of ions from the feed solution flow 3910, a solid electrolyte membrane 3808 may be tuned to selectively separate desired ions (lithium ions and/or sodium ions, for example) from the feed solution. In other words, the solid electrolyte membrane 3808 may be configured to allow selective passage of a specific alkali metal ions. For example, the lithium ion module 3902 may be configured to allow passage of lithium ions, and the sodium module 3904 may be configured to allow passage of sodium ions.

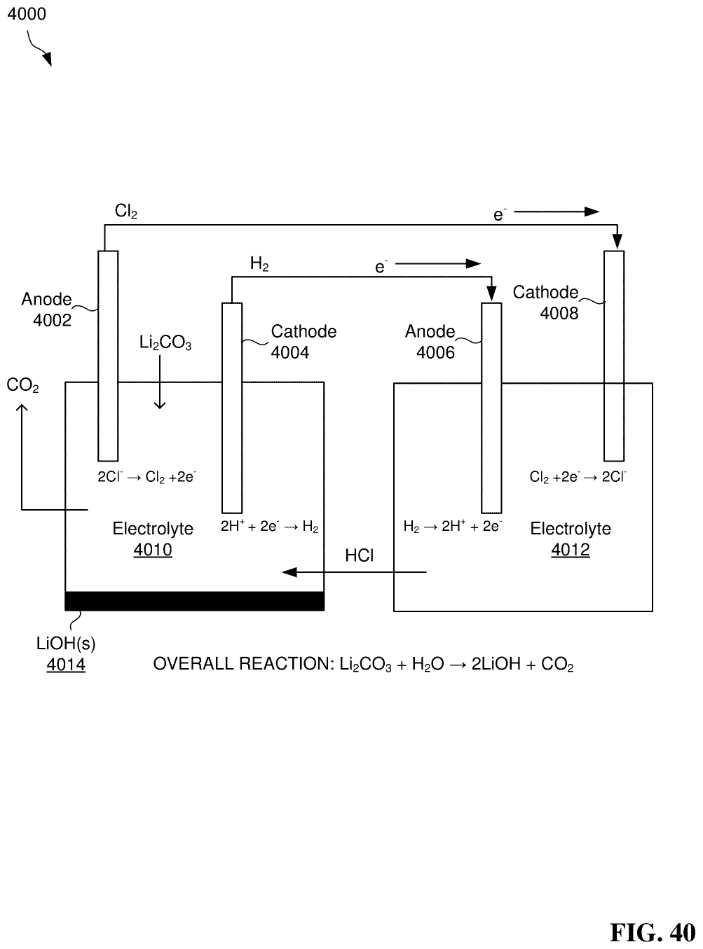

FIG. 40 illustrates an exemplary system 4000 for conversion to lithium hydroxide, in accordance with one embodiment. As an option, the exemplary system 4000 may be implemented in the context of any one or more of the embodiments set forth in any previous and/or subsequent Figures and/or description thereof. Of course, however, the exemplary system 4000 may be implemented in the context of any desired environment. Further, the aforementioned definitions may equally apply to the description below.

As shown, a first anode 4002 and a first cathode 4004 are in direct contact with a first electrolyte 4010 to comprise a first battery cell. In addition, a second anode 4006 and a second cathode 4008 are in direct contact with a second electrolyte 4012 to comprise a second battery cell. In operation, the conversion process first goes through a neutralization reaction phase where lithium carbonate (Li₂CO₃) is fed into the first electrolyte 4010 of the first battery cell where the lithium carbonate reacts with hydrogen chloride (HCl). In addition, the conversion process goes through an electrolysis reaction phase from which lithium hydroxide (LiOH), hydrogen (H₂) and chlorine (Cl₂) gases are produced. Additionally, the resulting hydrogen gas may be transferred from the first cell to the second cell via the second anode 4006 by way of the first cathode 4004. Likewise, the resulting chlorine gas may be transferred to the second cell via the second cathode 4008 by way of the first anode 4002. Further, the conversion process includes a hydrogen chloride reclamation reaction phase in which the resultant hydrogen and chlorine gases combine amidst the second electrolyte 4012 to form hydrogen chloride atoms that are ultimately fed back into the first cell to continue to react with lithium carbonate. Further still, a net result of the conversion process yields a mass of solid lithium hydroxide precipitate 4014 as well as a volume of both water (H₂O), which may be filtered out of the first electrolyte 4010, and carbon dioxide (CO₂) gas, which may be vented as byproduct waste.

In one embodiment, the exemplary system 4000 may include the overall reaction: Li₂CO₃+H₂O→2LiOH+CO₂.

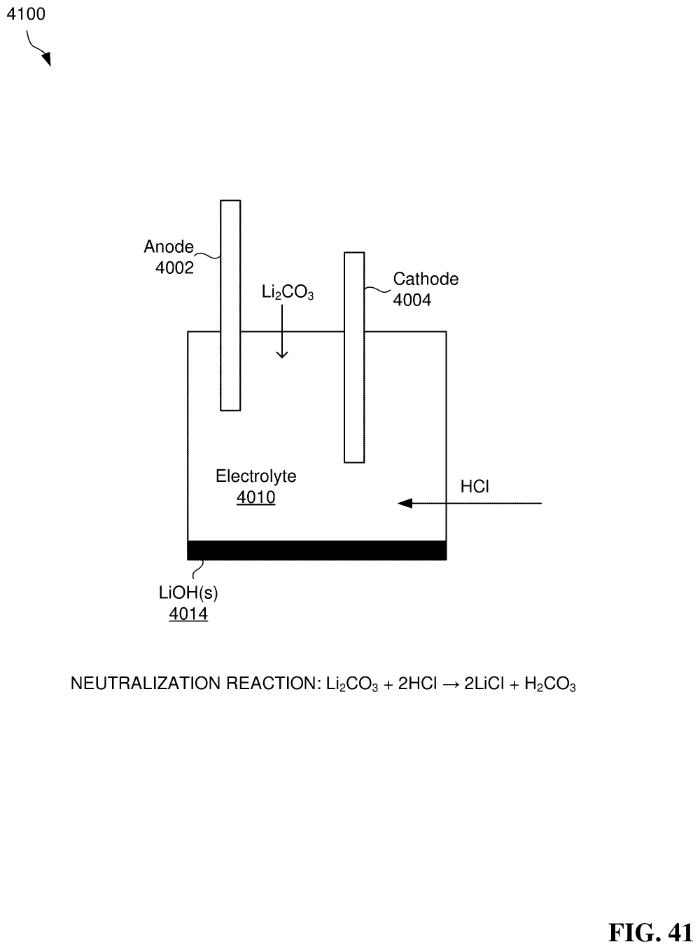

FIG. 41 illustrates a subset 4100 of the exemplary system 4000 for conversion to lithium hydroxide, in accordance with one embodiment. As an option, the subset 4100 may be implemented in the context of any one or more of the embodiments set forth in any previous and/or subsequent Figures and/or description thereof. Of course, however, the subset 4100 may be implemented in the context of any desired environment. Further, the aforementioned definitions may equally apply to the description below.

In operation, the neutralization reaction may include lithium carbonate (Li₂CO₃) being fed into the first electrolyte 4010 of the first battery cell where the lithium carbonate reacts with hydrogen chloride (HCl), ultimately producing a mass of solid lithium hydroxide (LiOH) precipitate 4014 (as a result, in one embodiment, of the Cl— anions being removed at the anode, etc.).

In one embodiment, the neutralization reaction may include: Li₂CO₃+2HCl→2LiCl+H₂CO₃.

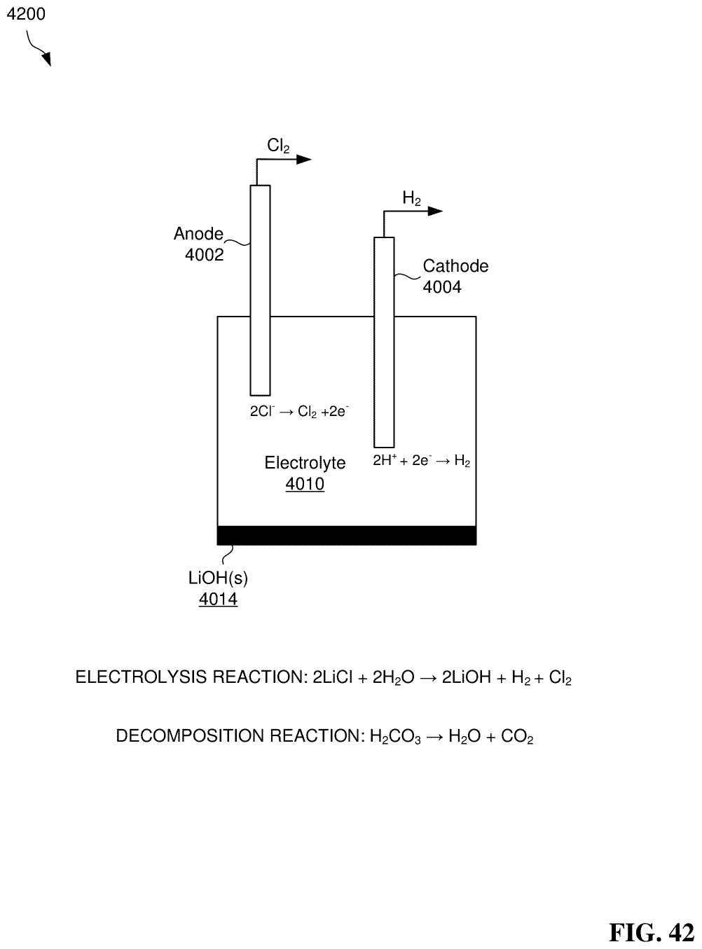

FIG. 42 illustrates a subset 4200 of the exemplary system 4000 for conversion to lithium hydroxide, in accordance with one embodiment. As an option, the subset 4200 may be implemented in the context of any one or more of the embodiments set forth in any previous and/or subsequent Figures and/or description thereof. Of course, however, the subset 4200 may be implemented in the context of any desired environment. Further, the aforementioned definitions may equally apply to the description below.

In operation, the electrolysis reaction from which solid lithium hydroxide precipitate 4014 and hydrogen (H₂) and chlorine (Cl₂) gases are produced may include the resulting hydrogen gas being transferred from the first electrolyte 4010 to the second cell via the first cathode 4004. Likewise, the resulting chlorine gas may be transferred to the second cell via the first anode 4002.

In one embodiment, the electrolysis reaction may include 2LiCl+2H₂O→2LiOH+H₂+Cl₂.

It should be noted that cell corresponding with the subset 4200 may include a decomposition reaction wherein a volume of both water (H₂O), which may be filtered out of the first electrolyte 4010, and carbon dioxide (CO₂) gas, which may be vented as byproduct waste, may be produced.

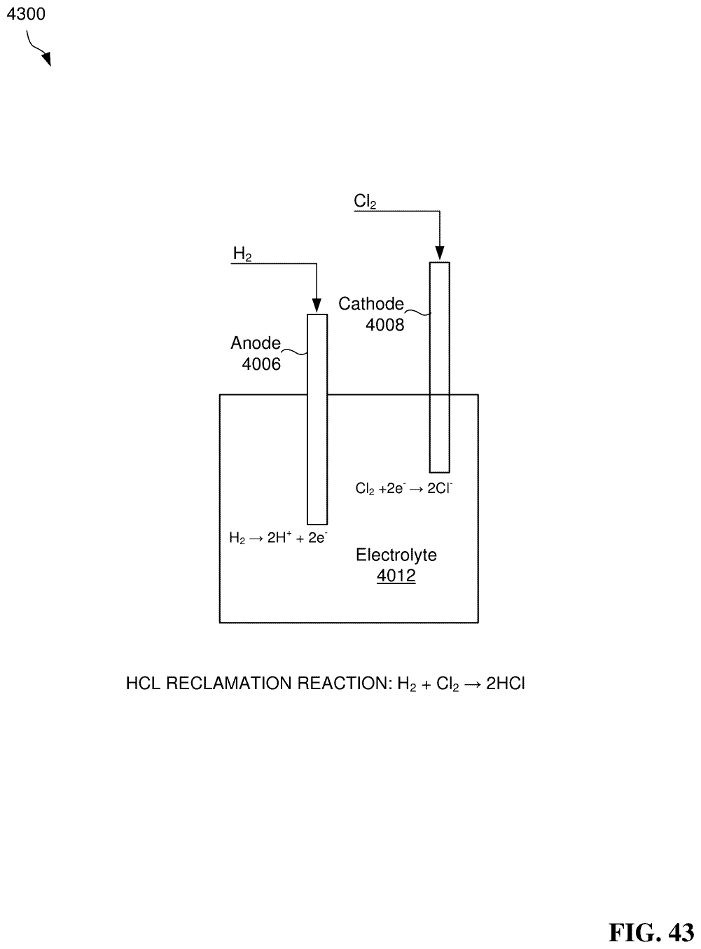

FIG. 43 illustrates a subset 4300 of the exemplary system 4000 for conversion to lithium hydroxide, in accordance with one embodiment. As an option, the subset 4300 may be implemented in the context of any one or more of the embodiments set forth in any previous and/or subsequent Figures and/or description thereof. Of course, however, the subset 4300 may be implemented in the context of any desired environment. Further, the aforementioned definitions may equally apply to the description below.

In operation, the hydrogen chloride reclamation reaction may include hydrogen and chlorine gases entering the second cell via anode 4006 and cathode 4008, respectively, and combining with one another in the second electrolyte 4012 to form hydrogen chloride atoms that are ultimately fed back into the first cell to continue to react with lithium carbonate.

In one embodiment, the HCl reclamation reaction may include H₂+Cl₂→2HCl. Additionally, the decomposition reaction may include H₂CO₃→H₂O+CO₂.

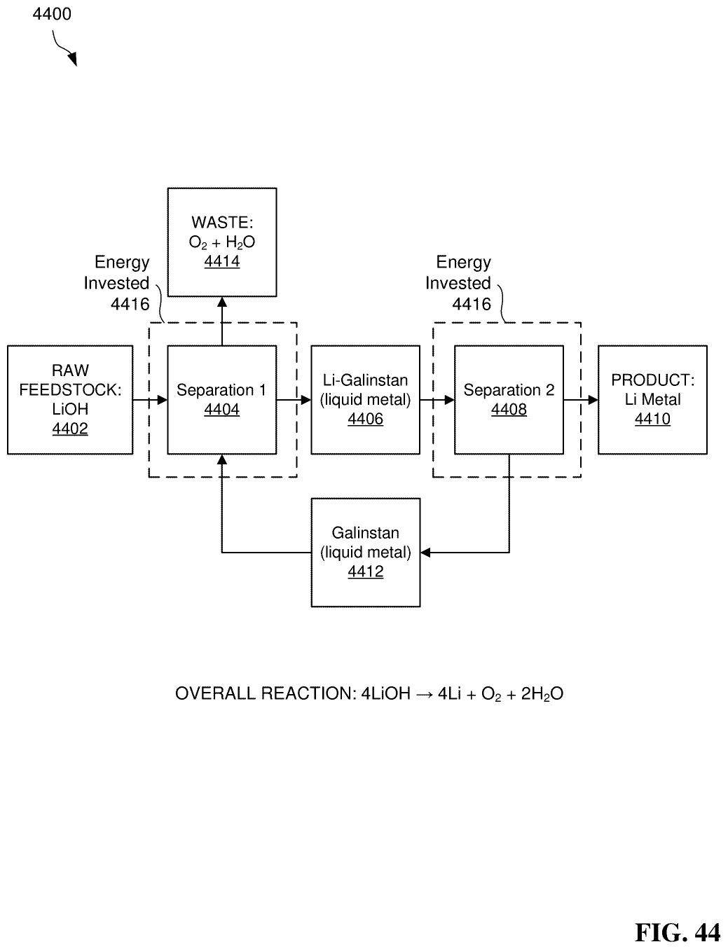

FIG. 44 illustrates an exemplary process 4400 for lithium metal production, in accordance with one embodiment. As an option, the exemplary process 4400 may be implemented in the context of any one or more of the embodiments set forth in any previous and/or subsequent Figures and/or description thereof. Of course, however, the exemplary process 4400 may be implemented in the context of any desired environment. Further, the aforementioned definitions may equally apply to the description below.

In operation, a raw feedstock 4402 of lithium hydroxide (LiOH) may feed lithium hydroxide into a separation subprocess 4404 to yield a concentration of lithiated galinstan liquid metal 4406. In addition, the lithiated galinstan liquid metal 4406 may be passed from separation subprocess 4404 into a second separation subprocess 4408, ultimately resulting in a lithium metal salt product 4410 and a concentration of galinstan liquid metal 4412, which may be passed back through the separation subprocess 4404, yielding a measure of O₂ and/or H₂O waste 4414.

In one embodiment, the measure of energy invested 4416 into the process 4400 for lithium metal production may be quantified by measuring the energy levels required to perform separation subprocess 4404 and second separation subprocess 4408.

In one embodiment, the exemplary process 4400 may include: 4LiOH→4Li+O₂+2H₂O.

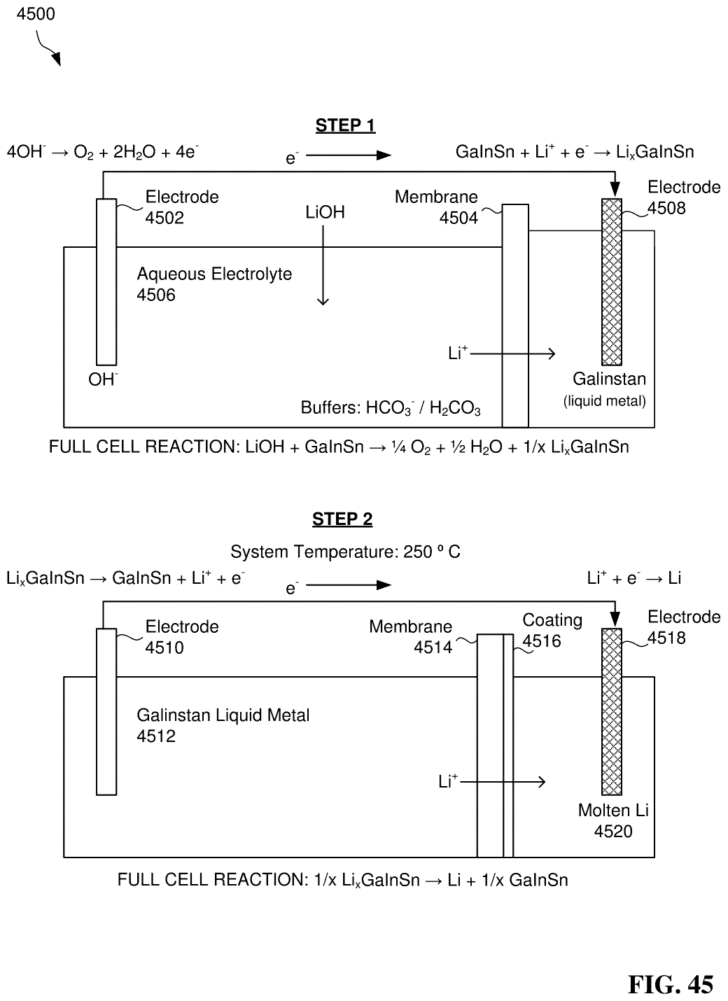

FIG. 45 illustrates an exemplary process 4500 for lithium metal production, in accordance with one embodiment. As an option, the exemplary process 4500 may be implemented in the context of any one or more of the embodiments set forth in any previous and/or subsequent Figures and/or description thereof. Of course, however, the exemplary process 4500 may be implemented in the context of any desired environment. Further, the aforementioned definitions may equally apply to the description below.

As shown in step 1, lithium ions (Li⁺) may pass from an anode comprised of aqueous electrolyte 4506 through a lithium ion-selective solid electrolyte membrane 4504 to a cathode comprised of lithiated galinstan (Ga—In—Sn) liquid metal. In operation, lithium hydroxide atoms may be continuously fed into (if not already present in an adequate volume in) the aqueous electrolyte 4506 and may break apart into positively-charged lithium ions and negatively-charged hydroxide (OH⁻) atoms. In addition, the lithium ions may then be drawn across the lithium ion-selective solid electrolyte membrane 4504 into the cathode containing the lithiated galinstan liquid metal. Additionally, the lithium metal production may simultaneously combine the actions of reduction of galinstan at a cathode-side electrode 4508, resulting in the recombination of lithium ions and electrons to form a lithiated galinstan liquid metal, and oxidation of OH— at an anode-side electrode 4502, producing oxygen gas (O₂), water (H₂O), and electrons. Further, to prevent corrosion and degradation of the effectiveness of the lithium ion-selective solid electrolyte membrane 4504, a suitable buffer may be used to coat the lithium ion-selective solid electrolyte membrane 4504 in the case of contact with the aqueous electrolyte 4506. By way of example, the compound used to comprise the buffer in the aqueous electrolyte 4506 may include bicarbonate (HCO₃⁻) and/or carbonic acid (H₂CO₃).

In one embodiment, the full cell reaction for step 1 may include: LiOH+GaInSn→¼O₂+½H₂O+1/xLiₓGaInSn.

In one embodiment, the resulting alkali metal may be in solid and/or liquid metal form upon completion of the alkali metal production process.

As shown in step 2, at a system temperature of 250 degrees Celsius, lithium ions (Li⁺) may pass from an anode comprised of lithiated galinstan (Ga—In—Sn) alloy 4512 through a lithium ion-selective solid electrolyte membrane 4514 with a lithium-stable coating 4516 to a cathode comprised of molten lithium 4520. In operation, lithiated galinstan alloy may be continuously fed into the anode (if an adequate amount of such lithiated galinstan alloy is not already present) where lithium ions may then be drawn across the lithium ion-selective solid electrolyte membrane 4514 into the cathode comprised of molten lithium 4520. Additionally, the lithium metal production process may simultaneously combine the actions of oxidation of galinstan-Li at an anode-side electrode 4510, resulting in lithium ions and electrons, and reduction at a cathode-side electrode 4518 where lithium ions are recombined with electrons to form the new lithium metal.

In one embodiment, the lithium ion-selective solid electrolyte membrane 4514 may comprise a layer of Li₁₀GeP₂Si₂ (LGPS) with a lithium-stable coating 4516 of, for example, lithium fluoride (LiF) and/or lithium oxide (Li₂O).

In one embodiment, the full cell reaction for step 2 may include: 1/xLiₓGaInSn→Li+1/xGaInSn.

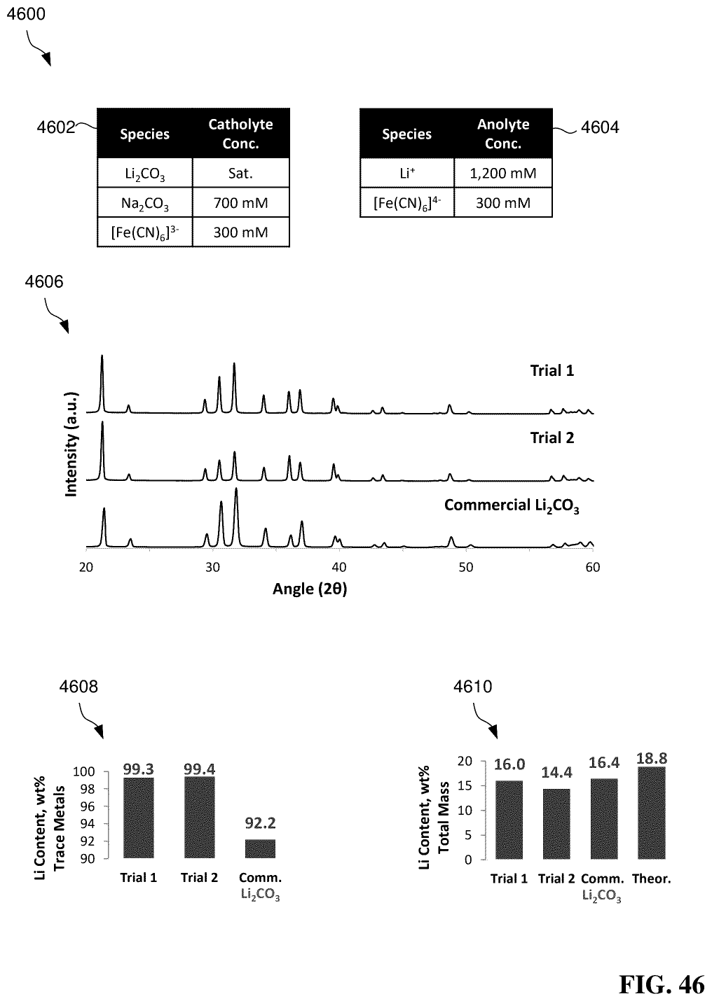

FIG. 46 illustrates results 4600 using redox electrode modules, in accordance with one embodiment. As an option, the results 4600 may be implemented in the context of any one or more of the embodiments set forth in any previous and/or subsequent Figures and/or description thereof. Of course, however, the results 4600 may be implemented in the context of any desired environment. Further, the aforementioned definitions may equally apply to the description below.

As shown, the results 4600 include preliminary data. For example, catholyte 4602 and anolyte 4604 show composition of electrolytes used for LCE precipitation test (specifically for Li2CO3). Additionally, graph 4606 shows XRD spectra of product confirming identity of precipitate as Li2CO3 in two separate trials. A graph 4608 shows a purity of Li2CO3 (wt % trace metals basis) analyzed via ICP-OES in two separate trials. Further, graph 4610 shows Li content (wt % total mass) in precipitation based on ICP-OES results compared to theoretical value of 18.8 wt % Li in pure Li2CO3. Commercial Li2CO3 from Sigma-Aldrich was used as a reference where indicated.

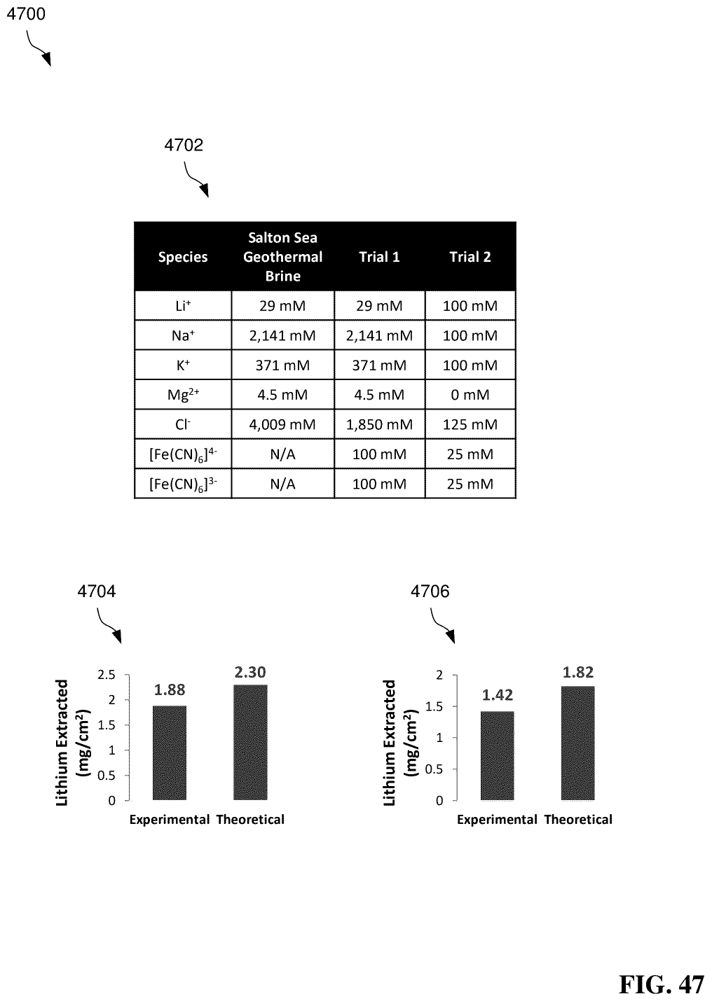

FIG. 47 illustrates results 4700 using redox electrode modules, in accordance with one embodiment. As an option, the results 4700 may be implemented in the context of any one or more of the embodiments set forth in any previous and/or subsequent Figures and/or description thereof. Of course, however, the results 4700 may be implemented in the context of any desired environment. Further, the aforementioned definitions may equally apply to the description below.

As shown, the results 4700 include preliminary data. For example, composition 4702 shows compositions of electrolytes used in two selectivity test trials compared to Salton Sea geothermal brine. A graph 4704 shows lithium extracted using Trial 1 electrolyte. Further, a graph 4706 shows lithium extracted using Trial 2 electrolyte. In one embodiment, theoretical values calculated assumed 100% of charge transferred is Li. Additionally, for each trial, the starting catholyte/anolyte were identical.

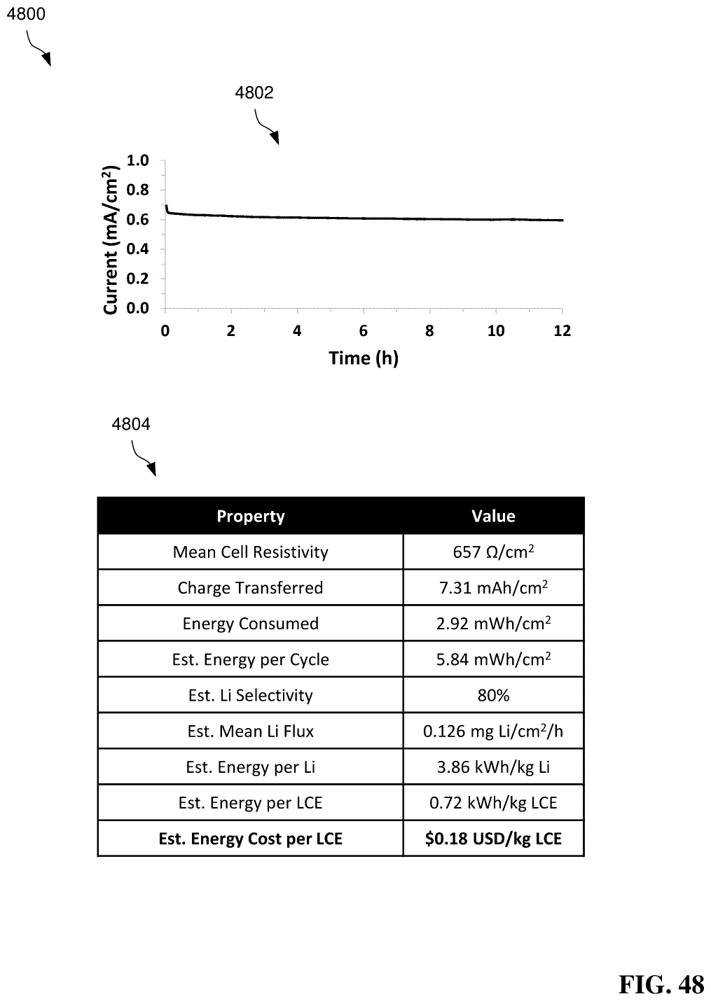

FIG. 48 illustrates results 4800 using redox electrode modules, in accordance with one embodiment. As an option, the results 4800 may be implemented in the context of any one or more of the embodiments set forth in any previous and/or subsequent Figures and/or description thereof. Of course, however, the results 4800 may be implemented in the context of any desired environment. Further, the aforementioned definitions may equally apply to the description below.

As shown, the results 4800 include preliminary data. For example, the graph 4802 shows a sample current vs time profiles of ion flow from anolyte to catholyte under constant potential of 0.4 V for 12 h. Additionally, the metrics 4804 show performance metrics calculated from data) associated with the graph 4802). In one embodiment, the estimated energy per cycle assumed a constant power for total of 24 h (12 h extraction, 12 h reclamation). Additionally, the energy cost per LCE produced was estimated using $0.25/kWh.

The lithium extraction system described herein provides a novel method for selectively extracting lithium ions from a feed solution, such as geothermal brine. The system utilizes ion-selective membranes and electrochemical processes to separate and concentrate lithium ions from other ions present in the feed solution.

### Overview of the Needle System

The present disclosure may relate to an innovative membrane and system for extracting lithium and other alkali metals from various feed solutions. This approach may address the growing global demand for lithium, particularly in the context of electric vehicle batteries and other energy storage applications, by providing a highly efficient and scalable method for lithium extraction and purification.

In some cases, the membrane at the core of this invention may comprise a solid electrolyte layer that may be specifically conductive to ions of a predetermined alkali metal, such as lithium. This solid electrolyte layer may be combined with a sorbent layer configured to adsorb the predetermined alkali metal, potentially enhancing the overall efficiency of the extraction process. The membrane's design may allow for use in a flow cell system, enabling continuous extraction of the predetermined alkali metal from a feed solution.

The lithium extraction system utilizing this membrane may incorporate two distinct electrolytes: one configured to store lithium ions and another to store sodium ions. These electrolytes may work in conjunction with two solid membrane layers. The first solid membrane layer may be designed to be lithium ion selective and may be positioned to transport lithium ions from the feed solution to the first electrolyte. The second solid membrane layer may be sodium ion selective and may be positioned to transport sodium ions from the second electrolyte to the feed solution. This dual-membrane configuration may allow for efficient separation and concentration of lithium ions while managing sodium ion levels.

In various embodiments, the second electrolyte may be configured to store any type of ion (such as but not limited to sodium, potassium, etc.). Additionally, the second electrolyte may be configured to store multiple non-lithium ions (e.g. potassium and sodium, etc.). Further, notwithstanding the selectivity of the membrane to a particular ion, it is acknowledged that other ions may be present (e.g. Na, K, Li, etc.), particularly ions with similar properties (such as charge or ionic radius) to the ion for which the ion-selective membrane is configured.

In some cases, one of the key advantages of this system may be modularity. Each unit operation may be contained within a standard shipping container, potentially allowing for easy transportation and scalability. The system may be designed with ambitious targets, aiming to process substantial volumes of lithium-containing produced water annually and produce significant quantities of lithium carbonate equivalent per year.

The efficiency of the system may be remarkable, with the capability to extract a high percentage of lithium from feed solutions containing relatively low concentrations of lithium. The projected electrochemical energy cost may be exceptionally low, potentially representing only a small fraction of the market value of lithium carbonate equivalent. This energy efficiency may be further enhanced by the system's ability to electrochemically concentrate lithium to high levels in a matter of hours, significantly reducing processing time compared to traditional methods.

In addition to lithium extraction, the system may also be capable of removing sodium (or other alkali metal) impurities from lithium-containing feedstocks, potentially further improving the purity of the final product. This multi-functional capability may add to the system's overall value and efficiency.

In various embodiments, the system may comprise several key components, including a unit operation referred to as a novel electrolytic and environmental direct lithium extraction extractor, a lithium collection tank, and various flow control components such as pumps, pipes, and valves. Within the context of the present disclosure, the novel electrolytic and environmental direct lithium extraction may be referred herein as “MOBILE”. As disclosed herein, the MOBILE extractor may include componentry for providing selective ion exchange.

In the MOBILE extractor, lithium and sodium storage modules may be arranged in an alternating parallel configuration. This arrangement may create rectangular ducts between the modules through which the feed solution flows. Each module may contain a liquid electrolyte separated from the feed solution by ion-selective membranes. The lithium storage modules may use lithium-selective membranes, while the sodium storage modules may use sodium-selective membranes.

In one embodiment, a principle of operation may involve the selective transport of lithium ions from the feed solution into the lithium storage modules, while simultaneously transporting sodium ions from the sodium storage modules into the feed solution. This ion exchange may be driven by an applied electrical potential across the system.

The extraction process may involve several main steps: 1. Lithium Extraction: The lithium-containing feed solution may be pumped through a MOBILE extractor. Lithium ions may be selectively transported from the feed solution into the lithium storage modules, while sodium ions may be transported from the sodium storage modules into the feed solution. 2. Lithium Concentration: The lithium-enriched solution from the lithium storage modules may be transferred to a lithium collection tank. In one embodiment, this step may be repeated to increase the lithium concentration in the collection tank. 3. Precipitation: Once the lithium concentration in the collection tank reaches a desired level, sodium carbonate may be added to precipitate lithium carbonate, which may be the final product. In various embodiments, it is acknowledged that a variety of methods may be used to precipitate lithium, including condensation precipitation (e.g. decreasing the temperature of the solution to induce precipitation of the target Li salt by reducing its solubility), evaporation of water, etc. Additionally, condensation precipitation may be used to provide various forms of lithium salts (lithium carbonate Li₂CO₃, lithium hydroxide LiOH, lithium sulfate Li₂SO₄, lithium phosphate Li₃PO₄, lithium florid LiF, etc.).

The system may be operated in either continuous flow or batch operation mode, depending on the specific requirements and conditions of the extraction process. In continuous flow mode, the feed solution may be constantly pumped through the system, allowing for ongoing extraction. In batch operation mode, a specific volume of feed solution may be processed before being replaced with a new batch.

This lithium extraction system may offer several advantages over traditional methods, including reduced reagent use, minimal waste generation, and the ability to process feed solutions with low lithium concentrations or high concentrations of interfering ions.

The lithium extraction system may utilize a composite membrane structure for selectively extracting lithium ions from a feed solution.

As shown hereinbelow, the MOBILE system, or any lithium (or other alkali metal) extraction system, may be modified to incorporate a sorbent layer and/or an anti-fouling layer to enhance performance and efficiency. The addition of a sorbent layer between the feed solution and the lithium-selective membrane may concentrate lithium ions near the membrane surface, potentially increasing the flux of lithium ions through the membrane and improving overall extraction efficiency. This sorbent layer may comprise materials selective for lithium adsorption, such as lithium titanate or other lithium-specific adsorbents. In a similar manner, the sorbent layer may be configured to selectively allow other alkali metals (e.g. Li, Na, etc.) to pass. In various embodiments, the lithium sorbent material may include alumina layered double hydroxide (Al-LDH) sorbents, with chemical formula Al(OH)₃.

Additionally, and/or alternatively, an anti-fouling layer may be applied to the surface of the lithium-selective membrane (and/or a sodium-selective membrane) facing the feed solution to mitigate membrane fouling caused by impurities in the brine or feed solution. This anti-fouling layer may be composed of materials resistant to scaling or organic fouling, such as hydrophilic polymers or nanostructured surfaces. The incorporation of these layers may allow the extraction system to process feed solutions with lower initial lithium concentrations or higher levels of impurities, potentially expanding the range of lithium-containing resources that can be economically extracted. Additionally, within the context disclosed, it is to be appreciated that although lithium extraction is focused on, the system may be equally modified for other alkali-metal extraction (e.g. Na, K, Rb, etc.).

In various embodiments, it is acknowledged that fouling may be caused by deposition of scale-forming minerals (such as but not limited to Ca2+, Mg2+, and silicate anions, such as SiO4(4-)), and/or deposition of hydrophobic organic substances that are strongly adhesive/cohesive due to their ability to make hydrophobic interactions (e.g. van der waals forces, etc.). Additionally, other mechanisms may be the accumulation of particulates or growth or microorganisms (biofouling). It is recognized that fouling may also be caused by other factors and the disclosure of these specific causes are intended merely as examples of possible causes.

### Sorbent Particle Layer Embodiment

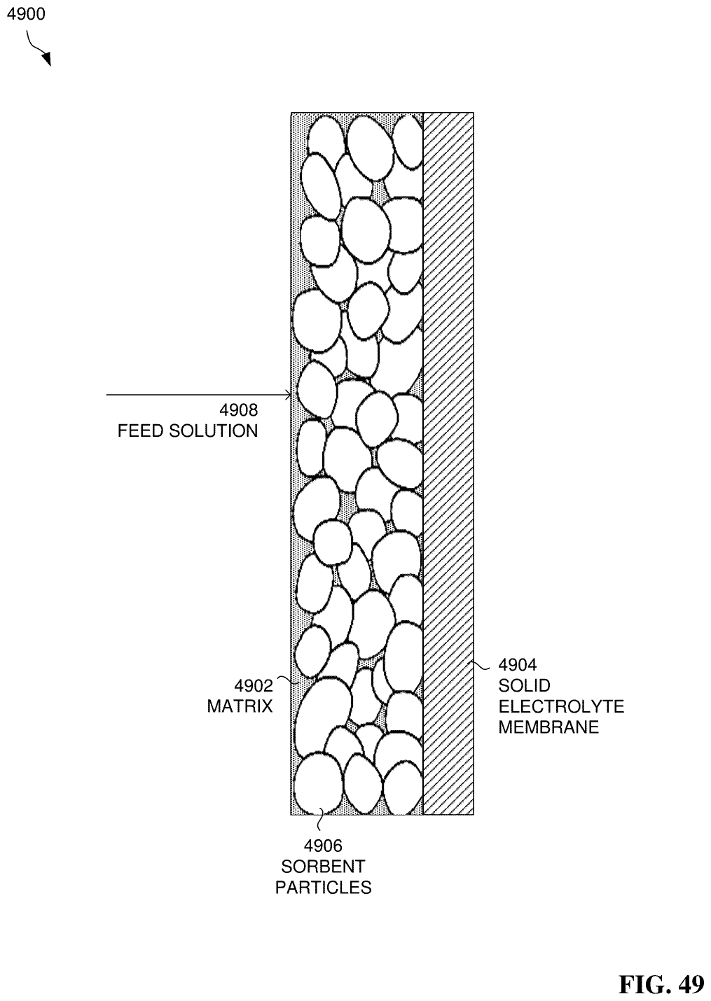

FIG. 49 illustrates a section view 4900 of a composite membrane structure for lithium extraction, in accordance with one embodiment. As an option, the section view 4900 may be implemented in the context of any one or more of the embodiments set forth in any previous and/or subsequent Figures and/or description thereof. Of course, however, the section view 4900 may be implemented in the context of any desired environment. Further, the aforementioned definitions may equally apply to the description below.

The composite membrane structure comprises a solid electrolyte membrane 4904, a matrix 4902, and sorbent particles 4906. The solid electrolyte membrane 4904 may be configured to be conductive to ions of a predetermined alkali metal, such as lithium. In some cases, the solid electrolyte membrane 4904 may comprise a ceramic material, such as a NASICON-type solid electrolyte. The NASICON-type solid electrolyte may be LATP (Li_{1.3}Al_{0.3}Ti_{1.7}(PO₄)₃) or LAGP. The solid electrolyte membrane 4904 may be substantially dense to prevent unwanted ion transport. In another embodiment, the solid electrolyte membrane 4904 may be constructed of a polymer with a preferred selectivity for lithium.

The matrix 4902 may serve as a support structure for the sorbent particles 4906. In some cases, the matrix 4902 may comprise a polymer matrix. The sorbent particles 4906 may be configured to adsorb the predetermined alkali metal. For lithium extraction, the sorbent particles 4906 may include materials such as Al(OH)₃, LiAlO₂, LiCuO₂, Li₂MnO₃, Li₄Mn₅O₁₂, Li₂SnO₃, Li₄TiO₄, Li₃Ti₅O₁₂, Li₇T₁₁nO₂₄, Li₃VO₄, Li₂TiO₃, LiTiO₂, Li₂FeO₃, or Li₂Si₃O₇. In like manner, other sorbent particles 4906 may be selected to absorb other specific predetermined alkali metals.

The composite membrane structure 4900 may be in contact with a feed solution 4908. The sorbent particles 4906 may be configured to enable reversible adsorption of the ions of the predetermined alkali metal from the feed solution 4908. This arrangement may allow for efficient extraction of the desired alkali metal ions from the feed solution 4908.

As an example, the feed solution 4908 may include a brine solution containing lithium ions along with other ions and substances typically found in geothermal or oilfield brines. This brine solution may contain relatively low concentrations of lithium, such as 100-200 parts per million (ppm), although any concentration of lithium may be theoretically used within the context of the present description. As the brine solution 4908 comes into contact with the sorbent particles 4906, the sorbent particles 4906 may selectively adsorb lithium ions from the brine solution 4908.

In various embodiments, this adsorption process of the sorbent particles 4906 may effectively concentrate the lithium ions near the surface of the solid electrolyte membrane 4904. While the bulk concentration of lithium in the feed solution 4908 may remain relatively low, the local concentration of lithium ions in the vicinity of the sorbent particles 4906 and the solid electrolyte membrane 4904 interface may be significantly higher.

In various embodiments, this increased local concentration of lithium ions may create a concentration gradient that enhances the transport of lithium through the solid electrolyte membrane 4904. When an electric potential is applied across the membrane, the higher concentration of lithium ions near the membrane surface may result in a greater flux of lithium ions through the solid electrolyte membrane 4904 compared to a system without the sorbent particles 4906.

In one embodiment, the sorbent particles 4906 may effectively act as a pre-concentrating mechanism, allowing the MOBILE system to efficiently extract lithium from brine solutions with relatively low initial lithium concentrations. This may enable the system to process a wider range of brine resources, including those that might be considered too dilute for conventional extraction methods.

In some cases, the solid electrolyte membrane 4904 may have a thickness between 0.1 mm and 2 mm, while the sorbent layer comprising the matrix 4902 and the sorbent particles 4906 may have a thickness between 0.05 mm and 1 mm. The solid electrolyte membrane 4904 may have an ionic conductivity for the predetermined alkali metal ion of at least 10'S/cm. The sorbent particles 4906 may have a capacity to adsorb at least 1 mg of the predetermined alkali metal per gram of sorbent material.

The composite membrane structure may be fabricated using various methods. In some cases, the solid electrolyte membrane 4904 may be fabricated by tape casting, roll-to-roll coating, die compaction followed by sintering, etc., consistent with the disclosure hereinabove. These fabrication methods may allow for scalable production of the membrane structure.

In various embodiments, the composite membrane structure may have a selectivity ratio for the predetermined alkali metal ion (such as lithium) over sodium ions of at least 10:1. This high selectivity may enable efficient separation of the desired alkali metal (such as lithium) from other ions present in the feed solution 4908.

In some cases, the solid electrolyte membrane 4904 may comprise solid electrolyte particles embedded in a polymer matrix. This configuration may provide both ionic conductivity and mechanical stability to the membrane structure.

The sorbent layer, comprising the matrix 4902 and sorbent particles 4906, may be adjacent to the solid electrolyte membrane 4904. This arrangement may allow for efficient transfer of the adsorbed alkali metal ions from the sorbent particles 4906 to the solid electrolyte membrane 4904.

Additionally, the matrix 4902 may comprise specific materials such as AmberSep G26 H, Amberlite IRN9687 Li/OH Ion exchange resin, poly(acrylic acid), perfluorosulfonic acid (PFSA) polymers (including but limited to Nafion, Aquivion, etc.). These materials may provide additional functionality to the sorbent layer, such as improved ion exchange capabilities or enhanced mechanical properties.

In other embodiments (not shown in FIG. 49), the two-layer construction comprising a first layer of the solid electrolyte membrane 4904, and a second layer as the sorbent layer, comprising the matrix 4902 and sorbent particles 4906, may be combined into a single dual-purpose layer. For example, the single layer construction may comprise a matrix material that incorporates both sorbent particles and ion-selective solid electrolyte particles. The matrix material may be a polymer or other suitable binder that provides mechanical stability and allows for the formation of a cohesive membrane structure. In various embodiments, the sorbent particles and ion-selective solid electrolyte particles may be uniformly distributed throughout such a single layer matrix. This homogeneous distribution may allow for synergistic effects between the two types of particles, potentially enhancing the overall lithium extraction efficiency of the membrane.

In various embodiments, the sorbent particles within the single layer construction may function to concentrate lithium ions from the feed solution, similar to their role in the two-layer design. These particles may create localized regions of high lithium concentration within the membrane structure. In various embodiments, the ion-selective solid electrolyte particles dispersed throughout the matrix may provide pathways for lithium ion conduction through the membrane. These particles may form interconnected networks within the matrix, allowing for efficient transport of lithium ions across the membrane. In various embodiments, the ratio of sorbent particles to ion-selective solid electrolyte particles may be optimized to achieve the desired balance between lithium concentration and ion transport properties. This optimization may involve varying the relative proportions of the two particle types to maximize overall lithium extraction performance. Further, the single layer construction may incorporate additional functional materials within the matrix (such as anti-fouling agents or other additives discussed hereinbelow). Still yet, the thickness of the single layer membrane may be adjusted to optimize performance. For example, the membrane thickness may be tailored to balance factors such as mechanical strength, ion transport efficiency, and overall system compactness.

In various embodiments, the porosity of the matrix material may be controlled to allow for efficient transport of the feed solution through the membrane while maintaining the structural integrity of the particle network. This porosity may be optimized to maximize contact between the feed solution and both the sorbent and ion-selective solid electrolyte particles.

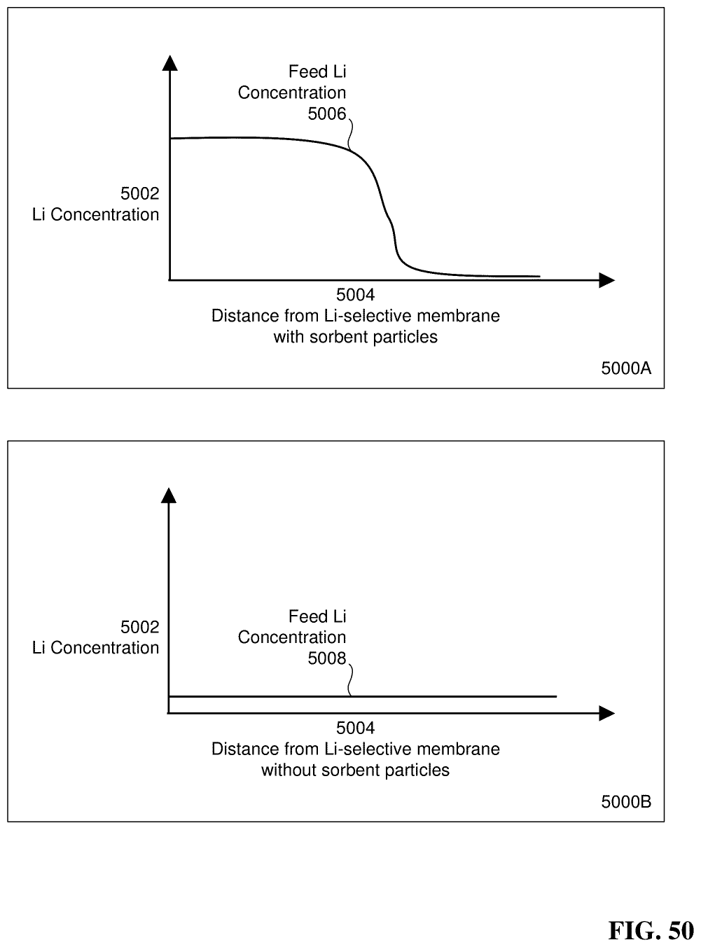

FIG. 50 depicts graphs 5000A, 5000B showing lithium concentration profiles near a Li-selective membrane, in accordance with one embodiment. As an option, the graphs 5000A, 5000B may be implemented in the context of any one or more of the embodiments set forth in any previous and/or subsequent Figures and/or description thereof. Of course, however, the graphs 5000A, 5000B may be implemented in the context of any desired environment. Further, the aforementioned definitions may equally apply to the description below.

As shown, the graphs 5000A and 5000B show lithium concentration profiles near a Li-selective membrane. Graph 5000A illustrates the concentration profile with sorbent particles present, while graph 5000B shows the profile without sorbent particles. In both graphs, the x-axis represents the distance from the Li-selective membrane and the y-axis represents the Li concentration.

In the case without sorbent particles per graph 5000B, the lithium concentration profile appears flat, with a constant feed Li concentration across the entire distance from the membrane. This suggests that without sorbent particles, there may be no concentration gradient driving lithium ions towards the membrane.

In contrast, the concentration profile with sorbent particles present per graph 5000A shows a curved profile. The lithium concentration may be higher near the membrane and may gradually decrease to a lower concentration further away. This gradient may indicate that the sorbent particles may be effectively concentrating lithium ions near the membrane surface.

The presence of a concentration gradient in the case with sorbent particles may have significant implications for lithium extraction efficiency. A higher concentration of lithium ions near the membrane surface may lead to increased flux of lithium ions through the membrane. This increased flux may result in more efficient lithium extraction compared to the case without sorbent particles. In some cases, the sorbent particles may act as a pre-concentrating mechanism, effectively increasing the local lithium concentration at the membrane interface. This pre-concentration effect may be particularly beneficial when dealing with feed solutions that have low initial lithium concentrations.

The steeper concentration gradient observed with sorbent particles may also suggest that the extraction process may be less limited by diffusion of lithium ions from the bulk solution to the membrane surface. This may potentially allow for higher extraction rates or the ability to extract lithium from more dilute solutions. In various embodiments, it is acknowledged that a diffusion-limited process may have a concentration gradient in the opposite direction (lower concentration at the surface of the membrane, higher concentration further away). Additionally, such graphs emphasize that the concentration of lithium within the sorbent layer may be relatively constant through the layer, but then once past the layer, the concentration of lithium may decrease (often sharply) since the concentration of lithium in the feed solution may be small. As such, the sorbent layer may cause a local concentration of lithium to be higher since the sorbent particles have an affinity for lithium. This higher concentration of lithium may result in higher amounts of lithium (compared to other substances) getting through the solid electrolyte layer, resulting in higher selectivity for lithium.

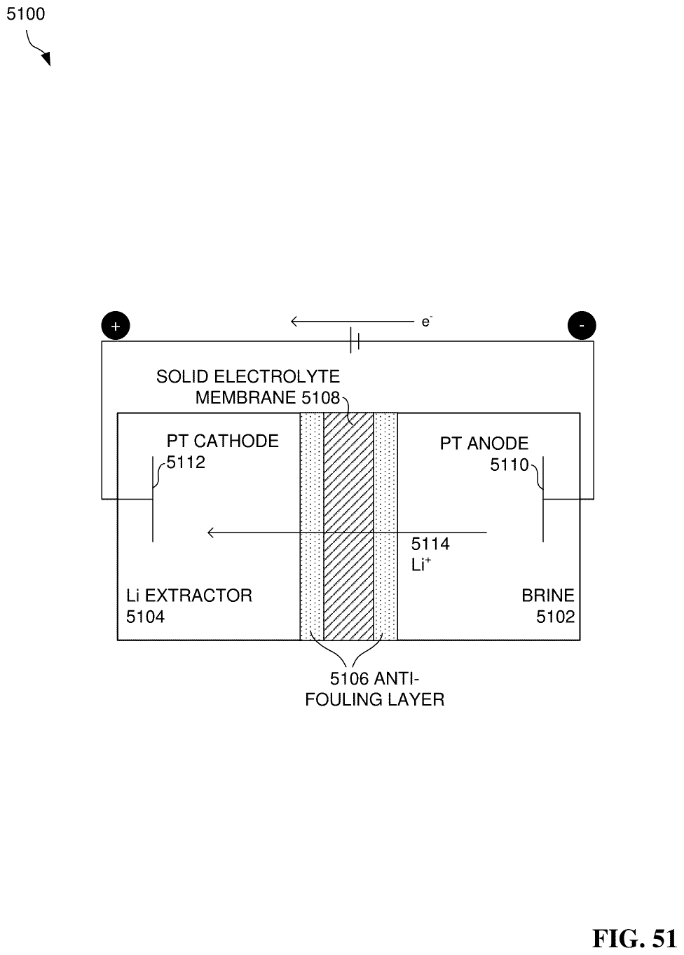

FIG. 51 illustrates a system diagram 5100 of a lithium extraction apparatus, in accordance with one embodiment. As an option, the system diagram 5100 may be implemented in the context of any one or more of the embodiments set forth in any previous and/or subsequent Figures and/or description thereof. Of course, however, the system diagram 5100 may be implemented in the context of any desired environment. Further, the aforementioned definitions may equally apply to the description below.

As shown, the lithium extraction system comprises a solid electrolyte membrane 5108, a PT cathode 5112, a PT anode 5110, and an anti-fouling layer 5106. It is recognized that the PT cathode 5112 and/or the PT anode 5110 may likewise be constructed of titanium or other similar elements. The solid electrolyte membrane 5108 may be configured to be conductive to lithium ions 5114. In some cases, the solid electrolyte membrane 5108 may comprise a NASICON-type solid electrolyte, consistent with the disclosure hereinabove. The NASICON-type solid electrolyte may be selected from the group consisting of LATP (Li_{1.3}Al_{0.3}Ti_{1.7}(PO₄)₃) and LAGP.

The PT cathode 5112 and PT anode 5110 may be positioned on opposite sides of the solid electrolyte membrane 5108. In some cases, a power supply may be configured to apply an electrical potential between the PT cathode 5112 and PT anode 5110. The power supply may be configured to apply a potential difference of between 0.1 V and 5 V (or any other preconfigured amount depending on the specific needs of the extraction process).

The anti-fouling layer 5106 may be adjacent to the solid electrolyte membrane 5108 and may interface with a brine 5102. The anti-fouling layer 5106 may be configured as a barrier between the brine 5102 and the solid electrolyte membrane 5108. In some cases, the anti-fouling layer 5106 may be ionically conductive to the lithium ions 5114. The anti-fouling layer 5106 may have a thickness, in one embodiment, between 0.01 mm and 0.5 mm.

As shown in the system diagram 5100, the anti-fouling layer 5106 may be positioned as a layer on both side of the solid electrolyte membrane 5108. In an alternative arrangement, the anti-fouling layer 5106 may be on a single side of the of the solid electrolyte membrane 5108 (such as on the side that interfaces directly with the brine 5102).

The anti-fouling layer 5106 may comprise specific materials. In some cases, the anti-fouling layer 5106 may comprise perfluorinated polymers, such as Nafion and/or Aquivion. The anti-fouling layer 5106 may also comprise super-hydrophilic materials, such as polyethylene glycol (PEG), polyethylene oxide (PEO), and/or poly(2-Methacryloyloxyethyl phosphorylcholine) (pMPC). In some cases, the anti-fouling layer 5106 may comprise hydrophobic materials, such as polyethylene, polypropylene, polyether ether ketone (PEEK), and/or sulfonated polyether ether ketone (SPEEK). The anti-fouling layer 5106 may also comprise carbonaceous materials, such as graphene, graphene oxide, carbon nano onions, or graphene nanoplatelets.

The lithium extraction system may comprise a Li extractor 5104 configured to receive lithium ions 5114 transported through the solid electrolyte membrane 5108. The Li extractor 5104 may comprise a first electrolyte configured to store the lithium ions 5114. In some cases, the first electrolyte may comprise an active material configured to reversibly store electrons. The active material may be selected from the group consisting of Fe(CN)₆^{3-/4-}, lithium titanate (LTO), lithium iron phosphate (LFP), and lithium manganese oxide (LMO).

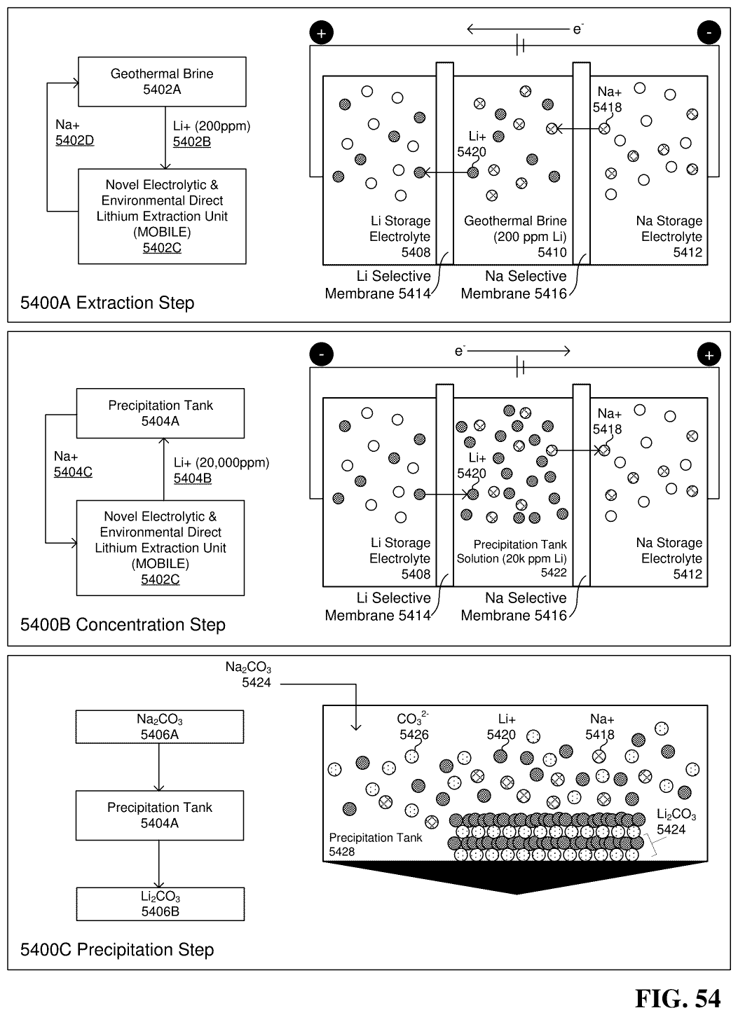

In various embodiments, the lithium extraction system may further comprise a second electrolyte configured to store sodium (or another alkali metal) ions. In some cases, the second electrolyte may comprise an active material configured to reversibly store electrons. The active material in the second electrolyte may be selected from the group consisting of Fe(CN)₆^{3-/4-} and Prussian Blue. As such, the lithium extraction system may include a second solid membrane layer configured to be sodium ion selective. The second solid membrane layer may be positioned to transport sodium ions from the second electrolyte to the brine 5102. In some cases, the second solid membrane layer may comprise a NASICON-type solid electrolyte. The NASICON-type solid electrolyte in the second solid membrane layer may be Na₃Si₂Zr₂PO₁₂. Although a two-membrane arrangement (one selective for lithium, another selective for sodium) is not shown in the context of FIG. 51, such arrangement is shown throughout the present disclosure (such as FIG. 54 amongst many others).

In various embodiments, the lithium extraction system may further comprise a pump configured to circulate the brine 5102 through the system. In particular, the lithium extraction system may be configured to be used in a flow cell system for continuous extraction of lithium from the brine 5102.

In various embodiments, the anti-fouling layer 5106 may be designed to prevent undesired items from fouling up the surface while still allowing lithium to pass through by utilizing specific material properties and surface chemistry. Additionally, the anti-fouling layer 5106 may be composed of materials that resist the adhesion and accumulation of scale-forming substances, organic matter, and other contaminants commonly found in brine solutions, while maintaining ionic conductivity for lithium ions.

In various embodiments, the anti-fouling layer may incorporate materials that may have extremely low surface energy due to the presence of fluorine atoms (such as Nafion or Aquivion), which makes it difficult for foulants to adhere to the surface. Additionally, the use of perfluorinated polymers may still contain sulfonic acid groups that allow for the transport of lithium ions through the layer. In various embodiments, the anti-fouling layer may utilize zwitterionic materials. These materials may have both positive and negative charges in their molecular structure, creating a strong hydration layer at the surface. This hydration layer may act as a barrier, preventing foulants from reaching and adhering to the surface, while still allowing the smaller, highly mobile lithium ions to pass through.

In various embodiments, the anti-fouling layer 5106 may be designed with a specific surface topography or roughness that minimizes the contact area available for foulant adhesion. This may be achieved through nano- or micro-structuring of the surface, creating a superhydrophobic effect that repels water-based contaminants while maintaining pathways for lithium ion transport.

In various embodiments, the use of carbon-based materials within the anti-fouling layer may provide a combination of anti-fouling properties due to their unique surface chemistry and high ionic conductivity for lithium ions. The carbon-based materials may be functionalized to enhance their anti-fouling capabilities while maintaining their conductive properties.

Additionally, the anti-fouling layer 5106 may be designed with a gradient structure, where the outer surface is highly resistant to fouling, while the inner portion of the layer becomes increasingly conductive to lithium ions. This gradient structure may provide an effective barrier against foulants while still facilitating efficient lithium ion transport through the layer.

In various embodiments, the anti-fouling layer 5106 may incorporate self-cleaning mechanisms. For example, the anti-fouling layer 5106 may be designed to undergo controlled swelling or conformational changes in response to specific stimuli, which can help dislodge any accumulated foulants while maintaining pathways for lithium ion transport.

Additionally, in other embodiments, a purge step may be used on the membrane layer. For example, the surface of the membrane may be rinsed with a wash solution to dislodge anything that may have accumulated on the surface. The cleaning solution may include substances such as acids (HCl, HNO3, aqua regia, other strong acids), bases (NaOH), solvents (alcohols, hydrocarbons), chelating agents (citrate, EDTA), sequestering agents (sodium hexametaphosphate), and detergents (SDS, PEO/PEG based polymers), etc. In one embodiment, this purge step may be used as an alternative to using the non-fouling layer 5106.

In various embodiments, the anti-fouling layer 5106 may utilize electrochemical effects to prevent fouling. For example, by maintaining a slight electrical charge on the surface, the anti-fouling layer 5106 may repel charged contaminants while still allowing lithium ions to pass through due to their smaller size and higher mobility.

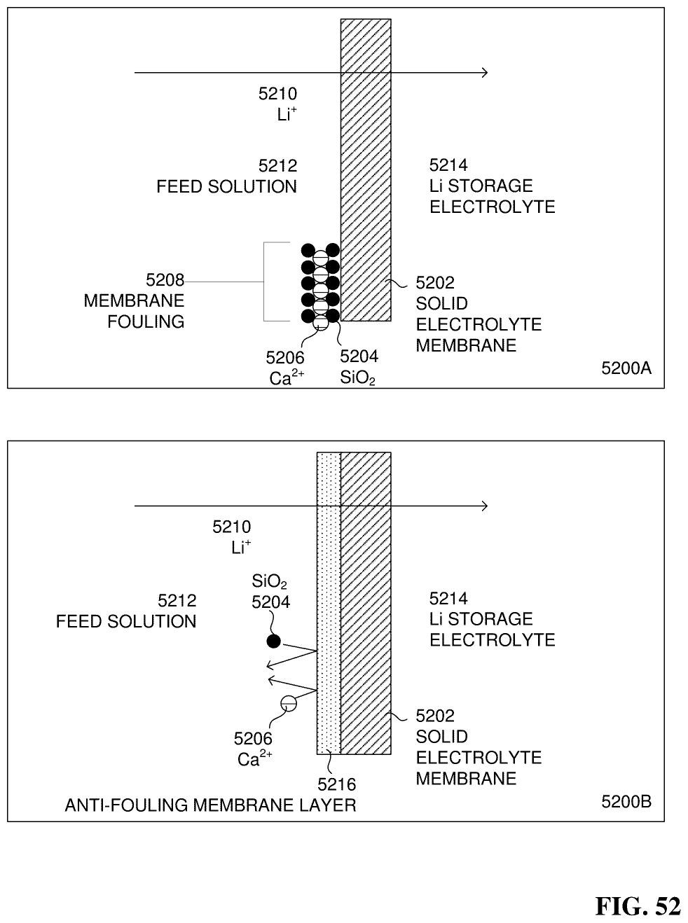

FIG. 52 illustrates a system for lithium extraction in two configurations 5200A, 5200B, in accordance with one embodiment. As an option, the two configurations 5200A, 5200B may be implemented in the context of any one or more of the embodiments set forth in any previous and/or subsequent Figures and/or description thereof. Of course, however, the two configurations 5200A, 5200B may be implemented in the context of any desired environment. Further, the aforementioned definitions may equally apply to the description below.

The configuration 5200A comprises a feed solution 5212, a solid electrolyte membrane 5202, and a lithium storage electrolyte 5214. The feed solution 5212 may contain lithium ions 5210. The solid electrolyte membrane 5202 may be positioned between the feed solution 5212 and the lithium storage electrolyte 5214. In some cases, the solid electrolyte membrane 5202 may be configured to selectively transport the lithium ions 5210 from the feed solution 5212 to the lithium storage electrolyte 5214.

In the configuration 5200A, membrane fouling 5208 may occur on the surface of the solid electrolyte membrane 5202 that is in contact with the feed solution 5212. The membrane fouling 5208 may be caused by the accumulation of calcium ions 5206 and silicon dioxide 5204 on the surface of the solid electrolyte membrane 5202. This fouling may reduce the efficiency of lithium ion transport through the solid electrolyte membrane 5202.

The modified lithium extraction system shown in configuration 5200B introduces an anti-fouling membrane layer 5216 to address the issue of membrane fouling 5208. The anti-fouling membrane layer 5216 may be positioned between the feed solution 5212 and the solid electrolyte membrane 5202. In some cases, the anti-fouling membrane layer 5216 may be configured to prevent or reduce the accumulation of calcium ions 5206 and silicon dioxide 5204 on the surface of the solid electrolyte membrane 5202.

In one embodiment, the anti-fouling membrane layer 5216, the solid electrolyte membrane 5202, and/or a sorbent layer (not shown in FIG. 52) may comprise sorbent particles configured to adsorb a predetermined alkali metal, such as lithium.

The addition of the anti-fouling membrane layer 5216 in the modified lithium extraction system of the configuration 5200B may allow for more efficient and selective transport of the lithium ions 5210 from the feed solution 5212 to the lithium storage electrolyte 5214. In one embodiment, by preventing or reducing membrane fouling 5208, the configuration 5200B may allow for greater performance over longer periods of operation compared to the standard lithium extraction system per configuration 5200A.

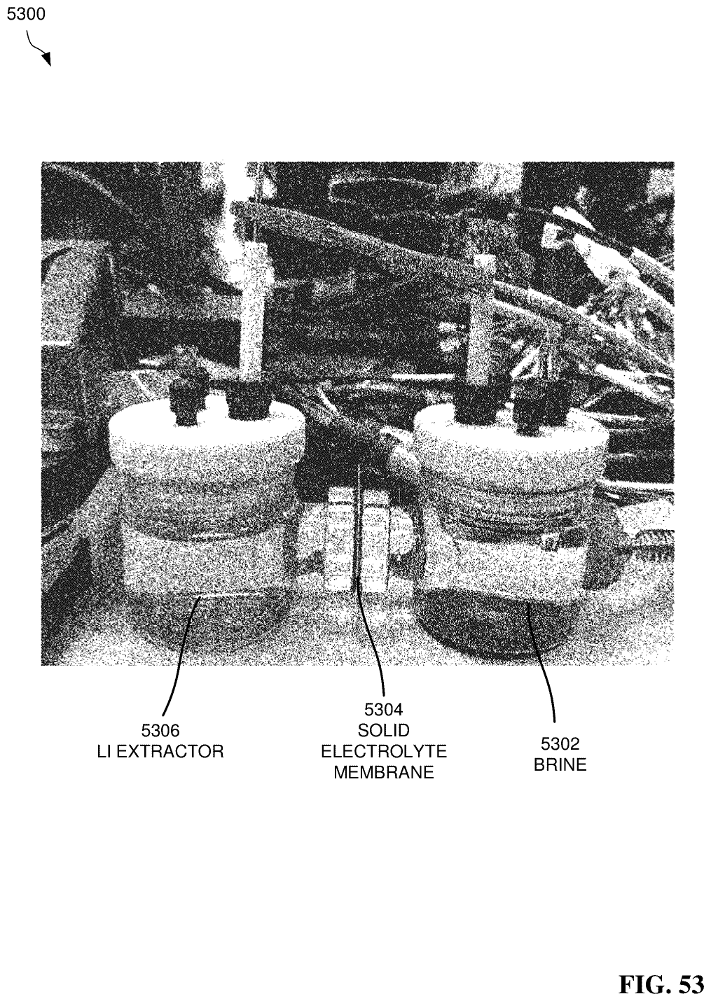

FIG. 53 illustrates a perspective view 5300 of a lithium extraction apparatus, in accordance with one embodiment. As an option, the perspective view 5300 may be implemented in the context of any one or more of the embodiments set forth in any previous and/or subsequent Figures and/or description thereof. Of course, however, the perspective view 5300 may be implemented in the context of any desired environment. Further, the aforementioned definitions may equally apply to the description below.

As shown, the lithium extraction apparatus comprises a container of brine 5302, a solid electrolyte membrane 5304, and a lithium extractor 5306. The brine 5302, in one embodiment, may be configured to hold a feed solution (such as brine, salt water, etc.).

The solid electrolyte membrane 5304 may be positioned between the brine 5302 and the lithium extractor 5306. In some cases, the solid electrolyte membrane 5304 may be similar to the solid electrolyte membrane described in previous embodiments. The solid electrolyte membrane 5304 may be configured to selectively allow the passage of lithium ions while blocking other ions present in the brine. The lithium extractor 5306 may be configured to collect the lithium ions that pass through the solid electrolyte membrane 5304.

In various embodiments, the lithium extraction apparatus may be arranged in a flow-through configuration. The brine 5302 may flow through (in a manner such that the solution is flown parallel to the membrane) the solid electrolyte membrane 5304, allowing lithium ions to be selectively extracted by the lithium extractor 5306. This configuration may enable continuous extraction of lithium from the original feed solution (i.e. the brine 5302).

The components of the lithium extraction apparatus may work together to efficiently extract lithium from the brine. The brine container 5302 may supply the lithium-containing feed solution to the solid electrolyte membrane 5304. The solid electrolyte membrane 5304 may selectively allow lithium ions to pass through while blocking other ions. The lithium extractor 5306 may then collect the lithium ions that have passed through the solid electrolyte membrane 5304.

In some cases, the lithium extraction apparatus may incorporate additional features from previously described embodiments. For example, the solid electrolyte membrane 5304 may include an anti-fouling layer to prevent or reduce membrane fouling, and/or sorbent particles. The lithium extractor 5306 may contain an electrolyte with an active material configured to reversibly store electrons, facilitating the electrochemical extraction process.

FIG. 54 illustrates steps 5402, 5404, 5406 of a system diagram for a lithium extraction process, in accordance with one embodiment. As an option, the steps 5402, 5404, 5406 may be implemented in the context of any one or more of the embodiments set forth in any previous and/or subsequent Figures and/or description thereof. Of course, however, the steps 5402, 5404, 5406 may be implemented in the context of any desired environment. Further, the aforementioned definitions may equally apply to the description below.

The lithium extraction process 5400 comprises three main steps: extraction step 5400A, concentration step 5400B, and precipitation step 5400C. In the extraction step 5400A, a geothermal brine 5402A containing a lithium concentration 5402B (including a low concentration of lithium such as 200 ppm) enters a novel electrolytic and environmental direct lithium extraction unit (MOBILE) 5402C, resulting in a sodium concentration 5402D that flows back into the geothermal brine 5402A.

During the extraction step, lithium ions 5420 may be transported from the geothermal brine 5410 to the lithium storage electrolyte 5408 via the lithium selective membrane 5414, while sodium ions 5418 may move from the sodium storage electrolyte 5412 to the geothermal brine 5410 via the sodium selective membrane 5416. The lithium selective membrane 5414 and the sodium selective membrane 5416 may each include a solid electrolyte particle membrane, consistent with the disclosure herein.

In some cases, the lithium selective membrane 5414 and/or the sodium selective membrane 5416 may further comprise sorbent particles and/or an anti-fouling layer adjacent to the ion selective membrane, as discussed hereinabove.

The concentration step 5400B shows the novel electrolytic and environmental direct lithium extraction unit (MOBILE) 5402C connected to a precipitation tank 5404A. In this step, the lithium concentration 5404B in a precipitation tank solution 5422 may increase to a concentrated lithium level (such as 20,000 ppm), while the sodium concentration 5404C may decrease, move from the precipitation tanks 5404A to the novel electrolytic and environmental direct lithium extraction unit (MOBILE) 5402C. The lithium ions 5420 may continue to move through the lithium selective membrane 5414 into the precipitation tank solution 5422, and sodium ions 5418 may move through the sodium selective membrane 5416 into the sodium storage electrolyte 5412. In comparing the extraction step 5400A to the concentration step 5400B, it is recognized that the solution flow of lithium ions is in a reverse direction. In the extraction step 5400A, the lithium flow from a low concentration geothermal brine to the MOBILE system. In the concentration step 5400B, the lithium flow from the MOBILE system and collects in higher concentration in the precipitation tank 5404A. In this manner, the precipitation tank solution 5422 may include a lithium concentration of in the range of or exceeding 20,000 ppm.

The precipitation step 5400C illustrates the final stage of the process. A sodium carbonate input 5406A may be provided to a precipitation tank 5404A, resulting in lithium carbonate 5406B. This is shown visually as well with sodium carbonate 5424 being introduced to the precipitation tank 5428. As a result, the sodium carbonate may dissociate and result in sodium ions 5418 and carbonate ions 5426, which carbonate ions 5426 may react with the concentrated lithium ions 5420 in the precipitation tank 5428, resulting in the formation and precipitation of lithium carbonate, which may be collected as a lithium carbonate 5424.

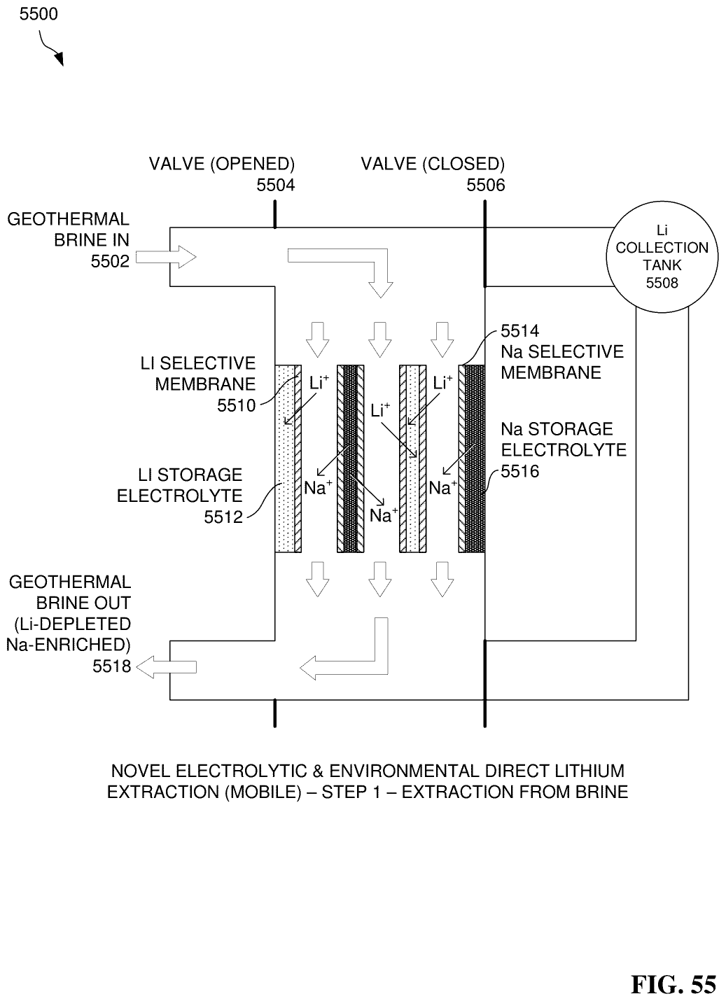

In some cases, the lithium extraction system may further comprise the precipitation tank 5428 configured to receive lithium ions 5420 from the lithium storage electrolyte 5408 and precipitate lithium carbonate. For example, as demonstrated in more detail hereinbelow in FIGS. 55-57, the precipitation tank may be connected to the extraction system and controlled via a series of valves. The lithium extraction system may further comprise a source of sodium carbonate configured to supply sodium carbonate 5424 to the precipitation tank 5428.

The lithium extraction system may be configured to operate in a continuous flow mode or in a batch mode. Additionally, in one embodiment, the precipitation tank (and/or a lithium collection tank) may comprise a buffer solution configured to maintain a high concentration of carbonate anions.

In the extraction step 5400A and/or the concentration step 5400B, electrical energy may be provided to drive the selective transport of ions across the membranes, enabling the efficient extraction and concentration of lithium from the geothermal brine 5410.

Taking a step back, the MOBILE extraction process 5400 provides an efficient and environmentally friendly process for extracting lithium from geothermal brines. By utilizing selective membranes and electrochemical processes, the system may achieve high lithium recovery rates, even from low concentration lithium solutions, while minimizing waste and energy consumption.

FIG. 55 illustrates a system diagram 5500 of a lithium extraction system during extraction, in accordance with one embodiment. As an option, the system diagram 5500 may be implemented in the context of any one or more of the embodiments set forth in any previous and/or subsequent Figures and/or description thereof. Of course, however, the system diagram 5500 may be implemented in the context of any desired environment. Further, the aforementioned definitions may equally apply to the description below.

The extraction system 5500 comprises a geothermal brine input 5502, an opened valve 5504, a closed valve 5506, a lithium collection tank 5508, a lithium selective membrane 5510 associated with a lithium storage electrolyte 5512, a sodium selective membrane 5514 associated with a sodium storage electrolyte 5516, and a geothermal brine output 5518.

In some cases, the geothermal brine input 5502 may introduce a feed solution into the extraction system 5500 through the opened valve 5504. The feed solution may comprise the geothermal brine 5502. In some cases, the feed solution may comprise a solution derived from recycled lithium-ion batteries. The geothermal brine may then flow through the lithium selective membrane 5510, which may allow lithium ions to pass through while blocking other ions.

The lithium ions may be collected in the lithium storage electrolyte 5512. Simultaneously, sodium ions from the sodium storage electrolyte 5516 may pass through the sodium selective membrane 5514 in the opposite direction, replacing the lithium ions in the geothermal brine. This process may result in a lithium-depleted, sodium-enriched geothermal brine that exits the extraction system 5500 through the geothermal brine output 5518.

The lithium collection tank 5508 may be connected to the extraction system 5500 but isolated by the closed valve 5506 during this extraction step. The arrangement of the membranes and electrolytes may allow for the selective extraction of lithium from the geothermal brine while maintaining charge balance through the exchange of sodium ions.

In some cases, the extraction system 5500 may further comprise a brine pretreatment unit configured to prepare the feed solution for lithium extraction. The brine pretreatment unit may be positioned between the geothermal brine input 5502 and the opened valve 5504.

In one embodiment, the extraction system 5500 may be configured to extract lithium from a feed solution containing less than 200 ppm of lithium. In some cases, the extraction system 5500 may be configured to concentrate lithium to at least 20 g/L in the lithium storage electrolyte 5512.

The extraction system 5500 may be designed to maintain at least 80% of its initial lithium extraction efficiency after 1000 hours of operation. In some cases, the extraction system 5500 may be configured to extract at least 90% of lithium ions from the feed solution in a single pass.

The extraction system 5500 represents the first step in the novel electrolytic and environmental direct lithium extraction (MOBILE) process, focusing on the extraction of lithium from the geothermal brine input 5502. As shown, the novel electrolytic and environmental direct lithium extraction (MOBILE) process enables efficient lithium extraction while minimizing environmental impact by avoiding the use of additional chemicals or extensive evaporation processes.

In various embodiments, the extraction system 5500 can be adapted for continuous flow operation to enable ongoing extraction of lithium from brine water. This continuous flow configuration may allow for more efficient and higher-volume lithium extraction compared to batch processing. Additionally, in various embodiments, the geothermal brine input 5502 may be configured to provide a constant flow of brine water into the extraction system 5500. The opened valve 5504 may remain open, allowing the brine to continuously enter the extraction system.

In various embodiments, the brine may flow through a channel or compartment adjacent to the lithium selective membrane 5510. As the brine flows past this lithium selective membrane 5510, lithium ions may be selectively transported through the lithium selective membrane 5510 into the lithium storage electrolyte 5512. The electric potential applied across the system may drive this selective transport of lithium ions. In various embodiments, simultaneously, sodium ions from the sodium storage electrolyte 5516 may be transported through the sodium selective membrane 5514 into the flowing brine stream. This exchange of sodium for lithium may help maintain charge balance in the system and facilitate continuous lithium extraction.

In various embodiments, the lithium-depleted brine may exit the system continuously through the geothermal brine output 5518. The flow rate of the brine through the system may be optimized to allow sufficient contact time with the membranes (such as the lithium selective membrane 5510 and/or the sodium selective membrane 5514, etc.) for efficient lithium extraction while maintaining a continuous flow.

In various embodiments, the lithium storage electrolyte 5512 may be circulated within its compartment to prevent concentration polarization and maintain efficient lithium uptake. Similarly, the sodium storage electrolyte 5516 may be circulated to ensure a consistent supply of sodium ions for exchange.

In various embodiments, the lithium collection tank 5508 may be used to periodically collect the lithium-enriched electrolyte from the lithium storage electrolyte 5512 (which will be discussed hereinbelow in more detail). In one particular embodiment, this collection process may be performed without interrupting the continuous flow of brine through the system, potentially by using a separate circulation loop or a bleed stream from the lithium storage electrolyte.

In various embodiments, the system may incorporate sensors and/or be connected to a sensors-as-a-service platform to monitor the lithium concentration in various parts of the system, allowing for real-time adjustments to flow rates, applied potentials, or other parameters to optimize continuous lithium extraction efficiency.

In various embodiments, multiple extraction units may be arranged in series or parallel to increase the overall lithium extraction capacity while maintaining continuous operation. This modular approach may allow for scalability and flexibility in system design to accommodate varying brine flow rates and lithium concentrations.

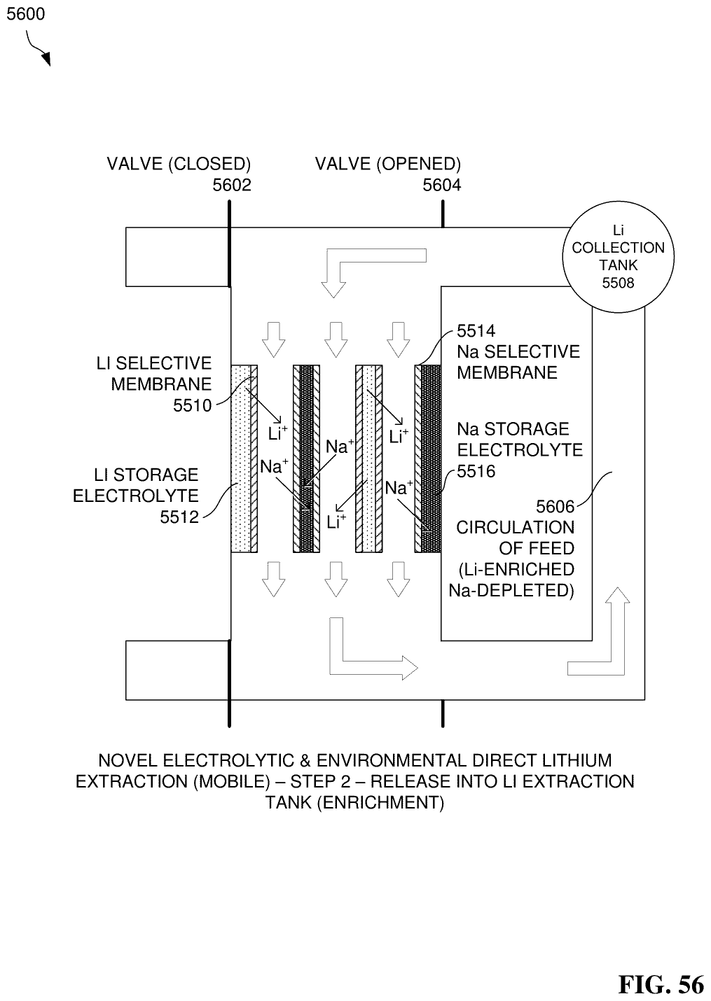

FIG. 56 illustrates a system diagram 5600 of a lithium extraction apparatus during lithium release, in accordance with one embodiment. As an option, the system diagram 5600 may be implemented in the context of any one or more of the embodiments set forth in any previous and/or subsequent Figures and/or description thereof. Of course, however, the system diagram 5600 may be implemented in the context of any desired environment. Further, the aforementioned definitions may equally apply to the description below.

The system diagram 5600 represents a second step building upon the system diagram 5500 of FIG. 55. Here, the system diagram 5600 comprises the lithium collection tank 5508, the lithium selective membrane 5510, the lithium storage electrolyte 5512, the sodium selective membrane 5514, and the sodium storage electrolyte 5516. The system diagram 5600 also includes a closed valve 5602 and an opened valve 5604. These valves may control the flow of solutions within the system. The opened valve 5604 may allow for a feed circulation 5606 of a solution through the system.

The lithium selective membrane 5510 and the sodium selective membrane 5514 may be positioned between the lithium storage electrolyte 5512 and the sodium storage electrolyte 5516. These membranes may facilitate the selective transport of lithium and sodium ions, respectively, consistent with the discussion hereinabove.

In some cases, the system diagram 5600 may show the movement of lithium (Li+) and sodium (Na+) ions through the membranes. Lithium ions may be transported from the lithium storage electrolyte 5512 through the lithium selective membrane 5510, while sodium ions may move from the sodium storage electrolyte 5516 through the sodium selective membrane 5514.

In comparing the system diagram 5600 to the system diagram 5500, it is recognized that the feed solution comprising geothermal brine in 5502 includes a low concentration of lithium ions. After the lithium ions have passed the lithium selective membrane 5510 and have accumulated in the lithium storage electrolyte 5512 (and in like manner the depletion of sodium ions from the sodium storage electrolyte 5516 passing through the sodium selective membrane 5514 back into the geothermal brine out 5518), the system 5500 may be ready for the second step of releasing the extracted lithium. In this manner, the input valves may be closed (via valve (closed) 5602), and the inter-system valves may be opened (via valve (opened) 5604) and the feed (which is lithium enriched and sodium depleted per circulation of feed 5606) may be circulated. In so doing, the lithium ions may be transported from the lithium storage electrolyte 5512 through the lithium selective membrane 5510 to the feed solution, which may coincide with the sodium ions being transported form the feed solution to the sodium storage electrolyte 5516 via the sodium selective membrane 5514. This lithium enriched circulation of feed 5606 may then be passed via the lithium collection tank 5508. In one embodiment, the transporting of lithium ions and sodium ions may be driven via an electric potential (as previously exhibited and discussed in the context of FIG. 54 amongst others).

As such, the system diagram 5600 represents a second component of the novel electrolytic and environmental direct lithium extraction (MOBILE) system.

It is to be appreciated that, consistent with the foregoing disclosure, the lithium selective membrane 5510 and/or sodium selective membrane 5514 may further comprise an anti-fouling layer adjacent to the solid electrolyte layer, and/or a layer of sorbent particles. The anti-fouling layer may be ionically conductive to a preconfigured alkali metal ions and the sorbent particles may absorb such preconfigured alkali metal ions.

In various embodiments, the lithium storage electrolyte 5512 and the sodium storage electrolyte 5516 may each comprise an active material configured to reversibly store electrons. In some cases, the active material in the lithium storage electrolyte 5512 may be selected from the group consisting of Fe(CN)₆^{3-/4-} lithium titanate (LTO), lithium iron phosphate (LFP), and lithium manganese oxide (LMO). The active material in the sodium storage electrolyte 5516 may be selected from the group consisting of Fe(CN)₆^{3-/4-} and Prussian Blue.

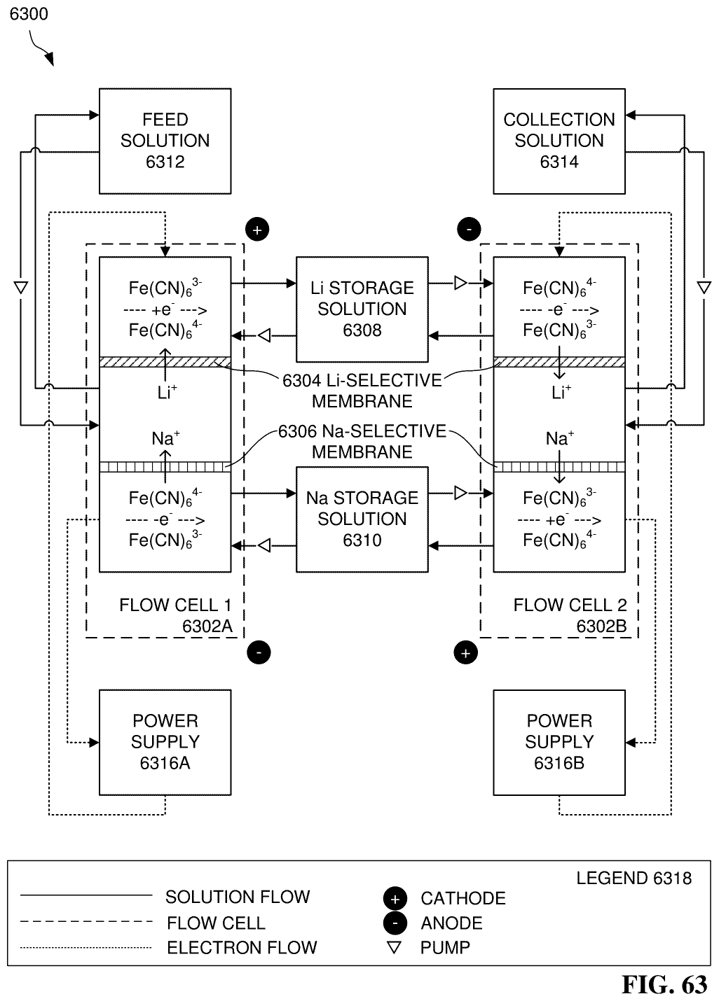

In comparing FIG. 55 and FIG. 56, each of the figures represents two distinct steps for the extraction of lithium, including where the brine is replaced by a second solution in the lithium collection tank 5508 between the two steps. In contrast, and as will be explained in further detail with respect to FIG. 63, the two separate steps (running at two different points in time) may be, in another embodiment, reduced to a single step by having two separate cells. In various embodiments, the flow cell 1 6302A may function in a manner similar to FIG. 55 (in removing lithium from the brine and replacing it with sodium), and the flow cell 2 6302B may function in a manner similar to FIG. 56 (in releasing lithium previously removed from the brine into the new solution while uptaking sodium from the new solution). As such, although FIG. 55 and FIG. 56 are shown herein as two separate steps, it is to be acknowledged that the process shown in FIG. 63 shows a single-step version of this same process. Additionally, as will be discussed later, FIG. 63 may further provide other benefits, including not having to switch solutions in a single compartment, preventing cross-contamination, allowing the process to run continuously, etc.

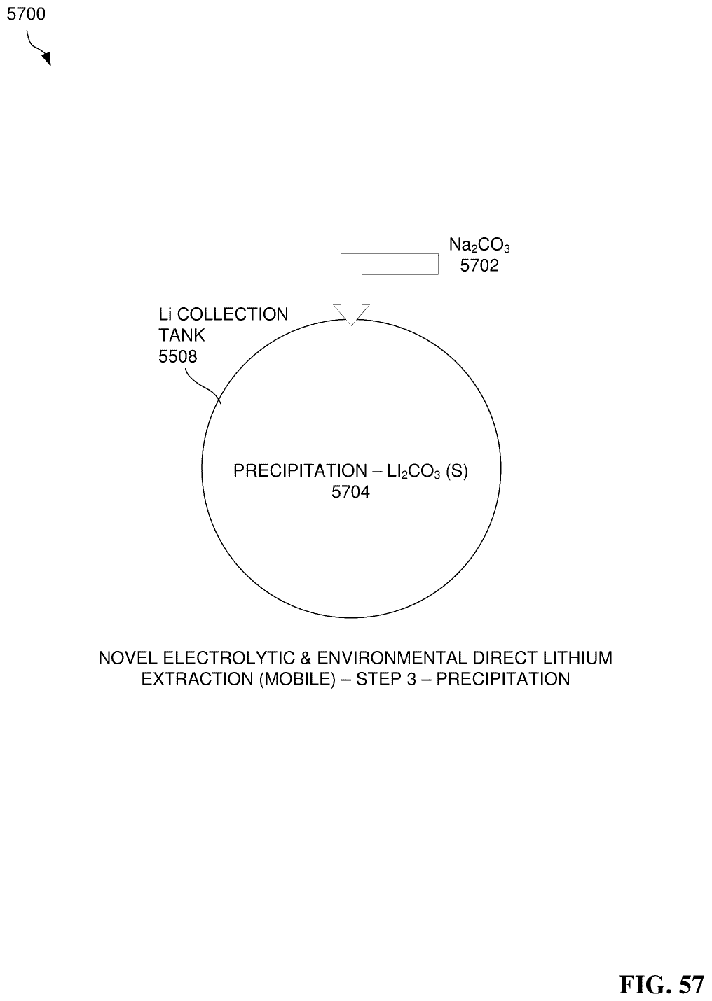

FIG. 57 illustrates a system diagram 5700 for a lithium extraction process during precipitation, in accordance with one embodiment. As an option, the system diagram 5700 may be implemented in the context of any one or more of the embodiments set forth in any previous and/or subsequent Figures and/or description thereof. Of course, however, the system diagram 5700 may be implemented in the context of any desired environment. Further, the aforementioned definitions may equally apply to the description below.

The system diagram 5700 represents a third step building upon the system diagram 5500 of FIG. 55 and the system diagram 5600 of FIG. 56. Here, after the lithium enriched circulation of feed 5606 has passed by the lithium collection tank 5508, the lithium collection tank 5508 may be further configured per the system diagram 5700.

In operation, the precipitation system 5700 comprises the lithium collection tank 5508, a sodium carbonate input 5702, and a precipitation chamber 5704. The lithium collection tank 5508 may contain the lithium-rich solution obtained from previous extraction steps. The sodium carbonate input 5702 may provide Na₂CO₃ to the lithium collection tank 5508. The precipitation chamber 5704 may be where the reaction between the lithium-rich solution and sodium carbonate occurs, resulting in the formation of solid lithium carbonate (Li₂CO₃). As noted hereinabove, the precipitation of lithium may occur by a variety of methods (i.e. condensation precipitation, evaporation, etc.), resulting potentially in a variety of lithium salts.

In some cases, the lithium collection tank 5508 may receive the lithium ions transported through the lithium selective membrane from the MOBILE extractor, as discussed in FIGS. 55 and 56. The lithium collection tank 5508 may comprise a buffer solution configured to maintain a high concentration of carbonate anions. This buffer solution may help to create favorable conditions for the precipitation of lithium carbonate. For example, in one embodiment, a tank may be initially filled with Na₂CO₃, a buffer, and the high pH may allow the carbonate ions to stay as CO₃⁽²⁻⁾, as opposed to its protonated forms (HCO₃⁻ or H₂CO₃) (which may not precipitate lithium). As such, the high pH may assist with the precipitation of the lithium.

In one embodiment, the sodium carbonate input 5702 may be configured to supply a controlled amount of sodium carbonate to the precipitation chamber 5704. In some cases, the amount of sodium carbonate added may correspond to the cumulative total quantity of lithium extracted from the preceding extraction and concentration cycles.

The precipitation chamber 5704 may be where the actual formation of solid lithium carbonate takes place. When the sodium carbonate 5702 is introduced into the lithium-rich solution of the lithium collection tank 5508, the carbonate ions may react with the lithium ions to form lithium carbonate precipitate.

In some cases, the precipitation system 5700 may include additional features to enhance the precipitation process. For example, the precipitation chamber 5704 may be equipped with temperature control mechanisms. Increasing the temperature may decrease the solubility of lithium carbonate, potentially improving the precipitation efficiency.

The precipitation system 5700 may also include mechanisms for agitation or sonication within the precipitation chamber 5704. These mechanisms may help to promote nucleation and growth of lithium carbonate crystals, potentially improving the yield and quality of the precipitated product.

In some cases, the precipitation system 5700 may be designed to operate in a continuous or batch mode, depending on the overall configuration of the MOBILE process. The system may include sensors and control mechanisms to monitor and adjust the precipitation conditions, such as pH, temperature, and reagent concentrations, to optimize the lithium carbonate yield.

The precipitation system 5700 represents the final step in the MOBILE process, where the extracted and concentrated lithium is converted into a solid, easily recoverable form (i.e. a solid precipitate that can be easily recovered, removed, and transported).

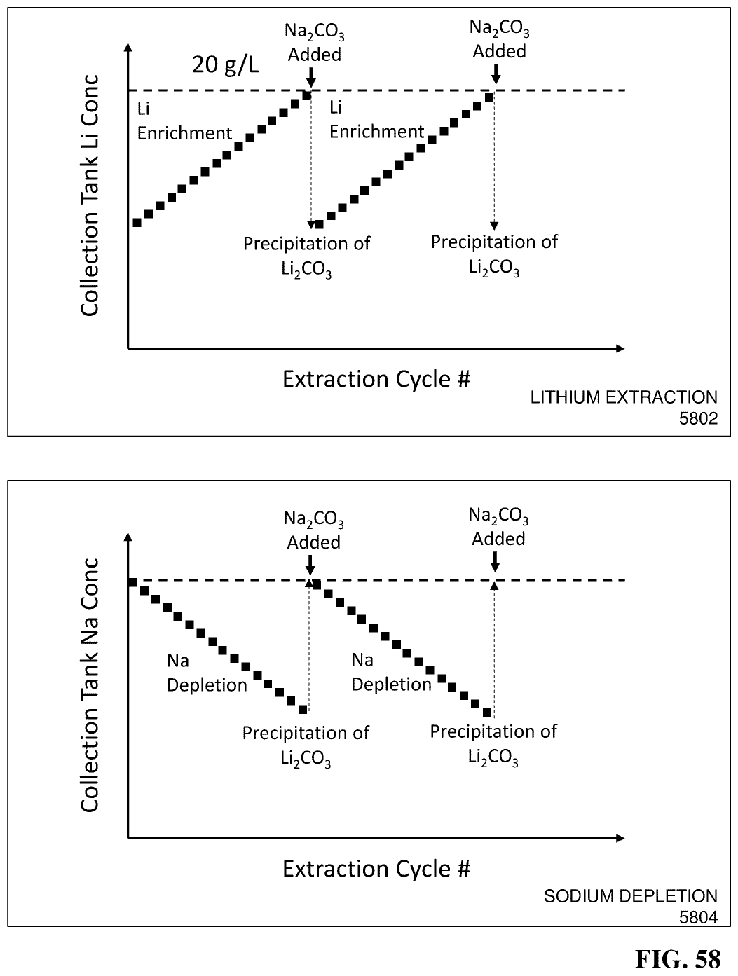

FIG. 58 depicts graphs 5802, 5804 illustrating lithium extraction and sodium depletion cycles, in accordance with one embodiment. As an option, the graphs 5802, 5804 may be implemented in the context of any one or more of the embodiments set forth in any previous and/or subsequent Figures and/or description thereof. Of course, however, the graphs 5802, 5804 may be implemented in the context of any desired environment. Further, the aforementioned definitions may equally apply to the description below.

Graph 5802 shows lithium extraction, where the collection tank lithium concentration increases over extraction cycles until reaching 20 g/L. At this point, Na₂CO₃ may be added, causing precipitation of Li₂CO₃. The process may then repeat for a second cycle. Graph 5804 shows the corresponding sodium depletion in the collection tank. As lithium may be extracted, sodium concentration may decrease. When Na₂CO₃ is added to precipitate Li₂CO₃, the sodium concentration may briefly increase before decreasing again in the next cycle.

In some cases, the lithium concentration in the collection tank may increase steadily over multiple extraction cycles. This increase may continue until the lithium concentration reaches a predetermined level (such as 20 g/L). At this point, sodium carbonate may be added to the collection tank, which may result in the precipitation of lithium carbonate. This precipitation step may cause a sharp decrease in the lithium ion concentration in the collection tank.

Simultaneously, the sodium ion concentration in the collection tank may decrease as the lithium ion concentration increases. This inverse relationship may be due to the exchange of lithium ions for sodium ions during the extraction process. When sodium carbonate is added for lithium carbonate precipitation, a brief spike in sodium concentration may be observed. However, this increase may be temporary, and the sodium concentration may begin to decrease again as the next extraction cycle begins.

The relationship between lithium extraction and sodium depletion, as illustrated in these graphs, may be a key aspect of the novel electrolytic and environmental direct lithium extraction (MOBILE) process discussed hereinabove. By leveraging this ion exchange mechanism, the system may effectively concentrate lithium from dilute feed solutions while managing sodium levels in the process.

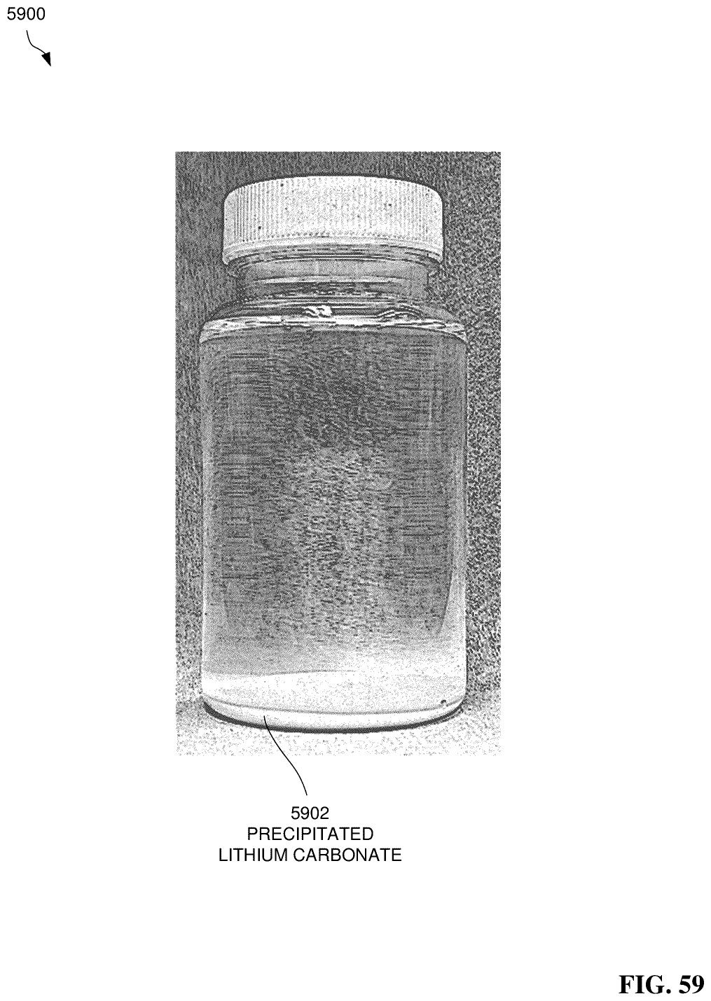

FIG. 59 illustrates an orthogonal view 5900 of a container holding precipitated lithium carbonate, in accordance with one embodiment. As an option, the orthogonal view 5900 may be implemented in the context of any one or more of the embodiments set forth in any previous and/or subsequent Figures and/or description thereof. Of course, however, the orthogonal view 5900 may be implemented in the context of any desired environment. Further, the aforementioned definitions may equally apply to the description below.

As shown, the orthogonal view 5900 shows precipitated lithium carbonate 5902. The precipitated lithium carbonate 5902 may appear as a fine, granular material settled at the base of the container. In some cases, the appearance of the precipitated lithium carbonate 5902 may be indicative of the purity and quality of the final product obtained from the lithium extraction process.

The container 5900 holding the precipitated lithium carbonate 5902 may represent the culmination of the lithium extraction process described in previous embodiments. The precipitated lithium carbonate 5902 may be the result of the reaction between the concentrated lithium ions from the lithium storage electrolyte and the carbonate ions introduced during the precipitation step in the precipitation tank (such as shown in the context of FIG. 57).

In some cases, the precipitated lithium carbonate 5902 may be the final product of the novel electrolytic and environmental direct lithium extraction (MOBILE) process. The presence of the precipitated lithium carbonate 5902 in the container may demonstrate the successful extraction and concentration of lithium from the initial feed solution, such as geothermal brine or recycled lithium-ion battery solutions.

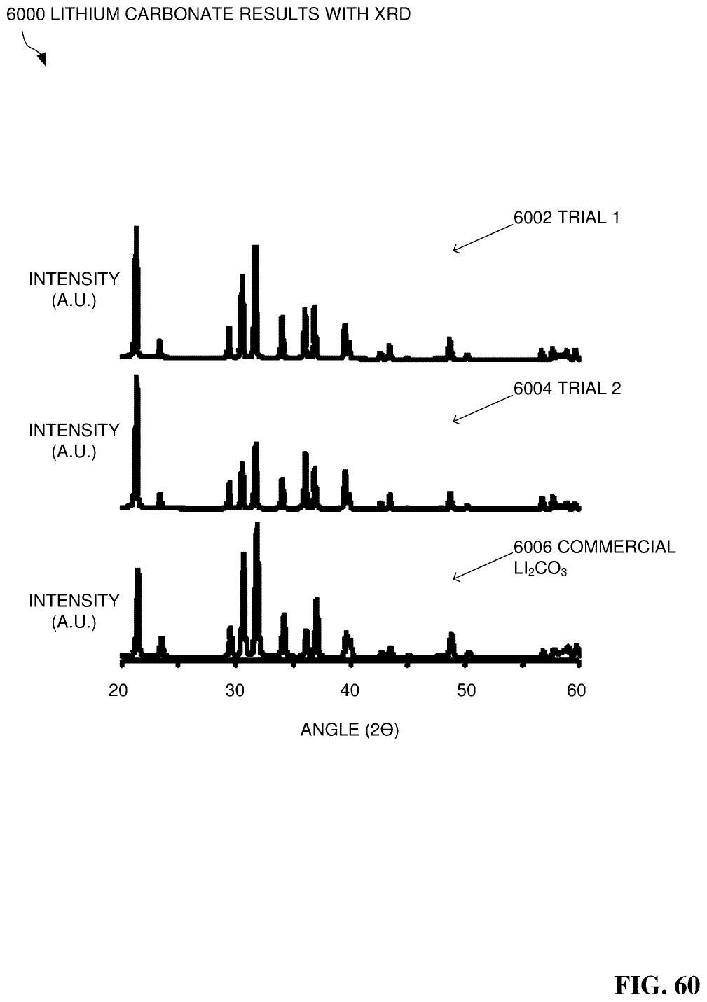

FIG. 60 depicts X-ray diffraction (XRD) results 6000 for lithium carbonate samples, in accordance with one embodiment. As an option, the X-ray diffraction results 6000 may be implemented in the context of any one or more of the embodiments set forth in any previous and/or subsequent Figures and/or description thereof. Of course, however, the X-ray diffraction results 6000 may be implemented in the context of any desired environment. Further, the aforementioned definitions may equally apply to the description below.

The XRD results 6000 comprise trial 1 results 6002, trial 2 results 6004, and commercial Li₂CO₃ results 6006. The trial 1 results 6002 and trial 2 results 6004 may represent the X-ray diffraction patterns of lithium carbonate samples produced using the lithium extraction system described in previous embodiments. The commercial Li₂CO₃ results 6006 may serve as a reference standard for comparison.

In some cases, the trial 1 results 6002 may show a series of peaks at various angles (20). These peaks may correspond to specific crystalline planes within the lithium carbonate structure. The trial 2 results 6004 may exhibit a similar peak pattern to the trial 1 results 6002, suggesting consistency in the crystal structure of the lithium carbonate produced across different extraction runs.

The commercial Li₂CO₃ results 6006 may demonstrate a peak pattern that closely resembles those of the trial 1 results 6002 and trial 2 results 6004. This similarity in peak positions and intensities may suggest that the lithium carbonate produced by the lithium extraction system may have a crystal structure comparable to that of commercial-grade lithium carbonate.

In some cases, the sharpness and intensity of the peaks in the trial 1 results 6002 and trial 2 results 6004 may be indicative of the crystallinity and purity of the produced lithium carbonate. Sharp, well-defined peaks may suggest a high degree of crystallinity, while the absence of additional peaks not present in the commercial Li₂CO₃ results 6006 may indicate a high level of purity.

The consistency between the trial 1 results 6002 and trial 2 results 6004 may demonstrate the reproducibility of the lithium extraction process.

In some cases, the close match between the XRD patterns of the produced lithium carbonate samples and the commercial Li₂CO₃ results 6006 may suggest that the lithium carbonate produced by the lithium extraction system may be suitable for commercial applications. As such, the novel electrolytic and environmental direct lithium extraction (MOBILE) process may be capable of producing high-quality lithium carbonate comparable to existing commercial products.

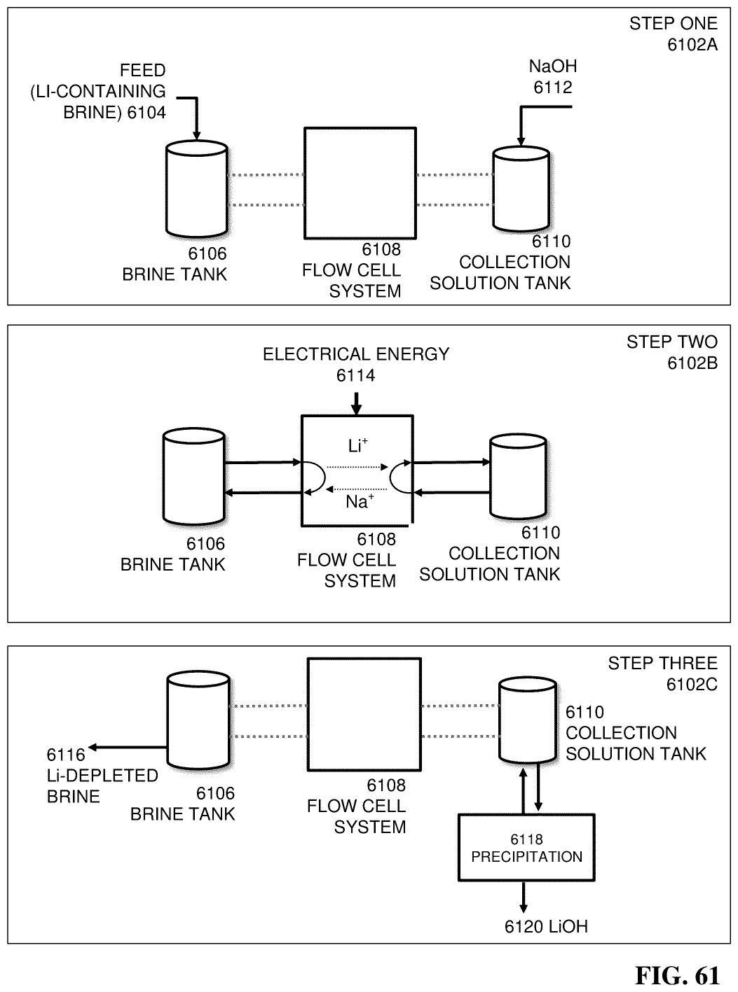

FIG. 61 illustrates steps 6102A, 6102B, 6102C of a system diagram for a lithium extraction process, in accordance with one embodiment. As an option, the steps 6102A, 6102B, 6102C may be implemented in the context of any one or more of the embodiments set forth in any previous and/or subsequent Figures and/or description thereof. Of course, however, the steps 6102A, 6102B, 6102C may be implemented in the context of any desired environment. Further, the aforementioned definitions may equally apply to the description below.

In comparing FIG. 61 to FIG. 54 (as an example), it is recognized that FIG. 61 illustrates a more compact and modular construction of the MOBILE system compared to the overall process depicted in FIG. 54. This modular design allows for an easy-to transport package form that can be more easily deployed and scaled as needed.

In various embodiments, FIG. 61 shows a simplified three-step process (extraction step 6102A, ion exchange step 6102B, and precipitation step 6102C) that incorporates the key elements of the MOBILE system as previously discussed in the context of FIG. 54.

With respect to FIG. 61, the process begins with step one 6102A where a feed brine 6104 is introduced into a brine tank 6106. A flow cell system 6108 may be connected to the brine tank 6106 (but with valves closed represented by the dotted lines) and a collection solution tank 6110 may be connected to the flow cell system 6108 (but with valves closed represented by the dotted lines). At the step 6102A, therefore, li-containing brine feed 6104 is fed into the brine tank 6106.

In various embodiments, NaOH may be used as the sodium-containing feed solution to cause the lithium salt precipitate LiOH. In contrast, and as has been discussed elsewhere, other sodium derivatives (such as Na₂CO₃) may be used to cause the lithium salt precipitate Li₂CO₃. It is recognized that LiOH may have more versatile applicability. As such, therefore, NaOH may be desired to be used to produce LiOH.

At step two 6102B, the valves may be opened between the brine tank 6106 and the flow cell system 6108, and the valves may be additionally opened between the flow cell system 6108 and the collection solution tank 6110. As such, step two 6102B shows the movement of ions between the brine tank 6106 and the collection solution tank 6110 through the flow cell system 6108. Electrical energy 6114 may be supplied to the flow cell system 6108 to facilitate the ion exchange process. In some cases, lithium ions may move from the brine tank 6106 to the collection solution tank 6110, and from the flow cell system 6108 to the collection solution tank 6110, while sodium ions may move in the opposite direction (from the collection solution tank 6110 to the flow cell system 6108 to the brine tank 6106). In one embodiment, an intermediate solution may exist. For example, the lithium may flow from the feed 6104 to a lithium storage solution, then from that lithium storage solution into a collection solution. As such, FIG. 61 may be amended (with additional solutions and/or steps) and represents just one possible process where the flow cell system 6108 is treated like a black box. It is to be understood that the flow cell system 6108 will be described in greater detail hereinbelow (such as seen in FIG. 63 with respect to the feed solution 6312, the collection solution 6314, etc.).

At step three 6102C, the valves between the brine tank 6106 and the flow cell system 6108 may be closed, and the valves between the collection solution tank 6110 and the flow cell system 6108 may be closed. The lithium depleted brine 6116 (which is sodium enriched) may be removed from the brine tank 6106. With respect to the collection solution tank 6110, a precipitation process 6118 may be applied to the collection solution tank 6110, resulting in the production of lithium hydroxide 6120. For purposes of clarity, it is to be understood that the system described herein may be configured to produce any desired lithium salt by using the corresponding sodium salt as the feed.

The flow cell system 6108 may play a central role in all three steps of the process shown in FIG. 61. In some cases, the flow cell system 6108 may incorporate components such as the lithium selective membrane and the sodium selective membrane to facilitate the selective transport of ions between the brine tank 6106 and the collection solution tank 6110, as previously discussed.

The electrical energy 6114 supplied to the flow cell system 6108 may drive the electrochemical processes necessary for lithium extraction. In some cases, this energy input may be optimized to maximize lithium extraction efficiency while minimizing overall energy consumption.

The precipitation process 6118 in the precipitation step 6102C may be similar to the process described in the precipitation system. In some cases, the precipitation process 6118 may involve the addition of specific reagents or the adjustment of solution conditions to promote the formation of solid lithium hydroxide 6120.

The lithium extraction process of FIG. 61 may represent an efficient method for extracting lithium from brine sources. By utilizing a combination of ion exchange and precipitation techniques, the process may enable the production of valuable lithium compounds such as lithium hydroxide 6120. The multi-step nature of the process may allow for optimization at each stage, potentially improving overall lithium recovery rates and product purity.

In various embodiments, the flow cell system 6108 in FIG. 61 represents a modular unit that combines the functions of the novel electrolytic and environmental direct lithium extraction unit (MOBILE) 5402C and associated components shown in FIG. 54. This compact flow cell system may contain both the lithium-selective and sodium-selective membranes, as well as the necessary electrolyte compartments, within a single modular unit.

In various embodiments, the brine tank 6106 and collection solution tank 6110 in FIG. 61 serve similar functions to the geothermal brine 5402A and precipitation tank 5404A in FIG. 54, but are depicted as more compact, integrated components of the modular system. This integration allows for a more self-contained unit that can be easily transported and installed.

In various embodiments, the modular design illustrated in FIG. 61 may allow for easier scaling of the MOBILE system. Multiple modular units could be connected in parallel or series to increase extraction capacity, providing flexibility that may not be as readily achievable with the larger-scale system shown in FIG. 54.

Additionally, in various embodiments, the lithium extraction process illustrated in FIG. 61 may be understood as a three-step MOBILE process, similar to the process described in the provided information. The extraction step 6102A, ion exchange step 6102B, and precipitation step 6102C in FIG. 61 may correspond to the steps outlined in the MOBILE process. In various embodiments, the extraction step 6102A may involve filling the brine tank 6106 with lithium-containing brine, which may be analogous to the feed brine 6104 shown in FIG. 61. Simultaneously, solid sodium hydroxide (NaOH) may be added to an aqueous collection solution in the collection solution tank 6110. This addition of NaOH may help maintain optimal pH conditions for lithium extraction and prepare the collection solution for the subsequent ion exchange process.

In various embodiments, the ion exchange step 6102B may involve circulating both the brine from the brine tank 6106 and the collection solution from the collection solution tank 6110 through the flow cell system 6108. This circulation process may allow for the exchange of ions between the two solutions, facilitated by the electrical energy 6114 supplied to the flow cell system. During this step, lithium ions may be selectively transported from the brine to the collection solution, while sodium ions may move in the opposite direction to maintain charge balance.

In various embodiments, the precipitation step 6102C may occur after the completion of the ion exchange process. The lithium-depleted brine 6116 may be discharged from the brine tank 6106, corresponding to the removal of Li-depleted brine described in the MOBILE process. Simultaneously, a precipitation process 6118 may be initiated in the collection solution tank 6110 to form lithium hydroxide (LiOH). This precipitation may result in the production of solid lithium hydroxide 6120, which can be further processed or used as a valuable lithium product.

In various embodiments, the flow cell system 6108 shown in FIG. 61 may represent a compact, modular version of the MOBILE flow cell system described in the provided information. This modular design may allow for efficient ion exchange between the brine and collection solutions while maintaining a small footprint suitable for containerized deployment.

In various embodiments, the continuous connection between the brine tank 6106, flow cell system 6108, and collection solution tank 6110 throughout all three steps, as depicted in FIG. 61, may emphasize the integrated nature of the MOBILE process. This integration may allow for efficient transfer of solutions and ions between different components of the system, potentially enhancing overall process efficiency.

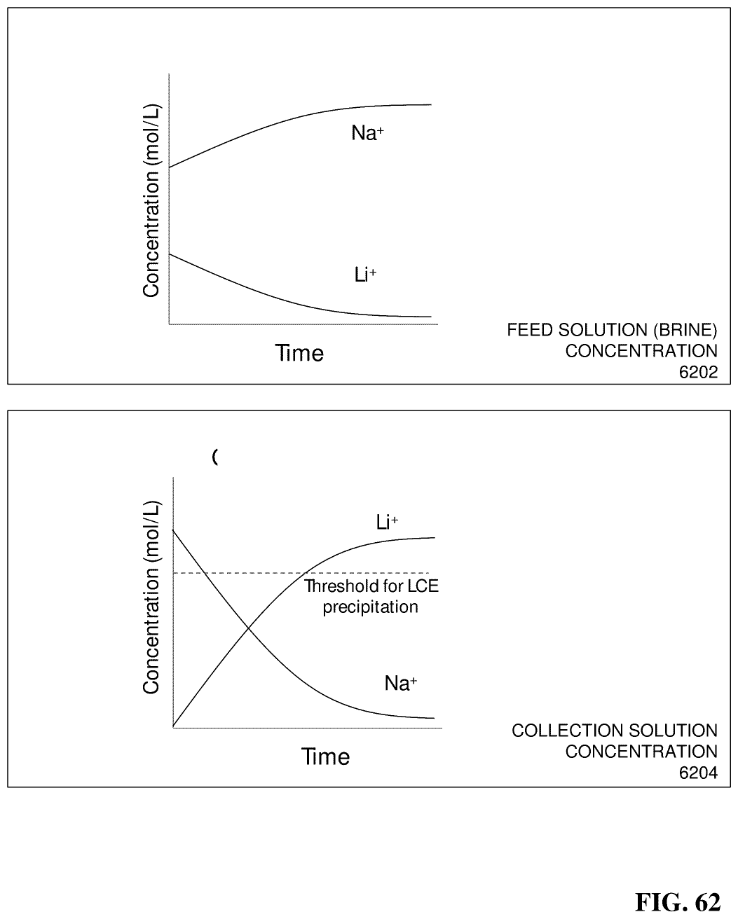

FIG. 62 depicts graphs 6202, 6204 showing concentration changes of lithium and sodium ions over time, in accordance with one embodiment. As an option, the graphs 6202, 6204 may be implemented in the context of any one or more of the embodiments set forth in any previous and/or subsequent Figures and/or description thereof. Of course, however, the graphs 6202, 6204 may be implemented in the context of any desired environment. Further, the aforementioned definitions may equally apply to the description below.

At graph 6202 the feed solution (brine) concentration is illustrated, while graph 6204 displays the collection solution concentration. Both graphs use time as the x-axis and concentration in mol/L as the y-axis.

In the feed solution graph 6202, the sodium ion concentration may increase over time while the lithium ion concentration may decrease. This inverse relationship may indicate that as lithium ions are extracted from the feed solution, sodium ions may replace them to maintain charge balance.

The collection solution graph 6204 shows an opposite trend. The lithium ion concentration may increase over time, while the sodium ion concentration may decrease. A horizontal dashed line may indicate a threshold for lithium carbonate equivalent (LCE) precipitation.

The inverse relationship between sodium and lithium ion concentrations in both solutions may be significant for the extraction process. In some cases, this relationship may demonstrate the selective nature of the extraction system, where lithium ions may be preferentially removed from the feed solution and concentrated in the collection solution. The increasing lithium concentration in the collection solution may indicate the effectiveness of the extraction process. In some cases, as the lithium concentration approaches the threshold for LCE precipitation, the system may be ready for the precipitation step to recover solid lithium carbonate.

In various embodiments, FIG. 62 illustrates the concentration changes of sodium and lithium ions over time in different solutions during the ion exchange process, which may correspond to Step 2 of the MOBILE process. The feed solution graph 6602A and the collection solution graph 6602B provide insights into the dynamics of ion exchange between the two solutions.

In various embodiments, the feed solution graph 6602A may depict the concentration changes of sodium (Na) and lithium (Li) in the feed solution during Step 2 of the process. It's important to note that the concentrations of Na and Li shown in this graph may not be drawn to scale, as the initial concentration of Na in the feed solution is typically orders of magnitude higher than that of Li.

In various embodiments, the feed solution graph 6602A may show a decrease in lithium concentration over time, indicating the extraction of lithium ions from the feed solution. Simultaneously, there may be a slight increase in sodium concentration, although this change may be relatively small compared to the initial sodium concentration due to the typically high initial sodium content in the feed solution.

In various embodiments, the change in sodium concentration in the feed solution over time may be orders of magnitude smaller than the initial concentration of sodium. This relatively small change in sodium concentration, despite the ion exchange process, may be attributed to the significantly higher initial sodium content compared to lithium in typical brine solutions.

FIG. 63 illustrates a system diagram 6300 of a lithium extraction apparatus, in accordance with one embodiment. As an option, the system diagram 6300 may be implemented in the context of any one or more of the embodiments set forth in any previous and/or subsequent Figures and/or description thereof. Of course, however, the system diagram 6300 may be implemented in the context of any desired environment. Further, the aforementioned definitions may equally apply to the description below.

As shown, the system diagram 6300 comprises two flow cells: the flow cell 1 6302A and the flow cell 2 6302B. Each flow cell includes the Li-selective membrane 6304 and the Na-selective membrane 6306. The Li storage solution 6308 and the Na storage solution 6310 are attached to each of flow cell 1 and the flow cell 2.

The feed solution 6312 and the collection solution 6314 flow through the system, interacting with the membranes in each flow cell. In particular, the feed solution 6312 may be provided (via a pump) to the flow cell 1 6302A, and lithium may be extracted from the feed solution via the lithium selective membrane 6304, with sodium replacing the lithium and extracted from an electrolyte solution via a sodium selective membrane. The feed solution may return back from the flow cell 1 to the feed solution 6312. Once the lithium is extracted via the lithium selective membrane 6304, it may be stored via the lithium storage solution 6308. In like manner, sodium may be provided to the flow cell 1 6302A from the sodium storage solution 6310 via a pump.

In similar manner, lithium may be provided from the lithium storage solution 6308 to the flow cell 2 6302B via a pump. Lithium may be extracted at the flow cell 2 6302B via the lithium selective membrane 6304, and sodium at the flow cell 2 6302B may be transported across the sodium selective membrane 6306 and pass to the sodium storage solution 6310 from the flow cell 2 6302B. Extracted lithium at the flow cell 2 6302B may then be transported to the collection solution 6314, and/or returned from the collection solution 6314 to the flow cell 2 6302B via a pump.

In various embodiments, each solution of FIG. 63 may be continuously circulated through each of the flow cell 1 6302A and the flow cell 2 6302B. The residence time for each solution in each the flow cell 1 6302A and the flow cell 2 6302B on a single pass is short (based on a low volume of the flow cell and/or high flow rate) in comparison to the timescale of the process depicted in FIG. 62 (at least for this process). As such, the concentration of each solution at every point in the stream, including within the storage tanks, within the tubing, and within the flow cell, may be assumed to be equal. The solution may be continuously circulated to reduce and/or prevent concentration gradients from forming (which may reduce the efficiency of ion transport in the system). Additionally, it may also provide a way to formulate each solution and send it to the cells in such a way where it can be returned and replaced in a convenient fashion.

In another embodiment, the process depicted in FIG. 63 may be configured such that the residence time of the solution in each of the flow cell 1 6302A and the flow cell 2 6302B is longer such that the the concentration of lithium and/or sodium in the solution entering the cell is different than that exiting the cell. In such an embodiment, the exiting solution may not be returned to the initial tank feeding the cell.

The power supply 1 6316A and the power supply 2 6316B provide electrical energy to drive the ion exchange processes in each of the flow cell 1 6302A and the flow cell 2 6302B.

As shown (via the legend provided), in the system diagram 6300, solid lines represent solution flow, dashed lines indicate flow cell boundaries, and dotted lines show electron flow. Additionally, triangles represent pumps, while + and − symbols denote cathodes and anodes, respectively.

In some cases, the Li-selective membrane 6304 may be similar to the solid electrolyte membrane described in previous embodiments. The Li-selective membrane 6304 may be configured to selectively allow lithium ions to pass through while blocking other ions. The Na-selective membrane 6306 may be designed to selectively transport sodium ions. Additionally, the Li storage solution 6308 and the Na storage solution 6310 may contain active materials capable of reversibly storing electrons.

The lithium extraction system of the system diagram 6300 may operate by circulating the feed solution 6312 and the collection solution 6314 through the flow cells. As the solutions flow through the system, lithium ions may be selectively transported from the feed solution 6312 through the Li-selective membrane 6304 into the Li storage solution 6308. Simultaneously, sodium ions may move from the Na storage solution 6310 through the Na-selective membrane 6306 into the feed solution 6312.

In some cases, the lithium extraction system 6300 may be configured to operate in both continuous flow mode and batch mode. The system may be modular and scalable to accommodate different lithium extraction capacities, allowing for flexible deployment in various environments and easy scaling of production capacity.

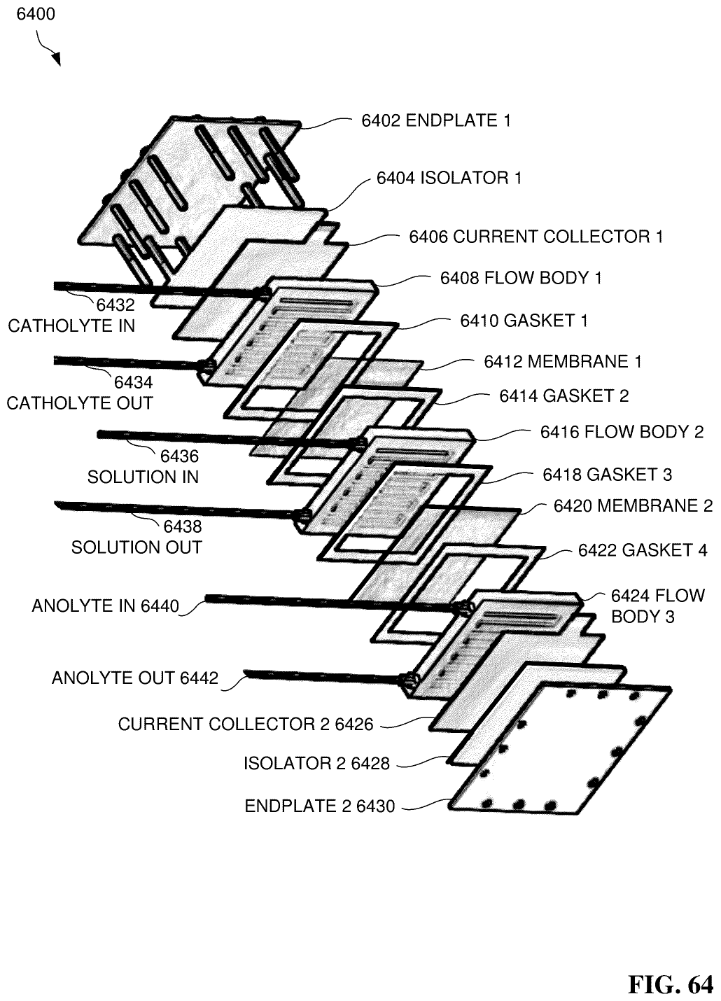

FIG. 64 illustrates an exploded view 6400 of a lithium extraction apparatus, in accordance with one embodiment. As an option, the exploded view 6400 may be implemented in the context of any one or more of the embodiments set forth in any previous and/or subsequent Figures and/or description thereof. Of course, however, the exploded view 6400 may be implemented in the context of any desired environment. Further, the aforementioned definitions may equally apply to the description below.

The exploded view 6400 comprises multiple components arranged in a layered structure. It is to be appreciated that the exploded view 6400 may represented the flow cell system 6108 described in FIG. 61, the flow cell 1 6302A and/or flow cell 2 6302B described in FIG. 63, and/or any other MOBILE flow cell system discussed herein.

With reference to the exploded view 6400, at the top of the structure is an endplate 6402, followed by an isolator 6404 and a current collector 6406. Below these components is a flow body 6408, which is separated from the next layer by a gasket 6410. A membrane 6412 is positioned between the gasket 6410 and another gasket 6414. As discussed herein, the membrane 6412 (as well as other membranes of the exploded view 6400 such as membrane 2 6420) may include an alkali metal ion specific selected membrane. It is to be appreciated that although multiple gaskets are shown in the configuration of FIG. 64, other embodiments may have a non-gasket assembly.

The central portion of the system includes a second flow body 6416, surrounded by gaskets 6414 and 6418, with a second membrane 6420 between the gasket 6418 and 6422. Another flow body 6424 is positioned below the fourth gasket 6422.

At the bottom of the structure are a second current collector 6426, a second isolator 6428, and a second endplate 6430, mirroring the components at the top of the system.

The system includes several inlet and outlet ports for fluid flow. On the left side, there is a catholyte inlet 6432 and a catholyte outlet 6434. In the center, a solution inlet 6436 and a solution outlet 6438 are visible. Further, an anolyte inlet 6440 and an anolyte outlet 6442 are shown.

In some cases, the endplates 6402 and 6430 may provide structural support and help to seal the flow cell system. The isolators 6404 and 6428 may serve to electrically insulate the current collectors 6406 and 6426 from the endplates 6402 and 6430.

The current collectors 6406 and 6426 may be responsible for conducting electrical current to and from the active components of the flow cell. In some cases, the current collectors 6406 and 6426 may be made of a conductive material such as titanium, copper, graphite, etc.

The flow bodies 6408, 6416, and 6424 may provide channels for the flow of various solutions through the system. In some cases, the flow bodies 6408, 6416, and 6424 may be designed with specific flow patterns to optimize the distribution of fluids across the membranes 6412 and 6420.

The gaskets 6410, 6414, 6418, and 6422 may serve to create a seal between the different layers of the flow cell, preventing leakage and ensuring that the fluids flow through the intended channels. In some cases, the gaskets 6410, 6414, 6418, and 6422 may be made of a flexible, chemically resistant material.

The membranes 6412 and 6420 may be key components in the lithium extraction process. In some cases, the membrane 6412 may be a Li-selective membrane and/or a Na-selective membrane, similar to the ion-selective membranes described in previous embodiments.

The catholyte inlet 6432 and catholyte outlet 6434 may allow for the flow of the lithium storage electrolyte through the system. The anolyte inlet 6440 and anolyte outlet 6442 may facilitate the flow of the sodium storage electrolyte. The solution inlet 6436 and solution outlet 6438 may be used for the feed solution or collection solution, depending on the stage of the extraction process.

In some cases, the assembly of these components may create two separate flow chambers within the flow cell system. One chamber may be formed between the membrane 6412 and the flow body 6408, while another may be formed between the membrane 6420 and the flow body 6424. These chambers may allow for the separation and controlled interaction of different solutions during the lithium extraction process.

In various embodiments, flow chambers may be separated by membranes. With respect to the configuration of FIG. 64, the cell depicted may include three separate flow chambers/solution, one for each of the flow bodies. The solution may be contained on either side of the flow body by either a membrane or current collector. The flow body may be hollow and the pattern goes through the entirety of the layer for every flow body.

The layered design of the flow cell system may allow for efficient ion exchange between the different solutions. As the feed solution flows through one chamber, lithium ions may be selectively transported across the membrane 6412 into the lithium storage electrolyte. Simultaneously, sodium ions may be transported from the sodium storage electrolyte across the membrane 6420 into the feed solution.

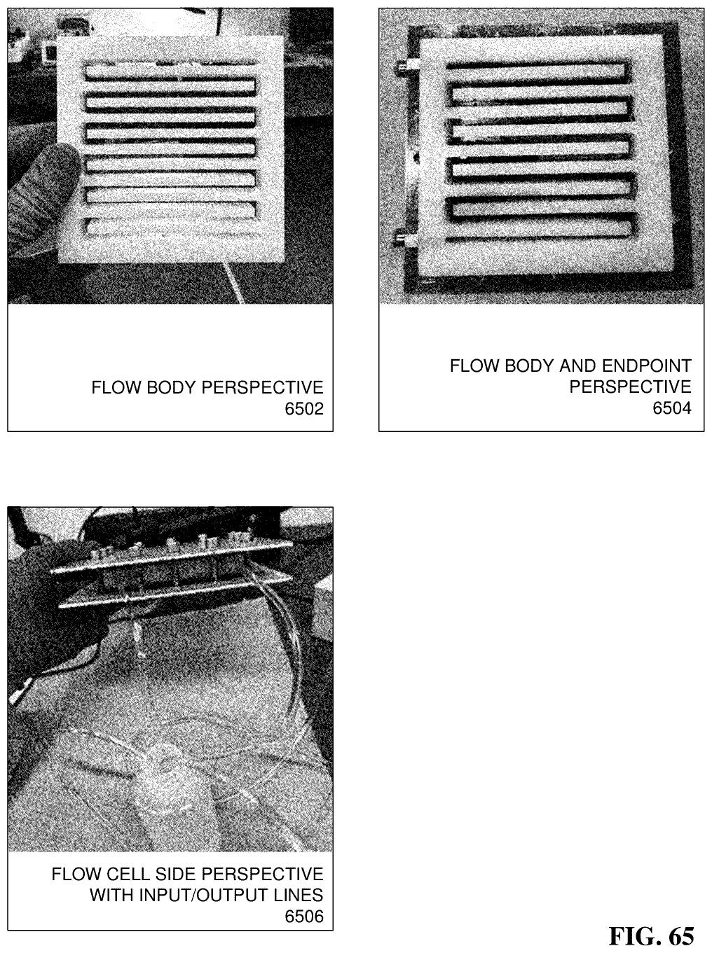

FIG. 65 illustrates perspective views 6502, 6504, 6506 of components of a lithium extraction apparatus, in accordance with one embodiment. As an option, the perspective views 6502, 6504, 6506 may be implemented in the context of any one or more of the embodiments set forth in any previous and/or subsequent Figures and/or description thereof. Of course, however, the perspective views 6502, 6504, 6506 may be implemented in the context of any desired environment. Further, the aforementioned definitions may equally apply to the description below.

The figure includes three separate images showing different views of the system components. A flow body 6502 is shown in the first image, presenting a perspective view of a flow body component. In some cases, the flow body 6502 may be a square-shaped structure with multiple parallel channels or grooves running across its surface. These channels may facilitate the flow of solutions through the system.

A flow body and endpoint 6504 is presented in the second image, showing a similar perspective view of the flow body component, but with additional structural elements visible around the edges. In some cases, the flow body and endpoint 6504 may represent the flow body integrated with endpoint components, providing a more complete assembly perspective.

A flow cell 6506 is displayed in the third image, showing a side perspective view of the assembled flow cell with input/output lines attached. In some cases, the flow cell 6506 may be a multi-layered structure with visible plates or membranes stacked together. Several tubes or lines may be connected to the flow cell 6506, potentially serving as input and output channels for the various solutions involved in the lithium extraction process.

The flow body 6502 and flow body and endpoint 6504 components shown in the first two images may be integrated into the larger flow cell 6506 assembly depicted in the third image. In some cases, these components may work together to form part of the system designed for the electrochemical extraction of lithium from feed solutions.

In various embodiments, the flow cell 6506 may represent the fully assembled unit where the actual lithium extraction process takes place, and may correspond with the flow cell design described hereinabove (in particular reference to FIGS. 61 63, 64, etc.). In some cases, the multi-layered structure of the flow cell 6506 may include the lithium selective membrane and the sodium selective membrane, separated by flow channels created by the flow body 6502. The input/output lines attached to the flow cell 6506 may allow for the circulation of the feed solution, lithium storage electrolyte, and sodium storage electrolyte through their respective chambers within the flow cell 6506. In an alternative embodiment, the flow cell 6506 may represent a flow cell configured expressly for lithium extraction from a brine solution, or a flow cell configured to increase concentration prior to precipitation. As such, the flow cell 6506 may be configured for a particular step in the MOBILE process, and/or may be combined into a single unit (as shown in the context of FIG. 63). It is to be appreciated that lithium extraction process shown in FIG. 65 may include multiple flow bodies (whereas the figure in particular with respect to the flow cell 6506 shows only a single flow cell). A such, the flow cell 6506 is provided merely as an example to show how the faces of the flow body, as well as a possible configuration for circulating the solution through the structure.

In the context of the overall lithium extraction system, the flow cell 6506 may be a critical component where the selective ion exchange occurs. The feed solution may be introduced into the flow cell 6506 through one of the input lines. As the feed solution flows through the channels created by the flow body 6502, lithium ions may be selectively transported across the lithium selective membrane into the lithium storage electrolyte. Simultaneously, sodium ions may be transported from the sodium storage electrolyte across the sodium selective membrane into the feed solution.

In various embodiments, multiple flow cells may be connected in series or parallel to increase the overall capacity of the lithium extraction system. As such, the modular nature of the flow cell(s) may provide flexibility in scaling up the lithium extraction process to meet various production requirements.

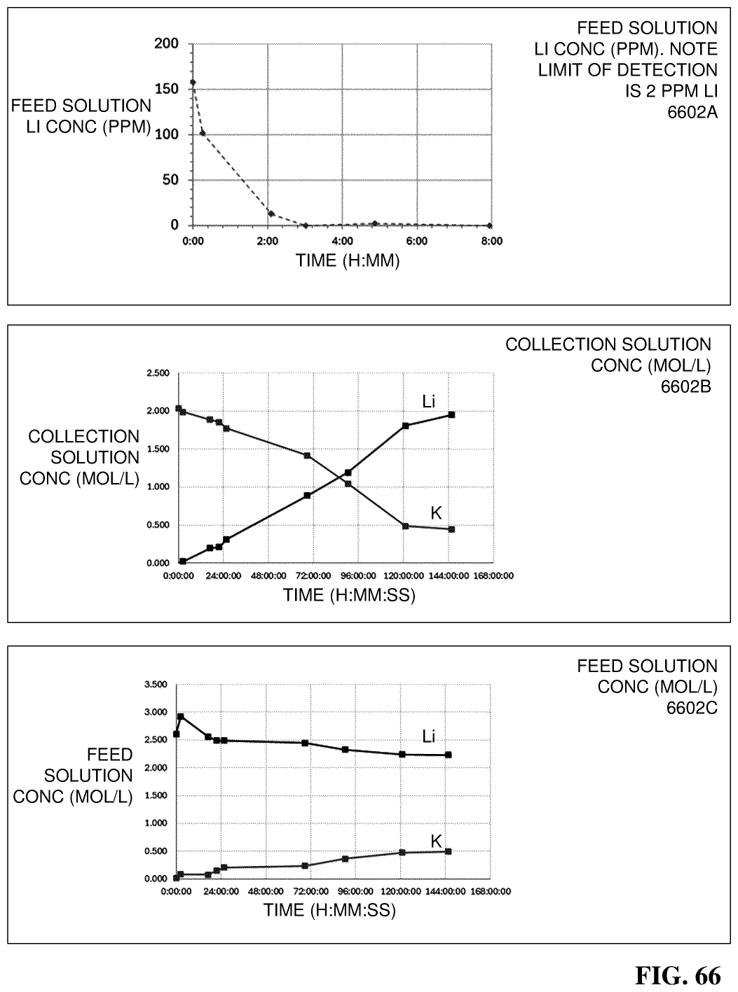

FIG. 66 depicts graphs 6602A, 6602B, 6602C showing concentration changes of lithium and other ions over time, in accordance with one embodiment. As an option, the graphs 6602A, 6602B, 6602C may be implemented in the context of any one or more of the embodiments set forth in any previous and/or subsequent Figures and/or description thereof. Of course, however, the graphs 6602A, 6602B, 6602C may be implemented in the context of any desired environment. Further, the aforementioned definitions may equally apply to the description below.

As shown, the graphs showing concentration changes in different solutions comprise a feed solution graph 6602A, a collection solution graph 6602B, and a feed solution concentration graph 6602C. The feed solution graph 6602A displays the lithium concentration in parts per million (PPM) over a period of 8 hours. The collection solution graph 6602B shows the concentration changes in mol/L for lithium and potassium over a period of approximately 168 hours. The feed solution concentration graph 6602C illustrates the changes in concentration (mol/L) of lithium and potassium in the feed solution over a similar time period of about 168 hours. It is to be understood that the setup conditions for each of the graphs 6602A, 6602B, 6602C may not be identical (in terms of setup and/or solution composition). However, the results may be nonetheless instructive and informative.

In the feed solution graph 6602A, the lithium concentration may decrease rapidly over the 8-hour period. In some cases, a limit of detection is 2 PPM Li. This rapid decrease in lithium concentration may suggest efficient extraction of lithium ions from the feed solution by the lithium extraction system.

The collection solution graph 6602B may show an increase in the concentration of lithium over time, while the concentration of potassium may decrease. In some cases, the increasing concentration of lithium may represent the accumulation of lithium ions in the collection solution, while the decreasing concentration of potassium may correspond to the depletion of sodium ions. This trend may indicate the selective transport of lithium ions from the feed solution to the collection solution, and the simultaneous movement of other ions (such as potassium, sodium, etc.) in the opposite direction.

In various embodiments, the active material Fe(CN)₆ may be commercially available as a potassium salt (e.g. K₃Fe(CN)₆). As such, when the lithium and sodium storage solutions are first prepared, the solutions may filled with potassium ions. In one embodiment, a lithium version of this potassium salt may be used (such as KCl). In an additional embodiment, the process described herein may tolerate potassium impurities better than sodium impurities.

The feed solution concentration graph 6602C may display the changes in concentration of lithium and potassium in the feed solution. In some cases, lithium is shown in a decreasing trend, representing the depletion of lithium ions in the feed solution, while the potassium may exhibit an increasing trend, possibly indicating the accumulation of potassium ions. These trends may further support the selective ion exchange process occurring in the lithium extraction system.

The observed concentration changes in the graphs may provide valuable insights into the dynamics of the lithium extraction process. The rapid decrease in lithium concentration in the feed solution graph 6602A may demonstrate the efficiency of the lithium selective membrane in transporting lithium ions. The simultaneous increase in lithium concentration and decrease in potassium concentration in the collection solution graph 6602B may highlight the selectivity of the extraction process. Further, although FIG. 66 does not display using membranes optimized for lithium and/or potassium selectivity, FIG. 66 may nonetheless be used to demonstrate that the process operates in such a way where the concentration of lithium and the other ion (in this case potassium) trends may follow the depiction shown the context of FIG. 62.

In some cases, the trends observed in these graphs may be used to optimize the operation of the lithium extraction system. For example, the rate of lithium concentration decrease in the feed solution may inform decisions about the optimal duration of the extraction step. Similarly, the rate of lithium concentration increase in the collection solution may guide the timing of the precipitation step to recover lithium carbonate.

As such, the graphs of FIG. 66 may provide quantitative evidence of the effectiveness of the novel electrolytic and environmental direct lithium extraction (MOBILE) process.

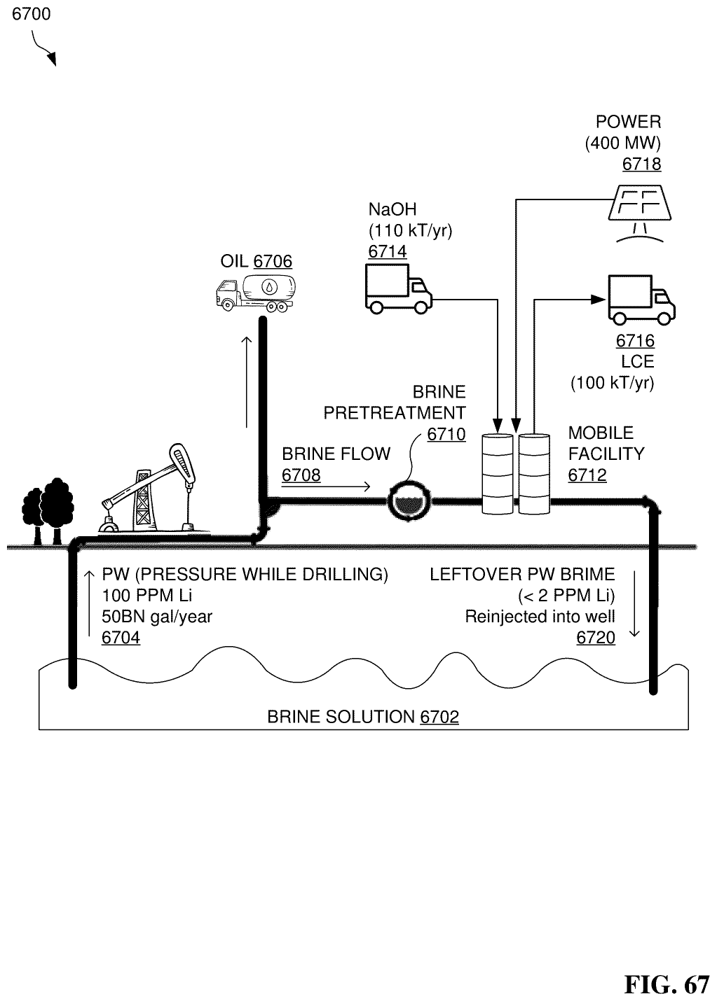

FIG. 67 illustrates a system diagram 6700 of a lithium extraction process, in accordance with one embodiment. As an option, the system diagram 6700 may be implemented in the context of any one or more of the embodiments set forth in any previous and/or subsequent Figures and/or description thereof. Of course, however, the system diagram 6700 may be implemented in the context of any desired environment. Further, the aforementioned definitions may equally apply to the description below.

As shown, the lithium extraction system of the system diagram 6700 comprises a brine solution 6702, pressure while drilling 6704 unit, an oil truck 6706, a brine flow 6708, a brine pretreatment 6710, a MOBILE facility 6712, a sodium hydroxide truck 6714, a lithium carbonate equivalent truck 6716, a power plant 6718, and leftover brine 6720.

In some cases, the brine solution 6702 may be extracted using the pressure while drilling 6704 unit. The pressure while drilling 6704 unit may transport brine with 100 PPM Li at a rate of 50BN gal/year. The extracted brine may flow through the brine flow 6708 to the brine pretreatment 6710.

The oil truck 6706 may be present, indicating the potential for oil extraction operations alongside the lithium extraction process. The sodium hydroxide truck 6714 may supply NaOH (110 kT/yr) to the process, which may be used for pH adjustment or other chemical treatments, and/or used in the precipitation process of lithium (as described, for example, in the context of FIG. 61 with respect to NaOH 6112).

The brine pretreatment 6710 may feed into the MOBILE facility 6712, where the lithium extraction process may take place. In some cases, the MOBILE facility 6712 may produce lithium carbonate equivalent (LCE), which may be transported by the lithium carbonate equivalent truck 6716 at a rate of 100 kT/yr. As such, the MOBILE facility 6712 may represent the site where the MOBILE flow cell systems may be located.

In one embodiment, the power 6718 may show the amount of power that would be consumed by the process. It is recognized that any power consumed may be dependent on all of the operating parameters of the final system (temperature, number of membranes, conductivity, etc.).

The lithium extraction system 6700 may also handle the leftover brine 6720, which may contain less than 2 PPM Li. In some cases, the leftover brine 6720 may be reinjected into the well, potentially completing the cycle and minimizing waste.

The lithium extraction system 6700 may be modular and scalable to accommodate different lithium extraction capacities. In some cases, each unit operation of the lithium extraction system may be contained within a standard shipping container, allowing for easy transportation and scalability. In this manner, the MOBILE facility 6712 may include a shipping container, and be placed on site (next to a brine solution) to collect and process the brine. The oil 6706 and NaOH 6714 may be provided in a modular fashion as needed. In various embodiments, the FIG. 67 may show a process that allows for co-production of lithium from existing oil production processes. This is particularly relevant as existing oil production wells often contain commercially significant quantities of lithium. As such, therefore, the processes disclosed herein may be used to extract lithium in a new and novel manner from these existing oil production streams.

In various embodiments, the lithium extraction system 6700 may be capable of extracting more than 99% of Li from a feed containing 160 ppm of Li. In some cases, the lithium extraction system 6700 may operate at a projected electrochemical energy cost of 1% of the market value of lithium carbonate equivalent. Additionally, in some cases, the lithium extraction system 6700 may electrochemically concentrate Li up to 20 g/L in a matter of hours, significantly reducing processing time compared to traditional methods.

In some embodiments, the lithium extraction system 6700 may be capable of removing Na impurities from Li-containing feedstocks. This multi-functional capability may add to the overall value and efficiency of the lithium extraction system.

The components of the lithium extraction system 6700 may work together to create an interconnected extraction process, from initial brine extraction to final LCE production and waste management. This integrated approach may illustrate the complete lithium extraction workflow, potentially enabling efficient and environmentally responsible lithium production from various sources, such as geothermal brines or recycled lithium-ion batteries.

In one embodiment, TABLE 3 (shown hereinbelow) shows, in particular, possible configurations process parameters, feed stream compositions, product LCE compositions and forms, and OPEX contributions.

TABLE 3

| Parameter | Trial 1 | Trial 2 | Trial 3 | Projected |
|---|---|---|---|---|
| System | MOBILE | Benchtop | Benchtop | Pilot MOBILE |
| | Prototype 1 | MOBILE System | MOBILE System | System |
| | (Figure 6) | (Figure 4) | (Figure 4) | |
| TRL | TRL-2 | TRL-3 | TRL-3 | TRL-6 |
| Completion Date | Q4 2023 | Q2 2024 | Q3 2024 | Q4 2026 (est) |
| Feed Solution | Well brine, Salar | Dilute LiCl | Recycled Li-S | Oilfield PW |
| | del Hombre | Solution | Cells | Brine |
| | Muerto | | | |
| Feed Li Content | 770 ppm | 160 ppm | 18,000 ppm | 100 ppm Li |
| Feed Composition | Na: 100,000 ppm | Na: <1 ppm | Na: <1 ppm | Na: 100,000 |
| | K: 7,000 ppm | K: <1 ppm | K: <1 ppm | ppm |
| | Mg: 1,700 ppm | Mg: <1 ppm | Mg: 1,980 ppm | K: 300 ppm |
| | Ca: 800 ppm | Ca: <1 ppm | Ca: <1 ppm | Mg: 30 ppm |
| | S: 200 ppm | S: <1 ppm | S: 100 ppm | Ca: 100 ppm |
| | B: 700 ppm | B: <1 ppm | B: <1 ppm | SO₄: 30 ppm |
| | HM: n.d. | HM: <1 ppm | HM: <1 ppm | B: 150 ppm |
| | HC: n.d. | HC: <1 ppm | HC: 100 ppm | HM: 20 ppm |
| | TSS: <1 ppm | TSS: <1 ppm | TSS: 7,500 ppm | HC: 1 ppm |
| | TDS: 300,000 | TDS: <1 ppm | TDS: 100,000 | TSS: 20 ppm |
| | ppm | | ppm | TDS: 30,000 |
| | | | | ppm |
| Membrane Type | Ceramic | Polymeric | Polymeric | Polymeric |
| Area per | 3 cm² | 64 cm² | 64 cm² | 4 m² |
| Membrane | | | | |
| Total Membrane | 6 cm² | 256 cm² | 256 cm² | 16 m² |
| Area | | | | |
| LCE Production | 3.1 mg LCE/day | 0.78 g LCE/day | 0.74 g LCE/day | 50 kg LCE/year |
| Rate | | | | |
| Brine/PW | 3 | 750 | 710 | 25,000 |
| Throughput | | | | |
| (gal/year)* | | | | |
| Reactant Costs | Na₂CO₃: $0.51 | Na₂CO₃: $0.51 | K₂CO₃: $1.90 | NaCl: $0.22 or |
| (USD/kg LCE) | | | | NaOH: $0.48 |
| Electrochemical | $0.05/kg LCE | $0.17/kg LCE | $0.16/kg LCE | ≤$2.50/kg LCE |
| Energy Cost | | | | |
| (USD/kg LCE) | | | | |
| Pump Energy Cost | — | $0.01/kg LCE | $0.01/kg LCE | $0.50/kg LCE |
| (USD/kg LCE) | | | | |
| Total OPEX | $0.56 | $0.69 | $2.07 | ≤$4/kg LCE |
| (USD/kg LCE) | | | | |
| Total CAPEX | $200,000 | $2,000 | $2,000 | ≤$30/kg LCE |
| (USD/kg LCE/year) | | | | |
| Li Recovery (%) | — | >99% | — | ≥90% |
| Product LCE Form | Li₂CO₃ (solid) | Li₂CO₃ (solid) | Li₂CO₃ (solid) | LiCl (solid) or |
| | | | | LiOH (solid) |
| Li Purity | 99.4% | 99.3% | 96.7% | 99 - 99.9% |
| Impurities: | Na: 200 ppm | Na: 200 ppm | Na: <l.o.d. | Na: <50 ppm |
| | K: 200 ppm | K: 200 ppm | K: 3.3% | K: <50 ppm |
| | Mg: <l.o.d. | Mg: <l.o.d. | Mg: <l.o.d. | Mg: <10 ppm |
| | Ca: <l.o.d. | Ca: <l.o.d. | Ca: <l.o.d. | Ca: <5 ppm |
| | S: <l.o.d. | S: <l.o.d. | S: <l.o.d. | S: <10 ppm |
| | B: n.d. | B:: n.d. | B: n.d. | B: <10 ppm |

Where:
HM: Heavy metals, includes transition metals, Pb, Hg, Cd, As, lanthanides and actinides
HC: Hydrocarbon content, includes benzene, toluene, and xylenes
TSS: Total suspended solids
TDS: Total dissolved solids
l.o.d.: Limit of detection
n.d.: Not determined
*If used at minimum Li conc in PW provided by Galvanic Energy

In various embodiments, the lithium extraction system 6700 may be configured to fully extract lithium from the process water (PW) in a single pass through the flow body. This configuration may eliminate the need for continuous circulation of the feed solution, potentially simplifying the overall system design and reducing energy consumption associated with pumping. Additionally, the MOBILE facility 6712 may be designed with a series of flow cells optimized for complete lithium extraction in a single pass. This approach may involve carefully engineered membrane configurations and electrode designs within each flow cell to maximize lithium capture efficiency as the brine solution 6702 flows through the system.

In various embodiments, an alternative configuration of the lithium extraction system 6700 may be implemented where only a fraction of lithium is extracted from a single pass through an individual flow cell. In this setup, the brine flow 6708 may be directed through multiple flow cells arranged in series within the noble facility 6712. Additionally, the module of cells within the MOBILE facility 6712 may be designed to gradually reduce the lithium concentration in the brine as it passes through successive flow cells. This sequential extraction approach may allow for more precise control over the extraction process and potentially improve overall system efficiency.

In various embodiments, the series configuration of flow cells may be optimized to achieve the target lithium recovery rate. The number of cells in series and their individual extraction efficiencies may be adjusted based on factors such as the initial lithium concentration in the brine solution 6702, desired final concentration in the leftover brine 6720, and overall system throughput requirements.

In various embodiments, the gradual extraction approach may allow for better management of other ions present in the brine solution 6702. By controlling the extraction rate across multiple cells, the system may be able to maintain a more stable ionic balance, potentially reducing issues related to scaling or fouling of membranes and electrodes.

In various embodiments, the series configuration may provide operational flexibility, allowing for individual flow cells or groups of cells to be bypassed or taken offline for maintenance without completely halting the extraction process. This modular approach may enhance the overall reliability and uptime of the lithium extraction system 6700.

In various embodiments, the lithium extraction system 6700 may incorporate sensors and control systems to monitor the lithium concentration at various points along the series of flow cells. This real-time monitoring may enable dynamic adjustment of operating parameters to maintain optimal extraction efficiency and achieve the desired lithium recovery rate.

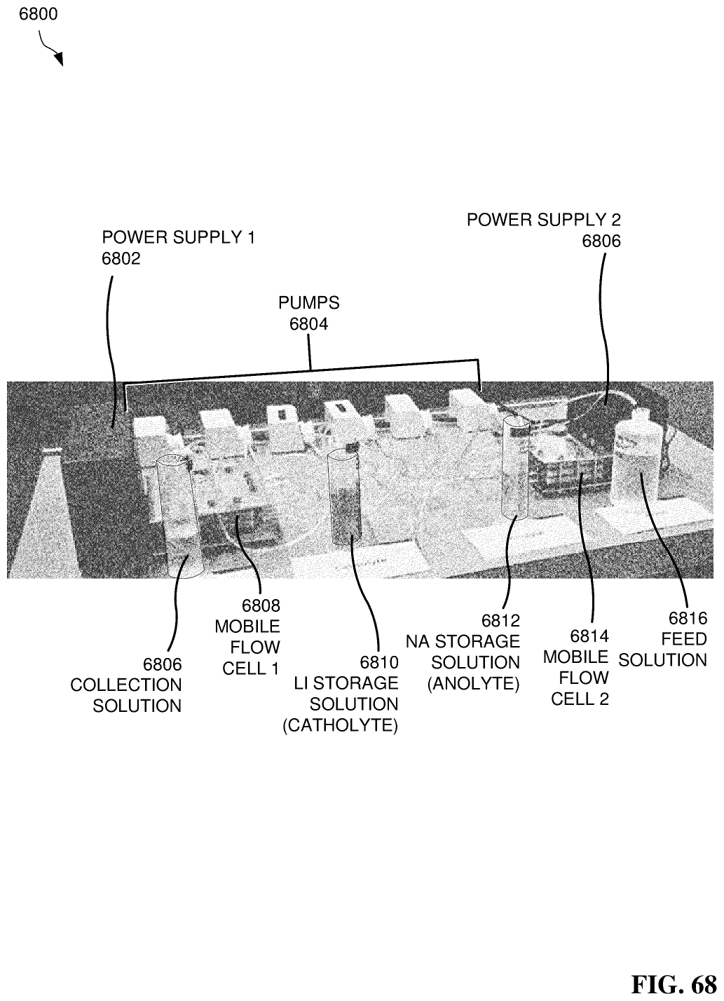

FIG. 68 illustrates a perspective view 6800 of a lithium extraction apparatus, in accordance with one embodiment. As an option, the perspective view 6800 may be implemented in the context of any one or more of the embodiments set forth in any previous and/or subsequent Figures and/or description thereof. Of course, however, the perspective view 6800 may be implemented in the context of any desired environment. Further, the aforementioned definitions may equally apply to the description below.

As shown, the lithium extraction apparatus comprises a power supply 1 6802, pumps 6804, a collection solution 6806, a mobile flow cell 1 6808, a lithium storage solution 6810, a sodium storage solution 6812, a mobile flow cell 2 6814, and a feed solution 6816. The power supply 1 6802 may be positioned at one end of the lithium extraction apparatus. In some cases, a second power supply 2 6806 may be located at another end of the lithium extraction apparatus. The pumps 6804 may be positioned near the center of the lithium extraction apparatus 6800. In one embodiment, each of the power supply 1 6802 and the power supply 2 6806 may be positioned to provide power to each flow cell (such as depicted in the power supply 6316A and the power supply 6316B with respect to the flow cell 1 6302A and the flow cell 2 6302B respectively of FIG. 63).

The mobile flow cell 1 6808 may be connected to the collection solution 6806 and the lithium storage solution 6810. In some cases, the mobile flow cell 1 6808 may contain a lithium selective membrane similar to the lithium selective membrane 5414 described in previous embodiments. The mobile flow cell 2 6814 may be connected to the sodium storage solution 6812 and the feed solution 6816. In some cases, the mobile flow cell 2 6814 may contain a sodium selective membrane similar to the sodium selective membrane 5416 described in previous embodiments.

The collection solution 6806 may be a container for storing the lithium-rich solution produced by the lithium extraction process. In some cases, the collection solution 6806 may be similar to the lithium collection tank 5508 described in previous embodiments. The lithium storage solution 6810 may contain a lithium storage electrolyte, which may be similar to the lithium storage electrolyte 5408 described in previous embodiments. The sodium storage solution 6812 may contain a sodium storage electrolyte, which may be similar to the sodium storage electrolyte 5412 described in previous embodiments.

The feed solution 6816 may be a container for the input brine or other lithium-containing solution. In some cases, the feed solution 6816 may be similar to the geothermal brine 5402A described in previous embodiments.

The components of the lithium extraction apparatus 6800 may work together to extract lithium from the feed solution 6816. The power supply 6802 may provide the electrical energy necessary to drive the ion exchange process in the mobile flow cells 6808 and 6814. The pumps 6804 may circulate the various solutions through the system.

In some cases, the feed solution 6816 may be pumped through the mobile flow cell 2 6814, where lithium ions may be selectively transported through the lithium selective membrane into the lithium storage solution 6810. Simultaneously, sodium ions from the sodium storage solution 6812 may be transported through the sodium selective membrane into the feed solution 6816.

The lithium-enriched solution in the lithium storage solution 6810 may then be pumped through the mobile flow cell 1 6808, where lithium ions may be further concentrated in the collection solution 6806. This process may continue until the desired concentration of lithium is achieved in the collection solution 6806.

The lithium extraction apparatus may represent a compact and modular design for lithium extraction. In some cases, the arrangement of components may allow for efficient use of space and easy maintenance. The mobile nature of the flow cells 6808 and 6814 may provide flexibility in system configuration and operation. In particular, the arrangement of components as illustrated in FIG. 68 represent one small-scale presentation of the MOBILE system disclosed herein. However, it is to be appreciated that a similar arrangement may be achieved but on a larger scale (such as within an entire shipping container, etc.).

In various embodiments, the lithium extraction apparatus of FIG. 68 may be part of a larger lithium extraction system, potentially incorporating additional components such as the brine pretreatment 6710 and the precipitation system 5700 described in previous embodiments. In some cases, multiple lithium extraction apparatus units may be connected in series or parallel to increase the overall lithium extraction capacity.

In some cases, the lithium extraction system may be capable of operating on brines containing very low concentrations of lithium. For example, the lithium extraction system may effectively extract lithium from brines containing as low as 2.65 parts per million (ppm) of lithium. This capability may allow for the utilization of lithium resources that were previously considered economically unfeasible due to their low lithium content.

The sorbent layer of the lithium extraction system may be designed to undergo an equilibration process with the feed solution before the electrochemical operation begins. In some cases, this equilibration process may involve immersing the sorbent layer in the feed solution for a sufficient period of time. During this equilibration, unwanted ions initially present in the sorbent layer may be significantly replaced by the lithium ions from the feed solution. This pre-equilibration step may enhance the efficiency of the subsequent lithium extraction process by ensuring that the sorbent layer is primed with lithium ions.

After a period of operation, the lithium extraction system may require a pause in its operation. In some cases, during this pause, the sorbent layer may undergo a re-equilibration process. This re-equilibration may involve allowing the sorbent layer to interact with the feed solution again, potentially replenishing the lithium ions adsorbed on the sorbent particles. The re-equilibration process may help maintain the efficiency of the lithium extraction system over extended periods of operation.

The ability to operate on low-concentration brines, combined with the equilibration and re-equilibration processes of the sorbent layer, may contribute to the versatility and sustainability of the lithium extraction system. These features may allow for the extraction of lithium from a wider range of sources, potentially including geothermal brines, oil field brines, or other low-grade lithium resources that were previously considered uneconomical. In some cases, this may lead to an expansion of viable lithium resources, contributing to the global supply of this critical element for various industries.

In various embodiments, the MOBILE system may be used to extract lithium from brine solutions. The system may comprise an extractor unit with alternating lithium and sodium storage modules, a lithium collection tank, and a precipitation stage. This process may allow for selective extraction of lithium from low-concentration feed solutions while reducing chemical consumption and minimizing environmental impact.

In various embodiments, the MOBILE system may be capable of extracting lithium from feed solutions containing as low as 2.65 ppm lithium. The system may have a projected electrochemical energy cost on the order of 20% of the market value of lithium carbonate equivalent (LCE). Additionally, the system may be able to electrochemically concentrate lithium up to 20 g/L in a matter of hours instead of months, as required by standard LCE production via solar evaporation. Of course, it is recognized that it is possible to operate such a system at a lower energy cost, but at a lower lithium production rate accordingly.

In various embodiments, the MOBILE system may utilize ion-selective solid electrolyte membranes to electrochemically extract lithium from geothermal brines and recycled lithium-ion batteries. The membranes may be composed of water-stable NASICON-type ceramic electrolytes known to have high charge-transport selectivity for Li⁺ over common ions such as Na+ and Mg2+.

It is to be appreciated that the membrane selected for the MOBILE system may include a ceramic or polymeric material. For example, in various embodiments, the membrane structure may incorporate both ceramic and polymeric components to optimize performance and manufacturability. Additionally, polymeric perfluorosulfonic acid (PFSA) membranes may demonstrate superior resistance to fouling. This fouling resistance may be a crucial factor in maintaining long-term performance and reducing maintenance requirements in lithium extraction systems. Commercial polymer membranes may offer a balance between performance and scalability.

In various embodiments, the membrane may leverage the high lithium selectivity demonstrated by various types of polymer membranes (which may include cation-exchange membranes, polyelectrolyte nanofiltration, etc.). In various embodiments, the membrane may incorporate PFSA materials, which may combine the advantages of fouling resistance with efficient lithium ion transport.

In various embodiments, the membrane design may seek to integrate the beneficial properties of both ceramic and polymeric materials. For example, a composite structure may be developed where a thin ceramic layer provides high lithium selectivity, while a polymeric support layer offers fouling resistance and mechanical stability. This hybrid approach may aim to overcome the limitations of each material while capitalizing on their respective strengths.

In various embodiments, the electrochemical cell of the MOBILE system may consist of two electrodes immersed in separate electrolytes: one configured to reversibly store Li+, and the other configured to reversibly store Na+. Each electrolyte may contain an active material and the alkali metal ion that it is configured to store. The electrochemical cell design may result from the layering of individual electrode modules assembled into a MOBILE Lithium Extractor.

In various embodiments, the MOBILE system may operate in three main steps: extraction, concentration, and precipitation. During extraction, lithium ions may be selectively transported from the brine to the lithium storage electrolyte. In the concentration step, lithium ions may be further concentrated in a collection solution. Finally, in the precipitation step, sodium carbonate may be added to precipitate solid lithium carbonate.

In various embodiments, the MOBILE system may be modular and scalable to accommodate different lithium extraction capacities. Each unit operation may be contained within a standard shipping container, allowing for easy transportation and scalability.

In various embodiments, the flow cell modules may contain intermediate solutions including a lithium storage solution and a sodium storage solution. These intermediate solutions may facilitate the transport of specific ions between the feed solution and collection solution. The lithium and sodium storage solutions may contain active materials such as ferri/ferrocyanide compounds that can be reversibly oxidized and reduced.

In various embodiments, the flow cells may comprise flow bodies made of chemically resistant materials such as HDPE or PTFE. The flow bodies may have patterned channels to enable even distribution of solutions across the membranes. Fittings and tubing made of materials like PVDF and PVC may be used to circulate solutions through the system. In various embodiments, PVDF and/or PVC may be specifically chosen due to their resistance to chemical attack (e.g. from acids, bases, and reducing/oxidizing compounds) and due to their non-stick properties (with similar rationale applied for HDPE and/or PTFE for the flow bodies).

In various embodiments, the system may be operated in either a continuous or stepwise/batch mode. In a stepwise mode, the feed solution may be circulated through the flow cells for a period of time to extract lithium, after which the lithium-enriched collection solution may be removed for further processing. In a continuous mode, fresh feed solution may be continuously introduced as lithium-depleted solution is removed.

In various embodiments, the modular design may allow the system to be scaled by adding additional flow cell modules in parallel. This may enable the lithium extraction capacity to be increased while maintaining the same performance metrics for each individual module. The modular approach may provide flexibility in deploying systems of various sizes.

In various embodiments, additional flow cell pairs may be added to the process (such as in a series configuration). Such a configuration may include causing the brine to enter a first flow cell (similar to the flow cell 6302A) in the first pair of flow cells and exit the first flow cell at a different concentration of lithium (in this case, the residence time would be sufficiently long such that the composition of the inlet to the flow cell differs from that exiting the flow cell). This exiting stream, now with lower lithium (and higher sodium), would then go into a second flow cell (similar to the flow cell 6302A) in a second pair of flow cells. This is repeated until this stream has sufficiently low concentrations of lithium that it may be ready to return to the well. Correspondingly, a collection solution may also flow through a flow cell (similar to the flow cell 6302B) in a first pair of flow cells, exiting that cell with a higher concentration of lithium and lower concentration of sodium compared to when it entered. This stream would then go into the next flow cell (similar to the flow cell 6302B) in the second pair of flow cells. This continues in a manner that mirrors the feed stream (in terms of number of iterations with other pairs of flow cells). Additionally, in such a configuration, the lithium storage solution 6308 and the sodium storage solution 6310 may be provided for each pair of the flow cells (compared to a single storage solution that flows through every flow cell in every pair of flow cells). Further, the flow cell pairs may be added in a combination of series and/or parallel configurations (such as is the case with a battery pack for electric vehicles, etc.).

In various embodiments, a lithium extraction system may include a two-layer membrane configuration comprising a solid electrolyte layer and an anti-fouling layer. The solid electrolyte layer may be configured to be conductive to lithium ions, while the anti-fouling layer may be designed to prevent fouling of the membrane surface by scale-forming minerals or other contaminants in the brine solution.

In various embodiments, the anti-fouling layer may function as a repellent screen, preventing substances from accumulating on the membrane surface. This may be achieved through the use of perfluorinated substances that resist non-covalent interactions, or zwitterionic materials that strongly attract water molecules and block nucleation of contaminants. The anti-fouling layer may be ionically conductive to allow lithium ions to pass through while preventing fouling.

In various embodiments, the system may include a sorbent layer comprising lithium sorbent particles, such as aluminum hydroxide. This sorbent layer may function as an attraction layer, concentrating lithium ions near the solid electrolyte membrane surface. The increased local lithium concentration may enhance the efficiency of lithium extraction by creating a higher fraction of lithium ions available for transport through the membrane when an electric potential is applied.

In various embodiments, the lithium extraction system may be configured as a flow cell, where feed solutions are circulated through the cell while an electric potential is applied. This flow cell design may allow for continuous operation and improved efficiency compared to static configurations. The system may be modular, with individual units capable of producing a set amount of lithium carbonate equivalent per year, allowing for scalable deployment.

In various embodiments, the solid electrolyte membrane may comprise of a single or multiple particles. This solid electrolyte membrane configuration, in combination with the anti-fouling or sorbent layers, may provide performance that meets or exceeds that of traditional systems.

In various embodiments, the lithium extraction system may incorporate both lithium-selective and sodium-selective membranes. While the lithium-selective membrane may be used for extracting lithium from the brine, the sodium-selective membrane may facilitate the exchange of sodium ions to maintain charge balance in the system. Both membranes may benefit from anti-fouling layers to prevent degradation and maintain performance over time.

In various embodiments, the MOBILE system may incorporate a protective coating on the solid electrolyte membranes to prevent fouling and enhance longevity.

In various embodiments, the system may utilize computational modeling to optimize the composition of the solid electrolyte membranes. This may involve screening various dopants for LAGP/LATP materials, mapping interstitial network energy landscapes to highlight diffusion mechanisms, and examining the selectivity of various ions through the chosen membrane compositions.

In various embodiments, the MOBILE system may incorporate active materials in the electrode modules that are specifically selected for their electrochemical stability in water, cost-effectiveness, and long-term durability. These materials may be screened and evaluated in small-scale prototype systems before being implemented in the full MOBILE extractor.

In various embodiments, the system may be designed to operate effectively on a wide range of feed solutions, including geothermal brines, oilfield produced waters, and solutions derived from recycled lithium-ion batteries. This versatility may allow for the extraction of lithium from various domestic resources that were previously considered economically unfeasible.

In various embodiments, the system may be designed with energy reclamation features, allowing for the recovery of a portion of the input energy used for lithium extraction. This energy efficiency may contribute to reducing the overall carbon footprint of the lithium production process.

In various embodiments, the MOBILE system may incorporate in-situ monitoring capabilities to assess the performance and integrity of the solid electrolyte membranes during operation. This may include the use of advanced characterization techniques (such as X-ray diffraction) to track changes in the crystallographic properties of the membranes over time. Further, the MOBILE system may include sensors (based on carbonaceous growth) designed to provide live feedback of the state of the membrane and/or MOBILE components.

In various embodiments, the DLE technology may employ a modular design where each unit operation is contained within a standard shipping container. This modular approach may allow for flexible deployment and scalability of the lithium extraction system. In various embodiments, a container-sized module may be capable of processing approximately 1 million gallons of Process Water (PW) annually. This standardized processing capacity may enable straightforward scaling of the system to meet various target PW processing throughputs.

In various embodiments, the desired PW processing capacity may be achieved by deploying and operating the appropriate number of container modules in parallel. This parallel operation of modular units may provide a high degree of flexibility in system design and implementation. In various embodiments, the modular container-based design may eliminate the need for extensive onsite fabrication and complex logistics typically associated with large-scale facilities. This advantage may be particularly beneficial for deployment in remote areas where traditional construction and logistics may be challenging.

In various embodiments, the system may be designed to operate effectively on domestic PW brines with lithium concentrations exceeding 100 ppm, which falls well within the operable range for the MOBILE technology. This capability may allow for efficient extraction of lithium from various domestic brine sources. In various embodiments, at a lithium concentration of 100 ppm, a single module may be capable of producing approximately 2 tonnes of lithium carbonate equivalent (LCE) per year. This production rate may provide a basis for estimating the overall system capacity and scaling requirements.

In various embodiments, a collection of MOBILE facilities deployed across the United States, with a combined footprint of approximately 3 km2, may have the potential to satisfy the entire domestic lithium demand projected for 2030. This large-scale deployment may significantly contribute to domestic lithium production capabilities.

In various embodiments, the MOBILE technology may align with the Department of Energy's goals to develop novel Direct Lithium Extraction (DLE) technologies. These technologies may aim to decrease reliance on foreign entities for critical minerals and make use of untapped domestic lithium resources.

In various embodiments, the MOBILE system may be designed to extract lithium from domestic resources in an environmentally responsible manner. This approach may contribute to sustainable development of lithium resources while minimizing environmental impacts.

In various embodiments, the lithium extraction system may incorporate principles from the chloralkali process, which may be used for producing sodium hydroxide (NaOH). In various embodiments, the system may consist of multiple independent modules, each capable of producing lithium compounds or processing brine solutions. This modular approach may allow for even distribution of current through each module, potentially optimizing energy efficiency and process control. The ability to operate modules independently may also facilitate ease of maintenance, as individual modules could be taken offline for servicing without affecting the entire system's operation.

In various embodiments, the modular design may enhance the scalability of the lithium extraction plant. This flexibility may allow the facility to adapt quickly to changes in demand for lithium carbonate equivalent (LCE) or fluctuations in the supply of process water (PW). The ability to add or remove modules as needed may provide a cost-effective way to adjust production capacity in response to market conditions.

In various embodiments, the lithium extraction system may incorporate electrosorption techniques. Electrosorption may utilize an electric field to drive lithium ions onto charged electrode surfaces, where they can be selectively adsorbed. This process may offer high selectivity for lithium ions and the potential for efficient desorption and recovery of the extracted lithium. In various embodiments, the system disclosed herein may integrate electrodialysis principles to enhance lithium separation efficiency. Electrodialysis may employ ion-selective membranes under an electric field to transport lithium ions selectively, separating them from other ions in the solution. This approach may complement other extraction methods disclosed herein.

In various embodiments, the lithium extraction system may be designed to scale from pilot to industrial-scale operations, drawing inspiration from mature electrosorption and electrodialysis processes. For example, the system may incorporate electrode stacks similar to those used in pilot-scale electrosorption systems utilizing λ-MnO2/Ag electrodes. This configuration may offer efficient lithium adsorption and desorption capabilities while maintaining a compact form factor. In various embodiments, the system may adopt design elements from industrial-scale rocking-chair electrosorption systems.

In various embodiments, the lithium extraction facility may utilize electrodialysis stack modules. These modules may be arranged to process high volumes of brine efficiently, potentially enabling annual production capacities of thousands of tonnes of lithium carbonate. The modular nature of these electrodialysis stacks may allow for flexible scaling of production capacity to meet varying demand.

In various embodiments, the MOBILE module design may involve scaling up the bench-scale pair of flow cells to dimensions that fit within a standard shipping container. This scaling approach may allow for efficient transportation and deployment of the lithium extraction system to various locations while maintaining the core functionality of the original design.

In various embodiments, each scaled-up flow cell pair may be engineered to process approximately 25,000 gallons of process water (PW) annually. This processing capacity may serve as the fundamental unit for constructing larger extraction systems, providing a modular basis for expansion tailored to specific site requirements and lithium extraction needs.

In various embodiments, a MOBILE module may be comprised of a stack of 40 pairs (or any preconfigured number) of flow cells grouped together. This configuration may enable a combined throughput of 1 million gallons of PW per year for each module. The stacking of multiple flow cell pairs within a single module may optimize space utilization, increase overall system efficiency, and potentially reduce the footprint of the extraction system.

In various embodiments, the entire MOBILE module, including the stack of 40 flow cell pairs and associated components, may be designed to fit within a standard shipping container. This containerized design may facilitate easy transportation, rapid deployment, and simplified installation at the extraction site. The use of standard containers may also allow for cost-effective shipping and handling of the modules, potentially reducing logistical challenges associated with system deployment.

In various embodiments, the MOBILE system may be designed for parallel operation of multiple modules, drawing inspiration from the approach used in chloralkali cells. Once delivered to the extraction site, individual MOBILE modules may be connected in parallel to achieve the desired PW processing capacity. This parallel configuration may allow for flexible scaling of the extraction system to meet varying production requirements and adapt to different brine compositions or lithium concentrations.

In various embodiments, the modular and containerized design of the MOBILE system may enable rapid expansion or contraction of processing capacity. Additional modules could be easily added to increase throughput, or individual modules could be removed or deactivated to reduce capacity, providing adaptability to changing market demands, brine availability, or environmental conditions at the extraction site.

In various embodiments, the proposed project may aim to construct and validate a flow cell pair (such as described for the MOBILE deployment hereinabove). This flow cell pair may represent the fundamental building block of the MOBILE module, serving as a crucial step in validating the technology before proceeding with further scale-up efforts. For example, initial results may have demonstrated the potential of the MOBILE technology to achieve high lithium throughput, excellent lithium selectivity, low operating costs, and efficient lithium recovery from dilute streams.

In various embodiments, as has been discussed, electrolyte membranes disclosed herein may demonstrate strong resistance to fouling. This development may be crucial for addressing the challenges posed by oilfield brines, which are often highly saline and contain scale-forming substances and particulate matter, including divalent ions (Mg2+, Ca2+, Ba2+, SO42-, CO32-) and dissolved silicates. In various embodiments, the MOBILE reactor components that come into contact with the brine may be designed using anti-fouling materials. This approach may be essential for maintaining the efficiency and longevity of the system when processing complex brine compositions typically found in sub-surface reservoirs worldwide.

In various embodiments, the development of polymer and composite membranes may be used as an alternative to ceramic membranes. In various embodiments, the membrane development process may aim to create anti-fouling membranes that are both conductive for lithium ions and resistant to fouling by substances present in the process water (PW).

In various embodiments, the membrane may include carbon-based membranes, zwitterionic/superhydrophilic membranes, fluoropolymer membranes, and/or other carbon-based membrane variations. These different membrane types may offer unique properties that could enhance fouling resistance while maintaining the necessary lithium ion conductivity.

In various embodiments, the membrane fabrication process may involve casting a pre-polymer solution or slurry into a film using a slip table. The membranes may undergo drying and potential post-processing steps, such as thermal treatment or UV curing, to achieve the desired properties.

In various embodiments, continuous operation tests may be conducted, with EIS measurements taken over time to assess changes in permeability due to fouling. Post-operation analysis may include optical imaging and SEM/EDS imaging to observe changes in membrane morphology and identify any buildup of scale or other foulants on the membrane surface.

In various embodiments, the anti-fouling membranes developed in this process may be used in flow cells upstream of the main lithium extraction process, prior to the selective removal of lithium using Li-selective membranes. In various embodiments, the anti-fouling membranes may be used in combination with Li-selective membranes, either as part of a dual-layer approach or by incorporating elements of the non-fouling membrane into the Li-selective membranes.

In various embodiments, the lithium extraction system may be configured to use a chloride (Cl—) selective membrane in place of the sodium (Na+) selective membrane. This alternative configuration may offer unique advantages in certain operational scenarios or feed solution compositions. For example, the flow of ions across the membranes may be altered to accommodate the use of Cl— selective membranes. Specifically, wherever Na+ ions were previously shown to flow across a membrane in the figures, Cl— ions may be used to flow across the same membrane but in the opposite direction. This reversal of ion flow may still enable the balance of charge within the system, maintaining the electrochemical equilibrium necessary for efficient lithium extraction. In various embodiments, all Na+ selective membranes in the system may be replaced by Cl— selective membranes. These Cl-selective membranes may also be referred to as “anion exchange membranes” in the context of the extraction system. The choice of Cl— as the second ion for this configuration may be based on its prevalence among anions in typical feed solutions, similar to the rationale for choosing Na+ in the original design.

In various embodiments, the use of Cl— selective membranes may eliminate the need for a sodium salt input in the process. However, this configuration may result in the production of lithium chloride (LiCl) instead of other lithium compounds. Consequently, additional process steps may be required to convert the LiCl into lithium hydroxide (LiOH) or other desired lithium salts.

In various embodiments, the conversion of LiCl to LiOH may be accomplished through a process analogous to the chloralkali process (which may be used to produce sodium hydroxide (NaOH) from sodium chloride (NaCl)). This additional conversion step may introduce new considerations for system design and operation, potentially affecting overall process efficiency and economics.

In various embodiments, the choice between Na+ selective and Cl— selective membrane configurations may depend on factors such as the composition of the feed solution, desired end products, and overall process integration. The flexibility to utilize either configuration may enhance the adaptability of the lithium extraction system to various operational requirements and feed solution characteristics. Additionally, the use of Cl— selective membranes may offer advantages in scenarios where the feed solution has a high chloride content or where the production of LiCl as an intermediate product is preferred. This configuration may also provide opportunities for integration with existing chloralkali processes in industrial settings where such infrastructure is already in place.

In various embodiments, the system may be designed with the capability to switch between Na+ selective and Cl— selective membrane configurations. This adaptability may allow operators to optimize the extraction process based on changing feed solution compositions or market demands for different lithium compounds.

The foregoing discussion, as it relates to selecting Cl— rather than Na+ emphasizes the flexibility of the MOBILE process. It is acknowledged that other ions and elements may be used to achieve the same function (of causing extraction of a preselected alkali metal ion such as lithium). Thus, it is to be appreciated that other alterations to the ions used and described herein are envisioned.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A green flow cell system, comprising:
a first cation-selective membrane with a first selectivity;
a second cation-selective membrane with a second selectivity, wherein the second selectivity differs from the first selectivity; and
a power supply, wherein the power supply is configured to transport two or more ions based on the first cation-selective membrane and the second cation-selective membrane.

2. The green flow cell system of claim 1, wherein the system is green in terms of power consumption by utilizing less than 10% of a market value of extracted ions for energy costs.

3. The green flow cell system of claim 1, wherein the system is configured for continuous flow operation.

4. The green flow cell system of claim 1, wherein the system further comprises a first cell, wherein the first cell is configured to extract a first predetermined ion.

5. The green flow cell system of claim 4, wherein at least one of:
the first cell is configured to increase a concentration of the first predetermined ion;
the first cell is configured to decrease a concentration of the first predetermined ion;
the first cell is configured to increase the concentration of the first predetermined ion in a first solution and simultaneously decrease the concentration of the first predetermined ion in a second solution; or
the first cell is configured to increase the concentration of the first predetermined ion and simultaneously decrease the concentration of a second ion.

6. The green flow cell system of claim 1, wherein each of the first selectivity and the second selectivity is for a specific ion relative to one or more different ions.

7. The green flow cell system of claim 1, wherein the power supply is configured to provide electrical energy during active operation of the system or the power supply is a charge storage device configured to store electrical energy.

8. The green flow cell system of claim 4, wherein the system further comprises a second cell, wherein the second cell is configured to extract a second predetermined ion.

9. The green flow cell system of claim 8, wherein at least one of:
the second cell is configured to increase a concentration of the second predetermined ion;
the second cell is configured to decrease a concentration of the second predetermined ion;
the second cell is configured to increase the concentration of the second predetermined ion in a third solution and simultaneously decrease the concentration of the second predetermined ion in a fourth solution; or
the second cell is configured to increase the concentration of the second predetermined ion and simultaneously decrease the concentration of the first predetermined ion.

10. The green flow cell system of claim 1, wherein:
the system comprises a plurality of flow cells arranged in a cascading configuration; and
each flow cell in the cascading configuration is optimized for extracting a specific ion species based on the selectivity of its cation-selective membranes.

11. The green flow cell system of claim 1, wherein:
the power supply includes a regenerative braking system to capture and store energy during ion reclamation processes; and
the stored energy is utilized to power subsequent ion extraction cycles.

12. The green flow cell system of claim 4, wherein the first cell and a second cell are configured to increase concentration of the first predetermined ion simultaneously with a decrease of a second predetermined ion.

13. The green flow cell system of claim 4, wherein the first cell and a second cell are configured to decrease concentration of the first predetermined ion simultaneously with an increase of a second predetermined ion.

14. The green flow cell system of claim 8, wherein the first predetermined ion is the same as the second predetermined ion.

15. The green flow cell system of claim 8, wherein the first predetermined ion differs from the second predetermined ion.

16. The green flow cell system of claim 1, wherein the power supply is configured to recover at least 50% of the energy used for ion extraction during ion reclamation.

17. The green flow cell system of claim 1, wherein the system comprises a plurality of flow cells arranged in series.

18. The green flow cell system of claim 1, wherein the system comprises a plurality of flow cells arranged in parallel.

19. The green flow cell system of claim 1, wherein at least one of the first cation-selective membrane or the second cation-selective membrane comprises a solid electrolyte material.

20. The green flow cell system of claim 1, further comprising at least one anionic selective membrane.

21. The green flow cell system of claim 1, wherein the two or more ions comprise lithium ions and sodium ions.

22. The green flow cell system of claim 1, further comprising a feed solution inlet and a processed solution outlet.

23. The green flow cell system of claim 1, wherein the system is modular and scalable to accommodate different ion extraction capacities.

24. The green flow cell system of claim 1, further comprising a precipitation tank for recovering extracted ions in solid form.

25. The green flow cell system of claim 1, wherein the system is configured to extract ions from a feed solution containing less than 200 ppm of a preselected target ion.

26. The green flow cell system of claim 1, wherein the system is contained within a standardized shipping container for easy transportation and deployment.

27. The green flow cell system of claim 1, wherein the power supply is configured to:
dynamically adjust its output based on real-time ion concentration measurements, and
optimizing energy consumption during both extraction phase and reclamation phase.

28. The green flow cell system of claim 1, further comprising a dual-function electrode system configured to reversibly switch between anodic and cathodic operations, wherein the dual-function electrode system is configured for bidirectional ion transportation across each of the first cation-selective membrane and the second cation-selective membrane without requiring physical reconfiguration of the system.

29. The green flow cell system of claim 1, wherein the system incorporates a cascading energy transfer mechanism that utilizes the energy released during reclamation of one ion species to at least partially power extraction of another ion species.

30. The green flow cell system of claim 1, wherein each of the first cation-selective membrane and the second cation-selective membrane are configured with a gradient structure comprising multiple layers of varying ion selectivity and conductivity for simultaneous extraction of different ion species.
